(19) United States
(12) Patent Application Publication
(10) Pub. No.: US 2014/0162980 A1
(43) Pub. Date: Jun. 12, 2014

(54) NOVEL MICROBIOCIDAL DIOXIME ETHER DERIVATIVES

(71) Applicants: Daniel Stierli, Stein (CH); Kurt Nebel, Stein (CH); Werner Zambach, Stein (CH); Andrea Bortolato, Stein (CH)

(72) Inventors: Daniel Stierli, Stein (CH); Kurt Nebel, Stein (CH); Werner Zambach, Stein (CH); Andrea Bortolato, Stein (CH)

(73) Assignee: SYNGENTA CROP PROTECTION LLC, Greensboro (US)

(21) Appl. No.: 13/813,131

(22) PCT Filed: Jul. 28, 2011
(86) PCT No.: PCT/EP2011/063018

§ 371 Date: May 8, 2013

(30) Foreign Application Priority Data
Jul. 29, 2010 (EP) 10171257.8

(51) Int. Cl. A01N 43/42; A01N 55/00

(52) U.S. Cl. CPC A01N 43/42; A01N 55/00
USPC 514/63; 546/112; 514/299; 546/171; 514/314; 546/14; 546/104; 514/297; 546/93; 546/159; 514/313

(57) ABSTRACT

The present invention provides compounds of formula (I) wherein G¹, G², G³, G⁴, G⁵, G⁶, Y¹, Y², Y³, Y⁴, Y⁵ and Y⁶ and p and q are as defined in the claims. The invention further relates to compositions which comprise these compounds and to their use in agriculture or horticulture for controlling or preventing infestation of plants by phytopathogenic microorganisms, preferably fungi.

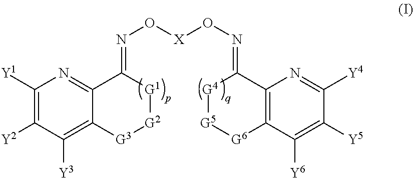

The present invention relates to novel microbiocidally active, in particular fungicidally active, cyclic bisoxime derivatives. It further relates to intermediates used in the preparation of these compounds, to compositions which comprise these compounds and to their use in agriculture or horticulture for controlling or preventing infestation of plants by phytopathogenic microorganisms, preferably fungi.

Fungicidally active bisoximes are described in WO08074418.

Surprisingly, it has been found that novel bisoxime derivatives based on a bicyclic fragment have microbiocidal activity.

The present invention accordingly relates to bisoxime derivatives of formula (I)

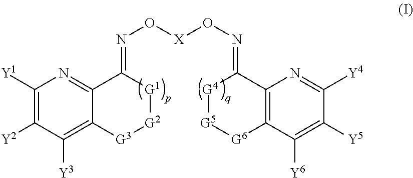

wherein

X represents X-2, X-3, X-4 or X-5:

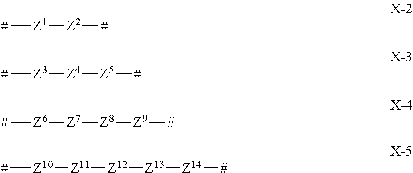

Z¹, Z², Z³, Z⁵, Z⁶, Z⁷, Z⁸, Z⁹, Z¹⁰, Z¹¹, Z¹³ and Z¹⁴ independently of one another represent CR¹R², C═CR³R⁴ or C═O;

Z⁴ and Z¹² independently of one another represent C═CR³R⁴, CR⁵R⁶, SiR⁷R⁸ or C═O;

each R¹ and R² independently of one another represent hydrogen, halogen, OH, C₁-C₄ alkyl, C₁-C₄ haloalkyl, C₃-C₆ cycloalkyl, C₃-C₆ halocycloalkyl, C₁-C₄ alkylthio, C₁-C₄ alkylsulphinyl, C₁-C₄ alkylsulphonyl, phenyl or CN, wherein the phenyl is optionally substituted by one or more groups independently selected from halogen, CN, C₁-C₄ alkyl, C₁-C₄ haloalkyl, C₁-C₄ alkoxy and C₁-C₄ haloalkoxy;

or R¹ and R² together with the carbon atom to which they are attached may form a C₃-C₆ cycloalkyl group or a C₃-C₆ halocycloalkyl group;

each R³ and R⁴ independently of one another represent hydrogen, halogen, C₁-C₄ alkyl or C₁-C₄ haloalkyl;

each R⁵, R⁶, R⁷ and R⁸ independently of one another represent hydrogen, halogen, OH, C₁-C₄ alkyl, C₁-C₄ haloalkyl, C₃-C₆ cycloalkyl, C₃-C₆ halocycloalkyl, phenyl or CN, wherein phenyl is optionally substituted by one or more groups independently selected from halogen, CN, C₁-C₄ alkyl, C₁-C₄ haloalkyl, C₁-C₄ alkoxy and C₁-C₄ haloalkoxy;

or R⁵ and R⁶ together with the carbon atom to which they are attached may form a C₃-C₆ cycloalkyl group or a C₃-C₆ halocycloalkyl group;

and wherein the groupings X-2, X-3, X-4 and X-5 may contain at most one ring (i.e. a cycloalkyl group or halocycloalkyl group) which contains either only one of the radicals Z¹ to Z¹⁴ or two radicals Z¹ to Z¹⁴ or three radicals Z¹ to Z¹⁴ or four radicals Z¹ to Z¹⁴ as ring members; and wherein radicals Z¹, Z², Z³, Z⁵, Z⁶, Z⁹, Z¹⁰ and Z¹⁴ are not substituted by OH;

Y¹, Y², Y³, Y⁴, Y⁵ and Y⁶ independently of one another represent hydrogen, halogen, CN, NO₂, C₁-C₈ alkyl, C₁-C₄-alkoxy-C₁-C₄-alkyl, C₁-C₄-alkoxy-C₁-C₄-alkoxy-C₁-C₄-alkyl, C₃-C₈ cycloalkyl, C₂-C₈ alkenyl, C₂-C₈ alkynyl, phenyl, pyridyl, pyrimidinyl, COR⁹, OR¹⁰, SH, C₁-C₈ alkylthio, C₁-C₈ alkylsulphinyl, C₁-C₈ alkylsulphonyl, N(R¹¹)₂, CO₂R¹⁰, O(CO)R⁹, CON(R¹¹)₂, NR¹¹COR⁹ or CR⁹N—OR¹⁰, wherein the alkyl, cycloalkyl, alkenyl, alkynyl, phenyl, pyrimidinyl and pyridyl are optionally substituted by one or more groups independently selected from halogen, CN, NH₂, NO₂, OH, C₁-C₄ alkyl, C₁-C₄ haloalkyl, C₁-C₄ alkoxy, C₁-C₄ haloalkoxy, C₁-C₄ alkylthio, C₁-C₄ alkylsulphinyl and C₁-C₄ alkylsulphonyl;

or independently Y¹ and Y², Y² and Y³, Y⁴ and Y⁵, Y⁵ and Y⁶ together with the fragment of the pyridyl ring to which they are attached may form a partially or fully unsaturated 5- to 7-membered carbocyclic ring or a 5- to 7-membered heterocyclic ring containing one to three heteroatoms independently selected from O, S, N and N(R¹²), providing that the heterocycle does not contain adjacent oxygen atoms, adjacent sulphur atoms, or adjacent sulphur and oxygen atoms, and wherein the ring formed by Y¹ and Y², Y² and Y³, Y⁴ and Y⁵, Y⁵ and Y⁶ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

each R⁹ independently of one another represents hydrogen, C₁-C₈ alkyl, C₃-C₈ cycloalkyl, C₂-C₈ alkenyl, C₂-C₈ alkynyl, benzyl, phenyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

each R¹⁰ independently of one another represents hydrogen, C₁-C₈ alkyl, C₃-C₈ cycloalkyl, C₃-C₈ alkenyl, C₃-C₈ alkynyl, benzyl, phenyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄ haloalkyl, C₁-C₄ alkoxy, C₁-C₄ haloalkoxy and C₁-C₄-alkoxy-C₁-C₄-alkyl;

each R¹¹ independently of one another represents hydrogen, OH, C₁-C₈ alkyl, C₁-C₈ alkoxy, C₁-C₈-alkoxy-C₁-C₄-alkyl, C₃-C₈ alkenyl, C₃-C₈ alkynyl, or COR⁹, wherein the alkyl, alkoxy, alkenyl and alkynyl are optionally substituted by one or more halogen;

wherein when two radicals R¹¹ are attached to the same nitrogen atom, these radicals can be identical or different;

wherein when two radicals R¹¹ are attached to the same nitrogen atom, both of these radicals cannot be OH, C₁-C₄ alkoxy or C₁-C₄ haloalkoxy;

and wherein when two radicals R¹¹ are attached to the same nitrogen atom, these two radicals together with the nitrogen atom to which they are attached may form a cycle B-1, B-2, B-3, B-4, B-5, B-6, B-7 or B-8:

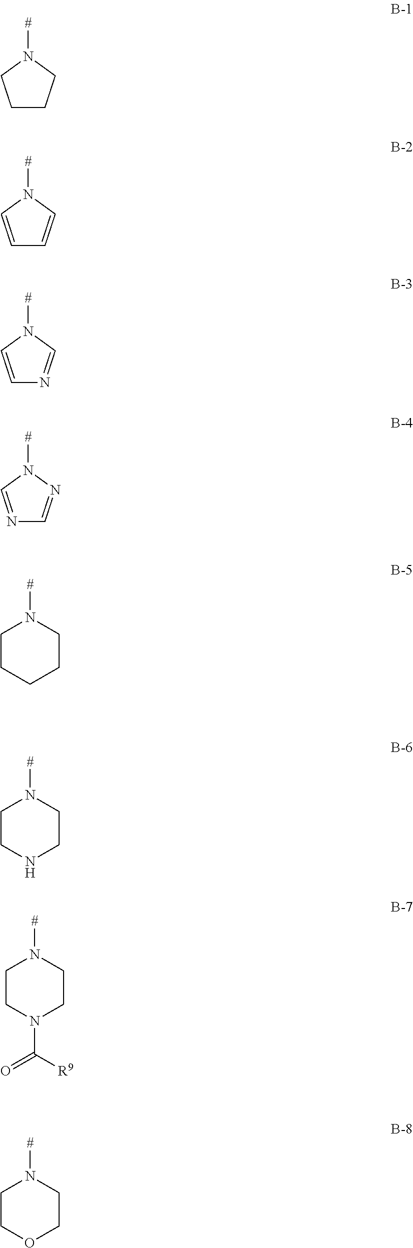

wherein the cycle formed is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

G¹, G², G⁴ and G⁵ independently of one another represent —C(R¹²R¹³)—;

G³ and G⁶ independently of one another represent —C(R¹²R¹³)—, O, N(R¹⁴) or 5; or G¹ and G², or G² and G³, or G¹ and G¹, or G⁴ and G⁵, or G⁵ and G⁶, or G⁴ and G⁴ together represent —CR¹²═CR¹³—;

each R¹² and R¹³ independently of one another represent hydrogen, halogen, C₁-C₄ alkyl, C₁-C₄ haloalkyl, C₁-C₄ alkoxy or C₁-C₄ haloalkoxy;

R¹⁴ represents hydrogen, OH, C₁-C₄ alkyl, C₁-C₄ alkoxy, C₃-C₆-cycloalkyl, C₁-C₈ alkylcarbonyl or C₁-C₈ haloalkylcarbonyl; and

p and q are each independently 0, 1 or 2;

or a salt or an N-oxide thereof.

Halogen, either as a lone substituent or in combination with another substituent (e.g. haloalkyl) is generally fluorine, chlorine, bromine or iodine, and usually fluorine, chlorine or bromine.

Each alkyl moiety (including the alkyl moiety of alkoxy, alkylthio, etc.) is a straight or branched chain and, depending on the number of carbon atoms it contains, is, for example, methyl, ethyl, n-propyl, n-butyl, n-pentyl, n-hexyl, iso-propyl, sec-butyl, iso-butyl, tert-butyl, neo-pentyl, n-heptyl or 1,3-dimethylbutyl, and usually methyl or ethyl.

The alkenyl and alkynyl groups can be mono- or di-unsaturated and are examples thereof are derived from the above mentioned alkyl groups.

Haloalkyl moieties are alkyl moieties which are substituted by one or more of the same or different halogen atoms and are, for example, monofluoromethyl, difluoromethyl, trifluoromethyl, monochloromethyl, dichloromethyl, trichloromethyl, 2,2,2-trifluoroethyl, 2,2-difluoroethyl, 2-fluoroethyl, 1,1-difluoroethyl, 1-fluoroethyl, 2-chloroethyl, pentafluoroethyl, 1,1-difluoro-2,2,2-trichloroethyl, 2,2,3,3-tetrafluoroethyl and 2,2,2-trichloroethyl, and typically trichloromethyl, difluorochloromethyl, difluoromethyl, trifluoromethyl and dichlorofluoromethyl.

Alkoxy is, for example, methoxy, ethoxy, propoxy, iso-propoxy, n-butoxy, iso-butoxy, sec-butoxy and tert-butoxy, and usually methoxy or ethoxy.

Haloalkoxy is, for example, fluoromethoxy, difluoromethoxy, trifluoromethoxy, 2,2,2-trifluoroethoxy, 1,1,2,2-tetrafluoroethoxy, 2-fluoroethoxy, 2-chloroethoxy, 2,2-difluoroethoxy and 2,2,2-trichloroethoxy, and usually difluoromethoxy, 2-chloroethoxy and trifluoromethoxy.

Alkylthio is, for example, methylthio, ethylthio, propylthio, iso-propylthio, n-butylthio, iso-butylthio, sec-butylthio or tert-butylthio, and usually methylthio or ethylthio.

Alkylsulphonyl is, for example, methylsulphonyl, ethylsulphonyl, propylsulphonyl, iso-propylsulphonyl, n-butylsulphonyl, iso-butylsulphonyl, sec-butylsulphonyl or tert-butylsulphonyl, and usually methylsulphonyl or ethylsulphonyl.

Alkylsulphinyl is, for example, methylsulphinyl, ethylsulphinyl, propylsulphinyl, iso-propylsulphinyl, n-butylsulphinyl, iso-butylsulphinyl, sec-butylsulphinyl or tert-butylsulphinyl, and usually methylsulphinyl or ethylsulphinyl

Cycloalkyl may be saturated or partially unsaturated, preferably fully saturated, and is, for example, cyclopropyl, cyclobutyl, cyclopentyl or cyclohexyl.

Alkoxyalkyl is, for example, methoxymethyl, methoxyethyl, ethoxymethyl, ethoxyethyl, n-propoxymethyl, n-propoxyethyl, iso-propoxymethyl or iso-propoxyethyl.

Aryl includes phenyl, naphthyl, anthracyl, fluorenyl and indanyl, but is usually phenyl.

Carbocycle includes cycloalkyl groups and aryl groups.

Heterocycloalkyl is a non-aromatic ring that may be saturated or partially unsaturated, preferably fully saturated, containing carbon atoms as ring members and at least one heteroatom selected from O, S and N as ring members. Examples include oxiranyl, oxetanyl, tetrahydrofuranyl, tetrahydropyranyl, 1,3-dioxolanyl, 1,4-dioxanyl, aziridinyl, azetidinyl, pyrrolidinyl, piperidinyl, oxazinanyl, morpholinyl, thiomorpholinyl, imidazolidinyl, pyrazolidinyl and piperazinyl, preferably morpholinyl, pyrrolidinyl, piperidinyl and piperazinyl, more preferably morpholinyl and pyrollidinyl.

Heteroaryl is, for example, a monovalent monocyclic or bicyclic aromatic hydrocarbon radical. Examples of monocyclic groups include pyridyl, pyridazinyl, pyrimidinyl, pyrazinyl, pyrrolyl, pyrazolyl, imidazolyl, triazolyl, tetrazolyl, furanyl, thiophenyl, oxazolyl, isoxazolyl, oxadiazolyl, thiazolyl, isothiazolyl, and thiadiazolyl. Examples of bicyclic groups include quinolinyl, cinnolinyl, quinoxalinyl, benzimidazolyl, benzothiophenyl, and benzothiadiazolyl. Monocyclic heteroaryl groups are preferred, preferably pyridyl, pyrrolyl, imidazolyl and triazolyl, e.g. 1,2,4 triazolyl, pyridyl and imidazolyl being most preferred.

The terms “heterocycle” and “heterocyclic ring” are used interchangeably and are defined to include heterocycloalkyl and heteroaryl groups. Any reference herein to a heterocycle or heterocyclic ring preferably refers to the specific examples given under the definition of heteroaryl and heterocycloalkyl above, and are preferably morpholinyl, pyrrolidinyl, piperidinyl, piperazinyl pyridyl, pyrrolyl, imidazolyl and triazolyl, e.g. 1,2,4 triazolyl, more preferably morpholinyl, pyrollidinyl, pyridyl and imidazolyl.

The term ‘trichloroacetimidate’ relates to the radical below:

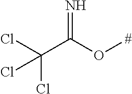

Where a moiety is indicated as being (optionally) substituted, e.g. alkyl, this includes those moieties where they are part of a larger group, e.g. the alkyl in the alkylthio group, the alkyl in the alkoxy group etc. Where a moiety is indicated as being optionally substituted by one or more other groups, preferably there are one to five optional substituents, more preferably one to three optional substituents.

The following substituents definitions, including preferred definitions, may be combined in any combination:

X represents X-2, X-3, X-4 or X-5:

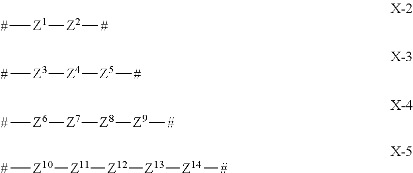

Preferably X represents X-3 or X-5. More preferably X represents X-3.

Z¹, Z², Z³, Z⁵, Z⁶, Z⁷, Z⁸, Z⁹, Z¹⁰, Z¹¹, Z¹³ and Z¹⁴ independently of one another represent CR¹R², C═CR³R⁴. Preferably Z¹, Z², Z³, Z⁵, Z⁶, Z⁷, Z⁸, Z⁹, Z¹⁰, Z¹¹, Z¹³ and Z¹⁴ independently of one another represent methylene, halomethylene, CH(CH₃) or C(CH₃)₂. More preferably Z¹, Z², Z³, Z⁵, Z⁶, Z⁷, Z⁸, Z⁹, Z¹⁰, Z¹¹, Z¹³ and Z¹⁴ represent methylene.

Z⁴ and Z¹² independently of one another represent CR⁵R⁶, SiR⁷R⁸, C═O or C═CR³R⁴. Preferably Z⁴ and Z¹² independently of one another represent CR⁵R⁶, SiR⁷R⁸ or C═CR³R⁴, more preferably CR⁵R⁶ or C═CR³R⁴, more preferably CR⁵R⁶.

Each R¹ and R² independently of one another represent hydrogen, halogen, OH, C₁-C₄ alkyl, C₁-C₄ haloalkyl, C₃-C₆ cycloalkyl, C₃-C₆ halocycloalkyl, C₁-C₄ alkylthio, C₁-C₄ alkylsulphinyl, C₁-C₄ alkylsulphonyl, phenyl or CN, wherein the phenyl is optionally substituted by one or more groups, e.g. one to five groups, independently selected from halogen, CN, C₁-C₄ alkyl, C₁-C₄ haloalkyl, C₁-C₄ alkoxy and C₁-C₄ haloalkoxy; or R¹ and R² together with the carbon atom to which they are attached may form a C₃-C₆ cycloalkyl group or a C₃-C₆ halocycloalkyl group.

Each R³ and R⁴ independently of one another represent hydrogen, halogen, C₁-C₄ alkyl or C₁-C₄ haloalkyl.

Preferably each R³ and R⁴ independently of one another represent hydrogen, halogen, methyl or halomethyl.

Each R⁵, R⁶, R⁷ and R⁸ independently of one another represent hydrogen, halogen, OH, C₁-C₄ alkyl, C₁-C₄ haloalkyl, C₃-C₆ cycloalkyl, C₃-C₆ halocycloalkyl, phenyl or CN, wherein phenyl is optionally substituted by one or more groups, e.g. one to five groups, independently selected from halogen, CN, C₁-C₄ alkyl, C₁-C₄ haloalkyl, C₁-C₄ alkoxy and C₁-C₄ haloalkoxy; or R⁵ and R⁶ together with the carbon atom to which they are attached may form a C₃-C₆ cycloalkyl group or a C₃-C₆ halocycloalkyl group.

Preferably, each R⁵, R⁶, R⁷ and R⁸ independently of one another represent hydrogen, halogen, OH, C₁-C₄ alkyl, C₁-C₄ haloalkyl, C₃-C₆ cycloalkyl, phenyl or CN, wherein phenyl is optionally substituted by one or more groups independently selected from halogen, CN, C₁-C₄ alkyl, C₁-C₄ haloalkyl, C₁-C₄ alkoxy and C₁-C₄ haloalkoxy; or R⁵ and R⁶ together with the carbon atom to which they are attached may form a C₃-C₆ cycloalkyl group or a C₃-C₆ halocycloalkyl group;

More preferably, each R⁵, R⁶, R⁷ and R⁸ independently of one another represent hydrogen, halogen, C₁-C₄ alkyl, C₁-C₄ haloalkyl or phenyl, wherein the phenyl is optionally substituted by one or more groups independently selected from halogen, CN, methyl, halomethyl, methoxy and halomethoxy; or R⁵ and R⁶ together with the carbon atom to which they are attached may form a C₃-C₆ cycloalkyl group optionally substituted by halogen.

Y¹, Y², Y³, Y⁴, Y⁵ and Y⁶ independently of one another represent hydrogen, halogen, CN, NO₂, C₁-C₈ alkyl, C₁-C₄-alkoxy-C₁-C₄-alkyl, C₁-C₄-alkoxy-C₁-C₄-alkoxy-C₁-C₄-alkyl, C₃-C₈ cycloalkyl, C₂-C₈ alkenyl, C₂-C₈ alkynyl, phenyl, pyridyl, pyrimidinyl, COR⁹, OR¹⁰, SH, C₁-C₈-alkylthio, C₁-C₈ alkylsulphinyl, C₁-C₈ alkylsulphonyl, N(R¹¹)₂, CO₂R¹⁰, O(CO)R⁹, CON(R¹¹)₂, NR¹¹COR⁹ or CR⁸N—OR¹⁰, wherein the alkyl, cycloalkyl, alkenyl, alkynyl, phenyl, pyrimidinyl and pyridyl are optionally substituted by one or more groups, e.g. one to five groups, independently selected from halogen, CN, NH₂, NO₂, OH, C₁-C₄ alkyl, C₁-C₄ haloalkyl, C₁-C₄ alkoxy, C₁-C₄ haloalkoxy, C₁-C₄ alkylthio, C₁-C₄ alkylsulphinyl and C₁-C₄ alkylsulphonyl;

or independently Y¹ and Y², Y² and Y³, Y⁴ and Y⁵, Y⁵ and Y⁶ together with the fragment of the pyridyl ring to which they are attached may form a partially or fully unsaturated 5- to 7-membered carbocyclic ring or a 5- to 7-membered heterocyclic ring containing one to three heteroatoms independently selected from O, S, N and N(R¹¹), providing that the heterocycle does not contain adjacent oxygen atoms, adjacent sulphur atoms, or adjacent sulphur and oxygen atoms, and wherein the ring formed by Y¹ and Y², Y² and Y³, Y⁴ and Y⁵, or Y⁵ and Y⁶ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy.

Preferably, Y¹, Y², Y³, Y⁴, Y⁵ and Y⁶ independently of one another represent hydrogen, halogen, N(R¹¹)₂, CN, NO₂, C₁-C₈ alkyl, C₁-C₆-alkoxy-C₁-C₄-alkyl, C₃-C₈ cycloalkyl, C₂-C₆ alkenyl, C₂-C₆ alkynyl, phenyl, pyridyl, OR¹⁰, SH, C₁-C₈ alkylthio, C₁-C₈ alkylsulphinyl or C₁-C₈ alkylsulphonyl, wherein the alkyl, cycloalkyl, alkenyl, alkynyl, phenyl and pyridyl are optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

or independently Y¹ and Y², Y² and Y³, Y⁴ and Y⁵, Y⁵ and Y⁶ together with the fragment of the pyridyl ring to which they are attached may form a partially or fully unsaturated 5- to 7-membered carbocyclic ring, wherein the ring formed by Y¹ and Y², Y² and Y³, Y⁴ and Y⁵, or Y⁵ and Y⁶ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

wherein each R¹⁰ independently of one another represent hydrogen, C₁-C₄ alkyl, C₃-C₆ cycloalkyl, C₃-C₆ alkenyl, C₃-C₆ alkynyl, benzyl, phenyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄-haloalkyl, C₁-C₄ alkoxy, C₁-C₄ haloalkoxy and C₁-C₄-alkoxy-C₁-C₄-alkyl;

each R¹¹ independently of one another represent hydrogen or C₁-C₈ alkyl, wherein the alkyl is optionally substituted by one or more halogen;

wherein when two radicals R¹¹ are attached to the same nitrogen atom, these radicals can be identical or different;

and wherein when two radicals R¹¹ are attached to the same nitrogen atom, these two radicals together with the nitrogen atom to which they are attached may form a cycle B-1, B-2, B-3, B-4 or B-5 wherein the cycle formed is optionally substituted by one or more groups independently selected from halogen, methyl and halomethyl.

Preferably, Y¹, Y², Y³, Y⁴, Y⁵ and Y⁶ independently of one another represent hydrogen, halogen, N(R¹¹)₂, CN, NO₂, C₁-C₆ alkyl, C₁-C₄-alkoxy-C₁-C₄-alkyl, C₃-C₆ cycloalkyl, C₂-C₆ alkenyl, C₂-C₆ alkynyl, phenyl, pyridyl, C₁-C₄-alkoxy, C₁-C₄-alkenoxy, C₁-C₄-alkynoxy, phenoxy, SH, C₁-C₈ alkylthio, C₁-C₈ alkylsulphinyl or C₁-C₈ alkylsulphonyl, wherein the alkyl, cycloalkyl, alkenyl, alkynyl, phenyl and pyridyl are optionally substituted by one or more groups independently selected from halogen, CN, NH₂, NO₂, OH, methyl and halomethyl;

or independently Y¹ and Y², Y² and Y³, Y⁴ and Y⁵, Y⁵ and Y⁶ together with the fragment of the pyridyl ring to which they are attached may form a partially or fully unsaturated 5- to 7-membered carbocyclic ring, wherein the ring formed by Y¹ and Y², Y² and Y³, Y⁴ and Y⁵, Y⁵ and Y⁶ is optionally substituted by one or more groups independently selected from halogen, CN, NH₂, NO₂, OH, methyl and halomethyl;

wherein each R¹¹ independently of one another represent hydrogen or C₁-C₈ alkyl, wherein the alkyl is optionally substituted by one or more halogen;

wherein when two radicals R¹¹ are attached to the same nitrogen atom, these radicals can be identical or different;

and wherein when two radicals R¹¹ are attached to the same nitrogen atom, these two radicals together with the nitrogen atom to which they are attached may form a cycle B-1, B-2, B-3, B-4 or B-5 wherein the cycle formed is optionally substituted by one or more groups independently selected from halogen, methyl and halomethyl.

Preferably, Y¹, Y², Y³, Y⁴, Y⁵ and Y⁶ independently of one another represent hydrogen, halogen, N(R¹¹)₂, CN, NO₂, C₁-C₆ alkyl, C₁-C₄-alkoxy-C₁-C₄-alkyl, C₃-C₆ cycloalkyl, C₂-C₆ alkenyl, C₂-C₆ alkynyl, phenyl, pyridyl, C₁-C₄-alkoxy, C₁-C₄-alkenoxy, C₁-C₄-alkynoxy, phenoxy, SH, C₁-C₈ alkylthio, C₁-C₈ alkylsulphinyl or C₁-C₈ alkylsulphonyl, wherein the alkyl, cycloalkyl, alkenyl, alkynyl, phenyl and pyridyl are optionally substituted by one or more groups independently selected from halogen, CN, NH₂, NO₂, OH, methyl and halomethyl;

or independently Y¹ and Y², Y² and Y³, Y⁴ and Y⁵, Y⁵ and Y⁶ together with the fragment of the pyridyl ring to which they are attached may form a partially or fully unsaturated 5- to 7-membered carbocyclic ring, wherein the ring formed by Y¹ and Y², Y² and Y³, Y⁴ and Y⁵, Y⁵ and Y⁶ is optionally substituted by one or more groups independently selected from halogen, CN, NH₂, NO₂, OH, methyl and halomethyl;

wherein each R¹¹ independently of one another represent hydrogen or C₁-C₈ alkyl, wherein the alkyl, is optionally substituted by one or more halogen;

wherein when two radicals R¹¹ are attached to the same nitrogen atom, these radicals can be identical or different;

and wherein when two radicals R¹¹ are attached to the same nitrogen atom, these two radicals together with the nitrogen atom to which they are attached may form a cycle B-1, B-2, B-3, B-4 or B-5 wherein the cycle formed is optionally substituted by one or more groups independently selected from halogen, methyl and halomethyl.

Preferably, Y¹, Y³, Y⁴, and Y⁶ independently of one another represent hydrogen, halogen, N(R¹¹)₂, CN, NO₂, C₁-C₆ alkyl, C₁-C₄-alkoxy-C₁-C₄-alkyl, C₃-C₆ cycloalkyl, C₂-C₆ alkenyl, C₂-C₆ alkynyl, phenyl, pyridyl, C₁-C₄-alkoxy, C₁-C₄-alkenoxy, C₁-C₄-alkynoxy, phenoxy, SH, C₁-C₈ alkylthio, C₁-C₈ alkylsulphinyl or C₁-C₈ alkylsulphonyl, wherein the alkyl, cycloalkyl, alkenyl, alkynyl, phenyl and pyridyl are optionally substituted by one or more groups independently selected from halogen, CN, NH₂, NO₂, OH, methyl and halomethyl;

Y² and Y⁵ independently of one another represent hydrogen, halogen, C₁-C₄ alkyl, or C₁-C₄ haloalkyl;

or independently Y¹ and Y², Y⁴ and Y⁵ together with the fragment of the pyridyl ring to which they are attached may form a partially or fully unsaturated 6-membered carbocyclic ring (e.g. via the fragment —CH₂—CH₂—CH₂—CH₂— or —CH═CH—CH═CH₂—) wherein the ring formed by Y¹ and Y², or Y⁴ and Y⁵ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

wherein each R¹¹ independently of one another represent hydrogen or C₁-C₈ alkyl, wherein the alkyl is optionally substituted by one or more halogen;

wherein when two radicals R¹¹ are attached to the same nitrogen atom, these radicals can be identical or different;

and wherein when two radicals R¹¹ are attached to the same nitrogen atom, these two radicals together with the nitrogen atom to which they are attached may form a cycle B-1, B-2, B-3, B-4 or B-5 wherein the cycle formed is optionally substituted by one or more groups independently selected from halogen, methyl and halomethyl.

In one group of compounds Y¹ and Y⁴ independently of one another represent C₁-C₈ alkyl, C₁-C₈ alkoxy, C₃-C₈ cycloalkyl, N(R¹¹)₂, phenyl, pyridyl, pyrimidinyl, C₁-C₈ alkylthio, C₁-C₈ alkylsulphinyl, C₁-C₈ alkylsulphonyl, wherein the alkyl, cycloalkyl, phenyl, pyrimidinyl and pyridyl are optionally substituted by one or more groups independently selected from halogen, CN, NH₂, C₁-C₄ alkyl, C₁-C₄ haloalkyl, C₁-C₄ alkoxy, C₁-C₄ haloalkoxy, C₁-C₄ alkylthio, C₁-C₄ alkylsulphinyl and C₁-C₄ alkylsulphonyl. More preferably, Y¹ and Y⁴ independently of one another represent C₁-C₄ alkyl, C₁-C₄ haloalkyl, OH, C₁-C₄ alkoxy, C₁-C₄ haloalkoxy, phenyl and pyridyl, wherein the phenyl and pyridyl are optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy.

In another group of compounds Y², Y³, Y⁵ and Y⁶ independently of one another represent hydrogen, CN, OR¹⁰, NH₂, halogen, C₁-C₈ alkyl, C₁-C₈ haloalkyl, C₂-C₈ alkenyl, C₂-C₈ alkynyl, C₃-C₈ cycloalkyl, SH, C₁-C₈ alkylthio, N(R¹¹)₂, NR¹¹COR⁹ or phenyl, wherein phenyl is optionally substituted by one or more groups independently selected from halogen, methyl, CN, methoxy, halomethyl and halomethoxy. More preferably Y², Y³, Y⁵, and Y⁶ independently of one another represent hydrogen, CN, OH, NH₂, halogen, C₁-C₄ alkyl, C₁-C₄ haloalkyl, C₁-C₄ alkoxy, C₁-C₄ haloalkoxy, C₃-C₆ cycloalkyl, N(R¹¹)₂, NR¹¹COR⁹ or phenyl, wherein phenyl is optionally substituted by one or more groups selected from halogen, methyl, CN, methoxy, halomethyl and halomethoxy.

In another group of compounds, Y¹, Y², Y³, Y⁵ and Y⁶ independently of one another represent hydrogen, halogen, OH, CN, C₁-C₈ alkyl, C₁-C₈ haloalkyl, C₁-C₈ alkoxy, C₁-C₈ haloalkoxy, C₃-C₈ cycloalkyl, phenyl, pyridyl, N(R¹¹)₂ or NR¹¹COR⁹, wherein phenyl and pyridyl are optionally substituted by one or more groups, e.g. one to five groups, independently selected from halogen, CN, C₁-C₄ alkyl, C₁-C₄ haloalkyl, C₁-C₄ alkoxy and C₁-C₄ haloalkoxy.

In another group of compounds, Y¹, Y², Y³, Y⁵ and Y⁶ independently of one another represent hydrogen, CN, OH, halogen, C₁-C₄ alkyl, C₁-C₄ haloalkyl, C₁-C₄ alkoxy, C₁-C₄ haloalkoxy, C₃-C₆ cycloalkyl, N(R¹¹)₂, NR¹¹COR⁹ or phenyl, wherein phenyl is optionally substituted by one or more groups, e.g. one to five groups, independently selected from halogen, CN, C₁-C₄ alkyl, C₁-C₄ haloalkyl, C₁-C₄ alkoxy and C₁-C₄ haloalkoxy.

In another group of compounds, Y¹, Y², Y³, Y⁵ and Y⁶ independently of one another represent hydrogen, CN, OH, NH₂, halogen, C₁-C₄ alkyl, C₁-C₄ haloalkyl, C₁-C₄ alkoxy, C₁-C₄ haloalkoxy, C₃-C₆ cycloalkyl, N(R¹¹)₂, NR¹¹COR⁹ or phenyl, wherein phenyl is optionally substituted by one or more groups, e.g. one to five groups, independently selected from halogen, methyl, CN, methoxy, halomethyl and halomethoxy.

In another group of compounds Y², Y³, Y⁵, and Y⁶ independently of one another represent hydrogen, C₁-C₄ alkyl, CN or C₁-C₄ alkoxy, wherein alkyl is optionally substituted by one or more groups independently selected from halogen, CN, C₁-C₄ alkoxy and C₁-C₄ haloalkoxy.

In another group of compounds Y¹, Y², Y³, Y⁴, Y⁵ and Y⁶ independently of one another represent hydrogen, C₁-C₄ alkyl, CN or C₁-C₄ alkoxy, wherein alkyl is optionally substituted by one or more groups independently selected from halogen, CN, C₁-C₄ alkoxy and C₁-C₄ haloalkoxy.

In another group of compounds, independently Y¹ and Y², Y² and Y³, Y⁴ and Y⁵, Y⁵ and Y⁶ together with the fragment of the pyridyl ring to which they are attached may form a partially or fully unsaturated 5- to 7-membered carbocyclic ring or a 5- to 7-membered heterocyclic ring containing one to three heteroatoms independently selected from O, S, N and N(R¹¹), providing that the heterocycle does not contain adjacent oxygen atoms, adjacent sulphur atoms, or adjacent sulphur and oxygen atoms, and wherein the ring formed by Y¹ and Y², Y² and Y³, Y⁴ and Y⁵, or Y⁵ and Y⁶ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy; preferably independently Y¹ and Y², Y² and Y³, Y⁴ and Y⁵, Y⁵ and Y⁶ together with the fragment of the pyridyl ring to which they are attached may form a partially or fully unsaturated 5- to 7-membered carbocyclic ring or a 5- to 7-membered heterocyclic ring containing one to three heteroatoms independently selected from N and N(R¹¹), and wherein the ring formed by Y¹ and Y², Y² and Y³, Y⁴ and Y⁵, or Y⁵ and Y⁶ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy.

In another group of compounds, independently Y¹ and Y², Y⁴ and Y⁵ together with the fragment of the pyridyl ring to which they are attached may form a partially or fully unsaturated 5- to 7-membered carbocyclic ring wherein the ring formed by Y¹ and Y², Y⁴ and Y⁵ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy.

In another group of compounds, independently Y¹ and Y², Y⁴ and Y⁵ together with the fragment of the pyridyl ring to which they are attached may form a partially or fully unsaturated 6-membered carbocyclic ring (e.g. via the fragment —CH₂—CH₂—CH₂—CH₂— or —CH═CH—CH═CH₂—) wherein the ring formed by Y¹ and Y², or Y⁴ and Y⁵ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy.

In one group of compounds Y² and Y⁵ independently of one another represent hydrogen, halogen, C₁-C₄ alkyl, or C₁-C₄ haloalkyl, preferably hydrogen, halogen, methyl or halomethyl, preferably hydrogen.

Each R⁹ independently of one another represents hydrogen, C₁-C₈ alkyl, C₃-C₈ cycloalkyl, C₂-C₈ alkenyl, C₂-C₈ alkynyl, benzyl, phenyl or pyridyl, wherein the alkyl, cycloalkyl, alkenyl, alkynyl, phenyl, benzyl and pyridyl are optionally substituted by one or more groups, e.g. one to five groups, independently selected from halogen, CN, NH₂, NO₂, OH, C₁-C₄ alkyl, C₁-C₄ haloalkyl, C₁-C₄ alkoxy and C₁-C₄ haloalkoxy.

Preferably each R⁹ independently of one another represent C₁-C₈ alkyl or C₁-C₈ haloalkyl, more preferably C₁-C₄ alkyl or C₁-C₄ haloalkyl.

Each R¹⁰ independently of one another represents hydrogen, C₁-C₈ alkyl, C₃-C₈ cycloalkyl, C₃-C₈ alkenyl, C₃-C₈ alkynyl, benzyl, phenyl or pyridyl, wherein the alkyl, cycloalkyl, alkenyl, alkynyl, phenyl, benzyl and pyridyl are optionally substituted by one or more groups, e.g. one to five groups, independently selected from halogen, CN, NH₂, NO₂, OH, C₁-C₄-alkyl, C₁-C₄-haloalkyl, C₁-C₄-alkoxy, C₁-C₄-haloalkoxy and C₁-C₄-alkoxy-C₁-C₄-alkyl.

Each R¹¹ independently of one another represents hydrogen, OH, C₁-C₈ alkyl, C₁-C₈ alkoxy, C₁-C₈-alkoxy-C₁-C₄-alkyl, C₃-C₈ alkenyl, C₃-C₈ alkynyl, or COR⁹, wherein the alkyl, alkoxy, alkenyl and alkynyl are optionally substituted by one or more halogen; wherein when two radicals R¹¹ are attached to the same nitrogen atom, these radicals can be identical or different; wherein when two radicals R¹¹ are attached to the same nitrogen atom, both of these radicals cannot be OH, C₁-C₄ alkoxy or C₁-C₄ haloalkoxy; and wherein when two radicals R¹¹ are attached to the same nitrogen atom, these two radicals together with the nitrogen atom to which they are attached may form a cycle B-1, B-2, B-3, B-4, B-5, B-6, B-7 or B-8:

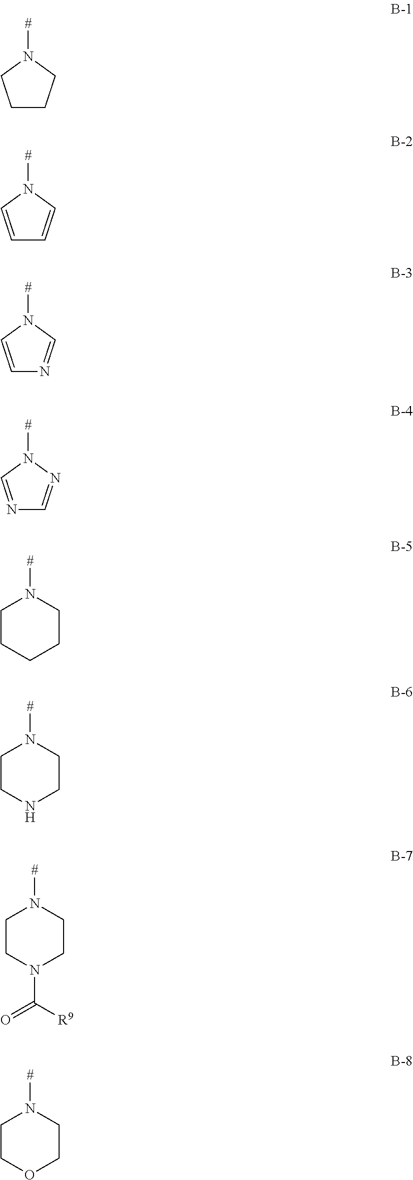

wherein the cycle formed is optionally substituted by one or more groups, e.g. one to five groups, independently selected from halogen, CN, NH₂, NO₂, OH, C₁-C₄-alkyl, C₁-C₄-haloalkyl, C₁-C₄-alkoxy and C₁-C₄-haloalkoxy.

Preferably each R¹¹ independently of one another represent hydrogen, C₁-C₈ alkyl or COR⁹; wherein when two radicals R¹¹ are attached to the same nitrogen atom, these radicals can be identical or different; and wherein when two radicals R¹¹ are attached to the same nitrogen atom, these two radicals together with the nitrogen atom to which they are attached may form a cycle B-1, B-2, B-3, B-4 or B-5 wherein the cycle formed is optionally substituted by one or more groups, e.g. one to five groups independently selected from halogen, methyl and halomethyl.

More preferably each R¹¹ independently of one another represent hydrogen or C₁-C₄ alkyl; wherein when two radicals R¹¹ are attached to the same nitrogen atom, these radicals can be identical or different; and wherein when two radicals R¹¹ are attached to the same nitrogen atom, these two radicals together with the nitrogen atom to which they are attached may form a cycle B-1, B-2, B-3, B-4 or B-5 wherein the cycle formed is optionally substituted by one or more groups, e.g. one to five groups, independently selected from halogen, methyl and halomethyl.

G¹, G², G⁴ and G⁵ independently of one another represent —C(R¹²R¹³)—; G³ and G⁶ independently of one another represent —C(R¹²R¹³)—, O, N(R¹⁴) or 5; or G¹ and G², or G² and G³, or G¹ and G¹, or G⁴ and G⁵, or G⁵ and G⁶, or G⁴ and G⁴ together represent —CR¹²═CR¹³. For the avoidance of doubt, when p is 2, G¹ and G¹ as well as G² and G³ may represent CR¹²═CR¹³ such that the ring contains two double bond moieties. Likewise, when q is 2, G⁴ and G⁴ as well as G⁵ and G⁶ may represent CR¹²═CR¹³.

Preferably G¹, G², G³, G⁴, G⁵ and G⁶ independently of one another represent —C(R¹²R¹³)—.

Even more preferably G¹, G², G³, G⁴, G⁵ and G⁶ represent methylene.

Each R¹² and R¹³ independently of one another represent hydrogen, halogen, C₁-C₄ alkyl, C₁-C₄ haloalkyl, C₁-C₄ alkoxy or C₁-C₄ haloalkoxy.

R¹⁴ represents hydrogen, OH, C₁-C₄ alkyl, C₁-C₄ alkoxy, C₃-C₆-cycloalkyl, C₁-C₈ alkylcarbonyl or C₁-C₈ haloalkylcarbonyl;

p and q are each independently of one another 0, 1 or 2.

Preferably p and q are each independently of one another 1 or 2.

More preferably p and q are 1.

In one group of compounds X represents X-2, X-3, X-4 or X-5:

Z¹, Z², Z³, Z⁵, Z⁶, Z⁷, Z⁸, Z⁹, Z¹⁰, Z¹¹, Z¹³ and Z¹⁴ independently of one another represent CR¹R², C═CR³R⁴ or C═O;

Z⁴ and Z¹² independently of one another represent C═CR³R⁴, CR⁵R⁶, SiR⁷R⁸ or C═O;

each R¹ and R² independently of one another represent hydrogen, halogen, OH, C₁-C₄ alkyl, C₁-C₄ haloalkyl, C₃-C₆ cycloalkyl, C₃-C₆ halocycloalkyl, C₁-C₄ alkylthio, C₁-C₄ alkylsulphinyl, C₁-C₄ alkylsulphonyl, phenyl or CN, wherein the phenyl is optionally substituted by one or more groups independently selected from halogen, CN, C₁-C₄ alkyl, C₁-C₄ haloalkyl, C₁-C₄ alkoxy and C₁-C₄ haloalkoxy;

or R¹ and R² together with the carbon atom to which they are attached may form a C₃-C₆ cycloalkyl group or a C₃-C₆ halocycloalkyl group;

each R³ and R⁴ independently of one another represent hydrogen, halogen, C₁-C₄ alkyl or C₁-C₄ haloalkyl;

each R⁵, R⁶, R⁷ and R⁸ independently of one another represent hydrogen, halogen, OH, C₁-C₄ alkyl, C₁-C₄ haloalkyl, C₃-C₆ cycloalkyl, C₃-C₆ halocycloalkyl, phenyl or CN, wherein phenyl is optionally substituted by one or more groups independently selected from halogen, CN, C₁-C₄ alkyl, C₁-C₄ haloalkyl, C₁-C₄ alkoxy and C₁-C₄ haloalkoxy;

or R⁵ and R⁶ together with the carbon atom to which they are attached may form a C₃-C₆ cycloalkyl group or a C₃-C₆ halocycloalkyl group;

and wherein the groupings X-2, X-3, X-4 and X-5 may contain at most one ring (i.e. a cycloalkyl group or halocycloalkyl group) which contains either only one of the radicals Z¹ to Z¹⁴ or two radicals Z¹ to Z¹⁴ or three radicals Z¹ to Z¹⁴ or four radicals Z¹ to Z¹⁴ as ring members; and wherein radicals Z¹, Z², Z³, Z⁵, Z⁶, Z⁹, Z¹⁰ and Z¹⁴ are not substituted by OH;

Y¹, Y², Y³, Y⁴, Y⁵ and Y⁶ independently of one another represent hydrogen, halogen, CN, NO₂, C₁-C₈ alkyl, C₁-C₄-alkoxy-C₁-C₄-alkyl, C₁-C₄-alkoxy-C₁-C₄-alkoxy-C₁-C₄-alkyl, C₃-C₈ cycloalkyl, C₂-C₈ alkenyl, C₂-C₈ alkynyl, phenyl, pyridyl, pyrimidinyl, COR⁹, OR¹⁰, SH, C₁-C₈ alkylthio, C₁-C₈ alkylsulphinyl, C₁-C₈ alkylsulphonyl, C₁-C₈ haloalkylthio, C₁-C₈ haloalkylsulphinyl, C₁-C₈ haloalkylsulphonyl, N(R¹¹)₂, CO₂R¹⁰, O(CO)R⁹, CON(R¹¹)₂, NR¹¹COR⁹ or CR⁹N—OR¹⁰, wherein the alkyl, alkoxy, cycloalkyl, alkenyl, alkynyl, phenyl, pyrimidinyl and pyridyl are optionally substituted by one or more groups independently selected from halogen, CN, NH₂, NO₂, OH, C₁-C₄ alkyl, C₁-C₄ haloalkyl, C₁-C₄ alkoxy, C₁-C₄ haloalkoxy, C₁-C₄ alkylthio, C₁-C₄ alkylsulphinyl and C₁-C₄ alkylsulphonyl;

each R⁹ independently of one another represents hydrogen, C₁-C₈ alkyl, C₃-C₈ cycloalkyl, C₂-C₈ alkenyl, C₂-C₈ alkynyl, benzyl, phenyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

each R¹⁰ independently of one another represents hydrogen, C₁-C₈ alkyl, C₃-C₈ cycloalkyl, C₃-C₈ alkenyl, C₃-C₈ alkynyl, benzyl, phenyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄ haloalkyl, C₁-C₄ alkoxy, C₁-C₄ haloalkoxy and C₁-C₄-alkoxy-C₁-C₄-alkyl;

each R¹¹ independently of one another represents hydrogen, OH, C₁-C₈ alkyl, C₁-C₈ alkoxy, C₁-C₈-alkoxy-C₁-C₄-alkyl, C₃-C₈ alkenyl, C₃-C₈ alkynyl, or COR⁹, wherein the alkyl, alkoxy, alkenyl and alkynyl are optionally substituted by one or more halogen;

wherein when two radicals R¹¹ are attached to the same nitrogen atom, these radicals can be identical or different;

wherein when two radicals R¹¹ are attached to the same nitrogen atom, both of these radicals cannot be OH, C₁-C₄ alkoxy or C₁-C₄ haloalkoxy;

and wherein when two radicals R¹¹ are attached to the same nitrogen atom, these two radicals together with the nitrogen atom to which they are attached may form a cycle B-1, B-2, B-3, B-4, B-5, B-6, B-7 or B-8;

wherein the cycle formed is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

G¹, G², G⁴ and G⁵ independently of one another represent —C(R¹²R¹³)—;

G³ and G⁶ independently of one another represent —C(R¹²R¹³)—, O, N(R¹⁴) or S;

or G¹ and G², or G² and G³, or G¹ and G¹, or G⁴ and G⁵, or G⁵ and G⁶, or G⁴ and G⁴ together represent —CR¹²═CR¹³—;

each R¹² and R¹³ independently of one another represent hydrogen, halogen, C₁-C₄ alkyl, C₁-C₄ haloalkyl, C₁-C₄ alkoxy or C₁-C₄ haloalkoxy;

R¹⁴ represents hydrogen, OH, C₁-C₄ alkyl, C₁-C₄ alkoxy, C₃-C₆-cycloalkyl, C₁-C₈ alkylcarbonyl or C₁-C₈ haloalkylcarbonyl; and

p and q are each independently 0, 1 or 2;

or a salt or an N-oxide thereof.

In one group of compounds

X represents X-3;

Z³ and Z⁵ independently of one another represent methylene, halomethylene, CH(CH₃) or C(CH₃)₂;

Z⁴ represents C═CR³R⁴, CR⁵R⁶, SiR⁷R⁸ or C═O;

R³ and R⁴ independently of one another represent hydrogen, halogen, C₁-C₄ alkyl or C₁-C₄ haloalkyl;

each R⁵, R⁶, R⁷ and R⁸ independently of one another represent hydrogen, halogen, OH, C₁-C₄ alkyl, C₁-C₄ haloalkyl, C₃-C₆ cycloalkyl, phenyl or CN, wherein the phenyl is optionally substituted by one or more groups independently selected from halogen, CN, C₁-C₄ alkyl, C₁-C₄ haloalkyl, C₁-C₄ alkoxy and C₁-C₄ haloalkoxy;

or R⁵ and R⁶ together with the carbon atom to which they are attached may form a C₃-C₆ cycloalkyl group or a C₃-C₆ halocycloalkyl group;

Y¹, Y², Y³, Y⁴, Y⁵ and Y⁶ independently of one another represent hydrogen, halogen, CN, NO₂, C₁-C₈ alkyl, C₁-C₄-alkoxy-C₁-C₄-alkyl, C₁-C₄-alkoxy-C₁-C₄-alkoxy-C₁-C₄-alkyl, C₃-C₈ cycloalkyl, C₂-C₈ alkenyl, C₂-C₈ alkynyl, phenyl, pyridyl, pyrimidinyl, COR⁹, OR¹⁰, SH, C₁-C₈ alkylthio, C₁-C₈ alkylsulphinyl, C₁-C₈ alkylsulphonyl, N(R¹¹)₂, CO₂R¹⁰, O(CO)R⁹, CON(R¹¹)₂, NR¹¹COR⁹ or CR⁹N—OR¹⁰, wherein the alkyl, cycloalkyl, alkenyl, alkynyl, phenyl, pyrimidinyl and pyridyl are optionally substituted by one or more groups independently selected from halogen, CN, NH₂, NO₂, OH, C₁-C₄ alkyl, C₁-C₄ haloalkyl, C₁-C₄ alkoxy, C₁-C₄ haloalkoxy, C₁-C₄ alkylthio, C₁-C₄ alkylsulphinyl and C₁-C₄ alkylsulphonyl;

or independently Y¹ and Y², Y² and Y³, Y⁴ and Y⁵, Y⁵ and Y⁶ together with the fragment of the pyridyl ring to which they are attached may form a partially or fully unsaturated 5- to 7-membered carbocyclic ring or a 5- to 7-membered heterocyclic ring containing one to three heteroatoms independently selected from O, S, N and N(R¹¹), providing that the heterocycle does not contain adjacent oxygen atoms, adjacent sulphur atoms, or adjacent sulphur and oxygen atoms, and wherein the ring formed by Y¹ and Y², Y² and Y³, Y⁴ and Y⁵, or Y⁵ and Y⁶ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy.each R⁹ independently of one another represents hydrogen, C₁-C₈ alkyl, C₃-C₈ cycloalkyl, C₂-C₈ alkenyl, C₂-C₈ alkynyl, benzyl, phenyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

each R¹⁰ independently of one another represents hydrogen, C₁-C₈ alkyl, C₃-C₈ cycloalkyl, C₃-C₈ alkenyl, C₃-C₈ alkynyl, benzyl, phenyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄-haloalkyl, C₁-C₄ alkoxy, C₁-C₄ haloalkoxy and C₁-C₄-alkoxy-C₁-C₄-alkyl;

each R¹¹ independently of one another represents hydrogen, OH, C₁-C₈ alkyl, C₁-C₈ alkoxy, C₁-C₈-alkoxy-C₁-C₄-alkyl, C₃-C₈ alkenyl, C₃-C₈ alkynyl, or COR⁹, wherein the alkyl, alkoxy, alkenyl and alkynyl are optionally substituted by one or more halogen;

wherein when two radicals R¹¹ are attached to the same nitrogen atom, these radicals can be identical or different;

wherein when two radicals R¹¹ are attached to the same nitrogen atom, both of these radicals cannot be OH, C₁-C₄ alkoxy or C₁-C₄ haloalkoxy;

and wherein when two radicals R¹¹ are attached to the same nitrogen atom, these two radicals together with the nitrogen atom to which they are attached may form a cycle B-1, B-2, B-3, B-4, B-5, B-6, B-7 or B-8:

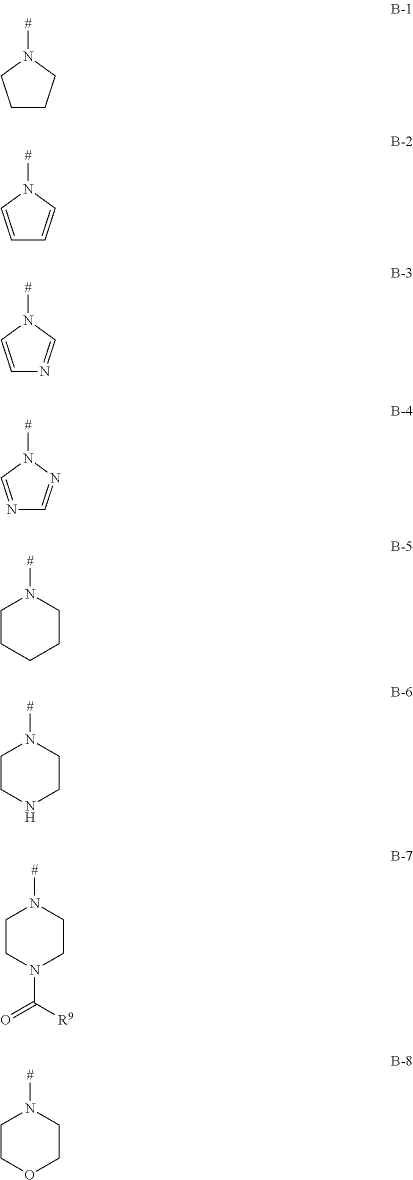

wherein the cycle formed is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

G¹, G², G⁴ and G⁵ independently of one another represent —C(R¹²R¹³)—;

G³ and G⁶ independently of one another represent —C(R¹²R¹³)—, O, N(R¹⁴) or S;

or G¹ and G², or G² and G³, or G¹ and G¹, or G⁴ and G⁵, or G⁵ and G⁶, or G⁴ and G⁴ together represent —CR¹²═CR¹³—;

each R¹² and R¹³ independently of one another represent hydrogen, halogen, C₁-C₄ alkyl, C₁-C₄ haloalkyl, C₁-C₄ alkoxy or C₁-C₄ haloalkoxy;

R¹⁴ represents hydrogen, OH, C₁-C₄ alkyl, C₁-C₄ alkoxy, C₃-C₆ cycloalkyl, C₁-C₈ alkylcarbonyl or C₁-C₈ haloalkylcarbonyl; and

p and q are each independently 0, 1 or 2;

In another group of compounds

X represents X-3;

Z³ and Z⁵ independently of one another represent methylene, halomethylene, CH(CH₃) or C(CH₃)₂;

Z⁴ represents C═CR³R⁴, CR⁵C⁶, SiR⁷R⁸ or C═O;

R³ and R⁴ independently of one another represent hydrogen, halogen, C₁-C₄ alkyl or C₁-C₄ haloalkyl;

each R⁵, R⁶, R⁷ and R⁸ independently of one another represent hydrogen, halogen, OH, C₁-C₄ alkyl, C₁-C₄ haloalkyl, C₃-C₆ cycloalkyl, phenyl or CN, wherein phenyl is optionally substituted by one or more groups independently selected from halogen, CN, C₁-C₄ alkyl, C₁-C₄ haloalkyl, C₁-C₄ alkoxy and C₁-C₄ haloalkoxy;

or R⁵ and R⁶ together with the carbon atom to which they are attached may form a C₃-C₆ cycloalkyl group or a C₃-C₆ halocycloalkyl group;

each R⁹ independently of one another represents hydrogen, C₁-C₈ alkyl, C₃-C₈ cycloalkyl, C₂-C₈ alkenyl, C₂-C₈ alkynyl, benzyl, phenyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

each R¹⁰ independently of one another represents hydrogen, C₁-C₈ alkyl, C₃-C₈ cycloalkyl, C₃-C₈ alkenyl, C₃-C₈ alkynyl, benzyl, phenyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄-haloalkyl, C₁-C₄ alkoxy, C₁-C₄ haloalkoxy and C₁-C₄-alkoxy-C₁-C₄-alkyl;

each R¹¹ independently of one another represents hydrogen, OH, C₁-C₈ alkyl, C₁-C₈ alkoxy, C₁-C₈-alkoxy-C₁-C₄-alkyl, C₃-C₈ alkenyl, C₃-C₈ alkynyl, or COR⁹, wherein the alkyl, alkoxy, alkenyl and alkynyl are optionally substituted by one or more halogen;

wherein when two radicals R¹¹ are attached to the same nitrogen atom, these radicals can be identical or different;

wherein when two radicals R¹¹ are attached to the same nitrogen atom, both of these radicals cannot be OH, C₁-C₄ alkoxy or C₁-C₄ haloalkoxy;

and wherein when two radicals R¹¹ are attached to the same nitrogen atom, these two radicals together with the nitrogen atom to which they are attached may form a cycle B-1, B-2, B-3, B-4, B-5, B-6, B-7 or B-8:

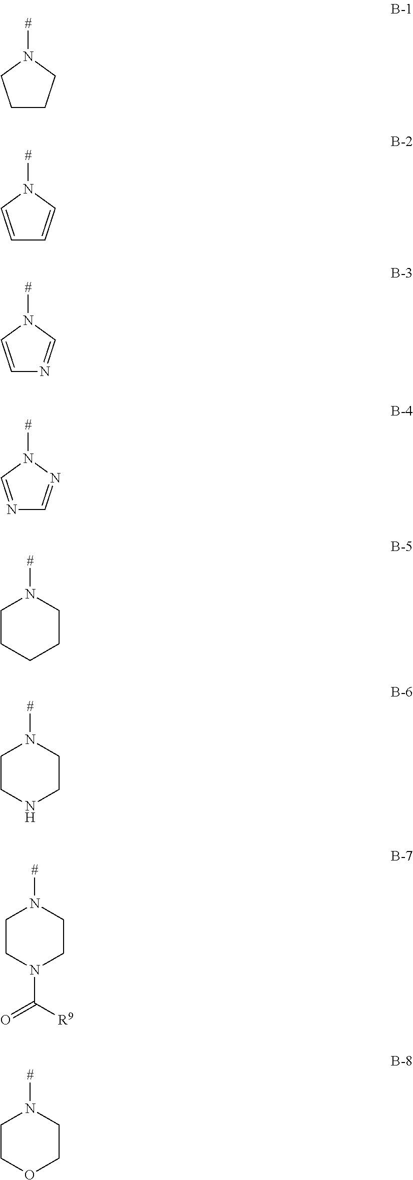

wherein the cycle formed is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

Y¹ and Y⁴ independently of one another represent C₁-C₈ alkyl, C₁-C₈ alkoxy, C₃-C₈ cycloalkyl, N(R¹¹)₂, phenyl, pyridyl, pyrimidinyl, C₁-C₈ alkylthio, C₁-C₈ alkylsulphinyl, C₁-C₈ alkylsulphonyl, wherein the alkyl, alkoxy, cycloalkyl, phenyl, pyrimidinyl and pyridyl are optionally substituted by one or more groups independently selected from halogen, CN, NH₂, NO₂, OH, C₁-C₄ alkyl, C₁-C₄ haloalkyl, C₁-C₄ alkoxy, C₁-C₄ haloalkoxy, C₁-C₄ alkylthio, C₁-C₄ alkylsulphinyl and C₁-C₄ alkylsulphonyl;

Y², Y³, Y⁵, and Y⁶ independently of one another represent hydrogen, halogen, CN, NO₂, C₁-C₈ alkyl, C₁-C₄-alkoxy-C₁-C₄-alkyl, C₁-C₄-alkoxy-C₁-C₄-alkoxy-C₁-C₄-alkyl, C₃-C₈ cycloalkyl, C₂-C₈ alkenyl, C₂-C₈ alkynyl, phenyl, pyridyl, pyrimidinyl, COR⁹, OR¹⁰, SH, C₁-C₈ alkylthio, C₁-C₈ alkylsulphinyl, C₁-C₈ alkylsulphonyl, N(R¹¹)₂, CO₂R¹⁰, O(CO)R⁹, CON(R¹¹)₂, NR¹¹COR⁹ or CR⁹N—OR¹⁰, wherein the alkyl, cycloalkyl, alkenyl, alkynyl, phenyl, pyrimidinyl and pyridyl are optionally substituted by one or more groups independently selected from halogen, CN, NH₂, NO₂, OH, C₁-C₄ alkyl, C₁-C₄ haloalkyl, C₁-C₄ alkoxy, C₁-C₄ haloalkoxy, C₁-C₄ alkylthio, C₁-C₄ alkylsulphinyl and C₁-C₄ alkylsulphonyl;

or independently Y¹ and Y², Y² and Y³, Y⁴ and Y⁵, Y⁵ and Y⁶ together with the fragment of the pyridyl ring to which they are attached may form a partially or fully unsaturated 5- to 7-membered carbocyclic ring or a 5- to 7-membered heterocyclic ring containing one to three heteroatoms independently selected from O, S, N and N(R¹¹), providing that the heterocycle does not contain adjacent oxygen atoms, adjacent sulphur atoms, or adjacent sulphur and oxygen atoms, and wherein the ring formed by Y¹ and Y², Y² and Y³, Y⁴ and Y⁵, or Y⁵ and Y⁶ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

G¹, G², G³, G⁴, G⁵ and G⁶ represent methylene;

p and q independently of one another represent 1 or 2.

In another group of compounds X represents X-3;

Z³ and Z⁵ represent methylene;

Z⁴ represents C═CR³R⁴, CR⁵R⁶ or SiR⁷R⁸;

R³ and R⁴ independently of one another represent hydrogen, halogen, methyl or halomethyl;

R⁵ and R⁶, R⁷ and R⁸ independently of one another represent hydrogen, halogen, OH, C₁-C₄ alkyl, C₁-C₄ haloalkyl or phenyl, wherein the phenyl is optionally substituted by one or more groups independently selected from halogen, CN, methyl, halomethyl, methoxy and halomethoxy;

or R⁵ and R⁶ together with the carbon atom to which they are attached may form a C₃-C₆ cycloalkyl group optionally substituted by halogen;

each R⁹ independently represents C₁-C₄-alkyl or C₁-C₄ haloalkyl;

each R¹¹ independently of one another represent hydrogen or C₁-C₄ alkyl;

wherein when two radicals R¹¹ are attached to the same nitrogen atom, these radicals can be identical or different;

and wherein when two radicals R¹¹ are attached to the same nitrogen atom, these two radicals together with the nitrogen atom to which they are attached may form a cycle B-1, B-2, B-3, B-4 or B-5, wherein the cycle formed is optionally substituted by one or more groups independently selected from halogen, methyl and halomethyl;

wherein Y¹ and Y⁴ independently of one another represent C₁-C₄ alkyl, C₁-C₄ haloalkyl, OH, C₁-C₄ alkoxy, C₁-C₄ haloalkoxy, phenyl or pyridyl, wherein the phenyl and pyridyl are optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

Y², Y³, Y⁵, and Y⁶ independently of one another represent hydrogen, CN, OH, NH₂, halogen, C₁-C₄ alkyl, C₁-C₄ haloalkyl, C₁-C₄ alkoxy, C₁-C₄ haloalkoxy, C₃-C₆ cycloalkyl, N(R¹¹)₂, NR¹¹COR⁹ or phenyl, wherein phenyl is optionally substituted by one or more groups selected from halogen, methyl, CN, methoxy, halomethyl and halomethoxy;

or independently Y¹ and Y², Y² and Y³, Y⁴ and Y⁵, Y⁵ and Y⁶ together with the fragment of the pyridyl ring to which they are attached may form a partially or fully unsaturated 5- to 7-membered carbocyclic ring, wherein the ring formed by Y¹ and Y², Y² and Y³, Y⁴ and Y⁵, Y⁵ and Y⁶ is optionally substituted by one or more groups independently selected from halogen, CN, NH₂, NO₂, OH, methyl and halomethyl; G¹, G², G³, G⁴, G⁵ and G⁶ represent methylene;

p and q independently of one another represent 1 or 2.

In yet another group of compounds Y², Y³, Y⁵ and Y⁶ independently of one another represent hydrogen, CN, OR¹⁰, NH₂, halogen, C₁-C₈ alkyl, C₁-C₈ haloalkyl, C₂-C₈ alkenyl, C₂-C₈ alkynyl, C₃-C₈ cycloalkyl, SH, C₁-C₈ alkylthio, N(R¹¹)₂, NR¹¹COR⁹ or phenyl, wherein phenyl is optionally substituted by one or more groups independently selected from halogen, methyl, CN, methoxy, halomethyl and halomethoxy;

or independently Y¹ and Y², Y² and Y³, Y⁴ and Y⁵, Y⁵ and Y⁶ together with the fragment of the pyridyl ring to which they are attached may form a partially or fully unsaturated 5- to 7-membered carbocyclic ring, wherein the ring formed by Y¹ and Y², Y² and Y³, Y⁴ and Y⁵, Y⁵ and Y⁶ is optionally substituted by one or more groups independently selected from halogen, CN, NH₂, NO₂, OH, methyl and halomethyl;

each R⁹ independently of one another represents C₁-C₄-alkyl or C₁-C₄ haloalkyl;

each R¹⁰ independently represents one another represents hydrogen, C₁-C₈ alkyl, C₃-C₈ cycloalkyl, C₃-C₈ alkenyl, C₃-C₈ alkynyl, benzyl, phenyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄-haloalkyl, C₁-C₄ alkoxy, C₁-C₄ haloalkoxy and C₁-C₄-alkoxy-C₁-C₄-alkyl;

each R¹¹ independently of one another represent hydrogen or C₁-C₄ alkyl;

wherein when two radicals R¹¹ are attached to the same nitrogen atom, these radicals can be identical or different;

and wherein when two radicals R¹¹ are attached to the same nitrogen atom, these two radicals together with the nitrogen atom to which they are attached may form a cycle B-1, B-2, B-3, B-4 or B-5, wherein the cycle formed is optionally substituted by one or more groups independently selected from halogen, methyl and halomethyl.

In a further preferred group of compounds Y², Y³, Y⁵, and Y⁶ independently of one another represent hydrogen, CN, OH, NH₂, halogen, C₁-C₄ alkyl, C₁-C₄ haloalkyl, C₁-C₄ alkoxy, C₁-C₄ haloalkoxy, C₃-C₆ cycloalkyl, N(R¹¹)₂, NR¹¹COR⁹ or phenyl, wherein phenyl is optionally substituted by one or more groups selected from halogen, methyl, CN, methoxy, halomethyl and halomethoxy;

or independently Y¹ and Y², Y⁴ and Y⁵ together with the fragment of the pyridyl ring to which they are attached may form a partially or fully unsaturated 6-membered carbocyclic ring wherein the ring formed by Y¹ and Y², or Y⁴ and Y⁵ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

each R⁹ independently represents C₁-C₄-alkyl or C₁-C₄ haloalkyl

each R¹¹ independently of one another represent hydrogen or C₁-C₄ alkyl;

wherein when two radicals R¹¹ are attached to the same nitrogen atom, these radicals can be identical or different;

and wherein when two radicals R¹¹ are attached to the same nitrogen atom, these two radicals together with the nitrogen atom to which they are attached may form a cycle B-1, B-2, B-3, B-4 or B-5, wherein the cycle formed is optionally substituted by one or more groups independently selected from halogen, methyl and halomethyl.

In a further preferred group of compounds

X represents X-3;

Z³ and Z⁵ represent methylene;

Z⁴ represents CR⁵R⁶, C═CR³R⁴, or SiR⁷R⁸;

R³ and R⁴ independently of one another represent hydrogen, halogen, methyl or halomethyl;

R⁵, R⁶, R⁷ and R⁸ independently of one another represent hydrogen, halogen, OH, C₁-C₄ alkyl, C₁-C₄ haloalkyl or phenyl, wherein the phenyl is optionally substituted by one or more groups independently selected from halogen, CN, methyl, halomethyl, methoxy and halomethoxy;

or R⁵ and R⁶ together with the carbon atom they are attached may form a C₃-C₆ cycloalkyl group or a C₃-C₆ halocycloalkyl group.

In a further preferred group of compounds

X represents X-3;

Z³ and Z⁵ represent methylene;

Z⁴ represents CR⁵R⁶ or C═CR³R⁴;

R³ and R⁴ independently of one another represent hydrogen, halogen, methyl or halomethyl;

R⁵ and R⁶ independently of one another represent hydrogen, halogen, C₁-C₄ alkyl, C₁-C₄ haloalkyl or phenyl, wherein the phenyl is optionally substituted by one or more groups independently selected from halogen, CN, methyl, halomethyl, methoxy and halomethoxy;

or R⁵ and R⁶ together with the carbon atom they are attached may form a C₃-C₆ cycloalkyl group or a C₃-C₆ halocycloalkyl group.

In yet another preferred group of compounds Y¹ represents the same substituent as Y⁴, Y² represents the same substituent as Y⁵, and Y³ represents the same substituent as Y⁶.

In yet another preferred group of compounds Y¹ represents the same substituent as Y⁴, Y² represents the same substituent as Y⁵, and Y³ represents the same substituent as Y⁶, and wherein p is the same as q and are either 1 or 2 (preferably 1), and wherein G¹ represents the same substituent as G⁴, G² represents the same substituent as G⁵ and G³ represents the same substituent as G⁶. In yet another preferred group of compounds Y¹ represents the same substituent as Y⁴, Y² represents the same substituent as Y⁵, and Y³ represents the same substituent as Y⁶, and wherein p is the same as q and are either 1 or 2 (preferably 1), and wherein G¹ represents the same substituent as G⁴, G² represents the same substituent as G⁵ and G³ represents the same substituent as G⁶, and wherein X is either X-3 or X-5 (preferably X-3) and wherein Z³ represents the same substituent as Z⁵, Z¹¹ represents the same substituent as Z¹³ and Z¹⁰ represents the same substituent as Z¹⁴.

In a further group of preferred compounds

X represents X-3;

Z³ and Z⁵ represent methylene;

Z⁴ represents C═CR³R⁴CR⁵R⁶ or SiR⁷R⁸;

R³ and R⁴ independently of one another represent hydrogen, halogen, methyl or halomethyl;

R⁵, R⁶, R⁷ and R⁸ independently of one another represent hydrogen, halogen, OH, C₁-C₄ alkyl, C₁-C₄ haloalkyl or phenyl, wherein the phenyl is optionally substituted by one or more groups independently selected from halogen, CN, methyl, halomethyl, methoxy and halomethoxy;

or R⁵ and R⁶ together with the carbon atom to which they are attached may form a C₃-C₆ cycloalkyl group optionally substituted by halogen;

Y¹, Y², Y³, Y⁴, Y⁵ and Y⁶ independently of one another represent hydrogen, halogen, N(R¹¹)₂CN, NO₂, C₁-C₈ alkyl, C₁-C₆-alkoxy-C₁-C₄-alkyl, C₃-C₈ cycloalkyl, C₂-C₆ alkenyl, C₂-C₆ alkynyl, phenyl, pyridyl, OR¹⁰, SH, C₁-C₈ alkylthio, C₁-C₈ alkylsulphinyl or C₁-C₈ alkylsulphonyl,

wherein the alkyl, cycloalkyl, alkenyl, alkynyl, phenyl and pyridyl are optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

or Y¹ and Y², Y² and Y³, Y⁴ and Y⁵, Y⁵ and Y⁶ together with the fragment of the pyridyl ring to which they are attached may form a partially or fully unsaturated 5- to 7-membered carbocyclic ring, wherein the ring formed by Y¹ and Y², Y² and Y³, Y⁴ and Y⁵, Y⁵ and Y⁶ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

each R¹⁰ independently of one another represent hydrogen, C₁-C₄ alkyl, C₃-C₄ cycloalkyl, C₃-C₆ alkenyl, C₃-C₆ alkynyl, benzyl, phenyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄-haloalkyl, C₁-C₄ alkoxy, C₁-C₄ haloalkoxy and C₁-C₄-alkoxy-C₁-C₄-alkyl;

each R¹¹ independently of one another represent hydrogen or C₁-C₈ alkyl, wherein the alkyl is optionally substituted by one or more halogen;

wherein when two radicals R¹¹ are attached to the same nitrogen atom, these radicals can be identical or different;

and wherein when two radicals R¹¹ are attached to the same nitrogen atom, these two radicals together with the nitrogen atom to which they are attached may form a cycle B-1, B-2, B-3, B-4 or B-5 wherein the cycle formed is optionally substituted by one or more groups independently selected from halogen, methyl and halomethyl;

G¹, G², G³, G⁴, G⁵ and G⁶ represent methylene; and

p and q are 1.

In yet another preferred group of compounds X represents X-3;

Z³ and Z⁵ represent methylene;

Z⁴ represents C═CR³R⁴, CR⁵R⁶ or SiR⁷R⁸;

each R³ and R⁴ independently of one another represent hydrogen, halogen, methyl or halomethyl;

each R⁵, R⁶, R⁷ and R⁸ independently of one another represent hydrogen, halogen, OH, C₁-C₄ alkyl, C₁-C₄ haloalkyl or phenyl, wherein the phenyl is optionally substituted by one or more groups independently selected from halogen, CN, methyl, halomethyl, methoxy and halomethoxy;

or R⁵ and R⁶ together with the carbon atom to which they are attached may form a C₃-C₆ cycloalkyl group optionally substituted by halogen; and

Y¹, Y², Y³, Y⁴, Y⁵ and Y⁶ independently of one another represent hydrogen, halogen, N(R¹¹)₂CN, NO₂, C₁-C₆ alkyl, C₁-C₄-alkoxy-C₁-C₄-alkyl, C₃-C₆ cycloalkyl, C₂-C₆ alkenyl, C₂-C₆ alkynyl, phenyl, pyridyl, C₁-C₄-alkoxy, C₁-C₄-alkenoxy, C₁-C₄-alkynoxy, phenoxy, SH, C₁-C₈ alkylthio, C₁-C₈ alkylsulphinyl or C₁-C₈ alkylsulphonyl, wherein the alkyl, cycloalkyl, alkenyl, alkynyl, phenyl and pyridyl are optionally substituted by one or more groups independently selected from halogen, CN, NH₂, NO₂, OH, methyl and halomethyl;

or Y¹ and Y², Y² and Y³, Y⁴ and Y⁵, Y⁵ and Y⁶ together with the fragment of the pyridyl ring to which they are attached may form a partially or fully unsaturated 5- to 7-membered carbocyclic ring, wherein the ring formed by Y¹ and Y², Y² and Y³, Y⁴ and Y⁵, Y⁵ and Y⁶ is optionally substituted by one or more groups independently selected from halogen, CN, NH₂, NO₂, OH, methyl and halomethyl;

each R¹¹ independently of one another represent hydrogen or C₁-C₈ alkyl, wherein the alkyl, is optionally substituted by one or more halogen;

wherein when two radicals R¹¹ are attached to the same nitrogen atom, these radicals can be identical or different;

and wherein when or two radicals R¹¹ are attached to the same nitrogen atom, these two radicals together with the nitrogen atom to which they are attached may form a cycle B-1, B-2, B-3, B-4 or B-5 wherein the cycle formed is optionally substituted by one or more groups independently selected from halogen, methyl and halomethyl;

G¹, G², G³, G⁴, G⁵ and G⁶ represent methylene; and

p and q are 1.

In yet another preferred group of compounds X represents X-3;

Z³ and Z⁵ represent methylene;

Z⁴ represents C═CR³R⁴, CR⁵R⁶ or SiR⁷R⁸;

each R³ and R⁴ independently of one another represent hydrogen, halogen, methyl or halomethyl;

each R⁵, R⁶, R⁷ and R⁸ independently of one another represent hydrogen, halogen, OH, C₁-C₄ alkyl, C₁-C₄ haloalkyl or phenyl, wherein the phenyl is optionally substituted by one or more groups independently selected from halogen, CN, methyl, halomethyl, methoxy and halomethoxy;

or R⁵ and R⁶ together with the carbon atom to which they are attached may form a C₃-C₆ cycloalkyl group optionally substituted by halogen; and

Y¹, Y³, Y⁴ and Y⁶ independently of one another represent hydrogen, halogen, N(R¹¹)₂CN, C₁-C₆ alkyl, C₃-C₆ cycloalkyl, C₂-C₆ alkenyl, C₂-C₆ alkynyl, phenyl, pyridyl, C₁-C₄-alkoxy, C₁-C₄-alkenoxy, C₁-C₄-alkynoxy, phenoxy, SH, C₁-C₈ alkylthio, C₁-C₈ alkylsulphinyl or C₁-C₈ alkylsulphonyl, wherein the alkyl, cycloalkyl, alkenyl, alkynyl, phenyl and pyridyl are optionally substituted by one or more groups independently selected from halogen, CN, NH₂, NO₂, OH, methyl and halomethyl;

Y² and Y⁵ independently of one another represent hydrogen, halogen, methyl, halomethyl;

or independently Y¹ and Y², Y⁴ and Y⁵ together with the fragment of the pyridyl ring to which they are attached may form a partially or fully unsaturated 6-membered carbocyclic ring (e.g. —CH₂—CH₂—CH₂—CH₂— or —CH═CH—CH═CH₂—), wherein the ring formed by Y¹ and Y², and Y⁴ and Y⁵ is optionally substituted by one or more groups independently selected from halogen, CN, NH₂, NO₂, OH, methyl and halomethyl;

each R¹¹ independently of one another represent hydrogen or C₁-C₈ alkyl, wherein the alkyl, is optionally substituted by one or more halogen;

wherein when two radicals R¹¹ are attached to the same nitrogen atom, these radicals can be identical or different;

and wherein when or two radicals R¹¹ are attached to the same nitrogen atom, these two radicals together with the nitrogen atom to which they are attached may form a cycle B-1, B-2, B-3, B-4 or B-5 wherein the cycle formed is optionally substituted by one or more groups independently selected from halogen, methyl and halomethyl;

G¹, G², G³, G⁴, G⁵ and G⁶ represent methylene; and

p and q are 1.

In one embodiment the invention relates to compounds of the formula (IA)

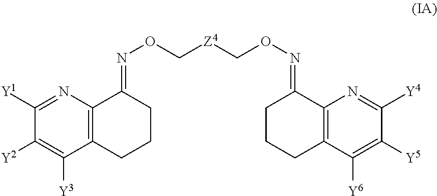

wherein Z⁴, Y¹, Y², Y³, Y⁴, Y⁵ and Y⁶ are as defined for a compound of formula (I). The preferred definitions of Z⁴, Y¹, Y², Y³, Y⁴, Y⁵ and Y⁶ defined in respect of compounds of formula (I) also apply to compounds of formula (IA).

In a further embodiment the invention relates to compounds of the formula (IB)

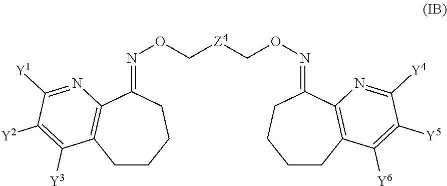

wherein Z⁴, Y¹, Y², Y³, Y⁴, Y⁵ and Y⁶ are as defined for a compound of formula (I). The preferred definitions of Z⁴, Y¹, Y², Y³, Y⁴, Y⁵ and Y⁶ defined in respect of compounds of formula (I) also apply to compounds of formula (IB).

In a further embodiment the invention relates to compounds of the formula (IC)

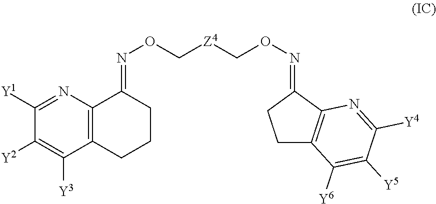

wherein Z⁴, Y¹, Y², Y³, Y⁴, Y⁵ and Y⁶ are as defined for a compound of formula (I). The preferred definitions of Z⁴, Y¹, Y², Y³, Y⁴, Y⁵ and Y⁶ defined in respect of compounds of formula (I) also apply to compounds of formula (IC).

Where it is stated above that Y¹ and Y², Y² and Y³, Y⁴ and Y⁵, Y⁵ and Y⁶ together with the fragment of the pyridyl ring to which they are attached may form a partially or fully unsaturated 5- to 7-membered carbocyclic ring or a 5- to 7-membered heterocyclic ring then compounds with a ring formed by Y¹ and Y² and/or Y⁴ and Y⁵ together with the fragment of the pyridyl ring to which they are attached are preferred.

Optionally, in any group of compounds of the invention, compounds in which any of Y¹ and Y², Y² and Y³, Y⁴ and Y⁵, Y⁵ and Y⁶ can form a partially or fully unsaturated 5- to 7-membered carbocyclic ring or a 5- to 7-membered heterocyclic ring may be excluded, although it is preferred that these compounds are not excluded.

Certain intermediates that can be used to prepare compounds of formula (I) are novel and as such also form part of the present invention.

Accordingly, in a further aspect the invention provides a compound of formula (II)

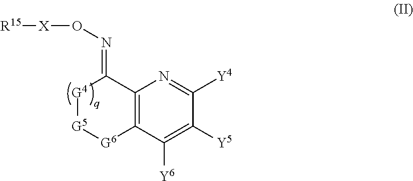

wherein R¹⁵ represents —ONH₂, halogen, —O—SO₂—R¹⁶, trichloroacetimidate, —ONH—CO—R⁹, —ONH—CO—OR¹⁰;

R¹⁶ represents C₁-C₄ alkyl, C₁-C₄ haloalkyl or phenyl, wherein the phenyl is optionally substituted by one or two substituents independently selected from methyl, trihalomethyl, NO₂, CN, C₁-C₇ alkoxycarbonyl;

and X, G⁴, G⁵, G⁶, Y⁴, Y⁵, Y⁶ and q are as defined for the compound of formula (I); or a salt or N-oxide thereof.

In one group of compounds of formula (II) at least one of Y⁴, Y⁵ or Y⁶ represents pyrimidinyl, C₁-C₈ haloalkylthio, C₁-C₈ haloalkylsulphinyl or C₁-C₈ haloalkylsulphonyl wherein the pyrimidinyl is optionally substituted by one or more groups independently selected from halogen, CN, NH₂, NO₂, OH, C₁-C₄ alkyl, C₁-C₄ haloalkyl, C₁-C₄ alkoxy, C₁-C₄ haloalkoxy, C₁-C₄ alkylthio, C₁-C₄ alkylsulphinyl and C₁-C₄ alkylsulphonyl.

In one group of compounds of formula (II) G⁶ represents N(R¹⁴) wherein R¹⁴ represents C₃-C₆ cycloalkyl.

The preferred definitions of X, G⁴, G⁵, G⁶, Y⁴, Y⁵, Y⁶ and q defined in respect of compounds of formula (I) also apply to compounds of formula (II).

Preferably R¹⁵ represents —ONH₂, —O—SO₂—R¹⁶, trichloroacetimidate or halogen.

Preferably R¹⁵ represents —ONH₂, tosylate, mesylate, triflate or trichloroacetimidate.

In a further aspect the invention provides a compound of formula (III)

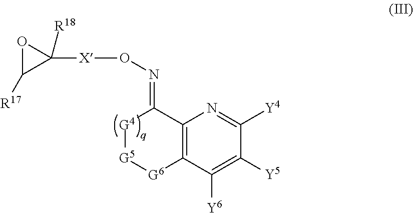

wherein X′ represents one of the groupings X′-1, X′-2 or X′-3:

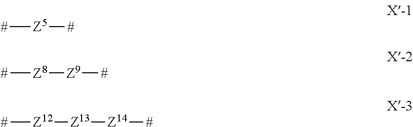

Z⁵, Z⁸, Z⁹, Z¹², Z¹³ and Z¹⁴ are as defined for a compound of formula (I);

R¹⁷ and R¹⁸ independently of one another represent hydrogen, halogen, C₁-C₄ alkyl, C₁-C₄ haloalkyl, phenyl or CN, wherein phenyl is optionally substituted by one or more groups, e.g. one to five groups, independently selected from halogen, CN, C₁-C₄ alkyl, C₁-C₄ haloalkyl, C₁-C₄ alkoxy and C₁-C₄ haloalkoxy; and

G⁴, G⁵, G⁶, Y⁴, Y⁵, Y⁶ and q are as defined for the compound of formula (I) described herein; or a salt or N-oxide thereof.

In one group of compounds of formula (III) at least one of Y⁴, Y⁵ or Y⁶ represents pyrimidinyl, C₁-C₈ haloalkylthio, C₁-C₈ haloalkylsulphinyl or C₁-C₈ haloalkylsulphonyl, wherein the pyrimidinyl is optionally substituted by one or more groups independently selected from halogen, CN, NH₂, NO₂, OH, C₁-C₄ alkyl, C₁-C₄ haloalkyl, C₁-C₄ alkoxy, C₁-C₄ haloalkoxy, C₁-C₄ alkylthio, C₁-C₄ alkylsulphinyl and C₁-C₄ alkylsulphonyl.

In another group of compounds of formula (III) G⁶ represents N(R¹⁴) wherein R¹⁴ represents C₃-C₆ cycloalkyl.

Preferably, R¹⁷ and R¹⁸ independently of one another represent hydrogen, halogen, C₁-C₄ alkyl, C₁-C₄ haloalkyl, phenyl or CN, wherein the phenyl is optionally substituted by one or more groups independently selected from halogen, CN, methyl, halomethyl, methoxy and halomethoxy.

The preferred definitions of Z⁵, Z⁸, Z⁹, Z¹², Z¹³, Z¹⁴, G⁴, G⁵, G⁶, Y⁴, Y⁵, Y⁶ and q defined in respect of compounds of formula (I) above also apply to compounds of formula (III).

Preferably X′ represents X′-1.

In a further aspect the invention provides a compound of formula (IV)

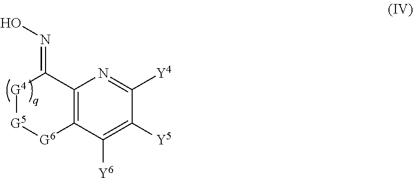

wherein G⁴, G⁵, G⁶, Y⁴, Y⁵, Y⁶ and q are as defined for a compound of formula (I) providing that:

when q is 1 and G⁴, G⁵, G⁶ are —CH₂—, then Y⁴, Y⁵ and Y⁶ are not all H;

when q is 1, G⁴, G⁵, G⁶ are —CH₂—, and Y⁵ and Y⁶ are H, then Y⁴ is not methoxy;

when q is 1, G⁴, G⁵, G⁶ are —CH₂—, and Y⁴ and Y⁶ are H, then Y⁵ is not methyl;

when q is 1, G⁴, G⁵ are —CH₂—, and Y⁴, Y⁵ and Y⁶ are H, then G⁶ is not O;

when q is 1, G⁴ and G⁵ together form CH═CH, Y⁴, Y⁵ and Y⁶ are H, then G⁶ is not C(CHCl₂)(CH₃);

when q is 2 and G⁴, G⁵, G⁶ are —CH₂—, then Y⁶, Y⁷ and Y⁸ are not all H;

when q is 0, G⁶ is —CH₂— and Y⁶, Y⁷ and Y⁸ are H, then G⁵ is not CH(CH₂CH₃);

or a salt or N-oxide thereof.

Preferably, Y⁴ represents halogen, CN, NO₂, C₁-C₈ alkyl, C₁-C₄-alkoxy-C₁-C₄-alkyl, C₁-C₄-alkoxy-C₁-C₄-alkoxy-C₁-C₄-alkyl, C₃-C₈ cycloalkyl, C₂-C₈ alkenyl, C₂-C₈ alkynyl, phenyl, pyridyl, pyrimidinyl, COR⁹, OR^{10′}, SH, C₁-C₈ alkylthio, C₁-C₈ alkylsulphinyl, C₁-C₈ alkylsulphonyl, N(R¹¹)₂, CO₂R¹⁰, O(CO)R⁹, CON(R¹¹)₂, NR¹¹COR⁹ or CR⁹N—OR¹⁰, wherein the alkyl, cycloalkyl, alkenyl, alkynyl, phenyl, pyrimidinyl and pyridyl are optionally substituted by one or more groups independently selected from halogen, CN, NH₂, NO₂, OH, C₁-C₄ alkyl, C₁-C₄ haloalkyl, C₁-C₄ alkoxy, C₁-C₄ haloalkoxy, C₁-C₄ alkylthio, C₁-C₄ alkylsulphinyl and C₁-C₄ alkylsulphonyl.

More preferably Y⁴ represents C₁-C₈ alkyl, C₂-C₈ alkoxy, C₃-C₈ cycloalkyl, N(R¹¹)₂, phenyl, pyridyl, pyrimidinyl, C₁-C₈ alkylthio, C₁-C₈ alkylsulphinyl, C₁-C₈ alkylsulphonyl, C₁-C₈ haloalkylthio, C₁-C₈ haloalkylsulphinyl or C₁-C₈ haloalkylsulphonyl, wherein the alkyl, cycloalkyl, phenyl, pyrimidinyl and pyridyl are optionally substituted by one or more groups independently selected from halogen, CN, NH₂, NO₂, OH, C₁-C₄ alkyl, C₁-C₄ haloalkyl, C₁-C₄ alkoxy, C₁-C₄ haloalkoxy, C₁-C₄ alkylthio, C₁-C₄ alkylsulphinyl and C₁-C₄ alkylsulphonyl.

Even more preferably Y⁴ represents C₁-C₄ alkyl, C₁-C₄ haloalkyl, OH, C₂-C₄ alkoxy, C₂-C₄ haloalkoxy, phenyl or pyridyl, wherein the phenyl and pyridyl are optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy.

R^{10′} represents hydrogen, C₂-C₈-alkyl, C₃-C₈-cycloalkyl, C₃-C₈-alkenyl, C₃-C₈-alkynyl, benzyl, phenyl or pyridyl, wherein the alkyl, cycloalkyl, alkenyl, alkynyl, phenyl and pyridyl are optionally substituted by one or more groups independently selected from halogen, CN, NH₂, NO₂, OH, C₁-C₄-alkyl, C₁-C₄-haloalkyl, C₁-C₄-alkoxy, C₁-C₄-haloalkoxy and C₁-C₄-alkoxy-C₁-C₄-alkyl.

In one group of compounds of formula (IV) at least one of Y⁴, Y⁵ or Y⁶ represents pyrimidinyl, C₁-C₈ haloalkylthio, C₁-C₈ haloalkylsulphinyl or C₁-C₈ haloalkylsulphonyl, wherein the pyrimidinyl is optionally substituted by one or more groups independently selected from halogen, CN, NH₂, NO₂, OH, C₁-C₄ alkyl, C₁-C₄ haloalkyl, C₁-C₄ alkoxy, C₁-C₄ haloalkoxy, C₁-C₄ alkylthio, C₁-C₄ alkylsulphinyl and C₁-C₄ alkylsulphonyl.

In another group of compounds of formula (IV) G⁶ represents N(R¹⁴) wherein R¹⁴ represents C₃-C₆ cycloalkyl or a salt or N-oxide thereof.

The preferred definitions of G³, G⁵, G⁶, Y⁴, Y⁵, Y⁶ and q are as defined in respect of compounds of formula (I) above also apply to compounds of formula (IV).

In a further aspect the invention provides a process for the production of a compound of formula (I) comprising reacting a compound of formula (IIb) with a compound of formula (V) as shown in scheme A

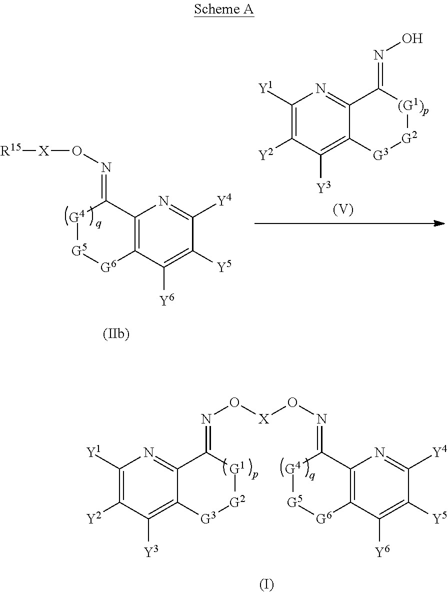

wherein R¹⁵ represents halogen, —O—SO₂—R¹⁶ or trichloroacetimidate;

R¹⁶ represents C₁-C₄-alkyl, C₁-C₄-haloalkyl or phenyl, wherein the phenyl is optionally substituted by one or two substituents independently selected from methyl, trihalomethyl, NO₂, CN, C₁-C₇-alkoxycarbonyl; and

X, G¹, G², G³, G⁴, G⁵, G⁶, Y¹, Y², Y³, Y⁴, Y⁵, Y⁶, p, and q are as defined for the compound of formula (I).

The preferred definitions of X, G¹, G², G³, G⁴, G⁵, G⁶, Y¹, Y², Y³, Y⁴, Y⁵, Y⁶, p, and q defined in respect of compounds of formula (I) above also apply to compound (IIb) and (V).

In a further aspect the invention relates to a process for the production of a compound of formula (I) comprising reacting a compound of formula (VIa) with a compound of formula (VIIa) to produce a compound of formula (IIa) and reacting the compound of formula (IIa) with a compound of formula (VIIIa) as shown in scheme B

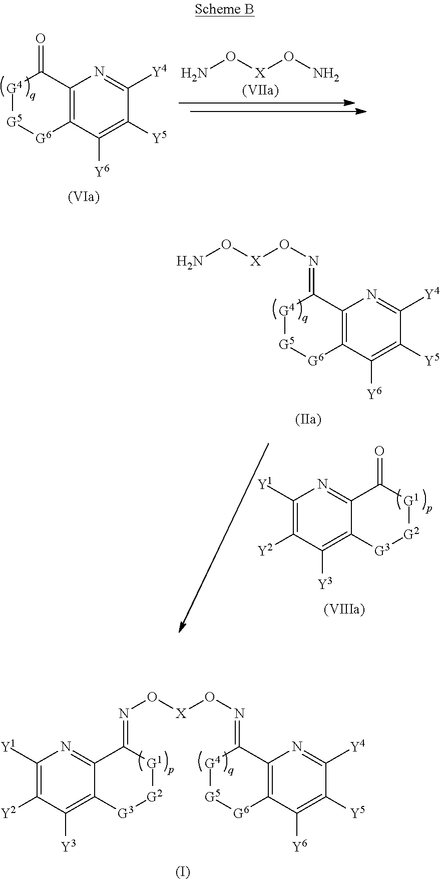

wherein X, G¹, G², G³, G⁴, G⁵, G⁶, Y¹, Y², Y³, Y⁴, Y⁵, Y⁶, p and q are as defined for the compound of formula (I) and wherein (VIIa) is for example either used in its free form or in the presence of one or more acids, such as HCl, HBr, CH₃COOH, oxalic acid, sulphuric acid, para-toluene-sulfonic acid. A suitable amount of acid is e.g. a catalytic amount or it may be present up to 1 or 2 or more equivalents with respect to compound (VIIa). The preferred definitions of X, G¹, G², G³, G⁴, G⁵, G⁶, Y¹, Y², Y³, Y⁴, Y⁵, Y⁶, p, and q defined in respect of compounds of formula (I) above also apply to compounds of formulas (IIa), (VIa), (VIIa) and (VIIIa).

In a further aspect the invention relates to a process for the production of a compound of formula (I) comprising reacting a compound of formula (VIa) with a compound of formula (VIIIa) and a compound of formula (VIIa) as shown in scheme C

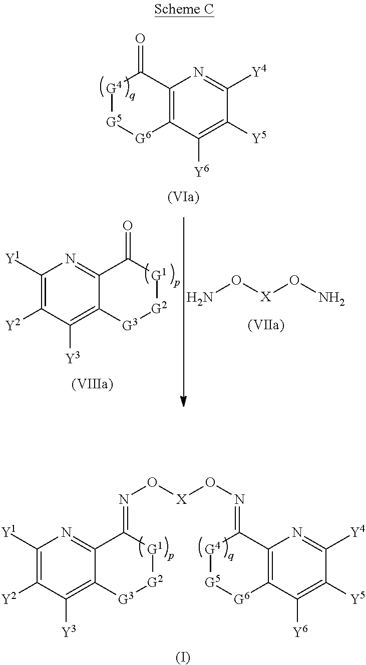

wherein X, G¹, G², G³, G⁴, G⁵, G⁶, Y¹, Y², Y³, Y⁴, Y⁵, Y⁶, p, and q are as defined for the compound of formula (I) and wherein (VIIa) is for example either used in its free form or in the presence of one or more acids, such as HCl, HBr, CH₃COOH, oxalic acid, sulphuric acid, para-toluene-sulfonic acid. A suitable amount of acid is e.g. a catalytic amount or it may be present up to 1 or 2 or more equivalents with respect to compound (VIIa). The preferred definitions of X, G¹, G², G³, G⁴, G⁵, G⁶, Y¹, Y², Y³, Y⁴, Y⁵, Y⁶, p, and q defined in respect of compounds of formula (I) above also apply to compounds of formulas (IIa), (VIa), (VIIa) and (VIIIa).

The compounds of formula (I) may exist as different geometric or optical isomers or in different tautomeric forms. These may be separated and isolated by well-known (usually chromatographic) techniques, and all such isomers and tautomers and mixtures thereof in all proportions as well as isotopic forms, such as deuterated compounds, are part of the present invention. In particular, the carbon-nitrogen double bonds of the compound of formula (I) allow the four cis/trans isomers shown below:

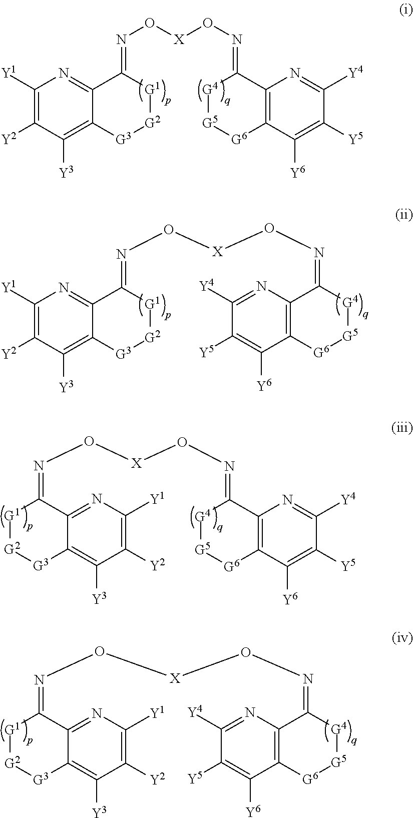

The present invention includes each of these isomers. The invention may provide a compound of formula (I) as just one of these isomers or as a mixture of one or more isomers in any ratio. Preferred compounds are those of isomer (i).

Likewise, the invention also includes the corresponding isomers of the intermediates described herein, e.g. compounds (II), (III) and (IV). In addition, where a reaction scheme depicts synthesis of one geometric isomer, the scheme also includes synthesis of the other geometric isomers where possible. For example Scheme A shown above encompasses the reactions below:

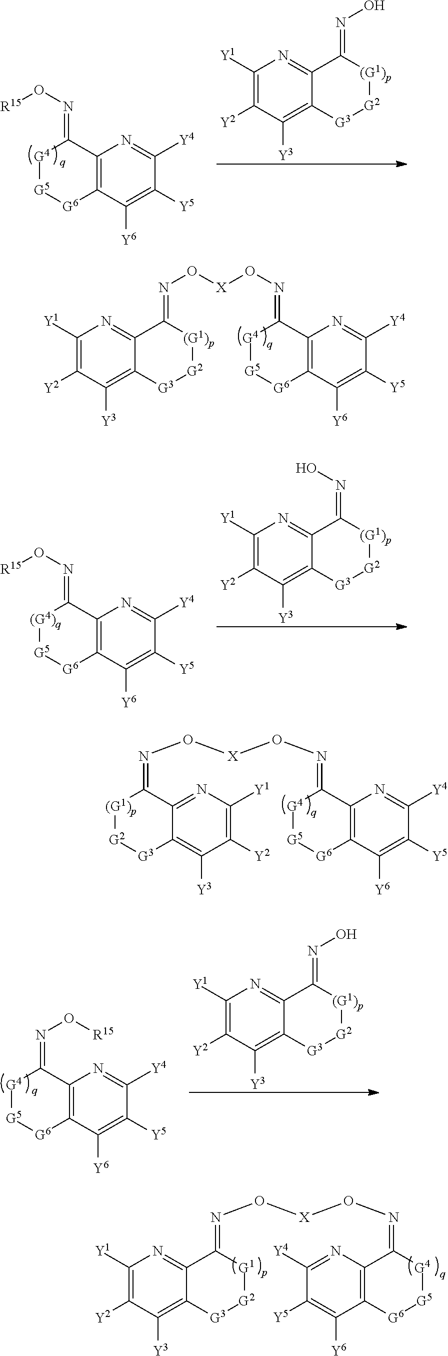

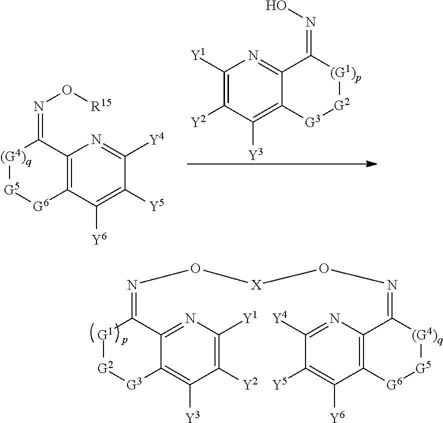

The compounds in tables 1 to 24 illustrate compounds of formula (I).

Table X represents Table 1 (when X is 1), Table 2 (when X is 2), Table 3 (when X is 3), Table 4 (when X is 4), Table 5 (when X is 5), Table 6 (when X is 6), Table 7 (when X is 7), Table 8 (when X is 8), Table 9 (when X is 9), Table 10 (when X is 10), Table 11 (when X is 11), Table 12 (when X is 12), Table 13 (when X is 13), Table 14 (when X is 14), Table 15 (when X is 15), Table 16 (when X is 16), Table 17 (when X is 17), Table 18 (when X is 18), Table 19 (when X is 19), Table 20 (when X is 20), Table 21 (when X is 21), Table 22 (when X is 22), Table 23 (when X is 23), Table 24 (when X is 24).

TABLE X

| Compound | Y¹ | Y² | Y³ | Y⁴ | Y⁵ | Y⁶ |
|---|---|---|---|---|---|---|
| X.001 | H | H | H | H | H | H |
| X.002 | CH₃ | H | H | H | H | H |
| X.003 | CH₂CH₃ | H | H | H | H | H |
| X.004 | OCH₃ | H | H | H | H | H |
| X.005 | OCH₂CH₃ | H | H | H | H | H |
| X.006 | phenyl | H | H | H | H | H |
| X.007 | 3-F-phenyl | H | H | H | H | H |
| X.008 | 3,5-di-Cl-phenyl | H | H | H | H | H |
| X.009 | OH | H | H | H | H | H |
| X.010 | NH₂ | H | H | H | H | H |
| X.011 | NH(CH₃) | H | H | H | H | H |
| X.012 | N(CH₃)₂ | H | H | H | H | H |
| X.013 | 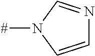 | H | H | H | H | H |
| X.014 | H | CH₃ | H | H | H | H |
| X.015 | CH₃ | CH₃ | H | H | H | H |
| X.016 | CH₂CH₃ | CH₃ | H | H | H | H |
| X.017 | OCH₃ | CH₃ | H | H | H | H |
| X.018 | H | H | CH₃ | H | H | H |
| X.019 | CH₃ | H | CH₃ | H | H | H |
| X.020 | CH₂CH₃ | H | CH₃ | H | H | H |
| X.021 | OCH₃ | H | CH₃ | H | H | H |
| X.022 | NH(CH₃) | H | CH₃ | H | H | H |
| X.023 | N(CH₃)₂ | H | CH₃ | H | H | H |
| X.024 | H | CH₃ | CH₃ | H | H | H |
| X.025 | CH₃ | CH₃ | CH₃ | H | H | H |
| X.026 | CH₂CH₃ | CH₃ | CH₃ | H | H | H |
| X.027 | OCH₃ | CH₃ | CH₃ | H | H | H |
| X.028 | H | H | CH₃ | CH₃ | H | H |
| X.029 | CH₃ | H | CH₃ | CH₃ | H | H |
| X.030 | CH₂CH₃ | H | CH₃ | CH₃ | H | H |
| X.031 | OCH₃ | H | CH₃ | CH₃ | H | H |
| X.032 | H | H | OCH₃ | H | H | H |
| X.033 | CH₃ | H | OCH₃ | H | H | H |
| X.034 | CH₂CH₃ | H | OCH₃ | H | H | H |
| X.035 | OCH₃ | H | OCH₃ | H | H | H |
| X.036 | NH(CH₃) | H | OCH₃ | H | H | H |
| X.037 | N(CH₃)₂ | H | OCH₃ | H | H | H |
| X.038 | H | H | CH₃ | H | H | CH₃ |
| X.039 | H | H | OCH₃ | H | H | OCH₃ |
| X.040 | H | CH₃ | H | H | CH₃ | H |
| X.041 | H | OCH₃ | H | H | OCH₃ | H |
| X.042 | H | CH₃ | H | H | H | CH₃ |
| X.043 | H | OCH₃ | H | H | H | OCH₃ |
| X.044 | H | H | CH₃ | H | CH₃ | H |
| X.045 | H | H | OCH₃ | H | OCH₃ | H |
| X.046 | H | H | H | CH₃ | H | H |
| X.047 | CH₃ | H | H | CH₃ | H | H |
| X.048 | CH₂CH₃ | H | H | CH₃ | H | H |
| X.049 | CH(CH₃)₂ | H | H | CH₃ | H | H |
| X.050 | C(CH₃)₃ | H | H | CH₃ | H | H |
| X.051 | cyclopropyl | H | H | CH₃ | H | H |
| X.052 | cyclohexyl | H | H | CH₃ | H | H |
| X.053 | CF₃ | H | H | CH₃ | H | H |
| X.054 | CHF₂ | H | H | CH₃ | H | H |
| X.055 | CH₂F | H | H | CH₃ | H | H |
| X.056 | CCl₃ | H | H | CH₃ | H | H |
| X.057 | CHCl₂ | H | H | CH₃ | H | H |
| X.058 | CH₂CN | H | H | CH₃ | H | H |
| X.059 | CH₂OCH₃ | H | H | CH₃ | H | H |
| X.060 | CH₂SCH₃ | H | H | CH₃ | H | H |
| X.061 | CH₂SO₂CH₃ | H | H | CH₃ | H | H |
| X.062 | CHO | H | H | CH₃ | H | H |
| X.063 | F | H | H | CH₃ | H | H |
| X.064 | Cl | H | H | CH₃ | H | H |
| X.065 | Br | H | H | CH₃ | H | H |
| X.066 | CN | H | H | CH₃ | H | H |
| X.067 | OH | H | H | CH₃ | H | H |
| X.068 | OCH₃ | H | H | CH₃ | H | H |
| X.069 | OCH₂CH₃ | H | H | CH₃ | H | H |
| X.070 | OCH(CH₃)₂ | H | H | CH₃ | H | H |
| X.071 | OCH₂CH₂CH₃ | H | H | CH₃ | H | H |
| X.072 | OCH₂CH═CH₂ | H | H | CH₃ | H | H |
| X.073 | OCH₂CH≡CH | H | H | CH₃ | H | H |
| X.074 | OCHF₂ | H | H | CH₃ | H | H |
| X.075 | O-cyclopropyl | H | H | CH₃ | H | H |
| X.076 | OCH₂CH₂OCH₃ | H | H | CH₃ | H | H |
| X.077 | O-phenyl | H | H | CH₃ | H | H |
| X.078 | O—4-Cl-phenyl | H | H | CH₃ | H | H |
| X.079 | O—3-CH₃-phenyl | H | H | CH₃ | H | H |
| X.080 | O—2,4-diCl-phenyl | H | H | CH₃ | H | H |
| X.081 | O—3-CN-phenyl | H | H | CH₃ | H | H |
| X.082 | NH₂ | H | H | CH₃ | H | H |
| X.083 | NH(CH₃) | H | H | CH₃ | H | H |
| X.084 | N(CH₃)₂ | H | H | CH₃ | H | H |
| X.085 | N(CH₂CH₃)₂ | H | H | CH₃ | H | H |
| X.086 | NHCH₂CH═CH₂ | H | H | CH₃ | H | H |
| X.087 | 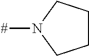 | H | H | CH₃ | H | H |
| X.088 | NHCOCH₃ | H | H | CH₃ | H | H |
| X.089 | N(CH₃)COCH₃ | H | H | CH₃ | H | H |
| X.090 | N(COCH₃)₂ | H | H | CH₃ | H | H |
| X.091 | NHCOCHCl₂ | H | H | CH₃ | H | H |
| X.092 | S—CH₃ | H | H | CH₃ | H | H |
| X.093 | S—CH₂CH₃ | H | H | CH₃ | H | H |
| X.094 | SO—CH₃ | H | H | CH₃ | H | H |
| X.095 | SO₂—CH₃ | H | H | CH₃ | H | H |
| X.096 | S—CHF₂ | H | H | CH₃ | H | H |
| X.097 | phenyl | H | H | CH₃ | H | H |
| X.098 | 2-CH₃-phenyl | H | H | CH₃ | H | H |
| X.099 | 4-CH₃-phenyl | H | H | CH₃ | H | H |
| X.100 | 2,4-diCH₃-phenyl | H | H | CH₃ | H | H |
| X.101 | 2-F-phenyl | H | H | CH₃ | H | H |
| X.102 | 3,5-diF-phenyl | H | H | CH₃ | H | H |
| X.103 | 2,6-diF-phenyl | H | H | CH₃ | H | H |
| X.104 | 4-Cl-phenyl | H | H | CH₃ | H | H |
| X.105 | 2,4-diCl-phenyl | H | H | CH₃ | H | H |
| X.106 | 3-CN-phenyl | H | H | CH₃ | H | H |
| X.107 | 3-OCH₃-phenyl | H | H | CH₃ | H | H |
| X.108 | 4-OCH₃-phenyl | H | H | CH₃ | H | H |
| X.109 | pyridin-2-yl | H | H | CH₃ | H | H |
| X.110 | 6-CH₃-pyridin-2-yl | H | H | CH₃ | H | H |
| X.111 | 4,6-diCH₃-pyridin-2-yl | H | H | CH₃ | H | H |
| X.112 | 6-Br-pyridin-2-yl | H | H | CH₃ | H | H |
| X.113 | 6-OCH₃-pyridin-2-yl | H | H | CH₃ | H | H |
| X.114 | 6-CH₃—4-OCH₃-pyridin-2-yl | H | H | CH₃ | H | H |
| X.115 | 3,5-diCl-pyridin-2-yl | H | H | CH₃ | H | H |
| X.116 | 3,5-pyridin-2-yl | H | H | CH₃ | H | H |
| X.117 | 6-CH₃—4-Cl-pyridin-3-yl | H | H | CH₃ | H | H |
| X.118 | 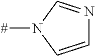 | H | H | CH₃ | H | H |
| X.119 | 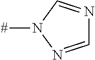 | H | H | CH₃ | H | H |
| X.120 | 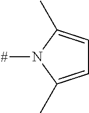 | H | H | CH₃ | H | H |
| X.121 | H | H | H | H | H | H |
| X.122 | CH₃ | H | H | CH₃ | H | H |
| X.123 | CH₂CH₃ | H | H | CH₂CH₃ | H | H |
| X.124 | CH(CH₃)₂ | H | H | CH(CH₃)₂ | H | H |
| X.125 | C(CH₃)₃ | H | H | C(CH₃)₃ | H | H |
| X.126 | cyclopropyl | H | H | cyclopropyl | H | H |
| X.127 | cyclohexyl | H | H | cyclohexyl | H | H |
| X.128 | CF₃ | H | H | CF₃ | H | H |
| X.129 | CHF₂ | H | H | CHF₂ | H | H |
| X.130 | CH₂F | H | H | CH₂F | H | H |
| X.131 | CCl₃ | H | H | CCl₃ | H | H |
| X.132 | CHCl₂ | H | H | CHCl₂ | H | H |
| X.133 | CH₂CN | H | H | CH₂CN | H | H |
| X.134 | CH₂OCH₃ | H | H | CH₂OCH₃ | H | H |
| X.135 | CH₂SCH₃ | H | H | CH₂SCH₃ | H | H |
| X.136 | CH₂SO₂CH₃ | H | H | CH₂SO₂CH₃ | H | H |
| X.137 | CHO | H | H | CHO | H | H |
| X.138 | F | H | H | F | H | H |
| X.139 | Cl | H | H | Cl | H | H |
| X.140 | Br | H | H | Br | H | H |
| X.141 | CN | H | H | CN | H | H |
| X.142 | OH | H | H | OH | H | H |
| X.143 | OCH₃ | H | H | OCH₃ | H | H |
| X.144 | OCH₂CH₃ | H | H | OCH₂CH₃ | H | H |
| X.145 | OCH(CH₃)₂ | H | H | OCH(CH₃)₂ | H | H |
| X.146 | OCH₂CH₂CH₃ | H | H | OCH₂CH₂CH₃ | H | H |
| X.147 | OCH₂CH═CH₂ | H | H | OCH₂CH═CH₂ | H | H |
| X.148 | OCH₂CH≡CH | H | H | OCH₂CH≡CH | H | H |
| X.149 | OCHF₂ | H | H | OCHF₂ | H | H |
| X.150 | O-cyclopropyl | H | H | O-cyclopropyl | H | H |
| X.151 | OCH₂CH₂OCH₃ | H | H | OCH₂CH₂OCH₃ | H | H |
| X.152 | O-phenyl | H | H | O-phenyl | H | H |
| X.153 | O-4-Cl-phenyl | H | H | O-4-Cl-phenyl | H | H |
| X.154 | O-3-CH₃-phenyl | H | H | O-3-CH₃-phenyl | H | H |
| X.155 | O-2,4-diCl-phenyl | H | H | O-2,4-diCl-phenyl | H | H |
| X.156 | O-3-CN-phenyl | H | H | O-3-CN-phenyl | H | H |
| X.157 | NH₂ | H | H | NH₂ | H | H |
| X.158 | NH(CH₃) | H | H | NH(CH₃) | H | H |
| X.159 | N(CH₃)₂ | H | H | N(CH₃)₂ | H | H |
| X.160 | N(CH₂CH₃)₂ | H | H | N(CH₂CH₃)₂ | H | H |
| X.161 | NHCH₂CH═CH₂ | H | H | NHCH₂CH═CH₂ | H | H |
| X.162 | 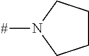 | H | H | 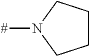 | H | H |
| X.163 | NHCOCH₃ | H | H | NHCOCH₃ | H | H |
| X.164 | N(CH₃)COCH₃ | H | H | N(CH₃)COCH₃ | H | H |
| X.165 | N(COCH₃)₂ | H | H | N(COCH₃)₂ | H | H |
| X.166 | NHCOCHCl₂ | H | H | NHCOCHCl₂ | H | H |
| X.167 | S—CH₃ | H | H | S—CH₃ | H | H |
| X.168 | S—CH₂CH₃ | H | H | S—-CH₂CH₃ | H | H |
| X.169 | SO—CH₃ | H | H | SO—CH₃ | H | H |
| X.170 | SO₂—CH₃ | H | H | SO₂—CH₃ | H | H |
| X.171 | S—CHF₂ | H | H | S—-CHF₂ | H | H |
| X.172 | phenyl | H | H | phenyl | H | H |
| X.173 | 2-CH₃-phenyl | H | H | 2-CH₃-phenyl | H | H |
| X.174 | 4-CH₃-phenyl | H | H | 4-CH₃-phenyl | H | H |
| X.175 | 2,4-diCH₃-phenyl | H | H | 2,4-diCH₃-phenyl | H | H |
| X.176 | 2-F-phenyl | H | H | 2-F-phenyl | H | H |
| X.177 | 3,5-diF-phenyl | H | H | 3,5-diF-phenyl | H | H |
| X.178 | 2,6-diF-phenyl | H | H | 2,6-diF-phenyl | H | H |
| X.179 | 4-Cl-phenyl | H | H | 4-Cl-phenyl | H | H |
| X.180 | 2,4-diCl-phenyl | H | H | 2,4-diCl-phenyl | H | H |
| X.181 | 3-CN-phenyl | H | H | 3-CN-phenyl | H | H |
| X.182 | 3-OCH₃-phenyl | H | H | 3-OCH₃-phenyl | H | H |
| X.183 | 4-OCH₃-phenyl | H | H | 4-OCH₃-phenyl | H | H |
| X.184 | pyridin-2-yl | H | H | pyridin-2-yl | H | H |
| X.185 | 6-CH₃-pyridin-2-yl | H | H | 6-CH₃-pyridin-2-yl | H | H |
| X.186 | 4,6-diCH₃-pyridin-2-yl | H | H | 4,6-diCH₃-pyridin-2-yl | H | H |
| X.187 | 6-Br-pyridin-2-yl | H | H | 6-Br-pyridin-2-yl | H | H |
| X.188 | 6-OCH₃-pyridin-2-yl | H | H | 6-OCH₃-pyridin-2-yl | H | H |
| X.189 | 6-CH₃—4-OCH₃-pyridin-2-yl | H | H | 6-CH₃—4-OCH₃-pyridin-2-yl | H | H |
| X.190 | 3,5-diCl-pyridin-2-yl | H | H | 3,5-diCl-pyridin-2-yl | H | H |
| X.191 | 3,5-pyridin-2-yl | H | H | 3,5-pyridin-2-yl | H | H |
| X.192 | 6-CH₃—4-Cl-pyridin-3-yl | H | H | 6-CH₃-4-Cl-pyridin-3-yl | H | H |
| X.193 | 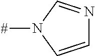 | H | H | 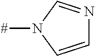 | H | H |
| X.194 | 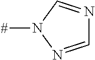 | H | H | 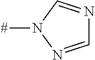 | H | H |
| X.195 | 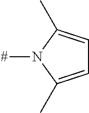 | H | H | 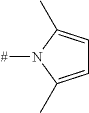 | H | H |
| X.196 | CH₃ | H | CH₃ | CH₃ | H | H |
| X.197 | CH₃ | H | CH₂CH₃ | CH₃ | H | H |
| X.198 | CH₃ | H | CH(CH₃)₂ | CH₃ | H | H |
| X.199 | CH₃ | H | C(CH₃)₃ | CH₃ | H | H |
| X.200 | CH₃ | H | cyclopropyl | CH₃ | H | H |
| X.201 | CH₃ | H | cyclohexyl | CH₃ | H | H |
| X.202 | CH₃ | H | CF₃ | CH₃ | H | H |
| X.203 | CH₃ | H | CHF₂ | CH₃ | H | H |
| X.204 | CH₃ | H | CH₂F | CH₃ | H | H |
| X.205 | CH₃ | H | CCl₃ | CH₃ | H | H |
| X.206 | CH₃ | H | CHCl₂ | CH₃ | H | H |
| X.207 | CH₃ | H | CH₂CN | CH₃ | H | H |
| X.208 | CH₃ | H | CH₂OCH₃ | CH₃ | H | H |
| X.209 | CH₃ | H | CH₂SCH₃ | CH₃ | H | H |
| X.210 | CH₃ | H | CH₂SO₂CH₃ | CH₃ | H | H |
| X.211 | CH₃ | H | CHO | CH₃ | H | H |
| X.212 | CH₃ | H | COOH | CH₃ | H | H |
| X.213 | CH₃ | H | COOCH₂CH₃ | CH₃ | H | H |
| X.214 | CH₃ | H | CON(CH₃)₂ | CH₃ | H | H |
| X.215 | CH₃ | H | F | CH₃ | H | H |
| X.216 | CH₃ | H | Cl | CH₃ | H | H |
| X.217 | CH₃ | H | Br | CH₃ | H | H |
| X.218 | CH₃ | H | CN | CH₃ | H | H |
| X.219 | CH₃ | H | OH | CH₃ | H | H |
| X.220 | CH₃ | H | OCH₃ | CH₃ | H | H |
| X.221 | CH₃ | H | OCH₂CH₃ | CH₃ | H | H |
| X.222 | CH₃ | H | OCH(CH₃)₂ | CH₃ | H | H |
| X.223 | CH₃ | H | OCH₂CH₂CH₃ | CH₃ | H | H |
| X.224 | CH₃ | H | OCH₂CH═CH₂ | CH₃ | H | H |
| X.225 | CH₃ | H | OCH₂CH≡CH | CH₃ | H | H |
| X.226 | CH₃ | H | OCHF₂ | CH₃ | H | H |
| X.227 | CH₃ | H | O—cyclopropyl | CH₃ | H | H |
| X.228 | CH₃ | H | OCH₂CH₂OCH₃ | CH₃ | H | H |
| X.229 | CH₃ | H | O-phenyl | CH₃ | H | H |
| X.230 | CH₃ | H | O—4-Cl-phenyl | CH₃ | H | H |
| X.231 | CH₃ | H | O—3-CH₃-phenyl | CH₃ | H | H |
| X.232 | CH₃ | H | O—2,4-diCl-phenyl | CH₃ | H | H |
| X.233 | CH₃ | H | O—3-CN-phenyl | CH₃ | H | H |
| X.234 | CH₃ | H | NH₂ | CH₃ | H | H |
| X.235 | CH₃ | H | NH(CH₃) | CH₃ | H | H |
| X.236 | CH₃ | H | N(CH₃)₂ | CH₃ | H | H |
| X.237 | CH₃ | H | N(CH₂CH₃)₂ | CH₃ | H | H |
| X.238 | CH₃ | H | NHCH₂CH═CH₂ | CH₃ | H | H |
| X.239 | CH₃ | H | 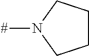 | CH₃ | H | H |
| X.240 | CH₃ | H | NHCOCH₃ | CH₃ | H | H |
| X.241 | CH₃ | H | N(CH₃)COCH₃ | CH₃ | H | H |
| X.242 | CH₃ | H | N(COCH₃)₂ | CH₃ | H | H |
| X.243 | CH₃ | H | NHCOCHCl₂ | CH₃ | H | H |
| X.244 | CH₃ | H | S—CH₃ | CH₃ | H | H |
| X.245 | CH₃ | H | S—CH₂CH₃ | CH₃ | H | H |
| X.246 | CH₃ | H | SO—CH₃ | CH₃ | H | H |
| X.247 | CH₃ | H | SO₂—CH₃ | CH₃ | H | H |
| X.248 | CH₃ | H | S—CHF₂ | CH₃ | H | H |
| X.249 | CH₃ | H | phenyl | CH₃ | H | H |
| X.250 | CH₃ | H | 2-CH₃-phenyl | CH₃ | H | H |
| X.251 | CH₃ | H | 4-CH₃-phenyl | CH₃ | H | H |
| X.252 | CH₃ | H | 2,4-diCH₃-phenyl | CH₃ | H | H |
| X.253 | CH₃ | H | 2-F-phenyl | CH₃ | H | H |
| X.254 | CH₃ | H | 3,5-diF-phenyl | CH₃ | H | H |
| X.255 | CH₃ | H | 2,6-diF-phenyl | CH₃ | H | H |
| X.256 | CH₃ | H | 4-Cl-phenyl | CH₃ | H | H |
| X.257 | CH₃ | H | 2,4-diCl-phenyl | CH₃ | H | H |
| X.258 | CH₃ | H | 3-CN-phenyl | CH₃ | H | H |
| X.259 | CH₃ | H | 3-OCH₃-phenyl | CH₃ | H | H |
| X.260 | CH₃ | H | 4-OCH₃-phenyl | CH₃ | H | H |
| X.261 | CH₃ | H | pyridin-2-yl | CH₃ | H | H |
| X.262 | CH₃ | H | 6-CH₃-pyridin-2-yl | CH₃ | H | H |
| X.263 | CH₃ | H | 4,6-diCH₃-pyridin-2-yl | CH₃ | H | H |
| X.264 | CH₃ | H | 6-Br-pyridin-2-yl | CH₃ | H | H |
| X.265 | CH₃ | H | 6-OCH₃-pyridin-2-yl | CH₃ | H | H |
| X.266 | CH₃ | H | 6-CH₃—4-OCH₃-pyridin-2-yl | CH₃ | H | H |
| X.267 | CH₃ | H | 3,5-diCl-pyridin-2-yl | CH₃ | H | H |
| X.268 | CH₃ | H | 3,5-pyridin-2-yl | CH₃ | H | H |
| X.269 | CH₃ | H | 6-CH₃—4-Cl-pyridin-3-yl | CH₃ | H | H |
| X.270 | CH₃ | H | 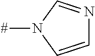 | CH₃ | H | H |
| X.271 | CH₃ | H | 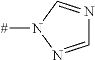 | CH₃ | H | H |
| X.272 | CH₃ | H | 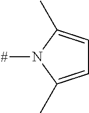 | CH₃ | H | H |
| X.273 | CH3 | H | CH₃ | CH₃ | H | CH₃ |
| X.274 | CH₃ | H | CH₂CH₃ | CH₃ | H | CH₂CH₃ |
| X.275 | CH₃ | H | CH(CH₃)₂ | CH₃ | H | CH(CH₃)₂ |
| X.276 | CH₃ | H | C(CH₃)₃ | CH₃ | H | C(CH₃)₃ |
| X.277 | CH₃ | H | cyclopropyl | CH₃ | H | cyclopropyl |
| X.278 | CH₃ | H | cyclohexyl | CH₃ | H | cyclohexyl |
| X.279 | CH₃ | H | CF₃ | CH₃ | H | CF₃ |
| X.280 | CH₃ | H | CHF₂ | CH₃ | H | CHF₂ |
| X.281 | CH₃ | H | CH₂F | CH₃ | H | CH₂F |
| X.282 | CH₃ | H | CCl₃ | CH₃ | H | CCl₃ |
| X.283 | CH₃ | H | CHCl₂ | CH₃ | H | CHCl₂ |
| X.284 | CH₃ | H | CH₂CN | CH₃ | H | CH₂CN |
| X.285 | CH₃ | H | CH₂OCH₃ | CH₃ | H | CH₂OCH₃ |
| X.286 | CH₃ | H | CH₂SCH₃ | CH₃ | H | CH₂SCH₃ |
| X.287 | CH₃ | H | CH₂SO₂CH₃ | CH₃ | H | CH₂SO₂CH₃ |
| X.288 | CH₃ | | CHO | CH₃ | | CHO |
| X.289 | CH₃ | H | COOH | CH₃ | H | COOH |
| X.290 | CH₃ | H | COOCH₂CH₃ | CH₃ | H | COOCH₂CH₃ |
| X.291 | CH₃ | H | CON(CH₃)₂ | CH₃ | H | CON(CH₃)₂ |
| X.292 | CH₃ | H | F | CH₃ | H | F |
| X.293 | CH₃ | H | Cl | CH₃ | H | Cl |
| X.294 | CH₃ | H | Br | CH₃ | H | Br |
| X.295 | CH₃ | H | CN | CH₃ | H | CN |
| X.296 | CH₃ | H | OH | CH₃ | H | OH |
| X.297 | CH₃ | H | OCH₃ | CH₃ | H | OCH₃ |
| X.298 | CH₃ | H | OCH₂CH₃ | CH₃ | H | OCH₂CH₃ |
| X.299 | CH₃ | H | OCH(CH₃)₂ | CH₃ | H | OCH(CH₃)₂ |
| X.300 | CH₃ | H | OCH₂CH₂CH₃ | CH₃ | H | OCH₂CH₂CH |
| X.301 | CH₃ | H | OCH₂CH═CH₂ | CH₃ | H | OCH₂CH═CH₂ |
| X.302 | CH₃ | H | OCH₂CH≡CH | CH₃ | H | OCH₂CH≡CH₂ |
| X.303 | CH₃ | H | OCHF₂ | CH₃ | H | OCHF₂ |
| X.304 | CH₃ | H | O-cyclopropyl | CH₃ | H | O-cyclopropyl |
| X.305 | CH₃ | H | OCH₂CH₂OCH₃ | CH₃ | H | OCH₂CH₂OCH₃ |
| X.306 | CH₃ | H | O-phenyl | CH₃ | H | O-phenyl |
| X.307 | CH₃ | H | O—4-Cl-phenyl | CH₃ | H | O—4-Cl-phenyl |
| X.308 | CH₃ | H | O—3-CH₃-phenyl | CH₃ | H | O—3-CH₃-phenyl |
| X.309 | CH₃ | H | O-2,4-diCl-phenyl | CH₃ | H | O-2,4-diCl-phenyl |
| X.310 | CH₃ | H | O-3-CN-phenyl | CH₃ | H | O—3-CN-phenyl |
| X.311 | CH₃ | H | NH₂ | CH₃ | H | NH₂ |
| X.312 | CH₃ | H | NH(CH₃) | CH₃ | H | NH(CH₃) |
| X.313 | CH₃ | H | N(CH₃)₂ | CH₃ | H | N(CH₃)₂ |
| X.314 | CH₃ | H | N(CH₂CH₃)₂ | CH₃ | H | N(CH₂CH₃)₂ |
| X.315 | CH₃ | H | NHCH₂CH═CH₂ | CH₃ | H | NHCH₂CH═CH₂ |
| X.316 | CH₃ | H | 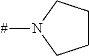 | CH₃ | H | 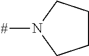 |
| X.317 | CH₃ | H | NHCOCH₃ | CH₃ | H | NHCOCH₃ |
| X.318 | CH₃ | H | N(CH₃)COCH₃ | CH₃ | H | N(CH₃)COCH₃ |
| X.319 | CH₃ | H | N(COCH₃)₂ | CH₃ | H | N(COCH₃)₂ |
| X.320 | CH₃ | H | NHCOCHCl₂ | CH₃ | H | NHCOCHCl₂ |
| X.321 | CH₃ | H | S—CH₃ | CH₃ | H | S—CH₃ |
| X.322 | CH₃ | H | S—CH₂CH₃ | CH₃ | H | S—CH₂CH₃ |
| X.323 | CH₃ | H | SO—CH₃ | CH₃ | H | SO—CH₃ |
| X.324 | CH₃ | H | SO₂—CH₃ | CH₃ | H | SO₂—CH₃ |
| X.325 | CH₃ | H | S—CHF₂ | CH₃ | H | S—CHF₂ |
| X.326 | CH₃ | H | phenyl | CH₃ | H | phenyl |
| X.327 | CH₃ | H | 2-CH₃-phenyl | CH₃ | H | 2-CH₃-phenyl |
| X.328 | CH₃ | H | 4-CH₃-phenyl | CH₃ | H | 4-CH₃-phenyl |
| X.329 | CH₃ | H | 2,4-diCH₃-phenyl | CH₃ | H | 2,4-diCH₃-phenyl |
| X.330 | CH₃ | H | 2-F-phenyl | CH₃ | H | 2-F-phenyl |
| X.331 | CH₃ | H | 3,5-diF-phenyl | CH₃ | H | 3,5-diF-phenyl |
| X.332 | CH₃ | H | 2,6-diF-phenyl | CH₃ | H | 2,6-diF-phenyl |
| X.333 | CH₃ | H | 4-Cl-phenyl | CH₃ | H | 4-Cl-phenyl |
| X.334 | CH₃ | H | 2,4-diCl-phenyl | CH₃ | H | 2,4-diCl-phenyl |
| X.335 | CH₃ | H | 3-CN-phenyl | CH₃ | H | 3-CN-phenyl |
| X.336 | CH₃ | H | 3-OCH₃-phenyl | CH₃ | H | 3-OCH₃-phenyl |
| X.337 | CH₃ | H | 4-OCH₃-phenyl | CH₃ | H | 4-OCH₃-phenyl |
| X.338 | CH₃ | H | pyridin-2-yl | CH₃ | H | pyridin-2-yl |
| X.339 | CH₃ | H | 6-CH₃-pyridin-2-yl | CH₃ | H | 6-CH₃-pyridin-2-yl |
| X.340 | CH₃ | H | 4,6-diCH₃-pyridin-2-yl | CH₃ | H | 4,6-diCH₃-pyridin-2-yl |
| X.341 | CH₃ | H | 6-Br-pyridin-2-yl | CH₃ | H | 6-Br-pyridin-2-yl |
| X.342 | CH₃ | H | 6-OCH₃-pyridin-2-yl | CH₃ | H | 6-OCH₃-pyridin-2-yl |
| X.343 | CH₃ | H | 6-CH₃—4-OCH₃-pyridin-2-yl | CH₃ | H | 6-CH₃—4-OCH₃-pyridin-2-yl |
| X.344 | CH₃ | H | 3,5-diCl-pyridin-2-yl | CH₃ | H | 3,5-diCl-pyridin-2-yl |
| X.345 | CH₃ | H | 3,5-pyridin-2-yl | CH₃ | H | 3,5-pyridin-2-yl |
| X.346 | CH₃ | H | 6-CH₃—4-Cl-pyridin-3-yl | CH₃ | H | 6-CH₃—4-Cl-pyridin-3-yl |
| X.347 | CH₃ | H | 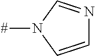 | CH₃ | H | 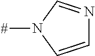 |
| X.348 | CH₃ | H | 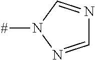 | CH₃ | | 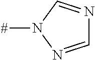 |
| X.349 | CH₃ | H | 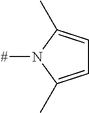 | CH₃ | H | 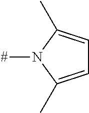 |
| X.350 | CH₂CH₃ | H | CH₃ | CH₃ | H | H |
| X.351 | cyclopropyl | H | CH₃ | CH₃ | H | H |
| X.352 | CF₃ | H | CH₃ | CH₃ | H | H |
| X.353 | CH₂F | H | CH₃ | CH₃ | H | H |
| X.354 | CHF₂ | H | CH₃ | CH₃ | H | H |
| X.355 | Cl | H | CH₃ | CH₃ | H | H |
| X.356 | OCH₃ | H | CH₃ | CH₃ | H | H |
| X.357 | OCH₂CH₃ | H | CH₃ | CH₃ | H | H |
| X.358 | NH₂ | H | CH₃ | CH₃ | H | H |
| X.359 | NH(CH₃) | H | CH₃ | CH₃ | H | H |
| X.360 | N(CH₃)₂ | H | CH₃ | CH₃ | H | H |
| X.361 | NHCOCH₃ | H | CH₃ | CH₃ | H | H |
| X.362 | SCH₃ | H | CH₃ | CH₃ | H | H |
| X.363 | SCHF₂ | H | CH₃ | CH₃ | H | H |
| X.364 | phenyl | H | CH₃ | CH₃ | H | H |
| X.365 | 2-CH₃-phenyl | H | CH₃ | CH₃ | H | H |
| X.366 | 4-CH₃-phenyl | H | CH₃ | CH₃ | H | H |
| X.367 | 2,4-diCH₃-phenyl | H | CH₃ | CH₃ | H | H |
| X.368 | 2-F-phenyl | H | CH₃ | CH₃ | H | H |
| X.369 | 3,5-diF-phenyl | H | CH₃ | CH₃ | H | H |
| X.370 | 2,6-diF-phenyl | H | CH₃ | CH₃ | H | H |
| X.371 | 4-Cl-phenyl | H | CH₃ | CH₃ | H | H |
| X.372 | 2,4-diCl-phenyl | H | CH₃ | CH₃ | H | H |
| X.373 | 3-CN-phenyl | H | CH₃ | CH₃ | H | H |
| X.374 | 3-OCH₃-phenyl | H | CH₃ | CH₃ | H | H |
| X.375 | 4-OCH₃-phenyl | H | CH₃ | CH₃ | H | H |
| X.376 | pyridin-2-yl | H | CH₃ | CH₃ | H | H |
| X.377 | 6-CH₃-pyridin-2-yl | H | CH₃ | CH₃ | H | H |
| X.378 | 4,6-diCH₃-pyridin-2-yl | H | CH₃ | CH₃ | H | H |
| X.379 | 6-Br-pyridin-2-yl | H | CH₃ | CH₃ | H | H |
| X.380 | 6-OCH₃-pyridin-2-yl | H | CH₃ | CH₃ | H | H |
| X.381 | 6-CH₃—4-OCH₃-pyridin-2-yl | H | CH₃ | CH₃ | H | H |
| X.382 | 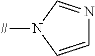 | H | CH₃ | CH₃ | H | H |
| X.383 | 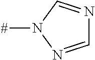 | H | CH₃ | CH₃ | H | H |
| X.384 | CH₂CH₃ | H | CH₃ | CH₂CH₃ | H | CH₃ |
| X.385 | cyclopropyl | H | CH₃ | cyclopropyl | H | CH₃ |
| X.386 | CF₃ | H | CH₃ | CF₃ | H | CH₃ |
| X.387 | CH₂F | H | CH₃ | CH₂F | H | CH₃ |
| X.388 | CHF₂ | H | CH₃ | CHF₂ | H | CH₃ |
| X.389 | CH₃ | H | H | Cl | H | H |
| X.390 | Cl | H | CH₃ | Cl | H | CH₃ |
| X.391 | OCH₃ | H | CH₃ | OCH₃ | H | CH₃ |
| X.392 | OCH₂CH₃ | H | CH₃ | OCH₂CH₃ | H | CH₃ |
| X.393 | NH₂ | H | CH₃ | NH₂ | H | CH₃ |
| X.394 | NH(CH₃) | H | CH₃ | NH(CH₃) | H | CH₃ |
| X.395 | N(CH₃)₂ | H | CH₃ | N(CH₃)₂ | H | CH₃ |
| X.396 | NHCOCH₃ | H | CH₃ | NHCOCH₃ | H | CH₃ |
| X.397 | SCH₃ | H | CH₃ | SCH₃ | H | CH₃ |
| X.398 | SCHF₂ | H | CH₃ | SCHF₂ | H | CH₃ |
| X.399 | phenyl | H | CH₃ | phenyl | H | CH₃ |
| X.400 | 2-CH₃-phenyl | H | CH₃ | 2-CH₃-phenyl | H | CH₃ |
| X.401 | 4-CH₃-phenyl | H | CH₃ | 4-CH₃-phenyl | H | CH₃ |
| X.402 | 2,4-diCH₃-phenyl | H | CH₃ | 2,4-diCH₃-phenyl | H | CH₃ |
| X.403 | 2-F-phenyl | H | CH₃ | 2-F-phenyl | H | CH₃ |
| X.404 | 3,5-diF-phenyl | H | CH₃ | 3,5-diF-phenyl | H | CH₃ |
| X.405 | 2,6-diF-phenyl | H | CH₃ | 2,6-diF-phenyl | H | CH₃ |
| X.406 | 4-Cl-phenyl | H | CH₃ | 4-Cl-phenyl | H | CH₃ |
| X.407 | 2,4-diCl-phenyl | H | CH₃ | 2,4-diCl-phenyl | H | CH₃ |
| X.408 | 3-CN-phenyl | H | CH₃ | 3-CN-phenyl | H | CH₃ |
| X.409 | 3-OCH₃-phenyl | H | CH₃ | 3-OCH₃-phenyl | H | CH₃ |
| X.410 | 4-OCH₃-phenyl | H | CH₃ | 4-OCH₃-phenyl | H | CH₃ |
| X.411 | pyridin-2-yl | H | CH₃ | pyridin-2-yl | H | CH₃ |
| X.412 | 6-CH₃-pyridin-2-yl | H | CH₃ | 6-CH₃-pyridin-2-yl | H | CH₃ |
| X.413 | 4,6-diCH₃-pyridin-2-yl | H | CH₃ | 4,6-diCH₃-pyridin-2-yl | H | CH₃ |
| X.414 | 6-Br-pyridin-2-yl | H | CH₃ | 6-Br-pyridin-2-yl | H | CH₃ |
| X.415 | 6-OCH₃-pyridin-2-yl | H | CH₃ | 6-OCH₃-pyridin-2-yl | H | CH₃ |
| X.416 | 6-CH₃—4-OCH₃-pyridin-2-yl | H | CH₃ | 6-CH₃—4-OCH₃-pyridin-2-yl | H | CH₃ |
| X.417 | 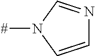 | H | H | 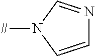 | H | CH₃ |
| X.418 | 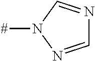 | H | H | 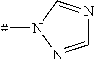 | H | CH₃ |
| X.419 | CH₃ | H | H | OCH₃ | H | H |
| X.420 | OCH₃ | H | H | OCH₃ | H | H |
| X.421 | OCH₂CH₃ | H | H | OCH₃ | H | H |
| X.422 | SCH₃ | H | H | OCH₃ | H | H |
| X.423 | SCHF₂ | H | H | OCH₃ | H | H |
| X.424 | N(CH₃)₂ | H | H | OCH₃ | H | H |
| X.425 | 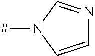 | H | H | OCH₃ | H | H |
| X.426 | phenyl | H | H | OCH₃ | H | H |
| X.427 | 3-Cl-phenyl | H | H | OCH₃ | H | H |
| X.428 | 3-CH₃-phenyl | H | H | OCH₃ | H | H |
| X.429 | 3,5-di-F-phenyl | H | H | OCH₃ | H | H |
| X.430 | pyridine-2-yl | H | H | OCH₃ | H | H |
| X.431 | 6-CH₃-pyridin-2-yl | H | H | OCH₃ | H | H |
| X.432 | 6-OCH₃-pyridin-2-yl | H | H | OCH₃ | H | H |
| X.433 | 4,6-di-CH₃-pyridin-2-yl | H | H | OCH₃ | H | H |
| X.434 | CH₃ | H | H | CH₃ | H | CH₃ |
| X.435 | OCH₃ | H | H | CH₃ | H | CH₃ |
| X.436 | OCH₂CH₃ | H | H | CH₃ | H | CH₃ |
| X.437 | SCH₃ | H | H | CH₃ | H | CH₃ |
| X.438 | SCHF₂ | H | H | CH₃ | H | CH₃ |
| X.439 | N(CH₃)₂ | H | H | CH₃ | H | CH₃ |
| X.440 | 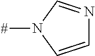 | H | H | CH₃ | H | CH₃ |
| X.441 | phenyl | H | H | CH₃ | H | CH₃ |
| X.442 | 3-Cl-phenyl | H | H | CH₃ | H | CH₃ |
| X.443 | 3-CH₃-phenyl | H | H | CH₃ | H | CH₃ |
| X.444 | 3,5-di-F-phenyl | H | H | CH₃ | H | CH₃ |
| X.445 | pyridine-2-yl | H | H | CH₃ | H | CH₃ |
| X.446 | 6-CH₃-pyridin-2-yl | H | H | CH₃ | H | CH₃ |
| X.447 | 6-OCH₃-pyridin-2-yl | H | H | CH₃ | H | CH₃ |
| X.448 | 4,6-di-CH₃-pyridin-2-yl | H | H | CH₃ | H | CH₃ |
| X.449 | CH₃ | H | H | CH₃ | H | OCH₃ |
| X.450 | OCH₃ | H | H | CH₃ | H | OCH₃ |
| X.451 | OCH₂CH₃ | H | H | CH₃ | H | OCH₃ |
| X.452 | SCH₃ | H | H | CH₃ | H | OCH₃ |
| X.453 | SCHF₂ | H | H | CH₃ | H | OCH₃ |
| X.454 | N(CH₃)₂ | H | H | CH₃ | H | OCH₃ |
| X.455 | 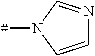 | H | H | CH₃ | H | OCH₃ |
| X.456 | phenyl | H | H | CH₃ | H | OCH₃ |
| X.457 | 3-Cl-phenyl | H | H | CH₃ | H | OCH₃ |
| X.458 | 3-CH₃-phenyl | H | H | CH₃ | H | OCH₃ |
| X.459 | 3,5-di-F-phenyl | H | H | CH₃ | H | OCH₃ |
| X.460 | pyridine-2-yl | H | H | CH₃ | H | OCH₃ |
| X.461 | 6-CH₃-pyridin-2-yl | H | H | CH₃ | H | OCH₃ |
| X.462 | 6-OCH₃-pyridin-2-yl | H | H | CH₃ | H | OCH₃ |
| X.463 | 4,6-di-CH₃-pyridin-2-yl | H | H | CH₃ | H | OCH₃ |
| X.464 | CH₃ | H | H | CH₃ | H | SCH₃ |
| X.465 | OCH₃ | H | H | CH₃ | H | SCH₃ |
| X.466 | OCH₂CH₃ | H | H | CH₃ | H | SCH₃ |
| X.467 | SCH₃ | H | H | CH₃ | H | SCH₃ |
| X.468 | SCHF₂ | H | H | CH₃ | H | SCH₃ |
| X.469 | N(CH₃)₂ | H | H | CH₃ | H | SCH₃ |
| X.470 | 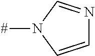 | H | H | CH₃ | H | SCH₃ |
| X.471 | phenyl | H | H | CH₃ | H | SCH₃ |
| X.472 | 3-Cl-phenyl | H | H | CH₃ | H | SCH₃ |
| X.473 | 3-CH₃-phenyl | H | H | CH₃ | H | SCH₃ |
| X.474 | 3,5-di-F-phenyl | H | H | CH₃ | H | SCH₃ |
| X.475 | pyridine-2-yl | H | H | CH₃ | H | SCH₃ |
| X.476 | 6-CH₃-pyridin-2-yl | H | H | CH₃ | H | SCH₃ |
| X.477 | 6-OCH₃-pyridin-2-yl | H | H | CH₃ | H | SCH₃ |
| X.478 | 4,6-di-CH₃-pyridin-2-yl | H | H | CH₃ | H | SCH₃ |
| X.479 | CH₃ | H | SCH₃ | CH₃ | H | H |
| X.480 | OCH₃ | H | SCH₃ | CH₃ | H | H |
| X.481 | SCH₃ | H | SCH₃ | CH₃ | H | H |
| X.482 | phenyl | H | SCH₃ | CH₃ | H | H |
| X.483 | 3-CH₃-phenyl | H | SCH₃ | CH₃ | H | H |
| X.484 | 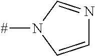 | H | SCH₃ | CH₃ | H | H |
| X.485 | CH₃ | H | SCH₃ | CH₃ | H | CH₃ |
| X.486 | OCH₃ | H | SCH₃ | CH₃ | H | CH₃ |
| X.487 | SCH₃ | H | SCH₃ | CH₃ | H | CH₃ |
| X.488 | phenyl | H | SCH₃ | CH₃ | H | CH₃ |
| X.489 | 3-CH₃-phenyl | H | SCH₃ | CH₃ | H | CH₃ |
| X.490 | 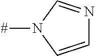 | H | SCH₃ | CH₃ | H | CH₃ |
| X.491 | CH₃ | H | SCH₃ | CH₃ | H | OCH₃ |
| X.492 | OCH₃ | H | SCH₃ | CH₃ | H | OCH₃ |
| X.493 | SCH₃ | H | SCH₃ | CH₃ | H | OCH₃ |
| X.494 | phenyl | H | SCH₃ | CH₃ | H | OCH₃ |
| X.495 | 3-CH₃-phenyl | H | SCH₃ | CH₃ | H | OCH₃ |
| X.496 | 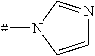 | H | SCH₃ | CH₃ | H | OCH₃ |
| X.497 | CH₃ | H | SCH₃ | OCH₃ | H | H |
| X.498 | OCH₃ | H | SCH₃ | OCH₃ | H | H |
| X.499 | SCH₃ | H | SCH₃ | OCH₃ | H | H |
| X.500 | phenyl | H | SCH₃ | OCH₃ | H | H |
| X.501 | 3-CH₃-phenyl | H | SCH₃ | OCH₃ | H | H |
| X.502 | 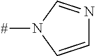 | H | SCH₃ | OCH₃ | H | H |
| X.503 | CH₃ | H | SCH₃ | OCH₃ | H | OCH₃ |
| X.504 | OCH₃ | H | SCH₃ | OCH₃ | H | OCH₃ |
| X.505 | SCH₃ | H | SCH₃ | OCH₃ | H | OCH₃ |
| X.506 | phenyl | H | SCH₃ | OCH₃ | H | OCH₃ |
| X.507 | 3-CH₃-phenyl | H | SCH₃ | OCH₃ | H | OCH₃ |
| X.508 | 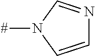 | H | SCH₃ | OCH₃ | H | OCH₃ |
| X.509 | CH₃ | H | SCH₃ | CH₃ | H | SCH₃ |
| X.510 | OCH₃ | H | SCH₃ | CH₃ | H | SCH₃ |
| X.511 | SCH₃ | H | SCH₃ | CH₃ | H | SCH₃ |
| X.512 | phenyl | H | SCH₃ | CH₃ | H | SCH₃ |
| X.513 | 3-CH₃-phenyl | H | SCH₃ | CH₃ | H | SCH₃ |
| X.514 | 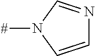 | H | SCH₃ | CH₃ | H | SCH₃ |
| X.515 | CH₃ | H | H | CH₃ | H | SCH₃ |
| X.516 | OCH₃ | H | H | CH₃ | H | SCH₃ |
| X.517 | SCH₃ | H | H | CH₃ | H | SCH₃ |
| X.518 | phenyl | H | H | CH₃ | H | SCH₃ |
| X.519 | 3-CH₃-phenyl | H | H | CH₃ | H | SCH₃ |
| X.520 | 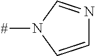 | H | H | CH₃ | H | SCH₃ |
| X.521 | CH₃ | H | H | SCH₃ | H | H |
| X.522 | OCH₃ | H | H | SCH₃ | H | H |
| X.523 | SCH₃ | H | H | SCH₃ | H | H |
| X.524 | phenyl | H | H | SCH₃ | H | H |
| X.525 | 3-CH₃-phenyl | H | H | SCH₃ | H | H |
| X.526 | 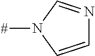 | H | H | SCH₃ | H | H |
| X.527 | CH₃ | H | OCH₃ | CH₃ | H | H |
| X.528 | OCH₃ | H | OCH₃ | CH₃ | H | H |
| X.529 | SCH₃ | H | OCH₃ | CH₃ | H | H |
| X.530 | phenyl | H | OCH₃ | CH₃ | H | H |
| X.531 | 3-CH₃-phenyl | H | OCH₃ | CH₃ | H | H |
| X.532 | 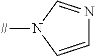 | H | OCH₃ | CH₃ | H | |
| X.533 | CH₃ | H | OCH₃ | CH₃ | H | CH₃ |
| X.534 | OCH₃ | H | OCH₃ | CH₃ | H | CH₃ |
| X.535 | SCH₃ | H | OCH₃ | CH₃ | H | CH₃ |
| X.536 | phenyl | H | OCH₃ | CH₃ | H | CH₃ |
| X.537 | 3-CH₃-phenyl | H | OCH₃ | CH₃ | H | CH₃ |
| X.538 | 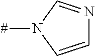 | H | OCH₃ | CH₃ | H | CH₃ |
| X.539 | CH₃ | H | CH₃ | CH₃ | H | H |
| X.540 | OCH₃ | H | CH₃ | OCH₃ | H | H |
| X.541 | SCH₃ | H | CH₃ | SCH₃ | H | H |
| X.542 | phenyl | H | CH₃ | phenyl | H | H |
| X.543 | 3-CH₃-phenyl | H | CH₃ | 3-CH₃-phenyl | H | H |
| X.544 | 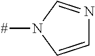 | H | CH₃ | 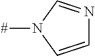 | H | H |
| X.545 | CH₃ | H | CH₃ | CH₃ | H | CH₃ |
| X.546 | OCH₃ | H | CH₃ | OCH₃ | H | CH₃ |
| X.547 | SCH₃ | H | CH₃ | SCH₃ | H | CH₃ |
| X.548 | phenyl | H | CH₃ | phenyl | H | CH₃ |
| X.549 | 3-CH₃-phenyl | H | CH₃ | 3-CH₃-phenyl | H | CH₃ |
| X.550 | 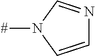 | H | CH₃ | 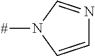 | H | CH₃ |
| X.551 | CH₃ | H | CH₃ | CH₃ | H | CH₃ |
| X.552 | CH₃ | H | OCH₃ | CH₃ | H | OCH₃ |
| X.553 | CH₃ | H | SCH₃ | CH₃ | H | SCH₃ |
| X.554 | CH₃ | H | phenyl | CH₃ | H | phenyl |
| X.555 | CH₃ | H | 3-CH₃-phenyl | CH₃ | H | 3-CH₃-phenyl |
| X.556 | CH₃ | H | 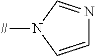 | CH₃ | H | 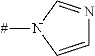 |
| X.557 | OCH₃ | H | CH₃ | CH₃ | H | CH₃ |
| X.558 | OCH₃ | H | OCH₃ | CH₃ | H | OCH₃ |
| X.559 | OCH₃ | H | SCH₃ | CH₃ | H | SCH₃ |
| X.560 | OCH₃ | H | phenyl | CH₃ | H | phenyl |
| X.561 | OCH₃ | H | 3-CH₃-phenyl | CH₃ | H | 3-CH₃-phenyl |
| X.562 | OCH₃ | H | 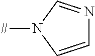 | CH₃ | H | 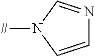 |
| X.563 | OCH₃ | H | CH₃ | OCH₃ | H | CH₃ |
| X.564 | OCH₃ | H | OCH₃ | OCH₃ | H | OCH₃ |
| X.565 | OCH₃ | H | SCH₃ | OCH₃ | H | SCH₃ |
| X.566 | OCH₃ | H | phenyl | OCH₃ | H | phenyl |
| X.567 | OCH₃ | H | 3-CH₃-phenyl | OCH₃ | H | 3-CH₃-phenyl |
| X.568 | OCH₃ | H | 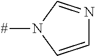 | OCH₃ | H | 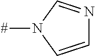 |
| X.569 | SCH₃ | H | CH₃ | CH₃ | H | H |
| X.570 | SCH₃ | H | OCH₃ | CH₃ | H | H |
| X.571 | SCH₃ | H | SCH₃ | CH₃ | H | H |
| X.572 | SCH₃ | H | phenyl | CH₃ | H | H |
| X.573 | SCH₃ | H | 3-CH₃-phenyl | CH₃ | H | H |
| X.574 | SCH₃ | H | 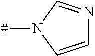 | CH₃ | H | H |
| X.575 | SCH₃ | H | CH₃ | SCH₃ | H | CH₃ |
| X.576 | SCH₃ | H | OCH₃ | SCH₃ | H | OCH₃ |
| X.577 | SCH₃ | H | SCH₃ | SCH₃ | H | SCH₃ |
| X.578 | SCH₃ | H | phenyl | SCH₃ | H | phenyl |
| X.579 | SCH₃ | H | 3-CH₃-phenyl | SCH₃ | H | 3-CH₃-phenyl |
| X.580 | SCH₃ | H | 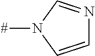 | SCH₃ | H | 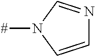 |
| X.581 | CH₃ | OCH₃ | H | CH₃ | H | H |
| X.582 | OCH₃ | OCH₃ | H | CH₃ | H | H |
| X.583 | SCH₃ | OCH₃ | H | CH₃ | H | H |
| X.584 | phenyl | OCH₃ | H | CH₃ | H | H |
| X.585 | 3-CH₃-phenyl | OCH₃ | H | CH₃ | H | H |
| X.586 | 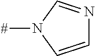 | OCH₃ | H | CH₃ | H | H |
| X.587 | CH₃ | OCH₃ | H | CH₃ | OCH₃ | H |
| X.588 | OCH₃ | OCH₃ | H | OCH₃ | OCH₃ | H |
| X.589 | SCH₃ | OCH₃ | H | SCH₃ | OCH₃ | H |
| X.590 | phenyl | OCH₃ | H | phenyl | OCH₃ | H |
| X.591 | 3-CH₃-phenyl | OCH₃ | H | 3-CH₃-phenyl | OCH₃ | H |
| X.592 | 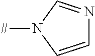 | OCH₃ | H | 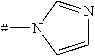 | OCH₃ | H |
| X.593 | CH₃ | H | H | CH₃ | H | H |
| X.594 | H | CH₃ | H | H | CH₃ | H |
| X.595 | H | H | CH₃ | H | H | CH₃ |
| X.596 | CH₃ | CH₃ | H | CH₃ | CH₃ | H |
| X.597 | CH₃ | H | CH₃ | CH₃ | H | CH₃ |
| X.598 | H | CH₃ | CH₃ | H | CH₃ | CH₃ |
| X.599 | CH₃ | CH₃ | CH₃ | CH₃ | CH₃ | CH₃ |
| X.600 | OCH₃ | H | H | OCH₃ | | H |
| X.601 | H | OCH₃ | H | H | OCH₃ | H |
| X.602 | H | H | OCH₃ | H | | OCH₃ |
| X.603 | OCH₃ | OCH₃ | H | OCH₃ | OCH₃ | H |
| X.604 | OCH₃ | H | OCH₃ | OCH₃ | H | OCH₃ |
| X.605 | H | OCH₃ | OCH₃ | H | OCH₃ | OCH₃ |
| X.606 | CH₃ | OCH₃ | H | CH₃ | OCH₃ | H |
| X.607 | OCH₃ | CH₃ | H | OCH₃ | CH₃ | H |
| X.608 | CH₃ | H | OCH₃ | CH₃ | H | OCH₃ |
| X.609 | OCH₃ | H | CH₃ | OCH₃ | H | CH₃ |
| X.610 | H | CH₃ | OCH₃ | H | CH₃ | OCH₃ |
| X.611 | H | OCH₃ | CH₃ | H | OCH₃ | CH₃ |
| X.612 | SCH₃ | H | CH₃ | SCH₃ | H | CH₃ |
| X.613 | SCH₃ | CH₃ | H | SCH₃ | CH₃ | H |
| X.614 | H | H | CH₂OH | CH₃ | H | H |
| X.615 | H | H | CH₂OH | H | H | CH₂OH |
| X.616 | H | H | CH₂F | H | H | CH₂F |
| X.617 | CH₂OCH₃ | H | CH₃ | CH₃ | H | H |

| X.618 | H | H | H | CH═CH—CH═CH | H |
|---|---|---|---|---|---|
| X.619 | CH₃ | H | H | CH═CH—CH═CH | H |
| X.620 | CH₃ | H | CH₃ | CH═CH—CH═CH | H |
| X.621 | CH₃ | H | CH₂CH₃ | CH═CH—CH═CH | H |
| X.622 | CH₃ | H | OCH₃ | CH═CH—CH═CH | H |
| X.623 | CH₃ | H | OCH₂CCH | CH═CH—CH═CH | H |
| X.624 | CH₃ | H | Cl | CH═CH—CH═CH | H |
| X.625 | OCH₃ | H | H | CH═CH—CH═CH | H |
| X.626 | OCH₃ | Cl | H | CH═CH—CH═CH | H |
| X.627 | H | H | H | CH═CH—CH═CH | CH₃ |
| X.628 | CH₃ | H | H | CH═CH—CH═CH | CH₃ |
| X.629 | CH₃ | H | CH₃ | CH═CH—CH═CH | CH₃ |
| X.630 | CH₃ | H | CH₂CH₃ | CH═CH—CH═CH | CH₃ |
| X.631 | CH₃ | H | OCH₃ | CH═CH—CH═CH | CH₃ |
| X.632 | CH₃ | H | OCH₂CCH | CH═CH—CH═CH | CH₃ |
| X.633 | CH₃ | H | Cl | CH═CH—CH═CH | CH₃ |
| X.634 | OCH₃ | H | H | CH═CH—CH═CH | CH₃ |
| X.635 | OCH₃ | Cl | H | CH═CH—CH═CH | CH₃ |
| X.636 | H | H | H | CH═CH—CH═CH | OCH₃ |
| X.637 | CH₃ | H | H | CH═CH—CH═CH | OCH₃ |
| X.638 | CH₃ | H | CH₃ | CH═CH—CH═CH | OCH₃ |
| X.639 | CH₃ | H | CH₂CH₃ | CH═CH—CH═CH | OCH₃ |
| X.640 | CH₃ | H | OCH₃ | CH═CH—CH═CH | OCH₃ |
| X.641 | CH₃ | H | OCH₂CCH | CH═CH—CH═CH | OCH₃ |
| X.642 | CH₃ | H | Cl | CH═CH—CH═CH | OCH₃ |
| X.643 | OCH₃ | H | H | CH═CH—CH═CH | OCH₃ |
| X.644 | OCH₃ | Cl | H | CH═CH—CH═CH | OCH₃ |
| X.645 | CH₃ | H | H | CH═CH—CH═CH | phenyl |
| X.646 | CH═CH—CH═CH | | H | CH═CH—CH═CH | H |
| X.647 | CH═CH—CH═CH | | H | CH═CH—CH═CH | CH₃ |
| X.648 | CH═CH—CH═CH | | CH₃ | CH═CH—CH═CH | CH₃ |
| X.649 | CH═CH—CH═CH | | phenyl | CH═CH—CH═CH | phenyl |
| X.650 | H | H | H | CH₂—CH₂—CH₂—CH₂ | H |
| X.651 | CH₃ | H | H | CH₂—CH₂—CH₂—CH₂ | H |
| X.652 | CH₃ | H | CH₃ | CH₂—CH₂—CH₂—CH₂ | H |
| X.653 | CH₃ | H | CH₂CH₃ | CH═CH—CH═CH | H |
| X.654 | CH₃ | H | OCH₃ | CH₂—CH₂—CH₂—CH₂ | H |
| X.655 | CH₃ | H | OCH₂CCH | CH₂—CH₂—CH₂—CH₂ | H |
| X.656 | CH₃ | H | Cl | CH₂—CH₂—CH₂—CH₂ | H |
| X.657 | OCH₃ | H | H | CH₂—CH₂—CH₂—CH₂ | H |
| X.658 | OCH₃ | Cl | H | CH₂—CH₂—CH₂—CH₂ | H |
| X.659 | Cl | Cl | H | CH₂—CH₂—CH₂—CH₂ | H |
| X.660 | H | H | H | CH₂—CH₂—CH₂—CH₂ | CH₃ |
| X.661 | CH₃ | H | H | CH₂—CH₂—CH₂—CH₂ | CH₃ |
| X.662 | CH₃ | H | CH₃ | CH₂—CH₂—CH₂—CH₂ | CH₃ |
| X.663 | CH₃ | H | CH₂CH₃ | CH₂—CH₂—CH₂—CH₂ | CH₃ |
| X.664 | CH₃ | H | OCH₃ | CH₂—CH₂—CH₂—CH₂ | CH₃ |
| X.665 | CH₃ | H | OCH₂CCH | CH₂—CH₂—CH₂—CH₂ | CH₃ |
| X.666 | CH₃ | H | Cl | CH₂—CH₂—CH₂—CH₂ | CH₃ |
| X.667 | OCH₃ | H | H | CH₂—CH₂—CH₂—CH₂ | CH₃ |
| X.668 | OCH₃ | Cl | H | CH₂—CH₂—CH₂—CH₂ | CH₃ |
| X.669 | Cl | Cl | H | CH₂—CH₂—CH₂—CH₂ | CH₃ |
| X.670 | H | H | H | CH₂—CH₂—CH₂—CH₂ | OCH₃ |
| X.671 | CH₃ | H | H | CH₂—CH₂—CH₂—CH₂ | OCH₃ |
| X.672 | CH₃ | H | CH₃ | CH₂—CH₂—CH₂—CH₂ | OCH₃ |
| X.673 | CH₃ | H | CH₂CH₃ | CH₂—CH₂—CH₂—CH₂ | OCH₃ |
| X.674 | CH₃ | H | OCH₃ | CH₂—CH₂—CH₂—CH₂ | OCH₃ |
| X.675 | CH₃ | H | OCH₂CCH | CH₂—CH₂—CH₂—CH₂ | OCH₃ |
| X.676 | CH₃ | H | Cl | CH₂—CH₂—CH₂—CH₂ | OCH₃ |
| X.677 | OCH₃ | H | H | CH₂—CH₂—CH₂—CH₂ | OCH₃ |
| X.678 | OCH₃ | Cl | H | CH₂—CH₂—CH₂—CH₂ | OCH₃ |
| X.679 | Cl | Cl | H | CH₂—CH₂—CH₂—CH₂ | OCH₃ |
| X.680 | H | H | H | CH₂—CH₂—CH₂—CH₂ | Cl |
| X.681 | CH₃ | H | H | CH₂—CH₂—CH₂—CH₂ | Cl |
| X.682 | CH₃ | H | CH₃ | CH₂—CH₂—CH₂—CH₂ | Cl |
| X.683 | CH₃ | H | OCH₃ | CH₂—CH₂—CH₂—CH₂ | Cl |

| | | | | |
|---|---|---|---|---|
| X.684 | CH₂—CH₂—CH₂—CH₂ | H | CH₂—CH₂—CH₂—CH₂ | H |
| X.685 | CH₂—CH₂—CH₂—CH₂ | CH₃ | CH₂—CH₂—CH₂—CH₂ | H |
| X.686 | CH₂—CH₂—CH₂—CH₂ | CH₃ | CH₂—CH₂—CH₂—CH₂ | CH₃ |
| X.687 | CH₂—CH₂—CH₂—CH₂ | Cl | CH₂—CH₂—CH₂—CH₂ | H |
| X.688 | CH₂—CH₂—CH₂—CH₂ | Cl | CH₂—CH₂—CH₂—CH₂ | CH₃ |
| X.689 | CH₂—CH₂—CH₂—CH₂ | Cl | CH₂—CH₂—CH₂—CH₂ | Cl |
| X.690 | CH₂—CH₂—CH₂—CH₂ | OCH₃ | CH₂—CH₂—CH₂—CH₂ | H |
| X.691 | CH₂—CH₂—CH₂—CH₂ | OCH₃ | CH₂—CH₂—CH₂—CH₂ | CH₃ |
| X.692 | CH₂—CH₂—CH₂—CH₂ | OCH₃ | CH₂—CH₂—CH₂—CH₂ | OCH₃ |

Table 1: This table discloses compounds 1.001 to 1.692 of the formula (I-I)

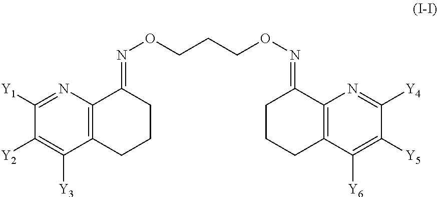

wherein Y¹, Y², Y³, Y⁴, Y⁵ and Y⁶ have the specific meanings given in the Table.

Table 2: This table discloses compounds 2.001 to 2.692 of the formula (I-II)

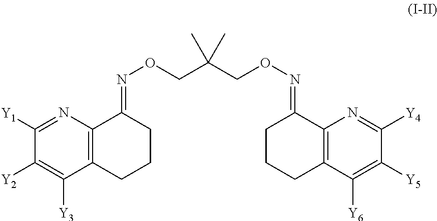

wherein Y¹, Y², Y³, Y⁴, Y⁵ and Y⁶ have the specific meanings given in the Table.

Table 3: This table discloses compounds 3.001 to 3.692 of the formula (I-III)

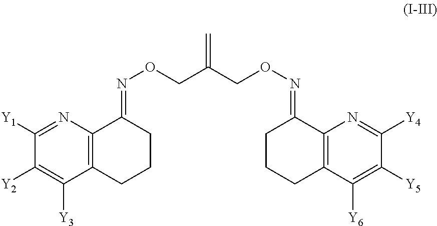

wherein Y¹, Y², Y³, Y⁴, Y⁵ and Y⁶ have the specific meanings given in the Table.

Table 4: This table discloses compounds 4.001 to 4.692 of the formula (I-IV)

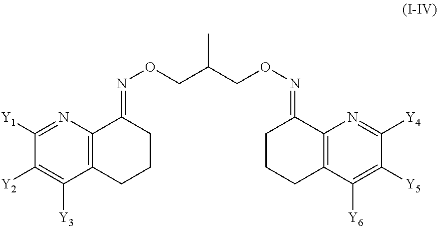

wherein Y¹, Y², Y³, Y⁴, Y⁵ and Y⁶ have the specific meanings given in the Table.

Table 5: This table discloses compounds 5.001 to 5.692 of the formula (I-V)

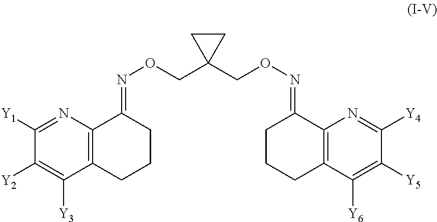

wherein Y¹, Y², Y³, Y⁴, Y⁵ and Y⁶ have the specific meanings given in the Table.

Table 6: This table discloses compounds 6.001 to 6.692 of the formula (I-VI)

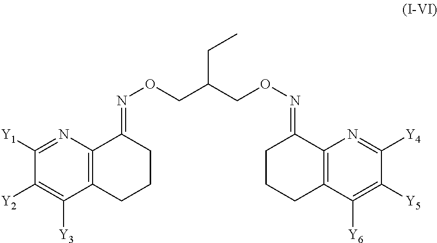

wherein Y¹, Y², Y³, Y⁴, Y⁵ and Y⁶ have the specific meanings given in the Table.

Table 7: This table discloses compounds 7.001 to 7.692 of the formula (I-VII)

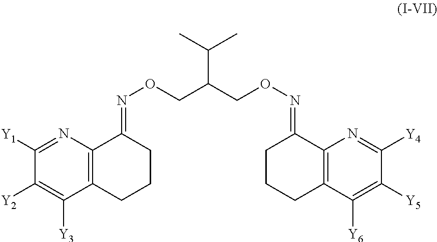

wherein Y¹, Y², Y³, Y⁴, Y⁵ and Y⁶ have the specific meanings given in the Table.

Table 8: This table discloses compounds 8.001 to 8.692 of the formula (I-VIII)

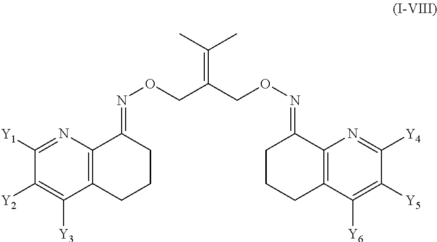

wherein Y¹, Y², Y³, Y⁴, Y⁵ and Y⁶ have the specific meanings given in the Table.

Table 9: This table discloses compounds 9.001 to 9.692 of the formula (I-IX)

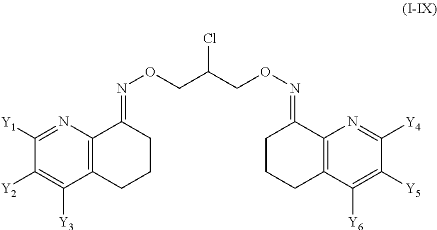

wherein Y¹, Y², Y³, Y⁴, Y⁵ and Y⁶ have the specific meanings given in the Table.

Table 10: This table discloses compounds 10.001 to 10.692 of the formula (I-X)

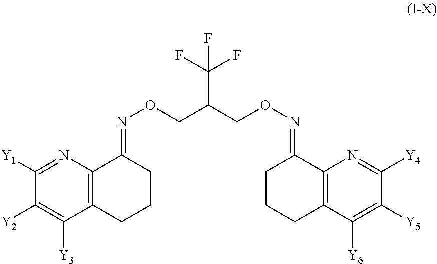

wherein Y¹, Y², Y³, Y⁴, Y⁵ and Y⁶ have the specific meanings given in the Table.

Table 11: This table discloses compounds 11.001 to 11.692 of the formula (I-XI)

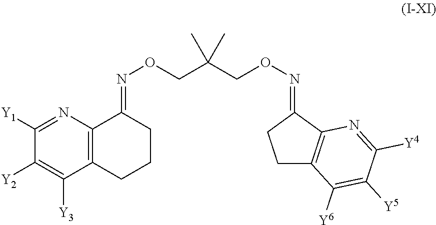

wherein Y¹, Y², Y³, Y⁴, Y⁵ and Y⁶ have the specific meanings given in the Table.

Table 12: This table discloses compounds 12.001 to 12.692 of the formula (I-XII)

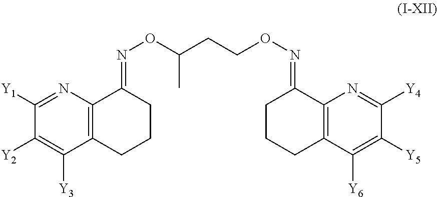

wherein Y¹, Y², Y³, Y⁴, Y⁵ and Y⁶ have the specific meanings given in the Table.

Table 13: This table discloses compounds 13.001 to 13.692 of the formula (I-XIII)

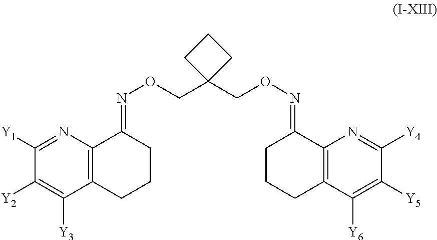

wherein Y¹, Y², Y³, Y⁴, Y⁵ and Y⁶ have the specific meanings given in the Table.

Table 14: This table discloses compounds 14.001 to 14.692 of the formula (I-XIV)

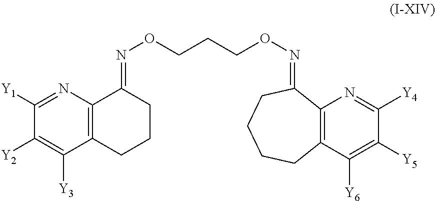

wherein Y¹, Y², Y³, Y⁴, Y⁵ and Y⁶ have the specific meanings given in the Table.

Table 15: This table discloses compounds 15.001 to 15.692 of the formula (I-XV)

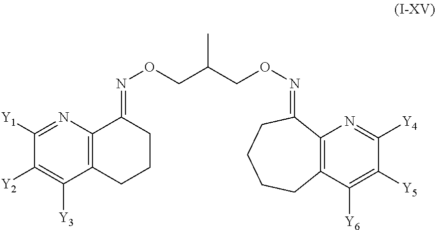

wherein Y¹, Y², Y³, Y⁴, Y⁵ and Y⁶ have the specific meanings given in the Table.

Table 16: This table discloses compounds 16.001 to 16.692 of the formula (I-XVI)

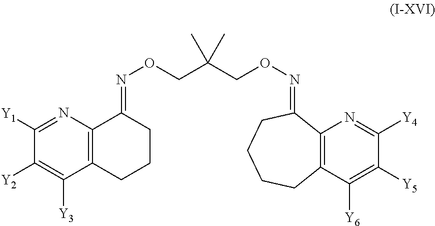

wherein Y¹, Y², Y³, Y⁴, Y⁵ and Y⁶ have the specific meanings given in the Table.

Table 17: This table discloses compounds 17.001 to 17.692 of the formula (I-XVII)

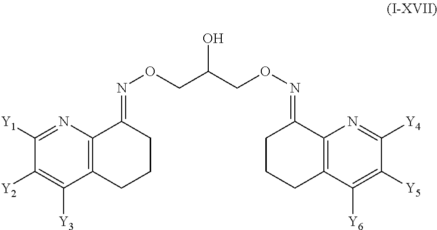

wherein Y¹, Y², Y³, Y⁴, Y⁵ and Y⁶ have the specific meanings given in the Table.

Table 18: This table discloses compounds 18.001 to 18.692 of the formula (I-XVIII)

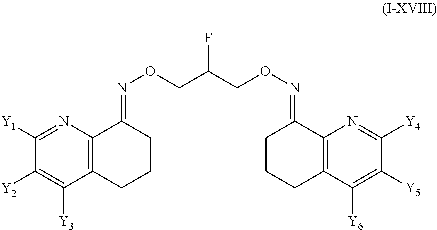

wherein Y¹, Y², Y³, Y⁴, Y⁵ and Y⁶ have the specific meanings given in the Table.

Table 19: This table discloses compounds 19.001 to 19.692 of the formula (I-XIX)

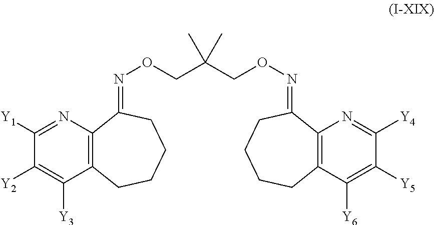

wherein Y¹, Y², Y³, Y⁴, Y⁵ and Y⁶ have the specific meanings given in the Table.

Table 20: This table discloses compounds 20.001 to 20.692 of the formula (I-XX)

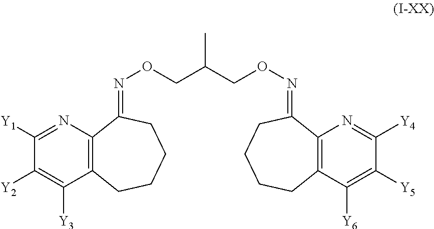

wherein Y¹, Y², Y³, Y⁴, Y⁵ and Y⁶ have the specific meanings given in the Table.

Table 21: This table discloses compounds 21.001 to 21.692 of the formula (I-XXI)

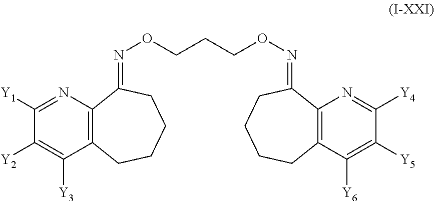

wherein Y¹, Y², Y³, Y⁴, Y⁵ and Y⁶ have the specific meanings given in the Table.

Table 22: This table discloses compounds 22.001 to 22.692 of the formula (I-XXII)

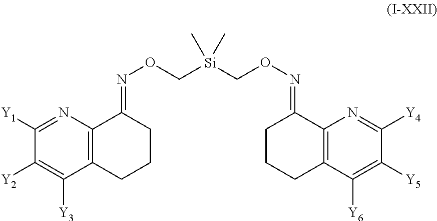

wherein Y¹, Y², Y³, Y⁴, Y⁵ and Y⁶ have the specific meanings given in the Table.

Table 23: This table discloses compounds 23.001 to 23.692 of the formula (I-XXIII)

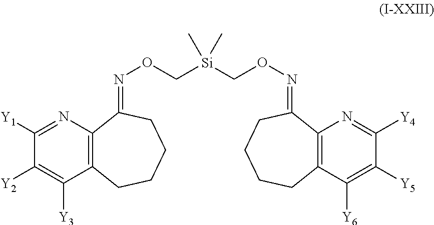

wherein Y¹, Y², Y³, Y⁴, Y⁵ and Y⁶ have the specific meanings given in the Table.

Table 24: This table discloses compounds 24.001 to 24.692 of the formula (I-XXIV)

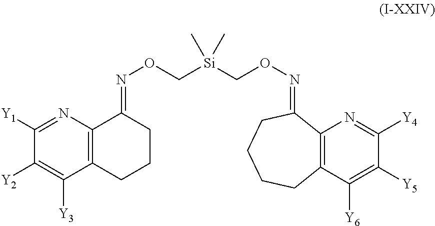

wherein Y¹, Y², Y³, Y⁴, Y⁵ and Y⁶ have the specific meanings given in the Table.

The compounds in Tables 1 to 24 include all isomers, tautomers and mixtures thereof, including the cis/trans isomers shown above.

The compounds of the invention may be made by a variety of methods, illustrated in schemes 1-7. The compounds depicted in the schemes also indicate any isomers and tautomers, in particular the geometric isomers arising from the oxime and oxime ether moieties.

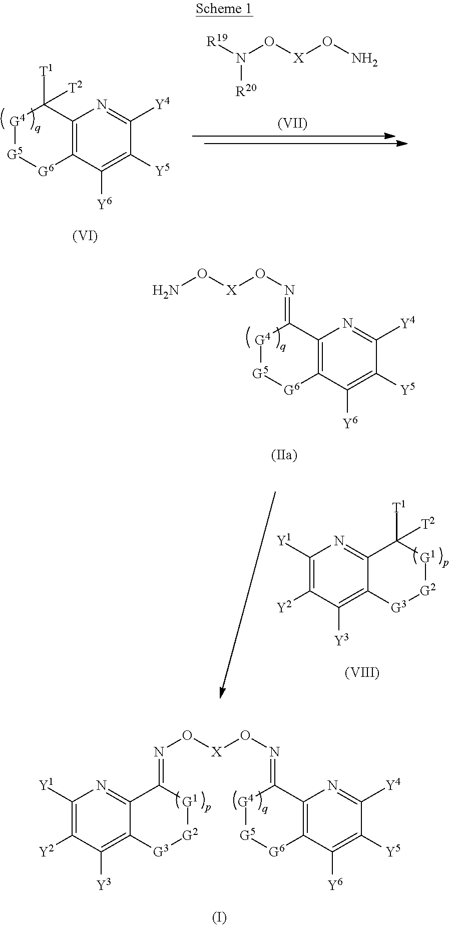

1) Compounds of formula (I) may be prepared by reacting a compound of formula (IIa), wherein X, G⁴, G⁵, G⁶, q, Y⁴, Y⁵ and Y⁶ are as defined herein for compounds of formula (I), with a compound of formula (VIII), wherein G¹, G², G³, p, Y¹, Y² and Y³ are as defined herein for compounds of formula (I), and T¹ and T² are C₁-C₈ alkoxy, or T¹ and T² together with the carbon they are attached to form a carbonyl group or an acetal or ketal function of the form C(O—C₁-C₆-alkylidene-O) whereby the alkylidene fragment may optionally be mono- to tetra-substituted by C₁-C₆ alkyl, as seen in scheme 1.

A general description of condensation reactions is given below, and typical reaction conditions for this type of reaction may be found in Journal of Organic Chemistry, 52(22), 4978-84; 1987; Chemical & Pharmaceutical Bulletin, 51(2), 138-151; 2003; Organic Letters, 10(2), 285-288; 2008; Journal of the American Chemical Society, 130(12), 4196-4201; 2008; Chemistry & Biology, 9(1), 113-129; 2002; Organic Preparations and Procedures International, 32(2), 153-159; 2000; Scientia Pharmaceutica, 66(1), 9-21; 1998, Journal of Medicinal Chemistry, 49(17), 5177-5186; 2006, Journal of Agricultural and Food Chemistry, 38(3), 839-44; 1990; Tetrahedron: Asymmetry, 8(2), 253-263; 1997; Journal of Medicinal Chemistry, 44(21), 3339-3342; 2001; Bioorganic & Medicinal Chemistry Letters, 12(3), 341-344; 2002; US 2007032470; WO 07/058,504; Journal of Organic Chemistry, 73(5), 2007-2010; 2008; Bioorganic & Medicinal Chemistry Letters, 19(10), 2683-2687; 2009; and Bioorganic & Medicinal Chemistry Letters, 19(10), 2654-2660; 2009.

2) Hydroxylamine derivatives of formula (IIa) may be made by reacting compounds of formula (VI), wherein G⁴, G⁵, G⁶, q, Y⁴, Y⁵ and Y⁶ are as defined herein for compounds of formula (I), and T¹ and T² are C₁-C₈ alkoxy, or T¹ and T² together with the carbon they are attached to form a carbonyl group or an acetal or ketal function of the form C(O—C₁-C₆-alkylidene-O) whereby the alkylidene fragment may optionally be mono- to tetra-substituted by C₁-C₆ alkyl, with a bishydroxylamine derivative of formula (VII), wherein X is as defined herein for a compound of formula (I) and R¹⁹ and R²⁰ are either hydrogen or suitable protecting groups such as tert-butyloxycarbonyl (BOC), allyloxycarbonyl, fluorenylmethyloxycarbonyl (FMOC), formyl, acetyl, propionyl, trifluoroacetyl, benzoyl, substituted benzoyl, STABASE, Si(O—C₁-C₈-alkyl)₃, bis-Si(O—C₁-C₈-alkyl)₃, bis-benzyl, substituted bis-benzyl, bis-allyl, substituted bis-allyl, bis C₁-C₈-alkoxy-alkyl, N-phenylmethylene, substituted N-phenylmethylene, trityl, benzhydryl, substituted benzhydryl, or R¹⁹ and R²⁰ together with the nitrogen atom to which they are attached may form a phthalyl group (scheme 1). General conditions for this type of condensation reaction can be found below.

When R¹⁹ and R²⁰ are hydrogen, in order to optimize the yield of compound (IIa) an excess of intermediate (V) over intermediate (IV) may preferably be used. If R¹⁹ or R²⁰ is not hydrogen, the hydroxylamine derivative may be deprotected using techniques well known to the person skilled in the art. Examples can be found in Greene, T. W., Wuts, P. G. N., Protective Groups in Organic Synthesis, John Wiley & Sons, Inc, 2006.

Monoprotection of bis-hydroxylamines has been described in Tetrahedron (1997), 53(15), 5485-5492. It is to be understood that methods used to obtain mono-protected diamines can be used in an analogous way to obtain mono-protected bis-hydroxylamine derivatives. Typical conditions for this type of reaction can be found in Synthetic Communications (2007), 37(5), 737-742; Organic Preparations and Procedures International (2009), 41(4), 301-307; Tetrahedron: Asymmetry (2003), 14(11), 1559-1563; Bulletin of the Korean Chemical Society (1994), 15(12), 1025-7; Synthesis (1990), (4), 366-8; and Synthesis (1984), (12), 1032-3.

Bishydroxylamine derivatives are known in the literature. A description of their preparation can be found in WO 08/074,418; Inorganic Chemistry Communications (2009), 12(3), 234-236; WO 99/49314; Synthesis (1997), (1), 38-40; and Gazzetta Chimica Italiana (1954), 84 915-20.

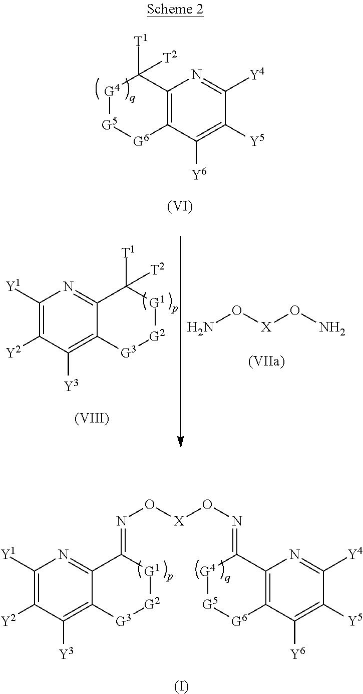

3) Alternatively, as seen in scheme 2, compounds of formula (I) may be prepared by reacting a compound of formula (IV) and a compound of formula (VIII) in the presence of a compound of formula (VIIa), that is a compound of formula (VII) wherein R¹⁹ and R²⁰ are both hydrogen. Compounds of formula (VI) and (VIII) are described under Scheme 1.

Typical reaction conditions for condensation reactions are seen below, and typical conditions for this particular condensation reaction are seen in the following references: Nature Chemical Biology, 5(6), 407-413; 2009; Acta Crystallographica, Section E: Structure Reports Online, E65(7), 01657; 2009; Acta Crystallographica, Section E: Structure Reports Online, E64(8), o1405, o1405/1-01405/7; 2008; Acta Crystallographica, Section E: Structure Reports Online, E64(7), o1324, o1324/1-o1324/6; 2008; Acta Crystallographica, Section E: Structure Reports Online, E63(10), o4080, So4080/1-So4080/7; 2007; Synthetic Communications, 33(4), 543-546; 2003.

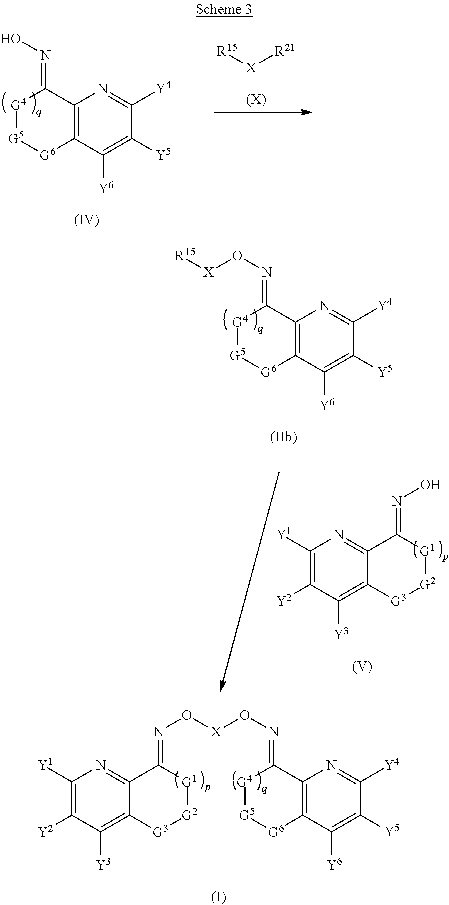

4) Alternatively, compounds of formula (I) can be obtained by reacting a compound of formula (IIb), that is a compound of formula (II) wherein R¹⁵ is a halogen, in particular chlorine, bromine or iodine, or a sulfonic acid ester group, such as mesylate, tosylate, triflate, a phenylsulfonic acid ester, a nitro-phenylsulfonic acid ester, or a nonafluorobutylsulfonic acid ester, or trichloroacetimidate, and G⁴, G⁵, G⁶, q, X, Y⁴, Y⁵ and Y⁶ are as defined herein for compounds of formula (I), with a compound of formula (V), wherein G¹, G², G³, p, Y¹, Y² and Y³ are as defined herein for compounds of formula (I) (scheme 3).

Typical reaction conditions for alkylation reactions such as this may be found below. These are further illustrated in Chinese Journal of Chemistry, 27(1), 33-42; 2009; WO 09/049,846; Journal of Antibiotics, 61(10), 603-614; 2008; Bioorganic & Medicinal Chemistry Letters, 18(24), 6471-6475; 2008; Journal of Medicinal Chemistry, 51(15), 4601-4608; 2008; WO 06/123145, Archiv der Pharmazie (Weinheim, Germany), 340(4), 202-208; 2007; Synthetic Communications, 37(7), 1155-1165; 2007; Russian Journal of Organic Chemistry, 42(5), 735-738; 2006; Bioinorganic Chemistry and Applications, 1(3-4), 299-308; 2003; Synthetic Communications, 28(14), 2621-2633; 1998; Synthetic Communications, 19(18), 3129-38; 1989.

5) Compounds of formula (IIb) may be obtained by reacting an oxime of formula (IV) wherein G⁴, G⁵, G⁶, q, Y⁴, Y⁵ and Y⁶ are as defined herein for compounds of formula (I), with a compound of formula (X), wherein R¹⁵ is as defined herein for compounds of formula (IIb) and R²¹ is a halogen, in particular chlorine, bromine or iodine, a sulfonic acid ester group, or trichloroacetimidate (scheme 3). R¹⁵ and R²¹ may be the same or different. Preferentially, R²¹ is a better leaving group under the conditions of the reaction, such as tosylate or bromine when R¹⁵ is chlorine. Preferentially, an excess of the compound of formula (X) relative to the oxime (IV) would be used in the reaction, especially when R¹⁵ and R²¹ are the same.

Typical reaction conditions for alkylation reactions such as this can be found below, and are further illustrated in Journal of Agricultural and Food Chemistry (2008), 56(23), 11376-1139, Farmaco (2003), 58(9), 707-714; 1985; Journal of Heterocyclic Chemistry (1979), 16(7), 1459-67; WO 08/074,418; Journal of Medicinal Chemistry (2008), 51(20), 6421-6431; Synthetic Communications (2007), 37(7), 1155-1165; Bioorganic & Medicinal Chemistry (2007), 15(13), 4520-4527; Journal of Medicinal Chemistry (2006), 49(15), 4638-4649; and Synlett (2001), (Spec. Issue), 931-936.

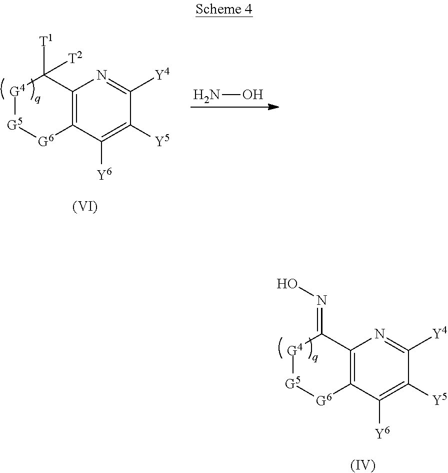

6) Oximes of formula (IV) may be obtained by a condensation reaction, whereby a compound of formula (VI), wherein G⁴, G⁵, G⁶, q, Y⁴, Y⁵ and Y⁶ are as defined herein for compounds of formula (I) and T¹ and T² are C₁-C₈ alkoxy, or T¹ and T² together with the carbon they are attached to form a carbonyl group or an acetal or ketal function of the form C(O—C₁-C₆-alkylidene-O) whereby the alkylidene fragment may optionally be mono- to tetra-substituted by C₁-C₆-alkyl, is reacted with hydroxylamine, or, alternatively, with a salt of hydroxylamine. Similar conditions may be used to obtain oximes of formula (V) from compounds of formula (VIII). A more detailed description of condensation processes is given below.

Related references include the following: Journal of Heterocyclic Chemistry, 46(1), 116-118; 2009; Journal of Medicinal Chemistry, 20(5), 718-21; 1977; Journal of Organic Chemistry, 73(11), 4017-4026; 2008; EJEAFChe, Electronic Journal of Environmental, Agricultural and Food Chemistry, 5(5), 1515-1521; 2006; Advanced Synthesis & Catalysis, 346(13-15), 1798-1811; 2004.

Some compounds of formula (VI) and formula (VIII) are known and their preparation has been published or they are available commercially. A few typical examples are given in Table 25 together with the corresponding CAS numbers. Analogous protocols to those used to prepare the following compounds can be used to prepare other compounds of formula (IV).

TABLE 25

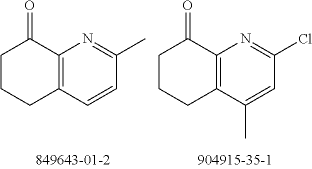

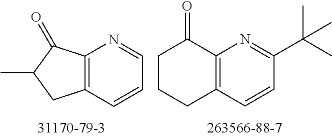

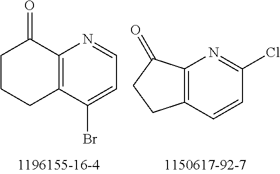

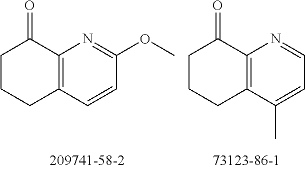

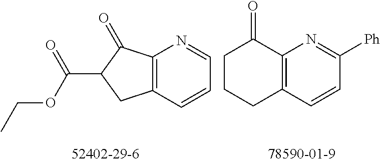

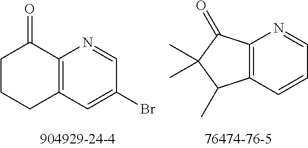

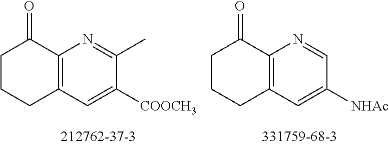 [SMILES: COC(=O)c1cc2c(nc1C)C(=O)CCC2 ; CC(=O)Nc1cnc2c(c1)CCCC2=O]

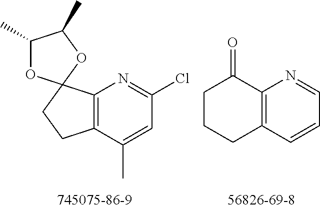

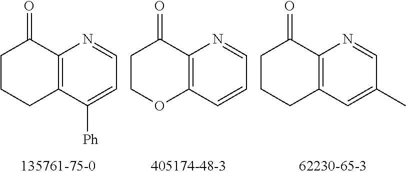

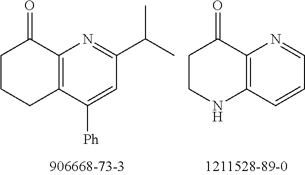

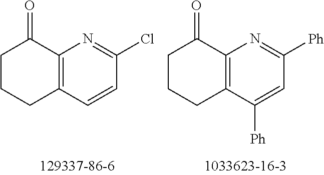

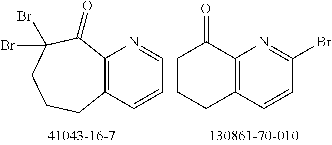

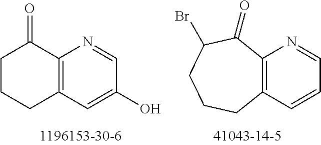 [SMILES: O=C1CCCc2cc(O)cnc21 ; O=C1c2ncccc2CCCC1Br]

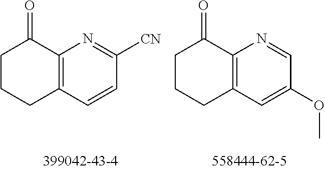

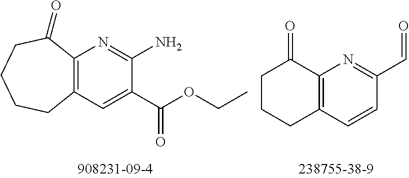

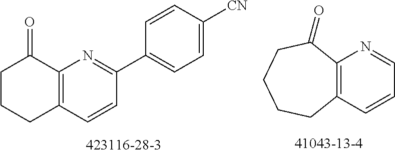 [SMILES: N#Cc1ccc(-c2ccc3c(n2)C(=O)CCC3)cc1 ; O=C1CCCCc2cccnc21]

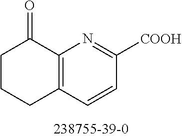 [SMILES: O=C(O)c1ccc2c(n1)C(=O)CCC2]

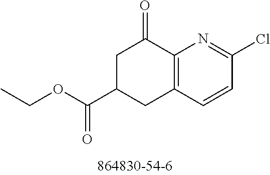 [SMILES: CCOC(=O)C1CC(=O)c2nc(Cl)ccc2C1]

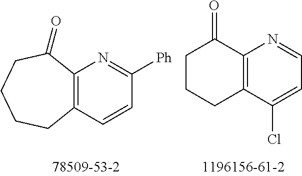

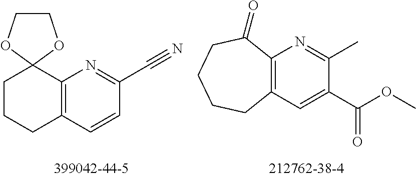

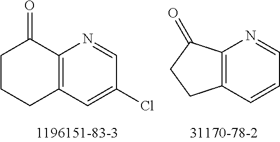

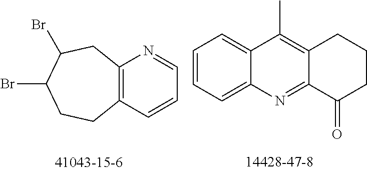

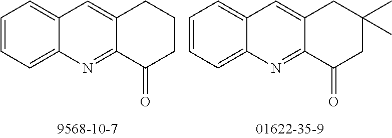

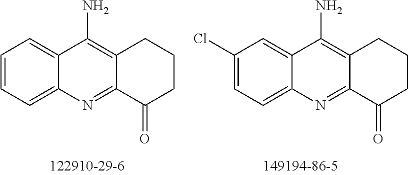

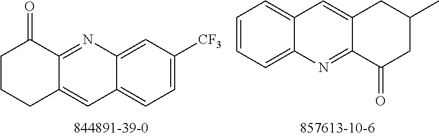

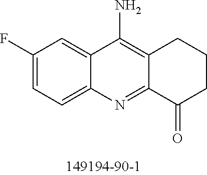 [SMILES: Nc1c2c(nc3ccc(F)cc13)C(=O)CCC2]

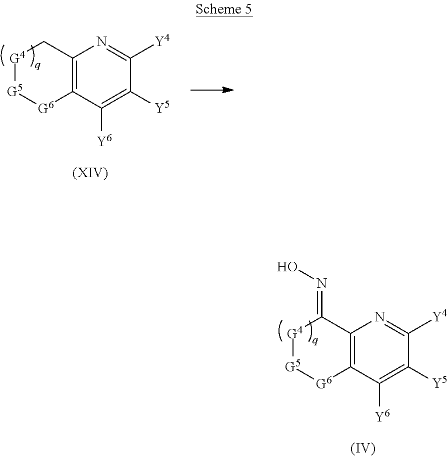

7) Alternatively, oximes of formula (IV) can be obtained by a nitrosation reaction of compounds of formula (XIV), wherein G⁴, G⁵, G⁶, q, Y⁴, Y⁵ and Y⁶ are as defined herein for compounds of formula (I), with base and an alkyl nitrite, as seen in scheme 5. Typical bases include lithium diisopropyl amide (LDA), lithium hexamethyldisilazane, n-butyl lithium, s-butyl lithium, tert-butyl lithium, sodium tert-butylate or potassium tert-butylate. Typical alkyl nitrites include isopentyl nitrite and tert-butyl nitrite. The compound of formula (XIV), the alkyl nitrite or the base can be used in different stoichiometric amounts, with each reagent possibly being in excess with respect to the others. Preferentially, such reactions are carried out under non-aqueous conditions in an inert solvent such as hexane, heptanes, cyclohexane, toluene or ethers such as THF or tert-butyl methyl ether. The reaction may be performed at temperatures ranging from −80 to 250° C., preferably between −50 and 120° C. Similar conditions can be used to prepare oximes of formula (X).

Such reactions can lead to a mixture of the E- and the Z-oxime (ether) product, or the product may also be exclusively either the E- or the Z-oxime (ether).

A large number of these types of transformations are known in the art. Typical reaction conditions for this type of reaction may be found in Crawford, Jason B.; Chen, Gang; Gauthier, David; Wilson, Trevor; Carpenter, Bryon; Baird, Ian R.; McEachern, Ernie; Kaller, Alan; Harwig, Curtis; Atsma, Bem; Skerlj, Renato T.; Bridger, Gary J., Organic Process Research & Development (2008), 12(5), 823-830, McEachern, E. J.; Yang, W.; Chen, G.; Skerlj, R. T.; Bridger, G. J., Synthetic Communications (2003), 33(20), 3497-350; and Bark, Thomas; Thummel, Randolph P., Inorganic Chemistry (2005), 44(24), 8733-8739.

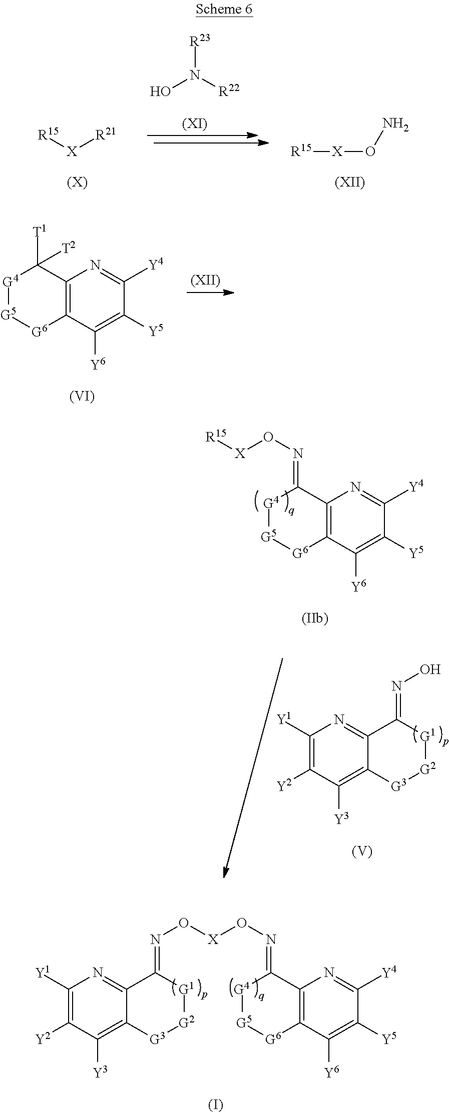

8) An alternative route to compounds of formula (I) is shown in Scheme 6. As in scheme 3, the compound of formula (I) is obtained by the reacting a compound of formula (IIb) with a compound of formula (V) as an alkylation reaction. Typical conditions for this type of reaction are described below.

9) The compounds of (IIb) can be formed by reacting a hydroxylamine derivative of formula (XII), wherein R¹⁵ is halogen, with a compound of formula (VI), as seen in scheme 6. Compounds of formula (VI) are described above.

Typical reaction conditions for this type of condensation reaction may be found below, and are further illustrated in Angewandte Chemie, International Edition (2006), 45(32), 5307-5311.

10) Compounds of formula (XII) can be made by alkylating a hydroxylamine derivative of formula (XI), wherein R²² and R²³, either independently of each other, or together with each other and the nitrogen atom to which they are attached, are protecting groups, such as tert-butoxy carbonyl, acetyl, benzyl, or phthalyl, with the alkylating agent (X), wherein R¹⁵ is halogen and R²¹ is halogen, in particular chloro, bromo or iodo, a sulfonic acid ester group, or trichloroacetimidate (scheme 6). Typical conditions for such an alkylation reaction may be found below. The protecting groups or group can then be removed using techniques well known to a person skilled in the art, examples of which can be found in Greene, T. W., Wuts, P. G. N., Protective Groups in Organic Synthesis, John Wiley & Sons, Inc, 2006.

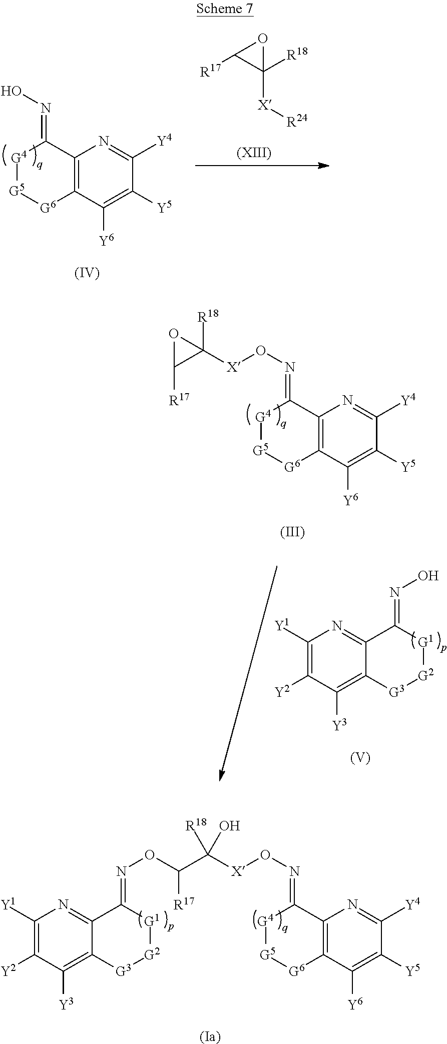

11) Compounds of formula (Ia), that is compounds of formula I wherein G¹, G², G³, G⁴, G⁵, G⁶, Y¹, Y², Y³, Y⁴, Y⁵, Y⁶, p and q are as defined herein for formula (I), X′ represents X′-1, X′-2 or X′-3

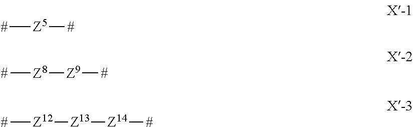

wherein Z⁵, Z⁸, Z⁹, Z¹², Z¹³ and Z¹⁴ are as defined herein for compounds of formula (I), and R¹⁷ and R¹⁸ independently of one another represent hydrogen, halogen, C₁-C₄ alkyl, C₁-C₄ haloalkyl, phenyl or CN, wherein phenyl is optionally substituted by one or more groups, e.g. one to five groups, independently selected from halogen, CN, C₁-C₄ alkyl, C₁-C₄ haloalkyl, C₁-C₄ alkoxy and C₁-C₄ haloalkoxy, can be made by reacting compounds of formula (III), wherein G⁴, G⁵, G⁶, Y⁴, Y⁵, Y⁶ and q are as defined herein for formula (I) and R¹⁷ and R¹⁸ independently of one another represent hydrogen, halogen, C₁-C₄ alkyl, C₁-C₄ haloalkyl, phenyl or CN, wherein phenyl is optionally substituted by one or more groups, e.g. one to five groups, independently selected from halogen, CN, C₁-C₄ alkyl, C₁-C₄ haloalkyl, C₁-C₄ alkoxy and C₁-C₄ haloalkoxy, with compounds of formula (V) which have been described herein.

Typical conditions for an alkylation such as this are described below, and a further illustrated in Synthesis, (13), 2055-2064; 2008; Russian Journal of Organic Chemistry, 43(2), 181-183; 2007; Russian Journal of Organic Chemistry 43(3), 449-453; 2007; and Journal of Molecular Catalysis B: Enzymatic, 11(4-6), 255-263; 2001.

Compounds of formula (Ia) are especially useful as intermediates to a number of other compounds, wherein the hydroxy group formed by the opening of the epoxide is transformed into other functional groups, for example carbonyl, fluorine or chlorine. Such transformations can be effected using a number of conditions well known to the person skilled in the art.

12) Compounds of formula (III) can be obtained by the alkylation of oximes of formula (IV) with epoxides of formula (XIII) wherein X′, R¹⁷ and R¹⁸ are as defined above for compounds of formula (III) and R²⁴ is halogen. Such alkylation processes are described in more detail below.

Relevant references include the following: Synthetic Communications, 37(7), 1155-1165; 2007; Molecules, 10(7), 747-754; 2005; Molecules, 10(11), 1399-1408; 2005; European Journal of Medicinal Chemistry, 40(12), 1351-1358; 2005; Organic Preparations and Procedures International, 30(2), 195-202; 1998; WO 08/074,418; and Journal fuer Praktische Chemie/Chemiker-Zeitung (1993), 335(7), 623-7.

A large number of compounds of formula (XIII) are commercially available or their preparation is to be found in the literature. Commercially available compounds (XIII) include epichlorohydrin, 2(S)-epichlorohydrin, 2(R)-epichlorohydrin, 2-methyl-epichlorohydrin, epibromohydrin.

Typical Conditions for Condensation Reactions:

This applies to procedures 1, 2, 3, 6 and 9.

Different stoichiometric set-ups may be used for these reactions, depending on the properties of reactants and product. An excess of the electrophile, the nucleophile, or equimolar amounts may be chosen. Preferentially equimolar amounts of electrophilic and nucleophilic compounds are used.

The reaction may be performed in the presence or absence of an inert organic or inorganic solvent, or in the presence of a mixture of such solvents. Preferentially, it is performed in the presence of one or more solvents. Preferred solvents include the following aliphatic or aromatic hydrocarbons, which may optionally be substituted by one or more halogen atoms, such as pentane, hexanes, heptanes, cyclohexane, petroleum ether, benzene, toluene, xylene, chlorobenzene, dichlorobenzenes, dichloromethane, chloroform, 1,2-dichloroethane or carbon tetrachloride, ethers such as diethylether, diisopropyl ether, tert-butyl methyl ether, tetrahydrofuran, 1,4-dioxane, dimethoxyethane or diglycol dimethyl ether, ketones such as acetone, methyl ethyl ketone, methyl isopropyl ketone or methyl isobutyl ketone, acids and ester such as acetic acid, ethyl acetate or methyl acetate, aprotic polar solvents such as acetonitrile, pripionitril, dimethyl formamide, dimethyl acetamide, N-methyl-pyrrolidone, dimethyl sulfoxide, sulfolane, DMPU, or pyridine and picolines. The selection of solvents includes water and alcohols such as methanol, ethanol, propanol, isopropanol, butanol, isobutanol, tert-butanol, pentanol, isopentanol, hexanol, trifluorethanol, ethylene glycol or methoxyethanol.

The reaction may be performed between −20° C. and 250° C., preferentially between 0° C. and 100° C. In some cases the reaction mixture may be heated to reflux.

Where appropriate, compounds can be used in the form of the free compound, or, alternatively, they can be used in the form of a salt such as the acetate, trifluoroacetate, propionate, benzoate, oxalate, methylsolfonate, phenylsulfonate, p-tolylsulfonate, trifluormethylsulfonate, fluoride, chloride, bromide, iodide, sulphate, hydrogensulphate or nitrate, including bis-salts if appropriate.

The reaction can be carried out in the absence of an acid using the free compounds. Alternatively, the reaction may be performed in the presence of an acid in catalytic, stoichiometric or excess amounts. Acids that could be used include acetic acid, propionic acid, oxalic acid, trifluoroacetic acid, hydrochloric acid, hydrobromic acid, hydroiodic acid, methansulfonic acid, para-toluenesulfonic acid, sulphuric acid, sodium hydrogensulphate and phosphoric acid. The reaction can optionally be carried out in a water-free solvent system in the presence of a drying agent, such as sodium or magnesium sulphate, potassium carbonate or molecular sieves.

If the two substituents at the carbon atom of the oxime or oxime ether function are different from each other, the condensation reaction can lead to a mixture of the E- and the Z-oxime (ether) product. The condensation product may also be exclusively either the E- or the Z-oxime (ether).

Condensations can be performed under reduced pressure, normal pressure or increased pressure. Preferentially the reaction is performed under normal pressure.

Typical Conditions for Alkylation Reactions:

This applies to procedures 4, 5, 8, 10, 11 and 12.

Different stoichiometric set-ups may be used for these reactions, depending on the properties of reactants and product. An excess of the electrophile, the nucleophile, or neither may be chosen. Usually, it is preferable that equimolar amounts of electrophilic and nucleophilic compounds are used.

The reaction may be performed in the absence or presence of a solvent or a mixture of solvents. Preferential solvents include the following aliphatic or aromatic hydrocarbons that may optionally be substituted by one or more halogen atoms such as pentane, hexanes, heptanes, cyclohexane, petroleum ether, benzene, toluene, xylene, chlorobenzene, dichlorobenzenes, dichloromethane, chloroform, 1,2-dichloroethanev or carbon tetrachloride, ethers such as diethyl ether, diisopropyl ether, tert-butyl-methyl ether, tetrahydrofuran, 1,4-dioxane, dimethoxyethane or diglycol dimethyl ether, ketones such as acetone, methyl ethyl ketone, methyl isopropyl ketone or methyl isobutyl ketone, acids and ester such as acetic acid, ethyl acetate or methyl acetate, aprotic polar solvents such as acetonitrile, pripionitrile, dimethyl formamide, dimethyl acetamide, N-methyl-pyrrolidone, dimethyl sulfoxide, sulfolane, DMPU, or pyridine and picolines. The selction of solvents includes also water and alcohols such as methanol, ethanol, propanol, isopropanol, butanol, isobutanol, tert-butanol, pentanol, isopentanol, hexanol, trifluorethanol, ethylene glycol or methoxyethanol.

The reaction may be performed in a biphasic system comprising an organic solvent that is not miscible with water, such as toluene, dichloromethane, dichloro-ethylene, and an aqueous solvent, such as water. Such a reaction would be performed in the presence of a phase-transfer catalyst, such as tetra-n-butylammonium bromide (TBAB), Tetradecyldimethylbenzylammonium chloride (TDMBAC), N-Benzyltrimethylammonium hydroxide, along with aqueous sodium or potassium hydroxide in stoichiometric amounts. The biphasic reaction may be performed with or without ultrasonication.

The reaction may be carried out at temperatures varying from −100° C. and 250° C. Preferentially, the temperature range is between 0° C. and 100° C.

Optionally, an organic or inorganic base may be present such as alkali- and earth alkali acetates, amides, carbonates, hydrogencarbonates, hydrides, hydroxides or alcoholates such as sodium, potassium, caesium or calcium acetate, sodium, potassium, caesium or calcium carbonate, sodium, potassium, caesium or calcium hydrogencarbonate, sodium, potassium, caesium or calcium hydride, sodium, potassium, caesium or calcium amide, sodium, potassium, caesium or calcium hydroxide, sodium, potassium, caesium or calcium methanolate, sodium, potassium, caesium or calcium ethanolate, sodium, potassium, caesium or calcium n-, i-, s- or t-butanolate, triethylamine, tripropylamine, tributylamine, di-isopropyl-ethylamine, N,N-dimethyl-cyclohexylamine, N-methyl-dicyclohexylamine, N,N-dimethyl-aniline, N,N-diethyl-aniline, N,N-dimethyl-benzylamine, N,N-diethyl-benzylamine, pyridine, 2-methyl-pyridine, 3-methyl-pyridine, 4-methyl-pyridine, 2,6-dimethyl-pyridine, 2,4,6-trimethyl-pyridine, 4-dimethylamino-pyridine, N-methyl-piperidine, N-ethyl-piperidine, N-methyl-morpholine, N-ethyl-morpholine, N,N′-dimethyl-piperazine, 1,4-Diazabicyclo[2.2.2]octane (DABCO), 1,8-Diaza-7-bicyclo[5.4.0]undecene (DBU), 1,5-Diazabicyclo[4.3.0]non-5-ene (DBN), 1-tert-Butyl-2,2,2-tri(1-pyrrolidinyl)phosphazene (BTPP), 1-tert-Butyl-2,2,2-tris(dimethylamino)phosphazene, sodium hexamethyldisilazane, potassium hexamethyldisilazane, lithium diisopropylamide, ethyl magnesium chloride, isopropylmagnesium chloride.

The alkylation can be performed under reduced pressure, normal pressure or increased pressure. Preferentially the reaction is performed under normal pressure.

The products of steps 1) to 12) may be required to be purified using, for example, chromatography, crystallisation or other purification techniques well known to the person skilled in the art.

The compounds of formula (I) to formula (XIII) and, where appropriate, the tautomers thereof, can, if appropriate, also be obtained in the form of hydrates and/or include other solvents, for example those which may have been used for the crystallization of compounds which are present in solid form.

It has now been found that the compounds of formula (I) according to the invention have, for practical purposes, a very advantageous spectrum of activities for protecting useful plants against diseases that are caused by phytopathogenic microorganisms, such as fungi, bacteria or viruses.

The invention therefore also relates to a method of controlling or preventing infestation of useful plants by phytopathogenic microorganisms, wherein a compound of formula (I) is applied as active ingredient to the plants, to parts thereof or the locus thereof. The compounds of formula (I) according to the invention are distinguished by excellent activity at low rates of application, by being well tolerated by plants and by being environmentally safe. They have very useful curative, preventive and systemic properties and are used for protecting numerous useful plants. The compounds of formula (I) can be used to inhibit or destroy the diseases that occur on plants or parts of plants (fruit, blossoms, leaves, stems, tubers, roots) of different crops of useful plants, while at the same time protecting also those parts of the plants that grow later e.g. from phytopathogenic microorganisms.

It is also possible to use compounds of formula (I) as dressing agents for the treatment of plant propagation material, in particular of seeds (fruit, tubers, grains) and plant cuttings (e.g. rice), for the protection against fungal infections as well as against phytopathogenic fungi occurring in the soil.

Furthermore the compounds of formula (I) according to the invention may be used for controlling fungi in related areas, for example in the protection of technical materials, including wood and wood related technical products, in food storage or in hygiene management.

The compounds of formula (I) are, for example, effective against the phytopathogenic fungi of the following classes: Fungi imperfecti (e.g. Botrytis, Pyricularia, Helminthosporium, Fusarium, Septoria, Cercospora and Alternaria) and Basidiomycetes (e.g. Rhizoctonia, Hemileia, Puccinia). Additionally, they are also effective against the Ascomycetes classes (e.g. Venturia and Erysiphe, Podosphaera, Monilinia, Uncinula) and of the Oomycetes classes (e.g. Phytophthora, Pythium, Plasmopara). Within the scope of the invention, useful plants to be protected typically comprise the following species of plants: cereal (wheat, barley, rye, oat, rice, maize, sorghum and related species); beet (sugar beet and fodder beet); pomes, drupes and soft fruit (apples, pears, plums, peaches, almonds, cherries, strawberries, raspberries and blackberries); leguminous plants (beans, lentils, peas, soybeans); oil plants (rape, mustard, poppy, olives, sunflowers, coconut, castor oil plants, cocoa beans, groundnuts); cucumber plants (pumpkins, cucumbers, melons); fibre plants (cotton, flax, hemp, jute); citrus fruit (oranges, lemons, grapefruit, mandarins); vegetables (spinach, lettuce, asparagus, cabbages, carrots, onions, tomatoes, potatoes, paprika); lauraceae (avocado, cinnamomum, camphor) or plants such as tobacco, nuts, coffee, eggplants, sugar cane, tea, pepper, vines, hops, bananas and natural rubber plants, as well as ornamentals.

The term “useful plants” is to be understood as including also useful plants that have been rendered tolerant to herbicides like bromoxynil or classes of herbicides (such as, for example, HPPD inhibitors, ALS inhibitors, for example primisulfuron, prosulfuron and trifloxysulfuron, EPSPS (5-enol-pyrovyl-shikimate-3-phosphate-synthase) inhibitors, GS (glutamine synthetase) inhibitors or PPO (protoporphyrinogen-oxidase) inhibitors) as a result of conventional methods of breeding or genetic engineering. An example of a crop that has been rendered tolerant to imidazolinones, e.g. imazamox, by conventional methods of breeding (mutagenesis) is Clearfield® summer rape (Canola). Examples of crops that have been rendered tolerant to herbicides or classes of herbicides by genetic engineering methods include glyphosate- and glufosinate-resistant maize varieties commercially available under the trade names RoundupReady®, Herculex I® and LibertyLink®.

The term “useful plants” is to be understood as including also useful plants which have been so transformed by the use of recombinant DNA techniques that they are capable of synthesising one or more selectively acting toxins, such as are known, for example, from toxin-producing bacteria, especially those of the genus Bacillus.

Examples of such plants are: YieldGard® (maize variety that expresses a CryIA(b) toxin); YieldGard Rootworm® (maize variety that expresses a CryIIIB(b1) toxin); YieldGard Plus® (maize variety that expresses a CryIA(b) and a CryIIIB(b1) toxin); Starlink® (maize variety that expresses a Cry9(c) toxin); Herculex I® (maize variety that expresses a CryIF(a2) toxin and the enzyme phosphinothricine N-acetyltransferase (PAT) to achieve tolerance to the herbicide glufosinate ammonium); NuCOTN 33B® (cotton variety that expresses a CryIA(c) toxin); Bollgard I® (cotton variety that expresses a CryIA(c) toxin); Bollgard II® (cotton variety that expresses a CryIA(c) and a CryIIA(b) toxin); VIPCOT® (cotton variety that expresses a VIP toxin); NewLeaf® (potato variety that expresses a CryIIIA toxin); Nature-Gard® Agrisure® GT Advantage (GA21 glyphosate-tolerant trait), Agrisure® CB Advantage (Bt11 corn borer (CB) trait), Agrisure® RW (corn rootworm trait) and Protecta®.

The term “useful plants” is to be understood as including also useful plants which have been so transformed by the use of recombinant DNA techniques that they are capable of synthesising antipathogenic substances having a selective action, such as, for example, the so-called “pathogenesis-related proteins” (PRPs, see e.g. EP-A-0 392 225). Examples of such antipathogenic substances and transgenic plants capable of synthesising such antipathogenic substances are known, for example, from EP-A-0 392 225, WO 95/33818, and EP-A-0 353 191. The methods of producing such transgenic plants are generally known to the person skilled in the art and are described, for example, in the publications mentioned above.

The term “locus” of a useful plant as used herein is intended to embrace the place on which the useful plants are growing, where the plant propagation materials of the useful plants are sown or where the plant propagation materials of the useful plants will be placed into the soil. An example for such a locus is a field, on which crop plants are growing.

The term “plant propagation material” is understood to denote generative parts of the plant, such as seeds, which can be used for the multiplication of the latter, and vegetative material, such as cuttings or tubers, for example potatoes. There may be mentioned for example seeds (in the strict sense), roots, fruits, tubers, bulbs, rhizomes and parts of plants. Germinated plants and young plants which are to be transplanted after germination or after emergence from the soil, may also be mentioned. These young plants may be protected before transplantation by a total or partial treatment by immersion. Preferably “plant propagation material” is understood to denote seeds.

The compounds of formula (I) can be used in unmodified form or, preferably, together with carriers and adjuvants conventionally employed in the art of formulation.

Therefore the invention also relates to compositions for controlling and protecting against phytopathogenic microorganisms, comprising a compound of formula (I) and an inert carrier, and to a method of controlling or preventing infestation of useful plants by phytopathogenic microorganisms, wherein a composition, comprising a compound of formula (I) as active ingredient and an inert carrier, is applied to the plants, to parts thereof or the locus thereof.

To this end compounds of formula (I) and inert carriers are conveniently formulated in known manner to emulsifiable concentrates, coatable pastes, directly sprayable or dilutable solutions, dilute emulsions, wettable powders, soluble powders, dusts, granulates, and also encapsulations e.g. in polymeric substances. As with the type of the compositions, the methods of application, such as spraying, atomising, dusting, scattering, coating or pouring, are chosen in accordance with the intended objectives and the prevailing circumstances. The compositions may also contain further adjuvants such as stabilizers, antifoams, viscosity regulators, binders or tackifiers as well as fertilizers, micronutrient donors or other formulations for obtaining special effects.

Suitable carriers and adjuvants (auxiliaries) can be solid or liquid and are substances useful in formulation technology, e.g. natural or regenerated mineral substances, solvents, dispersants, wetting agents, tackifiers, thickeners, binders or fertilizers. Such carriers are for example described in WO 97/33890.

The compounds of formula (I) or compositions, comprising a compound of formula (I) as active ingredient and an inert carrier, can be applied to the locus of the plant or plant to be treated, simultaneously or in succession with further compounds. These further compounds can be e.g. fertilizers or micronutrient donors or other preparations which influence the growth of plants. They can also be selective herbicides as well as insecticides, fungicides, bactericides, nematicides, molluscicides or mixtures of several of these preparations, if desired together with further carriers, surfactants or application promoting adjuvants customarily employed in the art of formulation.

A preferred method of applying a compound of formula (I), or a composition, comprising a compound of formula (I) as active ingredient and an inert carrier, is foliar application. The frequency of application and the rate of application will depend on the risk of infestation by the corresponding pathogen. However, the compounds of formula (I) may also penetrate the plant through the roots via the soil (systemic action) by drenching the locus of the plant with a liquid formulation, or by applying the compounds in solid form to the soil, e.g. in granular form (soil application). In crops of water rice such granulates can be applied to the flooded rice field. The compounds of formula (I) may also be applied to seeds (coating) by impregnating the seeds or tubers either with a liquid formulation of the fungicide or coating them with a solid formulation.

A formulation, i.e. a composition comprising the compound of formula (I) and, if desired, a solid or liquid adjuvant, is prepared in a known manner, typically by intimately mixing and/or grinding the compound with extenders, for example solvents, solid carriers and, optionally, surface-active compounds (surfactants).

The agrochemical formulations will usually contain from 0.1 to 99% by weight, preferably from 0.1 to 95% by weight, of the compound of formula (I), 99.9 to 1% by weight, preferably 99.8 to 5% by weight, of a solid or liquid adjuvant, and from 0 to 25% by weight, preferably from 0.1 to 25% by weight, of a surfactant.

Whereas it is preferred to formulate commercial products as concentrates, the end user will normally use dilute formulations.

Advantageous rates of application are normally from 5 g to 2 kg of active ingredient (a.i.) per hectare (ha), preferably from 10 g to 1 kg a.i./ha, most preferably from 20 g to 600 g a.i./ha. When used as seed drenching agent, convenient rates of application are from 10 mg to 1 g of active substance per kg of seeds. The rate of application for the desired action can be determined by experiments. It depends for example on the type of action, the developmental stage of the useful plant, and on the application (location, timing, application method) and can, owing to these parameters, vary within wide limits.

The compounds of formula (I), or a pharmaceutical salt thereof, described above may also have an advantageous spectrum of activity for the treatment and/or prevention of microbial infection in an animal. “Animal” can be any animal, for example, insect, mammal, reptile, fish, amphibian, preferably mammal, most preferably human. “Treatment” means the use on an animal which has microbial infection in order to reduce or slow or stop the increase or spread of the infection, or to reduce the infection or to cure the infection. “Prevention” means the use on an animal which has no apparent signs of microbial infection in order to prevent any future infection, or to reduce or slow the increase or spread of any future infection.

According to the present invention there is provided the use of a compound of formula (I) in the manufacture of a medicament for use in the treatment and/or prevention of microbial infection in an animal. There is also provided the use of a compound of formula (I) as a pharmaceutical agent. There is also provided the use of a compound of formula (I) as an antimicrobial agent in the treatment of an animal. According to the present invention there is also provided a pharmaceutical composition comprising as an active ingredient a compound of formula (I), or a pharmaceutically acceptable salt thereof, and a pharmaceutically acceptable diluent or carrier. This composition can be used for the treatment and/or prevention of antimicrobial infection in an animal. This pharmaceutical composition can be in a form suitable for oral administration, such as tablet, lozenges, hard capsules, aqueous suspensions, oily suspensions, emulsions dispersible powders, dispersible granules, syrups and elixirs. Alternatively this pharmaceutical composition can be in a form suitable for topical application, such as a spray, a cream or lotion. Alternatively this pharmaceutical composition can be in a form suitable for parenteral administration, for example injection. Alternatively this pharmaceutical composition can be in inhalable form, such as an aerosol spray.

The compounds of formula (I) may be effective against various microbial species able to cause a microbial infection in an animal. Examples of such microbial species are those causing Aspergillosis such as Aspergillus fumigatus, A. flavus, A. terrus, A. nidulans and A. niger, those causing Blastomycosis such as Blastomyces dermatitidis; those causing Candidiasis such as Candida albicans, C. glabrata, C. tropicalis, C. parapsilosis, C. krusei and C. lusitaniae; those causing Coccidioidomycosis such as Coccidioides immitis; those causing Cryptococcosis such as Cryptococcus neoformans; those causing Histoplasmosis such as Histoplasma capsulatum and those causing Zygomycosis such as Absidia corymbifera, Rhizomucor pusillus and Rhizopus arrhizus. Further examples are Fusarium Spp such as Fusarium oxysporum and Fusarium solani and Scedosporium Spp such as Scedosporium apiospermum and Scedosporium prolificans. Still further examples are Microsporum Spp, Trichophyton Spp, Epidermophyton Spp, Mucor Spp, Sporothorix Spp, Phialophora Spp, Cladosporium Spp, Petriellidium spp, Paracoccidioides Spp and Histoplasma Spp.

The compositions of this invention may contain other compounds having biological activity, for example micronutrients or compounds having fungicidal activity or which possess plant growth regulating, herbicidal, insecticidal, nematicidal or acaricidal activity.

The present invention provides a fungicidal composition comprising a fungicidally effective amount of a compound of formula (I), optionally comprising an additional active ingredient. The compound of formula (I) may be the sole active ingredient of the composition or it may be admixed with one or more additional active ingredients such as an insecticide, fungicide, synergist, herbicide or plant growth regulator where appropriate. The further, other biocidally active ingredient are known for example from “The Pesticide Manual” [The Pesticide Manual—A World Compendium; Thirteenth Edition (New edition (2 Nov. 2003)); Editor: C. D. S. Tomlin; The British Crop Protection Council, ISBN-10: 1901396134; ISBN-13: 978-1901396133] or its electronic version “e-Pesticide Manual V4.2” or from the website http://www.alanwood.net/pesticides/ or preferably one of the further pesticides listed below.

The following mixtures of the compounds of TX with a further active ingredient (B) are preferred (the abbreviation “TX” means a compound encompassed by the compounds of formula I, or preferably the term “TX” refers to a compound selected from the Tables 1-24):

(B)

(B1) a strobilurin fungicide+TX,

(B2) an azole fungicide+TX,

(B3) a morpholine fungicide+TX,

(B4) an anilinopyrimidine fungicide+TX,

(B5) a fungicide selected from the group consisting of

Fluconazole+TX, Fluconazole-cis+TX, Fluxapyroxad+TX, Ametoctradin+TX, Flutianil+TX, Isotianil+TX, Valiphenal+TX, Anilazine+TX, arsenates+TX, benalaxyl+TX, benalaxyl-M+TX, benodanil+TX, benomyl+TX, benthiavalicarb+TX, benthiavalicarb-isopropyl+TX, biphenyl+TX, bitertanol+TX, blasticidin-S+TX, bordeaux mixture+TX, boscalid+TX, bupirimate+TX, cadmium chloride+TX, captafol+TX, captan+TX, carbendazim+TX, carbon disulfide+TX, carboxin+TX, carpropamid+TX, cedar leaf oil+TX, chinomethionat+TX, chlorine+TX, chloroneb+TX, chlorothalonil+TX, chlozolinate+TX, cinnamaldehyde+TX, copper+TX, copper ammoniumcarbonate+TX, copper hydroxide+TX, copper octanoate+TX, copper oleate+TX, copper sulphate+TX, cyazofamid+TX, cycloheximide+TX, cymoxanil+TX, dichlofluanid+TX, dichlone+TX, dichloropropene+TX, diclocymet+TX, diclomezine+TX, dicloran+TX, diethofencarb+TX, diflumetorim+TX, dimethirimol+TX, dimethomorph+TX, dinocap+TX, dithianon+TX, dodine+TX, edifenphos+TX, ethaboxam+TX, ethirimol+TX, etridiazole+TX, famoxadone+TX, fenamidone+TX, fenaminosulf+TX, fenamiphos+TX, fenarimol+TX, fenfuram+TX, fenhexamid+TX, fenoxanil+TX, fenpiclonil+TX, fentin acetate+TX, fentin chloride+TX, fentin hydroxide+TX, ferbam+TX, ferimzone+TX, fluazinam+TX, fludioxonil+TX, flusulfamide+TX, flusulfamide+TX, flutolanil+TX, folpet+TX, formaldehyde+TX, fosetyl-aluminium+TX, fthalide+TX, fuberidazole+TX, furalaxyl+TX, furametpyr+TX, flyodin+TX, fuazatine+TX, hexachlorobenzene+TX, hymexazole+TX, iminoctadine+TX, iodocarb+TX, iprobenfos+TX, iprodione+TX, iprovalicarb+TX, isoprothiolane+TX, kasugamycin+TX, mancozeb+TX, maneb+TX, manganous dimethyldithiocarbamate+TX, mefenoxam+TX, mepronil+TX, mercuric chloride+TX, mercury+TX, metalaxyl+TX, methasulfocarb+TX, metiram+TX, metrafenone+TX, nabam+TX, neem oil (hydrophobic extract)+TX, nuarimol+TX, octhilinone+TX, ofurace+TX, oxadixyl+TX, oxine copper+TX, oxolinic acid+TX, oxycarboxin+TX, oxytetracycline+TX, paclobutrazole+TX, paraffin oil+TX, paraformaldehyde+TX, pencycuron+TX, pentachloronitrobenzene+TX, pentachlorophenol+TX, penthiopyrad+TX, perfurazoate+TX, phosphoric acid+TX, polyoxin+TX, polyoxin D zinc salt+TX, potassium bicarbonate+TX, probenazole+TX, procymidone+TX, propamocarb+TX, propineb+TX, proquinazid+TX, prothiocarb+TX, pyrazophos+TX, pyrifenox+TX, pyroquilon+TX, quinoxyfen+TX, quintozene+TX, silthiofam+TX, sodium bicarbonate+TX, sodium diacetate+TX, sodium propionate+TX, streptomycin+TX, sulphur+TX, TCMTB+TX, tecloftalam+TX, tecnazene+TX, thiabendazole+TX, thifluzamide+TX, thiophanate+TX, thiophanate-methyl+TX, thiram+TX, tolclofos-methyl+TX, tolyfluanid+TX, triazoxide+TX, trichoderma harzianum+TX, tricyclazole+TX, triforine+TX, triphenyltin hydroxide+TX, validamycin+TX, vinclozolin+TX, zineb+TX, ziram+TX, zoxamide+TX, 1+TX,1-bis(4-chlorophenyl)-2-ethoxyethanol+TX, 2+TX,4-dichlorophenyl benzenesulfonate+TX, 2-fluoro-N-methyl-N-1-naphthylacetamide+TX, 4-chlorophenyl phenyl sulfone+TX,

a compound of formula B-5.1+TX

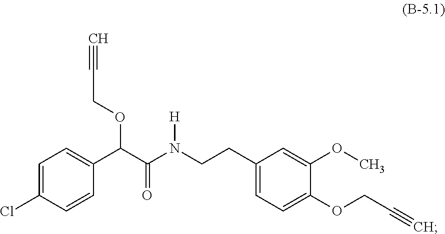 [SMILES: C#CCOc1ccc(CCNC(=O)C(OCC#C)c2ccc(Cl)cc2)cc1OC]

a compound of formula B-5.2+TX

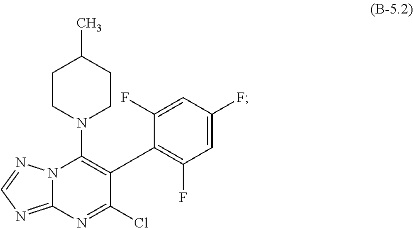 [SMILES: CC1CCN(c2c(-c3c(F)cc(F)cc3F)c(Cl)nc3ncnn23)CC1]

a compound of formula B-5.3+TX

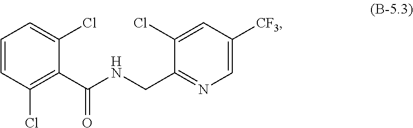 [SMILES: O=C(NCc1ncc(C(F)(F)F)cc1Cl)c1c(Cl)cccc1Cl]

a compound of formula B-5.4+TX

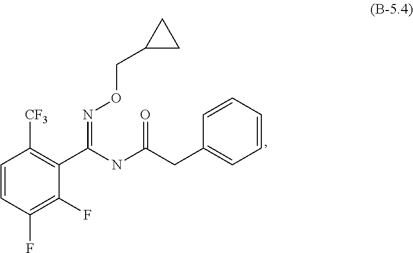 [SMILES: O=C(Cc1ccccc1)N/C(=N\OCC1CC1)c1c(C(F)(F)F)ccc(F)c1F]

a compound of formula B-5.5+TX

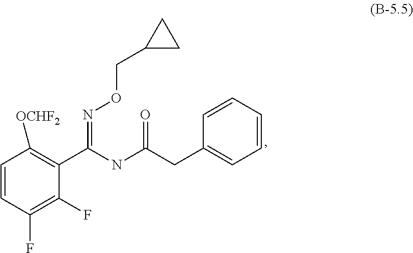 [SMILES: O=C(Cc1ccccc1)N/C(=N\OCC1CC1)c1c(OC(F)F)ccc(F)c1F]

a compound of formula B-5.6+TX

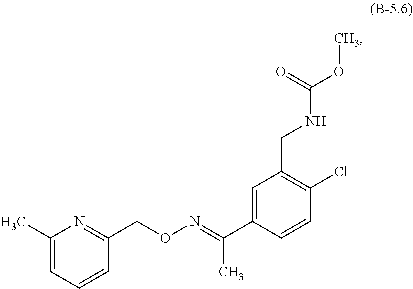 [SMILES: COC(=O)NCc1cc(/C(C)=N/OCc2cccc(C)n2)ccc1Cl]

a compound of formula B-5.7+TX

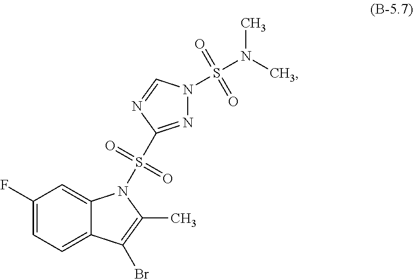 [SMILES: Cc1c(Br)c2ccc(F)cc2n1S(=O)(=O)c1ncn(S(=O)(=O)N(C)C)n1]

3-difluoromethyl-1-methyl-1H-pyrazole-4-carboxylic acid (2-bicyclopropyl-2-yl-phenyl)-amide (compound B-5.8)+TX, 3-difluoromethyl-1-methyl-1H-pyrazole-4-carboxylic acid (9-isopropyp-1,2,3,4-tetrahydro-1,4-methano-naphthalen-5-yl)-amide (compound B-5.9)+TX, 1,3-di methyl-5-fluoro-1H-pyrazole-4-carboxylic acid [2-(1,3-dimethylbutyl)phenyl]-amide (compound B-5.10)+TX, 3-difluoromethyl-1-methyl-1H-pyrazole-4-carboxylic acid (3′,4′-dichloro-5-fluoro-1,1′-biphenyl-2-yl)-amide (compound B-5.11)+TX, N-{2-[3-chloro-5-(trifluoromethyl)pyridin-2-yl]ethyl}-2-(trifluoromethyl)benzam id (compound B-5.12)+TX, 3-difluoromethyl-1-methyl-1H-pyrazole-4-carboxylic acid N-[2-(1,1,2,2-tetrafluoroethoxy)phenyl]-amide (compound B-5.13)+TX, 3-difluoromethyl-1-methyl-1H-pyrazole-4-carboxylic acid N-[2-(1,1,2,3,3,3-hexafluoropropoxy)phenyl]-amide (compound B-5.14), 3-difluoromethyl-1-methyl-1H-pyrazole-4-carboxylic acid N-[2-(2-chloro-1+TX,1,2-trifluoroethoxy)phenyl]-amide (compound B-5.15)+TX, 3-difluoromethyl-1-methyl-1H-pyrazole-4-carboxylic acid N-(4′-trifluoromethyl-biphen-2-yl)-amide (compound B-5.16)+TX, 3-difluoromethyl-1-methyl-1H-pyrazole-4-carboxylic acid N-(2′-trifluoromethyl-biphen-2-yl)-amide (compound B-5.17)+TX, 3-difluoromethyl-1-methyl-1H-pyrazole-4-carboxylic acid N-(2′-trifluoromethyl-biphen-2-yl)-amide (compound B-5.18)+TX; 3-difluoromethyl-1-methyl-1H-pyrazole-4-carboxylic acid (4′-methylsulfanyl-biphenyl-2-yl)-amide (compound B-5.19)+TX, 3-difluoromethyl-1-methyl-1H-pyrazole-4-carboxylic acid (2-dichloromethylene-3-ethyl-1-methyl-indan-4-yl)-amide (compound B-5.20)+TX

a compound of formula B-5.21+TX

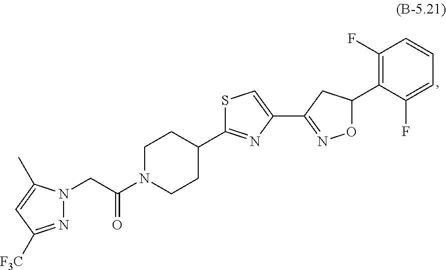 [SMILES: Cc1cc(C(F)(F)F)nn1CC(=O)N1CCC(c2nc(C3=NOC(c4c(F)cccc4F)C3)cs2)CC1]

(B6) a plant-bioregulator selected from the group consisting of

Acibenzolar+TX, 1-methyl-cyclopropene+TX, acibenzolar-5-methyl+TX, chlormequat chloride+TX, ethephon+TX, mepiquat chloride and trinexapc-ethyl;

(B7) an insecticide selected from the group consisting of

abamectin+TX, clothianidin+TX, emamectin benzoate+TX, imidacloprid+TX, tefluthrin+TX, thiamethoxam+TX,

and a compound of formula IV+TX

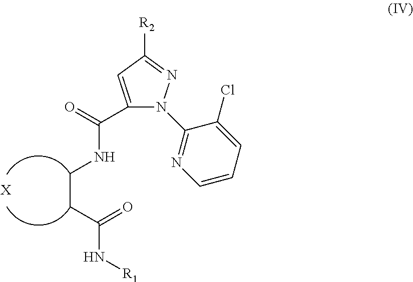

wherein X is a bivalent group selected from

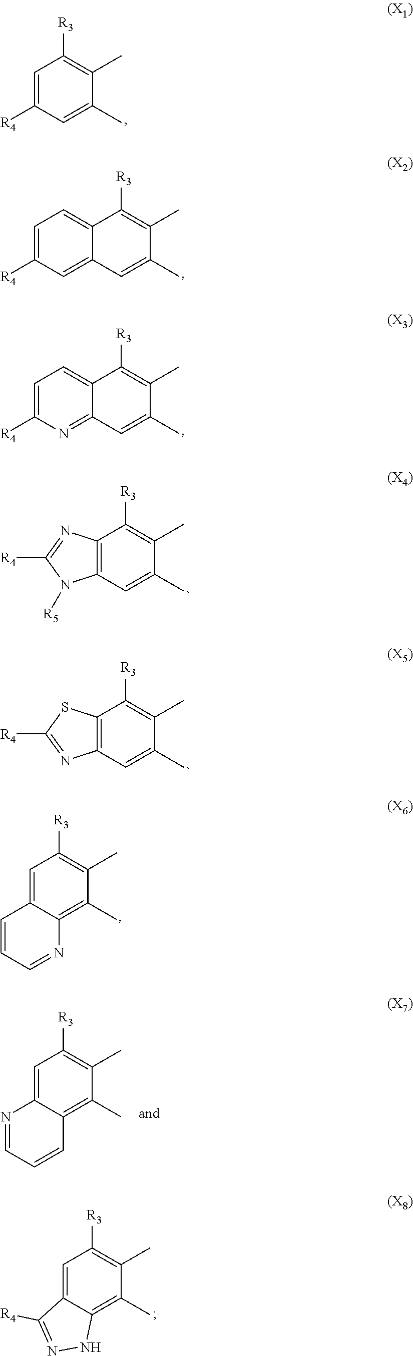

wherein

a) R₁ is cyclopropyl substituted by cyclopropyl at the 1-position, R₂ is bromine, R₃ is methyl, R₄ is CN and X is X₁;

b) R₁ is methyl substituted by cyclopropyl, R₂ is CF₃, R₃ is methyl, R₄ is Cl and X is X₁;

c) R₁ is cyclopropyl substituted by cyclopropyl at the 1-position, R₂ is CF₃, R₃ is methyl,

R₄ is Cl and X is X₁;

d) R₁ is cyclopropyl substituted by cyclopropyl at the 1-position, R₂ is CF₃, R₃ is methyl,

R₄ is CN and X is X₁;

e) R₁ is cyclopropyl substituted by cyclopropyl at the 1-position, R₂ is OCH₂CF₃, R₃ is methyl, R₄ is CN and X is X₁;

f) R₁ is isopropyl, R₂ is methoxy; R₃ is methyl, R₄ is hydrogen and X is X₈;

g) R₁ is isopropyl, R₂ is trifluoromethyl, R₃ is chlorine, R₄ is hydrogen and X is X₈;

h) R₁ is isopropyl, R₂ is trifluoromethyl, R₃ is methyl, R₄ is hydrogen and X is X₈;

i) R₁ is methyl, R₂ is bromine, R₃ is methyl, R₄ is CN and X is X₁;

j) R₁ is methyl, R₂ is bromine, R₃ is methyl, R₄ is Cl and X is X₁; and (B8) glyphosate+TX, glyphosate diammonium+TX, glyphosate dimethylammonium+TX, glyphosate isopropylammonium+TX, glyphosate monoammonium+TX, glyphosate potassium+TX, glyphosate sesquisodium+TX, glyphosate trimesium+TX, (5-chloro-2,4-dimethyl-pyridin-3-yl)-(2,3,4-trimethoxy-6-methyl-phenyl)-methanone+TX, (5-bromo-4-chloro-2-methoxy-pyridin-3-yl)-(2,3,4-trimethoxy-6-methyl-phenyl)-methanone+TX, 2-{2-[(E)-3-(2,6-Dichloro-phenyl)-1-methyl-prop-2-en-(E)-ylideneaminooxymethyl]-phenyl}-2-[(Z)-methoxyimino]-N-methyl-acetamide+TX, 3-[5-(4-Chloro-phenyl)-2,3-dimethyl-isoxazolidin-3-yl]-pyridine+TX

a compound of formula V+TX

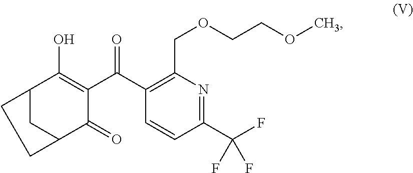 [SMILES: COCCOCc1nc(C(F)(F)F)ccc1C(=O)C1=C(O)C2CCC(C2)C1=O]

fomesafen+TX, Glufosinate and its salts TX, and (B9) Isopyrazam+TX, Sedaxane+TX,

a compound of formula (VI)+TX

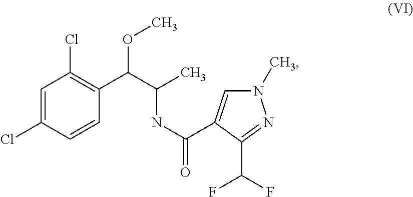 [SMILES: COC(c1ccc(Cl)cc1Cl)C(C)NC(=O)c1cn(C)nc1C(F)F]

a compound of formula (VII)+TX

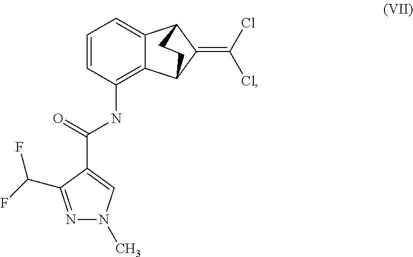 [SMILES: Cn1cc(C(=O)Nc2cccc3c2[C@@H]2CC[C@H]3C2=C(Cl)Cl)c(C(F)F)n1]

Preferred compositions comprising a compound of formula TX and

(B) a compound selected from the group consisting of

(B1) a strobilurin fungicide+TX, (B2) an azole fungicide+TX, (B3) a morpholine fungicide+TX, (B4) an anilinopyrimidine fungicide+TX, (B5) a fungicide selected from the group consisting of

anilazine (878)+TX, arsenates+TX, benalaxyl (56)+TX, benalaxyl-M+TX, benodanil (896)+TX, benomyl (62)+TX, benthiavalicarb+TX, benthiavalicarb-isopropyl (68)+TX, biphenyl (81)+TX, bitertanol (84)+TX, blasticidin-S (85)+TX, bordeaux mixture (87)+TX, boscalid (88)+TX, bupirimate (98)+TX, cadmium chloride+TX, captafol (113)+TX,

captan (114)+TX, carbendazim (116)+TX, carbon disulfide (945)+TX, carboxin (120)+TX, carpropamid (122)+TX, cedar leaf oil+TX, chinomethionat (126)+TX, chlorine+TX, chloroneb (139)+TX, chlorothalonil (142)+TX, chlozolinate (149)+TX, cinnamaldehyde+TX, copper+TX, copper ammoniumcarbonate+TX, copper hydroxide (169)+TX, copper octanoate (170)+TX, copper oleate+TX, copper sulphate (87)+TX, cyazofamid (185)+TX, cycloheximide (1022)+TX, cymoxanil (200)+TX, dichlofluanid (230)+TX, dichlone (1052)+TX, dichloropropene (233)+TX, diclocymet (237)+TX, diclomezine (239)+TX, dicloran (240)+TX, diethofencarb (245)+TX, diflumetorim (253)+TX, dimethirimol (1082)+TX, dimethomorph (263)+TX, dinocap (270)+TX, dithianon (279)+TX, dodine (289)+TX, edifenphos (290)+TX, ethaboxam (304)+TX, ethirimol (1133)+TX, etridiazole (321)+TX, famoxadone (322)+TX, fenamidone (325)+TX, fenaminosulf (1144)+TX, fenamiphos (326)+TX, fenarimol (327)+TX, fenfuram (333)+TX, fenhexamid (334)+TX, fenoxanil (338)+TX, fenpiclonil (341)+TX, fentin acetate (347)+TX, fentin chloride+TX, fentin hydroxide (347)+TX, ferbam (350)+TX, ferimzone (351)+TX, fluazinam (363)+TX, fludioxonil (368)+TX, flusulfamide (394)+TX, flutolanil (396)+TX, folpet (400)+TX, formaldehyde (404)+TX, fosetyl-aluminium (407)+TX, fthalide (643)+TX, fuberidazole (419)+TX, furalaxyl (410)+TX, furametpyr (411)+TX, flyodin (1205)+TX, fuazatine (422)+TX, hexachlorobenzene (434)+TX, hymexazole+TX, iminoctadine (459)+TX, iodocarb (3-Iodo-2-propynyl butyl carbamate)+TX, iprobenfos (IBP) (469)+TX, iprodione (470)+TX, iprovalicarb (471)+TX, isoprothiolane (474)+TX, kasugamycin (483)+TX, mancozeb (496)+TX, maneb (497)+TX, manganous dimethyldithiocarbamate+TX, mefenoxam (Metalaxyl-M) (517)+TX, mepronil (510)+TX, mercuric chloride (511)+TX, mercury+TX, metalaxyl (516)+TX, methasulfocarb (528)+TX, metiram (546)+TX, metrafenone+TX, nabam (566)+TX, neem oil (hydrophobic extract)+TX, nuarimol (587)+TX, octhilinone (590)+TX, ofurace (592)+TX, oxadixyl (601)+TX, oxine copper (605)+TX, oxolinic acid (606)+TX, oxycarboxin (608)+TX, oxytetracycline (611)+TX, paclobutrazole (612)+TX, paraffin oil (628)+TX, paraformaldehyde+TX, pencycuron (620)+TX, pentachloronitrobenzene (716)+TX, pentachlorophenol (623)+TX, penthiopyrad+TX, perfurazoate+TX, phosphoric acid+TX, polyoxin (654)+TX, polyoxin D zinc salt (654)+TX, potassium bicarbonate+TX, probenazole (658)+TX, procymidone (660)+TX, propamocarb (668)+TX, propineb (676)+TX, proquinazid (682)+TX, prothiocarb (1361)+TX, pyrazophos (693)+TX, pyrifenox (703)+TX, pyroquilon (710)+TX, quinoxyfen (715)+TX, quintozene (PCNB) (716)+TX, silthiofam (729)+TX, sodium bicarbonate+TX, sodium diacetate+TX, sodium propionate+TX, streptomycin (744)+TX, sulphur (754)+TX, TCMTB+TX, tecloftalam+TX, tecnazene (TCNB) (767)+TX, thiabendazole (790)+TX, thifluzamide (796)+TX, thiophanate (1435)+TX, thiophanate-methyl (802)+TX, thiram (804)+TX, tolclofos-methyl (808)+TX, tolylfluanid (810)+TX, triazoxide (821)+TX, trichoderma harzianum (825)+TX, tricyclazole (828)+TX, triforine (838)+TX, triphenyltin hydroxide (347)+TX, validamycin (846)+TX, vinclozolin (849)+TX, zineb (855)+TX, ziram (856)+TX, zoxamide (857)+TX, 1,1-bis(4-chlorophenyl)-2-ethoxyethanol (IUPAC-Name) (910)+TX, 2+TX, 4-dichlorophenyl benzenesulfonate (IUPAC-/Chemical Abstracts-Name) (1059)+TX, 2-fluoro-N-methyl-N-1-naphthylacetamide (IUPAC-Name) (1295)+TX, 4-chlorophenyl phenyl sulfone (IUPAC-Name) (981)+TX,

a compound of formula B-5.1+TX

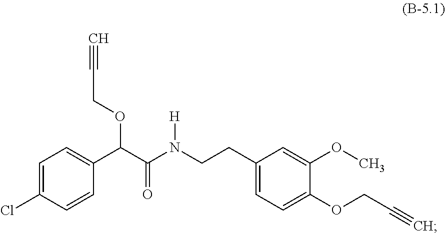 [SMILES: C#CCOc1ccc(CCNC(=O)C(OCC#C)c2ccc(Cl)cc2)cc1OC]

a compound of formula B-5.2+TX

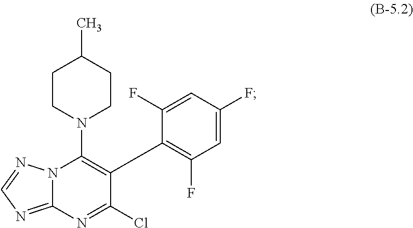 [SMILES: CC1CCN(c2c(-c3c(F)cc(F)cc3F)c(Cl)nc3ncnn23)CC1]

a compound of formula B-5.3+TX

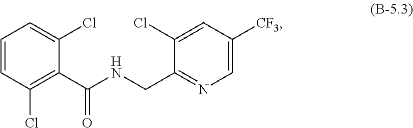 [SMILES: O=C(NCc1ncc(C(F)(F)F)cc1Cl)c1c(Cl)cccc1Cl]

a compound of formula B-5.4+TX

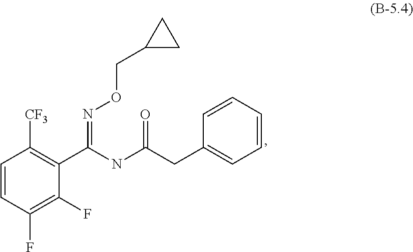 [SMILES: O=C(Cc1ccccc1)N/C(=N\OCC1CC1)c1c(C(F)(F)F)ccc(F)c1F]

a compound of formula B-5.5+TX

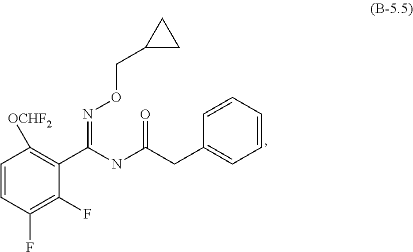 [SMILES: O=C(Cc1ccccc1)N/C(=N\OCC1CC1)c1c(OC(F)F)ccc(F)c1F]

a compound of formula B-5.6+TX

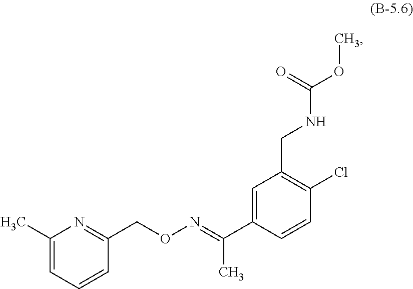 [SMILES: COC(=O)NCc1cc(/C(C)=N/OCc2cccc(C)n2)ccc1Cl]

a compound of formula B-5.7+TX

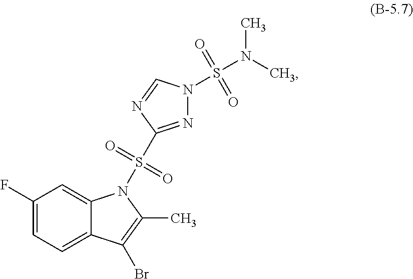 [SMILES: Cc1c(Br)c2ccc(F)cc2n1S(=O)(=O)c1ncn(S(=O)(=O)N(C)C)n1]

3-difluoromethyl-1-methyl-1H-pyrazole-4-carboxylic acid (2-bicyclopropyl-2-yl-phenyl)-amide (compound B-5.8)+TX, 3-difluoromethyl-1-methyl-1H-pyrazole-4-carboxylic acid (9-isopropyp-1,2,3,4-tetrahydro-1,4-methano-naphthalen-5-yl)-amide (compound B-5.9)+TX, 1,3-dimethyl-5-fluoro-1H-pyrazole-4-carboxylic acid [2-(1,3-dimethylbutyl)phenyl]-amide (compound B-5.10)+TX, 3-difluoromethyl-1-methyl-1H-pyrazole-4-carboxylic acid (3′,4′-dichloro-5-fluoro-1,1′-biphenyl-2-yl)-amide (compound B-5.11)+TX, N-{2-[3-chloro-5-(trifluoromethyl)pyridin-2-yl]ethyl}-2-(trifluoromethyl)benzamid (compound B-5.12)+TX, 3-difluoromethyl-1-methyl-1H-pyrazole-4-carboxylic acid N-[2-(1,1,2,2-tetrafluoroethoxy)phenyl]-amide (compound B-5.13)+TX, 3-difluoromethyl-1-methyl-1H-pyrazole-4-carboxylic acid N-[2-(1,1,2,3,3,3-hexafluoropropoxy)phenyl]-amide (compound B-5.14)+TX, 3-difluoromethyl-1-methyl-1H-pyrazole-4-carboxylic acid N-[2-(2-chloro-1,1,2-trifluoroethoxy)phenyl]-amide (compound B-5.15)+TX, 3-difluoromethyl-1-methyl-1H-pyrazole-4-carboxylic acid N-(4′-trifluoromethyl-biphen-2-yl)-amide (compound B-5.16)+TX, 3-difluoromethyl-1-methyl-1H-pyrazole-4-carboxylic acid N-(2′-trifluoromethyl-biphen-2-yl)-amide (compound B-5.17)+TX, and 3-difluoromethyl-1-methyl-1H-pyrazole-4-carboxylic acid N-(2′-trifluoromethyl-biphen-2-yl)-amide (compound B-5.18)+TX

(B6) a plant-bioregulator selected from the group consisting of

acibenzolar-5-methyl (6)+TX, chlormequat chloride (137)+TX, ethephon (307)+TX, mepiquat chloride (509) and trinexapc-ethyl (841);

(B7) an insecticide selected from the group consisting of

abamectin (1)+TX, clothianidin (165)+TX, emamectin benzoate (291)+TX, imidacloprid (458)+TX, tefluthrin (769)+TX, thiamethoxam (792)+TX, a compound of formula B-7.1+TX

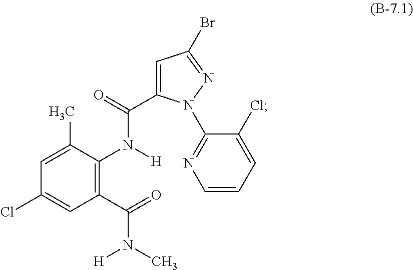 [SMILES: CNC(=O)c1cc(Cl)cc(C)c1NC(=O)c1cc(Br)nn1-c1ncccc1Cl]

and a compound of formula B-7.2+TX;

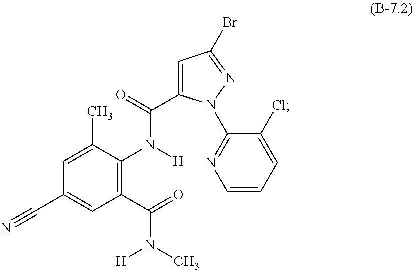 [SMILES: CNC(=O)c1cc(C#N)cc(C)c1NC(=O)c1cc(Br)nn1-c1ncccc1Cl]

and (B8) glyphosate (419)+TX.

Examples of especially suitable mixtures selected from the following group P

Group P: Especially Suitable Mixtures According to the Invention:

a strobilurin fungicide selected from azoxystrobin (47)+TX, dimoxystrobin (226)+TX, fluoxastrobin (382)+TX, kresoxim-methyl (485)+TX, metominostrobin (551)+TX, orysastrobin+TX, picoxystrobin (647)+TX, pyraclostrobin (690); trifloxystrobin (832)+TX, a compound of formula B-1.1+TX

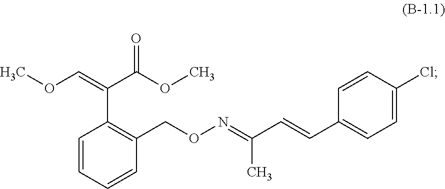 [SMILES: CO/C=C(/C(=O)OC)c1ccccc1CO/N=C(C)/C=C/c1ccc(Cl)cc1]

an azole fungicide selected from azaconazole (40)+TX, bromuconazole (96)+TX, cyproconazole (207)+TX, difenoconazole (247)+TX, diniconazole (267)+TX, diniconazole-M (267)+TX, epoxiconazole (298)+TX, fenbuconazole (329)+TX, fluquinconazole (385)+TX, flusilazole (393)+TX, flutriafol (397)+TX, hexaconazole (435)+TX, imazalil (449)+TX, imibenconazole (457)+TX, ipconazole (468)+TX, metconazole (525)+TX, myclobutanil (564)+TX, oxpoconazole (607)+TX, pefurazoate (618)+TX, penconazole (619)+TX, prochloraz (659)+TX, propiconazole (675)+TX, prothioconazole (685)+TX, simeconazole (731)+TX, tebuconazole (761)+TX, tetraconazole (778)+TX, triadimefon (814)+TX, triadimenol (815)+TX, triflumizole (834)+TX, triticonazole (842)+TX, diclobutrazol (1068)+TX, etaconazole (1129)+TX, furconazole (1198)+TX, furconazole-cis (1199) and quinconazole (1378);

a morpholine fungicide mixture selected from aldimorph+TX, dodemorph (288)+TX, fenpropimorph (344)+TX, tridemorph (830)+TX, fenpropidin (343)+TX, spiroxamine (740)+TX, piperalin (648) and a compound of formula B-3.1+TX

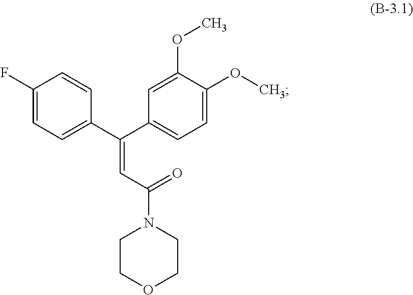 [SMILES: COc1ccc(/C(=C\C(=O)N2CCOCC2)c2ccc(F)cc2)cc1OC]

an anilino-pyrimidine fungicide selected from cyprodinil (208)+TX, mepanipyrim (508) and pyrimethanil (705);

a fungicide mixture selected from the group consisting of anilazine (878)+TX, arsenates+TX, benalaxyl (56)+TX, benalaxyl-M+TX, benodanil (896)+TX, benomyl (62)+TX, benthiavalicarb+TX, benthiavalicarb-isopropyl (68)+TX, biphenyl (81)+TX, bitertanol (84)+TX, blasticidin-S (85)+TX, bordeaux mixture (87)+TX, boscalid (88)+TX, bupirimate (98)+TX, cadmium chloride+TX, captafol (113)+TX,

captan (114)+TX, carbendazim (116)+TX, carbon disulfide (945)+TX, carboxin (120)+TX, carpropamid (122)+TX, cedar leaf oil+TX, chinomethionat (126)+TX, chlorine+TX, chloroneb (139)+TX, chlorothalonil (142)+TX, chlozolinate (149)+TX, cinnamaldehyde+TX, copper+TX, copper ammoniumcarbonate+TX, copper hydroxide (169)+TX, copper octanoate (170)+TX, copper oleate+TX, copper sulphate (87)+TX, cyazofamid (185)+TX, cycloheximide (1022)+TX, cymoxanil (200)+TX, dichlofluanid (230)+TX, dichlone (1052)+TX, dichloropropene (233)+TX, diclocymet (237)+TX, diclomezine (239)+TX, dicloran (240)+TX, diethofencarb (245)+TX, diflumetorim (253)+TX, dimethirimol (1082)+TX, dimethomorph (263)+TX, dinocap (270)+TX, dithianon (279)+TX, dodine (289)+TX, edifenphos (290)+TX, ethaboxam (304)+TX, ethirimol (1133)+TX, etridiazole (321)+TX, famoxadone (322)+TX, fenamidone (325)+TX, fenaminosulf (1144)+TX, fenamiphos (326)+TX, fenarimol (327)+TX, fenfuram (333)+TX, fenhexamid (334)+TX, fenoxanil (338)+TX, fenpiclonil (341)+TX, fentin acetate (347)+TX, fentin chloride+TX, fentin hydroxide (347)+TX, ferbam (350)+TX, ferimzone (351)+TX, fluazinam (363)+TX, fludioxonil (368)+TX, flusulfamide (394)+TX, flutolanil (396)+TX, folpet (400)+TX, formaldehyde (404)+TX, fosetyl-aluminium (407)+TX, fthalide (643)+TX, fuberidazole (419)+TX, furalaxyl (410)+TX, furametpyr (411)+TX, flyodin (1205)+TX, fuazatine (422)+TX, hexachlorobenzene (434)+TX, hymexazole+TX, iminoctadine (459)+TX, iodocarb (3-Iodo-2-propynyl butyl carbamate)+TX, iprobenfos (IBP) (469)+TX, iprodione (470)+TX, iprovalicarb (471)+TX, isoprothiolane (474)+TX, kasugamycin (483)+TX, mancozeb (496)+TX, maneb (497)+TX, manganous dimethyldithiocarbamate+TX, mefenoxam (Metalaxyl-M) (517)+TX, mepronil (510)+TX, mercuric chloride (511)+TX, mercury+TX, metalaxyl (516)+TX, methasulfocarb (528)+TX, metiram (546)+TX, metrafenone+TX, nabam (566)+TX, neem oil (hydrophobic extract)+TX, nuarimol (587)+TX, octhilinone (590)+TX, ofurace (592)+TX, oxadixyl (601)+TX, oxine copper (605)+TX, oxolinic acid (606)+TX, oxycarboxin (608)+TX, oxytetracycline (611)+TX, paclobutrazole (612)+TX, paraffin oil (628)+TX, paraformaldehyde+TX, pencycuron (620)+TX, pentachloronitrobenzene (716)+TX, pentachlorophenol (623)+TX, penthiopyrad+TX, perfurazoate+TX, phosphoric acid+TX, polyoxin (654)+TX, polyoxin D zinc salt (654)+TX, potassium bicarbonate+TX, probenazole (658)+TX, procymidone (660)+TX, propamocarb (668)+TX, propineb (676)+TX, proquinazid (682)+TX, prothiocarb (1361)+TX, pyrazophos (693)+TX, pyrifenox (703)+TX, pyroquilon (710)+TX, quinoxyfen (715)+TX, quintozene (PCNB) (716)+TX, silthiofam (729)+TX, sodium bicarbonate+TX, sodium diacetate+TX, sodium propionate+TX, streptomycin (744)+TX, sulphur (754)+TX, TCMTB+TX, tecloftalam+TX, tecnazene (TCNB) (767)+TX, thiabendazole (790)+TX, thifluzamide (796)+TX, thiophanate (1435)+TX, thiophanate-methyl (802)+TX, thiram (804)+TX, tolclofos-methyl (808)+TX, tolylfluanid (810)+TX, triazoxide (821)+TX, trichoderma harzianum (825)+TX, tricyclazole (828)+TX, triforine (838)+TX, triphenyltin hydroxide (347)+TX, validamycin (846)+TX, vinclozolin (849)+TX, zineb (855)+TX, ziram (856)+TX, zoxamide (857)+TX, 1+TX,1-bis(4-chlorophenyl)-2-ethoxyethanol (IUPAC-Name) (910)+TX, 2+TX,4-dichlorophenyl benzenesulfonate (IUPAC-/Chemical Abstracts-Name) (1059)++TX, 2-fluoro-N-methyl-N-1-naphthylacetamide (IUPAC-Name) (1295)+TX, 4-chlorophenyl phenyl sulfone (IUPAC-Name) (981)+TX,

a compound of formula B-5.1+TX, a compound of formula B-5.2+TX, a compound of formula B-5.3+TX, a compound of formula B-5.4+TX, a compound of formula B-5.5+TX, a compound of formula B-5.6+TX, a compound of formula B-5.7+TX, compound B-5.8+TX, compound B-5.9+TX, compound B-5.10+TX, compound B-5.11+TX, compound B-5.12+TX, compound B-5.13+TX, compound B-5.14+TX, compound B-5.15+TX, compound B-5.16+TX, compound B-5.17 and compound B-5.18;

a plant-bioregulator selected from the group consisting of

acibenzolar-5-methyl (6)+TX, chlormequat chloride (137)+TX, ethephon (307)+TX, mepiquat chloride (509) and trinexapc-ethyl (841);

an insecticide selected from the group consisting of

abamectin (1)+TX, clothianidin (165)+TX, emamectin benzoate (291)+TX, imidacloprid (458)+TX, tefluthrin (769)+TX, thiamethoxam (792)+TX, and glyphosate (419)+TX, a compound of formula V)+TX

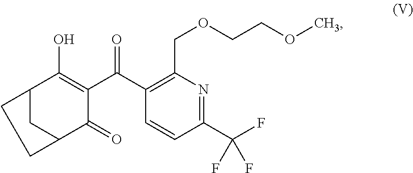 [SMILES: COCCOCc1nc(C(F)(F)F)ccc1C(=O)C1=C(O)C2CCC(C2)C1=O]

fomesafen+TX, and (B9) Isopyrazam+TX, Sedaxane+TX,

a compound of formula (VI)+TX

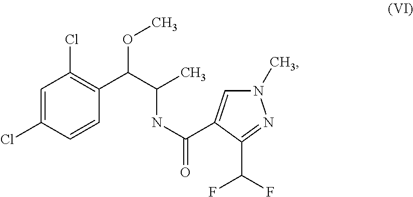 [SMILES: COC(c1ccc(Cl)cc1Cl)C(C)NC(=O)c1cn(C)nc1C(F)F]

a compound of formula (VII)+TX

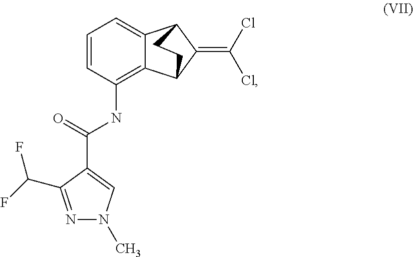 [SMILES: Cn1cc(C(=O)Nc2cccc3c2[C@@H]2CC[C@H]3C2=C(Cl)Cl)c(C(F)F)n1]

Further examples of especially suitable mixtures selected from the following group Q:

Group Q: Especially Suitable Compositions According to the Invention:

a strobilurin fungicide selected from the group consisting of azoxystrobin+TX, dimoxystrobin+TX, fluoxastrobin+TX, kresoxim-methyl+TX, metominostrobin+TX, orysastrobin+TX, picoxystrobin+TX, pyraclostrobin; trifloxystrobin and a compound of formula B-1.1;

an azole fungicide selected from the group consisting of azaconazole+TX, bromuconazole+TX, cyproconazole+TX, difenoconazole+TX, diniconazole+TX, diniconazole-M+TX, epoxiconazole+TX, fenbuconazole+TX, fluquinconazole+TX, flusilazole+TX, flutriafol+TX, hexaconazole+TX, imazalil+TX, imibenconazole+TX, ipconazole+TX, metconazole+TX, myclobutanil+TX, oxpoconazole+TX, pefurazoate+TX, penconazole+TX, prochloraz+TX, propiconazole+TX, prothioconazole+TX, simeconazole+TX, tebuconazole+TX, tetraconazole+TX, triadimefon+TX, triadimenol+TX, triflumizole+TX, triticonazole+TX, diclobutrazol+TX, etaconazole+TX, furconazole+TX, furconazole-cis+TX and quinconazole+TX;

a morpholine fungicide selected from the group consisting of aldimorph+TX, dodemorph+TX, fenpropimorph+TX, tridemorph+TX, fenpropidin+TX, spiroxamine+TX, piperalin and a compound of formula B-3.1;

an anilino-pyrimidine fungicide selected from the group consisting of cyprodinil+TX, mepanipyrim and pyrimethanil;

a fungicide selected from the group consisting of benalaxyl+TX, benalaxyl-M+TX, benomyl+TX, bitertanol+TX, boscalid+TX, captan+TX, carboxin+TX, carpropamid+TX, chlorothalonil+TX, copper+TX, cyazofamid+TX, cymoxanil+TX, diethofencarb+TX, dithianon+TX, famoxadone+TX, fenamidone+TX, fenhexamide+TX, fenoxycarb+TX, fenpiclonil+TX, fluazinam+TX, fludioxonil+TX, flutolanil+TX, folpet+TX, guazatine+TX, hymexazole+TX, iprodione+TX, lufenuron+TX, mancozeb+TX, metalaxyl+TX, mefenoxam+TX, metrafenone+TX, nuarimol+TX, paclobutrazol+TX, pencycuron+TX, penthiopyrad+TX, procymidone+TX, proquinazid+TX, pyroquilon+TX, quinoxyfen+TX, silthiofam+TX, sulfur+TX, thiabendazole+TX, thiram+TX, triazoxide+TX, tricyclazole+TX, a compound of formula B-5.1+TX, a compound of formula B-5.2+TX, a compound of formula B-5.3+TX, a compound of formula B-5.4+TX, a compound of formula B-5.5+TX, a compound of formula B-5.6+TX, a compound of formula B-5.7+TX, a compound of formula B-5.8+TX, a compound of formula B-5.9+TX, a compound of formula B-5.10 and a compound of formula B-5.12;

a plant-bioregulator selected from acibenzolar-5-methyl+TX, chlormequat chloride+TX, ethephon+TX, mepiquat chloride and trinexapc-ethyl;

an insecticide selected from abamectin+TX, emamectin benzoate+TX, tefluthrin+TX, thiamethoxam+TX, and glyphosate+TX, a compound of formula V

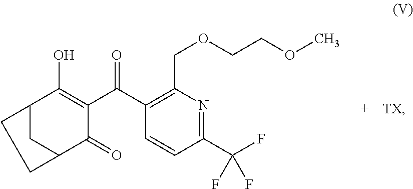 [SMILES: COCCOCc1nc(C(F)(F)F)ccc1C(=O)C1=C(O)C2CCC(C2)C1=O]

fomesafen+TX, and (B9) Isopyrazam+TX, Sedaxane+TX,

a compound of formula (VI)+TX

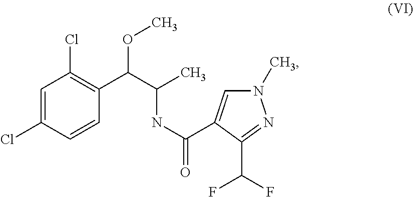 [SMILES: COC(c1ccc(Cl)cc1Cl)C(C)NC(=O)c1cn(C)nc1C(F)F]

a compound of formula (VII)+TX

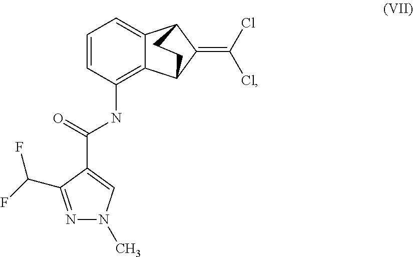 [SMILES: Cn1cc(C(=O)Nc2cccc3c2[C@@H]2CC[C@H]3C2=C(Cl)Cl)c(C(F)F)n1]

It has been found that the use of component (B) in combination with component TX surprisingly and substantially may enhance the effectiveness of the latter against fungi, and vice versa. Additionally, the method of the invention is effective against a wider spectrum of such fungi that can be combated with the active ingredients of this method, when used solely.

The active ingredient mixture of component TX to component (B) comprises compounds of formula I and a further, other biocidally active ingredients or compositions or if desired, a solid or liquid adjuvant preferably in a mixing ratio of from 100:1 to 1:6000, especially from 50:1 to 1:50, more especially in a ratio of from 20:1 to 1:20, even more especially from 10:1 to 1:10, very especially from 5:1 and 1:5, special preference being given to a ratio of from 2:1 to 1:2, and a ratio of from 4:1 to 2:1 being likewise preferred, above all in a ratio of 1:1, or 5:1, or 5:2, or 5:3, or 5:4, or 4:1, or 4:2, or 4:3, or 3:1, or 3:2, or 2:1, or 1:5, or 2:5, or 3:5, or 4:5, or 1:4, or 2:4, or 3:4, or 1:3, or 2:3, or 1:2, or 1:600, or 1:300, or 1:150, or 1:35, or 2:35, or 4:35, or 1:75, or 2:75, or 4:75, or 1:6000, or 1:3000, or 1:1500, or 1:350, or 2:350, or 4:350, or 1:750, or 2:750, or 4:750. Those mixing ratios are understood to include, on the one hand, ratios by weight and also, on other hand, molar ratios.

It has been found, surprisingly, that certain weight ratios of component TX to component (B) are able to give rise to synergistic activity. Therefore, a further aspect of the invention are compositions, wherein component TX and component (B) are present in the composition in amounts producing a synergistic effect. This synergistic activity is apparent from the fact that the fungicidal activity of the composition comprising component TX and component (B) is greater than the sum of the fungicidal activities of component TX and of component (B). This synergistic activity extends the range of action of component TX and component (B) in two ways. Firstly, the rates of application of component TX and component (B) are lowered whilst the action remains equally good, meaning that the active ingredient mixture still achieves a high degree of phytopathogen control even where the two individual components have become totally ineffective in such a low application rate range. Secondly, there is a substantial broadening of the spectrum of phytopathogens that can be controlled.

A synergistic effect exists whenever the action of an active ingredient combination is greater than the sum of the actions of the individual components. The action to be expected E for a given active ingredient combination obeys the so-called COLBY formula and can be calculated as follows (COLBY, S. R. “Calculating synergistic and antagonistic responses of herbicide combination”. Weeds, Vol. 15, pages 20-22; 1967):

ppm=milligrams of active ingredient (=a.i.) per liter of spray mixture

X=% action by active ingredient A) using p ppm of active ingredient

Y=% action by active ingredient B) using q ppm of active ingredient.

According to COLBY, the expected (additive) action of active ingredients A)+B) using p+q ppm of active ingredient is

$$E = X + Y - \frac{X \cdot Y}{100}$$

If the action actually observed (O) is greater than the expected action (E), then the action of the combination is super-additive, i.e. there is a synergistic effect. In mathematical terms, synergism corresponds to a positive value for the difference of (O−E). In the case of purely complementary addition of activities (expected activity), said difference (O−E) is zero. A negative value of said difference (O−E) signals a loss of activity compared to the expected activity.

However, besides the actual synergistic action with respect to fungicidal activity, the compositions according to the invention can also have further surprising advantageous properties. Examples of such advantageous properties that may be mentioned are: more advantageuos degradability; improved toxicological and/or ecotoxicological behaviour; or improved characteristics of the useful plants including: emergence, crop yields, more developed root system, tillering increase, increase in plant height, bigger leaf blade, less dead basal leaves, stronger tillers, greener leaf colour, less fertilizers needed, less seeds needed, more productive tillers, earlier flowering, early grain maturity, less plant verse (lodging), increased shoot growth, improved plant vigor, and early germination.

Some compositions according to the invention have a systemic action and can be used as foliar, soil and seed treatment fungicides.

With the compositions according to the invention it is possible to inhibit or destroy the phytopathogenic microorganisms which occur in plants or in parts of plants (fruit, blossoms, leaves, stems, tubers, roots) in different useful plants, while at the same time the parts of plants which grow later are also protected from attack by phytopathogenic microorganisms.

The compositions according to the invention can be applied to the phytopathogenic microorganisms, the useful plants, the locus thereof, the propagation material thereof, storage goods or technical materials threatened by microorganism attack.

The compositions according to the invention may be applied before or after infection of the useful plants, the propagation material thereof, storage goods or technical materials by the microorganisms.

A further aspect of the present invention is a method of controlling diseases on useful plants or on propagation material thereof caused by phytopathogens, which comprises applying to the useful plants, the locus thereof or propagation material thereof a composition according to the invention. Preferred is a method, which comprises applying to the useful plants or to the locus thereof a composition according to the invention, more preferably to the useful plants. Further preferred is a method, which comprises applying to the propagation material of the useful plants a composition according to the invention.

The components (B) are known. Where the components (B) are included in “The Pesticide Manual” [The Pesticide Manual—A World Compendium; Thirteenth Edition; Editor: C. D. S. Tomlin; The British Crop Protection Council], they are described therein under the entry number given in round brackets hereinabove for the particular component (B); for example, the compound “abamectin” is described under entry number (1). Most of the components (B) are referred to hereinabove by a so-called “common name”, the relevant “ISO common name” or another “common name” being used in individual cases. If the designation is not a “common name”, the nature of the designation used instead is given in round brackets for the particular component (B); in that case, the IUPAC name, the IUPAC/Chemical Abstracts name, a “chemical name”, a “traditional name”, a “compound name” or a “development code” is used or, if neither one of those designations nor a “common name” is used, an “alternative name” is employed.

The following components B) are registered under a CAS-Reg. No.

Fluconazole (86386-73-4), Fluconazole-cis (112839-32-4), Fluxapyroxad (907204-31-3), Ametoctradin (865318-97-4), Flutianil (958647-10-4), Isotianil (224049-04-1), Valiphenal (283159-90-0), Acibenzolar (126448-41-7), 1-methyl-cyclopropene (3100-04-7), glyphosate diammonium (69254-40-6), glyphosate dimethylammonium (34494-04-7), glyphosate isopropylammonium (38641-94-0), glyphosate monoammonium (40465-66-5), glyphosate potassium (70901-20-1), glyphosate sesquisodium (70393-85-0), glyphosate trimesium (81591-81-3), Glufosinate and its salts (51276-47-2, 35597-44-5 (S-isomer)), aldimorph (CAS 91315-15-0); arsenates (CAS 1327-53-3); benalaxyl-M (CAS 98243-83-5); benthiavalicarb (CAS 413615-35-7); cadmium chloride (CAS 10108-64-2); cedar leaf oil (CAS 8007-20-3); chlorine (CAS 7782-50-5); cinnamaldehyde (CAS: 104-55-2); copper ammoniumcarbonate (CAS 33113-08-5); copper oleate (CAS 1120-44-1); iodocarb (3-Iodo-2-propynyl butyl carbamate) (CAS 55406-53-6); hymexazole (CAS 10004-44-1); manganous di methyldithiocarbamate (CAS 15339-36-3); mercury (CAS 7487-94-7; 21908-53-2; 7546-30-7); metrafenone (CAS 220899-03-6); neem oil (hydrophobic extract) (CAS 8002-65-1); orysastrobin CAS 248593-16-0); paraformaldehyde (CAS 30525-89-4); penthiopyrad (CAS 183675-82-3); phosphoric acid (CAS 7664-38-2); potassium bicarbonate (CAS 298-14-6); sodium bicarbonate (CAS 144-55-8); sodium diacetate (CAS 127-09-3); sodium propionate (CAS 137-40-6); TCMTB (CAS 21564-17-0); and tolyfluanid (CAS 731-27-1).

Compound B-1.1 (“enestrobin”) is described in EP-0-936-213; compound B-3.1 (“flumorph”) in U.S. Pat. No. 6,020,332, CN-1-167-568, CN-1-155-977 and in EP-0-860-438; compound B-5.1 (“mandipropamid”) in WO 01/87822; compound B-5.2 in WO 98/46607; compound B-5.3 (“fluopicolide”) in WO 99/42447; compound B-5.4 (“cyflufenamid”) in WO 96/19442; compound B-5.5 in WO 99/14187; compound B-5.6 (“pyribencarb”) is registered under CAS-Reg. No. 325156-49-8; compound B-5.7 (“amisulbrom” or “ambromdole”) is registered under CAS-Reg. No. 348635-87-0; compound B-5.8 (3-difluoromethyl-1-methyl-1H-pyrazole-4-carboxylic acid (2-bicyclopropyl-2-yl-phenyl)-amide) is described in WO 03/74491; compound B-5.9 (3-difluoromethyl-1-methyl-1H-pyrazole-4-carboxylic acid (9-isopropyp-1,2,3,4-tetrahydro-1,4-methano-naphthalen-5-yl)-amide) is described in WO 04/35589 and in WO 06/37632; compound B-5.10 (1,3-dimethyl-5-fluoro-1H-pyrazole-4-carboxylic acid [2-(1,3-dimethylbutyl)phenyl]-amide) is described in WO 03/10149; compound B-5.11 (3-difluoromethyl-1-methyl-1H-pyrazole-4-carboxylic acid (3′,4′-dichloro-5-fluoro-1,1′-biphenyl-2-yl)-amide; “bixafen”) is registered under CAS-Reg. No.: 581809-46-3 and described in WO 03/70705; compound B-5.12 (N-{2-[3-Chloro-5-(trifluoromethyl)pyridin-2-yl]ethyl}-2-(trifluoromethyl)benzamid; “fluopyram”) is registered under CAS-Reg. No: 658066-35-4 and described in WO 04/16088; compounds B-5.13, B-5.14 and B-5.15 are described in WO 2007/17450; compounds B-5.16, B-5.17 and B-5.18 are described in WO 2006/120219; The compounds of formula IV are for example described in WO 04/067528, WO 2005/085234, WO 2006/111341, WO 03/015519, WO 2007/020050, WO 2006/040113, and WO 2007/093402; The compound of formula V is described in WO 2001/094339; compound B-21 is described in WO 2010/123791. Isopyrazam (3-(difluoromethyl)-1-methyl-N-[1,2,3,4-tetrahydro-9-(1-methylethyl)-1,4-methanonaphthalen-5-yl]-1H-pyrazole-4-carboxamide) is described in WO 2004/035589, in WO 2006/037632 and in EP1556385B1 and is registered under the CAS-Reg. 881685-58-1. Sedaxane (N-[2-[1,1′-bicyclopropyl]-2-ylphenyl]-3-(difluoromethyl)-1-methyl-1H-pyrazole-4-carboxamide) is described in WO 2003/074491 and is registered under the CAS-Reg. 874967-67-6; The compound of formula (VI) is described in WO 2008/014870; and the compounds of formula (VII) is described in WO 2007/048556. Fomesafen is registered under the CAS-Reg. No. 72178-02-0.

3-Difluoromethyl-1-methyl-1H-pyrazole-4-carboxylic acid (4′-methylsulfanyl-biphenyl-2-yl)-amide (compound B-5.19) is registered under CAS number 1021864-46-9, 3-difluoromethyl-1-methyl-1H-pyrazole-4-carboxylic acid (2-dichloromethylene-3-ethyl-1-methyl-indan-4-yl)-amide (compound B-5.20) is registered under CAS number

The compositions according to the invention may also comprise more than one of the active components (B), if, for example, a broadening of the spectrum of disease control is desired. For instance, it may be advantageous in the agricultural practice to combine two or three components (B) with component TX. An example is a composition comprising a compound of formula (I), azoxystrobin and cyproconazole.

In the above different lists of active ingredients to be mixed with a TX, the compound of the formula I is preferably a compound of Tables 1-24.

In the above-mentioned mixtures of compounds of formula I, in particular a compound selected from said Tables 1-24, with other insecticides, fungicides, herbicides, safeners, adjuvants and the like, the mixing ratios can vary over a large range and are, preferably 100:1 to 1:6000, especially 50:1 to 1:50, more especially 20:1 to 1:20, even more especially 10:1 to 1:10. Those mixing ratios are understood to include, on the one hand, ratios by weight and also, on other hand, molar ratios.

The mixtures can advantageously be used in the above-mentioned formulations (in which case “active ingredient” relates to the respective mixture of TX with the mixing partner).

Some mixtures may comprise active ingredients which have significantly different physical, chemical or biological properties such that they do not easily lend themselves to the same conventional formulation type. In these circumstances other formulation types may be prepared. For example, where one active ingredient is a water insoluble solid and the other a water insoluble liquid, it may nevertheless be possible to disperse each active ingredient in the same continuous aqueous phase by dispersing the solid active ingredient as a suspension (using a preparation analogous to that of an SC) but dispersing the liquid active ingredient as an emulsion (using a preparation analogous to that of an EW). The resultant composition is a suspoemulsion (SE) formulation.

The mixtures comprising a TX selected from Tables 1-24 and one or more active ingredients as described above can be applied, for example, in a single “ready-mix” form, in a combined spray mixture composed from separate formulations of the single active ingredient components, such as a “tank-mix”, and in a combined use of the single active ingredients when applied in a sequential manner, i.e. one after the other with a reasonably short period, such as a few hours or days. The order of applying the compounds of formula I selected from Tables 1-24 and the active ingredients as described above is not essential for working the present invention.

The following non-limiting Examples illustrate the above-described invention in greater detail without limiting it. Those skilled in the art will promptly recognize appropriate variations from the procedures both as to reactants and as to reaction conditions and techniques. All references mentioned herein are incorporated by reference in their entirety. Where compounds are denoted by name and structure, in case of discrepency the structure should be considered correct.

### PREPARATORY EXAMPLES

### Preparation of Compound E/E-11.389

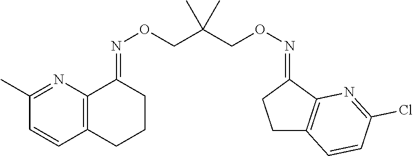 [SMILES: Cc1ccc2c(n1)/C(=N/OCC(C)(C)CO/N=C1\CCc3ccc(Cl)nc31)CCC2]

A solution of (1E)-1-(6-methyl-pyridin-2-yl)-ethanone-O-(3-aminooxy-2,2-dimethyl-propyl)-oxime (80.0 mg) in absolute ethanol (2.00 mL) was charged to a 10 mL single-necked round-bottomed flask. Under stirring, p-toluenesulphonic acid (3.3 mg) was added, followed by the addition of 2-chloro-5,6-dihydro-7H-cyclopenta[b]pyridin-7-one (48.3 mg). The resulting light-yellow solution was stirred at room temperature for 3 hours. TLC indicated that no starting materials were remaining after this time. The ethanol was removed in vacuo. Water (2.00 mL) was added to the resulting residue, followed by 2M aqueous NaOH solution to obtain a pH in the range of 7-8. Extraction was carried out using ethyl acetate (2×10 mL). The combined organic layers were washed with brine, dried over sodium sulphate and filtered. The solvent was removed in vacuo to give a green-brown gum (118 mg). No further purification was required.

LC-MS (ZCQ): UV Detection: 220 nm; Rₜ=1.52 min. MS: (M⁺+1)=427, (M⁺+23)=449.

TLC: Plates: Merck DC-Plates, silica gel F₂₅₄, saturated atmosphere in developing tank, UV detection, eluent: heptane/ethyl acetate 1:4 (v:v); R_{f} of title compound=0.39, R_{f} of ketone starting material=0.29, R_{f} of hydroxylamine starting material=0.14.

### Preparation of 1,3-bis-[O-(5,6-Dihydro-2-methyl-5,6-dihydro-7H-cyclopenta[b]pyridin-7-one oxime]-2,2-dimethylpropane (compound E/E-11.047)

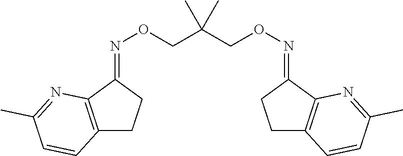

A solution of 2-hydroxylamine-O-[3-(aminooxy)-2,2-dimethylpropyl]hydrochloride (1:2) (45 mg) in absolute ethanol (1.00 mL) was charged to a 5 mL single-necked round-bottomed flask. Under stirring, 5,6-dihydro-2-methyl-7H-cyclopenta[b]pyridin-7-one, (1.56 g) was added. Stirring was continued at room temperature for 3.5 hours. TLC indicated that the ketone was consumed by this time. The reaction was quenched by the addition of water (5 mL). The pH was adjusted to 9 to 10 by the addition of a 1M aqueous NaOH solution. Extraction was carried out using ethyl acetate (2×10 mL). The combined organic phases were washed with brine, dried over sodium sulphate and filtered. The solvent was removed in vacuo to give a dark red gum (84.8 mg). No further purification was required.

LC-MS (Method ZCQ): UV Detection: 220 nm; Rₜ=1.74 min. MS: (M⁺+1)=393, (M⁺+23)=415, (M²⁺+1)=197.

TLC: Plates: Merck DC-Plates, silica gel F₂₅₄, saturated atmosphere in developing tank,

UV detection, eluent: heptane/ethyl acetate 1:4 (v:v); R_{f} of title compound=0.15, R_{f} of ketone starting material=0.25.

### Preparation of Compound E/E-17.047

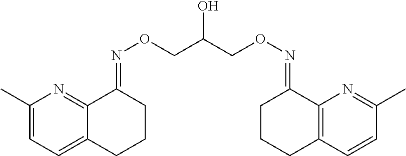

A solution of 2-methyl-6,7-dihydro-5H-quinolin-8-one oxime (230 mg) in absolute dimethyl sulfoxide (2.00 mL) was charged to a 10 mL single-necked round-bottomed flask. Under stirring potassium tert-butoxide (146 mg) was added to the flask. Thereafter, the reaction mixture is heated to 60° C. under stirring. After 20 minutes, a solution of 2-methyl-6,7-dihydro-5H-quinolin-8-one-O-(oxiranylmethyl)-E-oxime (300 mg) in absolute dimethylsulfoxide (2.00 mL) was slowly added to the reaction mixture at 60° C. The resulting orange-brown solution was stirred at 60° C. for 19 hours. The course of the reaction was followed by TLC, which indicated that substantial amounts of starting materials were consumed at this time. The reaction was quenched by the addition of water (20 mL), whereupon a pH in the range of 7-8 of the aqueous phase was observed. The solution was extracted using ethyl acetate (2×10 mL). The combined organic phases were dried over sodium sulphate, filtered and the solvent removed in vacuo to give a brown gum (360 mg). The crude material was purified by chromatography on silica gel (eluent: heptane/ethyl acetate 9:1 (v:v) with 0.5% v/v of triethylamine), giving a light orange gum. In order to remove a remaining amount of dimethyl sulfoxide, the material was dried in high vacuum to give an orange gum (104 mg).

LC-MS (Method ZMD): UV Detection: 220 nm; Rₜ=0.95 min. MS: 409 ([M⁺+1]⁺), 205 ([M⁺+2]2⁺), 431 ([M⁺+23]⁺).

TLC: Plates: Merck DC-Plates, silica gel F₂₅₄, saturated atmosphere in developing tank, UV detection, eluent: ethyl acetate/triethylamine 10:1 (V: V); R_{f} of title compound=0.09, R_{f} of oxime starting material=0.18, R_{f} of epoxide starting material=0.38.

### Preparation of Compound E/E-1.203

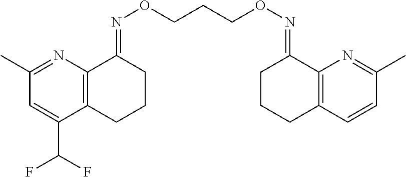

A 5 ml flask was charged with a solution of 2-methyl-6,7-dihydro-5H-quinolin-8-one O-(3-aminooxy-propyl)-E-oxime (47 mg; 0.19 mmol) in ethanol (2 mL). Under stirring, paratoluene sulfonic acid (2 mg; 0.012 mmol) and 4-difluoromethyl-2-methyl-6,7-dihydro-5H-quinolin-8-one (40 mg; 0.19 mmol) dissolved in ethanol (1 mL) were added. The resulting orange solution was stirred at room temperature for 2 hours. TLC analysis of an aliquot of the reaction mixture showed that a substantial amount of starting materials was consumed at this point in time. The reaction was quenched by the addition of water (1 mL), and the pH was adjusted to 14 by the addition of a 2M aqueous NaOH solution. The aqueous phase was extracted using ethyl acetate (3×10 mL). The combined organic phases were dried over sodium sulphate, filtered and the solvent removed in vacuo to to give a brown gum (75 mg). The crude material was purified by chromatography on silica gel (eluent: dichloromethane/methanol). This gave the title compound as a light yellow gum (65 mg).

LC-MS (Method ZCQ_OA_{—}3 min_{—}30V): UV Detection: 220 nm; Rₜ=1.38 min. MS: (M⁺+1)=443

TLC: Plates: Merck DC-Plates, silica gel F₂₅₄, saturated atmosphere in developing tank, UV detection, eluent: dichloromethane/methanol 95:5 (v:v); R_{f} of title compound=0.46, R_{f} of ketone starting material=0.15, R_{f} of oxime starting material=0.28.

### Preparation of Compound E/E-18.047

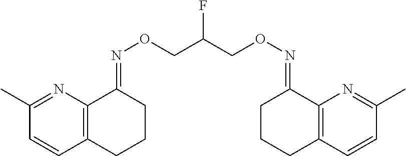

A 5 ml flask was charged with a solution of 2-methyl-6,7-dihydro-5H-quinolin-8-one O-(3-aminooxy-2-fluoropropyl)-oxime (125 mg; 1 mmol) in ethanol (2 mL). Under stirring, paratoluene sulfonic acid (11 mg; 0.006 mmol) and 2-methyl-6,7-dihydro-5H-quinolin-8-one (386 mg; 2 mmol) dissolved in ethanol (1 mL) were added. The yellow solution was stirred at room temperature for 20 hours. TLC analysis of an aliquot of the reaction mixture showed that most of the starting materials was consumed at this point in time. The solvent was removed in vacuo. Water (1 mL) was then added to the residue, and the pH was adjusted to 14 by the addition of a 2M aqueous NaOH solution. The reaction mixture was extracted using ethyl acetate (3×10 mL). The combined organic phases were dried over sodium sulphate, filtered and the solvent removed in vacuo to give a brown oil (527 mg). The crude material was purified by chromatography on silica gel (eluent: heptane/ethyl acetate). This gave the title compound as a beige oil (330 mg).

LC-MS (Method ZCQ_OA_{—}3 min_{—}30V): UV Detection: 220 nm; Rₜ=1.12 min. MS: (M⁺+1)=411

TLC: Plates: Merck DC-Plates, silica gel F₂₅₄, saturated atmosphere in developing tank, UV detection, eluent: heptane/ethyl acetate 1:2 (v:v); R_{f} of title compound=0.46, R_{f} of ketone starting material=0.21.

### Preparation of Compound E/E-2.651

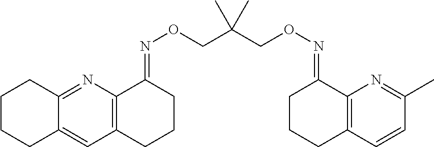 [SMILES: Cc1ccc2c(n1)/C(=N/OCC(C)(C)CO/N=C1\CCCc3cc4c(nc31)CCCC4)CCC2]

A solution of 2,3,5,6,7,8-hexahydro-1H-acridin-4-one (181 mg; 0.9 mmol) in methanol (15 mL) was charged to a 50 mL single-necked round-bottomed flask. Under stirring, 2-methyl-6,7-dihydro-5H-quinolin-8-one O-(3-aminooxy-2,2-dimethyl-propyl)-E-oxime (250 mg; 0.9 mmol) was added. Stirring was continued at room temperature for 15 hours. TLC analysis of an aliquot of the reaction mixture showed that no starting materials were left at this point in time. The solvent was removed in vacuo to give an orange oil (372 mg). The crude material was purified by chromatography on silica gel (eluent: cyclohexane/ethyl acetate). This gave the title compound as a colorless oil (365 mg).

LC-MS (Method ZMD): UV Detection: 220 nm; Rₜ=1.25 min. MS: (M⁺+1)=461.

TLC: Plates: Merck DC-Plates, silica gel F₂₅₄, saturated atmosphere in developing tank, UV detection, eluent: heptane/ethyl acetate 3:7 (v:v); R_{f} of title compound=0.35, R_{f} of ketone starting material=0.30, R_{f} of oxime starting material=0.84.

### Preparation of Compound E/E-21.648

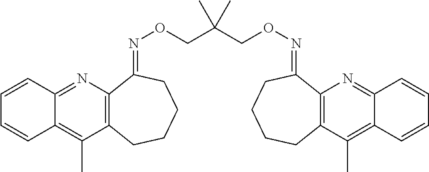 [SMILES: Cc1c2c(nc3ccccc13)/C(=N/OCC(C)(C)CO/N=C1\CCCCc3c1nc1ccccc1c3C)CCCC2]

A solution of 1,3-propandiyl-bis-hydroxylamin hydrochloride (1:2) (238 mg; 1.33 mmol) in methanol (15 mL) was charged to a 50 mL single-necked round-bottomed flask. Under stirring, pyridine (0.21 mL; 2.66 mmol) and 11-methyl-7,8,9,10-tetrahydro-cyclohepta[b]quinolin-6-one (600 mg; 2.66 mmol) were added. Stirring was continued at room temperature for 3 hours. The solvent was removed in vacuo to give a brown foam (980 mg). Purification was carried out by chromatography on silica gel (eluent: cyclohexane/ethyl acetate 1:1 (v:v)). This gave the title compound as a yellow oil (250 mg).

LC-MS (Method ZMD): UV Detection: 220 nm; Rₜ=2.01 min. MS: (M⁺+1)=521.

TLC: Plates: Merck DC-Plates, silica gel F₂₅₄, saturated atmosphere in developing tank, UV detection, eluent: cyclohexane/ethyl acetate 4:6 (v:v); R_{f} of title compound=0.35, R_{f} of ketone starting material=0.46, R_{f} of oxime starting material=0.64.

The following examples provide useful intermediates:

### 2-Methyl-6,7-dihydro-5H-quinolin-8-one-(E)-oxime

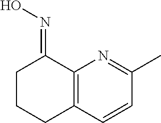

A 250 mL single-necked round-bottomed flask, equipped with a condenser, was charged with a solution of 2-methyl-6,7-dihydro-5H-quinolin-8-one (7.00 g) (CA Registry Number: 849643-01-2) in absolute ethanol (70 mL). Under stirring, first hydroxylamine-hydrochloride (4.50 g) was added and then a solution of NaOH (8.70 g) dissolved in water (14.00 mL) was added in portions. Stirring was continued under heating to reflux for 6.0 hours. Following the course of the reaction by TLC indicated that starting materials were consumed by this time. The suspension was cooled to room temperature. Under stirring and cooling with an ice-water cooling bath, 10 mL of water was added and the pH was adjusted to 6 by the addition of 6 M aqueous HCl. Extraction was carried out using ethyl acetate (2×100 mL). The combined organic phases were washed with brine and then dried over sodium sulphate, filtered and the solvent was removed in vacuo to give a yellow solid (7.65 g).

LC-MS (Method ZMD) UV Detection: 220 nm; Rₜ=0.20, MS: (M⁺+1)=177, (M⁺+23)=179; melting point=177-181° C.

TLC: Plates: Merck DC-Plates, silica gel F₂₅₄, saturated atmosphere in developing tank,

UV detection, eluent: ethyl acetate/triethylamine 10:1 (v:v); R_{f} of title compound=0.26, R_{f} of the ketone starting material=0.46.

### Preparation of 2-Methyl-6,7-dihydro-5H-quinolin-8-one-O-(oxiranylmethyl)-E-oxime

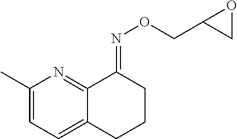 [SMILES: Cc1ccc2c(n1)/C(=N/OCC1CO1)CCC2]

A solution of 2-methyl-6,7-dihydro-5H-quinolin-8-one-(E)-oxime (1.00 g) in absolute dimethyl sulfoxide (10 mL) was charged to a 25 mL reaction flask which had previously been placed under an atmosphere of argon. Under stirring, 4M aqueous KOH solution (1.56 mL) was added. The resulting orange suspension was stirred at room temperature for 2 hours, whereupon the suspension had turned into a brown solution. Epichlorohydrin (0.49 mL) was then added dropwise and stirring was continued for a further 5 hours at room temperature. Following the course of the reaction by TLC indicated that no starting materials were left at this time. The reaction was quenched by the addition of an excess of 1M aqueous NaOH solution. Extraction was carried out using tert-butyl methyl ether (2×15 mL). The combined organic layers were dried over sodium sulphate, filtered and the solvent was removed in vacuo to give a brown oil (1.20 g). This raw material was purified by chromatography on silica gel (eluent: heptane/ethyl acetate 7:3 (v:v) with 0.5 vol-% of triethylamine). The title compound 2-methyl-6,7-dihydro-5H-quinolin-8-one-O-(oxiranylmethyl)-E-oxime (480 mg) was obtained in the form of a light yellow oil.

LC-MS (Method ZMD): UV Detection: 220 nm; Rₜ=0.78 min. MS: 233 ([M+1]⁺), 255 ([M+23]⁺).

TLC: Plates: Merck DC-Plates, silica gel F₂₅₄, saturated atmosphere in developing tank, UV detection, eluent: ethyl acetate/triethylamine 10:1 (v:v); R_{f} of title compound=0.29.

### Preparation of 2-Methyl-6,7-dihydro-5H-quinolin-8-one-O-(3-aminooxy-2,2-dimethyl-propyl)-E-oxime

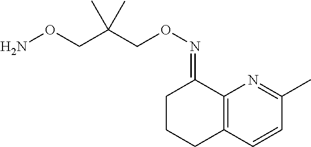 [SMILES: Cc1ccc2c(n1)/C(=N/OCC(C)(C)CON)CCC2]

A solution of hydroxylamine-O-[3-(aminooxy)-2,2-dimethylpropyl]hydrochloride (1:2) (21.7 g) in absolute ethanol (300 mL) was charged to a 500 mL reaction flask which had previously been placed under an atmosphere of argon. Under stirring, p-toluenesulphonic acid (1.2 g) was added, followed by the dropwise addition of 2-methyl-6,7-dihydro-5H-quinolin-8-one (6.77 g) dissolved in absolute ethanol (30 mL). The resulting yellow solution was stirred at room temperature for 1.5 hours. Following the course of the reaction by TLC indicated that no starting materials were left at this point in time. The ethanol was removed in vacuo. Aqueous sodium bicarbonate solution (150 mL) was then added. Extraction was carried out using ethyl acetate (2×100 mL). The combined organic layers were dried over sodium sulphate, filtered and the solvent was removed in vacuo to give a beige oil (10.9 g). This raw material was purified by chromatography on silica gel (eluent: heptane/ethyl acetate 2:1 (v:v) with 1 vol-% of triethylamine). This was followed by RP-HPLC chromatography (Separation Laboratory: Method 10-40). The title compound (6.00 g) was obtained in the form of a light yellow gum.

LC-MS (Method ZMD): UV Detection: 220 nm; Rₜ=0.83 min.

TLC: Plates: Merck DC-Plates, silica gel F₂₅₄, saturated atmosphere in developing tank, UV detection, eluent: heptane/ethyl acetate 1:2 (v:v); R_{f} of title compound=0.11.

### Preparation of 2-Methyl-6,7-dihydro-5H-quinolin-8-one-O-(2-methyl-oxiranylmethyl)-E-oxime

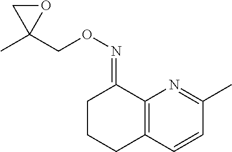

To a 100 mL single-necked round-bottomed flask, kept under an atmosphere of argon, was charged a solution of E-1-(6-methyl-2-pyridinyl)-ethanone-E-oxime (6.00 g) in absolute acetone (35 mL). Under stirring, finely powdered NaOH (3.20 g) was added portionwise. Stirring was continued at room temperature for 4.5 hours, giving a light orange suspension. A solution of α-methylepichlorohydrin (6.08 g) dissolved in absolute acetone (5.00 mL) was then added to the flask slowly, using a syringe. The resulting mixture was then heated to reflux under stirring for 2.5 hours, when TLC indicated that the starting materials had been consumed. The suspension was cooled to room temperature and then filtered. The filter cake was washed with absolute acetone. Water (50 mL) was added to the filtrate, giving a pH in the range of 7-8. Extraction was carried out using ethyl acetate (2×100 ml). The combined organic phases were dried over sodium sulphate, filtered and the solvent removed in vacuo to give an orange oil (12.0 g). The crude material was purified by chromatography on silica gel (eluent: heptane/ethyl acetate 95:5 (v:v)). This gave 1-(6-methyl-pyridin-2-yl)-ethanone-O-(2-methyl-oxiranylmethyl)-oxime (7.35 g) in the form of a yellow oil.

LC-MS (Method ZCQ): UV Detection: 220 nm; Rₜ=1.21 min. MS: (M⁺+1)=221, (M⁺+23)=243.

TLC: Plates: Merck DC-Plates, silica gel F₂₅₄, saturated atmosphere in developing tank, UV detection, eluent: heptane/ethyl acetate 1:2 (v:v); R_{f} of title compound=0.37, R_{f} of oxime starting material=0.29.

### Preparation of 2-Methyl-4-methylsulfanyl-5,6,7,8-tetrahydro-quinolin-8-ol

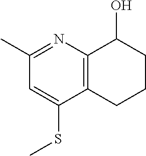

A flask equipped with a condenser was charged with a mixture of 4-chloro-2-methyl-5,6,7,8-tetrahydro-quinolin-8-ol (0.9 g; 4.55 mmol) in DMF (27 mL). Under stirring sodium methanethiolate (1.6 g; 22.77 mmol) was added and the resulting mixture was stirred under heating to reflux for 3 hours. The resulting solution was cooled to room temperature and diluted with water and 2M aqueous NaOH. The reaction mixture was extracted with diethyl ether. The combined organic phases were dried over sodium sulphate, filtered and the solvent was removed in vacuo to give a yellow gum (600 mg) which was used as such for the next step.

LC-MS (ZCQ) UV Detection: 220 nm; Rₜ=0.23, MS: (M⁺+1)=210.

### Preparation of 2-Methyl-4-methylsulfanyl-6,7-dihydro-5H-quinolin-8-one

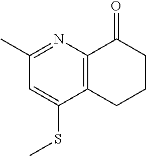

A flask, equipped with a condenser was charged with a mixture of 2-methyl-4-methylsulfanyl-5,6,7,8-tetrahydro-quinolin-8-ol (500 mg; 2.4 mmol) in chloroform (10 mL). Under stirring, manganese (IV) oxide (830 mg) was added and the resulting black suspension was stirred under heating to reflux for 18 hours, after which time TLC indicated that no starting material remained. The resulting black material was allowed to return to ambient temperature and filtered over hyflo before purification by chromatography on silica gel (eluent: heptane/ethyl acetate). This gave the title compound (420 mg) as an orange solid. LC-MS (ZMD): UV Detection: 220 nm; Rₜ=0.2 min. MS: (M⁺+1)=208.

### Preparation of 4-Methanesulfonyl-2-methyl-6,7-dihydro-5H-quinolin-8-one

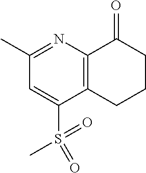 [SMILES: Cc1cc(S(C)(=O)=O)c2c(n1)C(=O)CCC2]

To a solution of 2-methyl-4-methylsulfanyl-6,7-dihydro-5H-quinolin-8-one (110 mg; 0.53 mmol) in dichloromethane (10 mL) was added a solution of sodium bicarbonate (267 mg; 3.18 mmol) in water (3.5 mL) at 0° C. After 1 h, a solution of 3-chloroperbenzoic acid (183 mg, 1.06 mmol) in dichloromethane (35 mL) was slowly added over 1 h at 0° C. The resulting solution was stirred at 0° C. for 30 min then ambient temperature for 12 h. Following the course of the reaction by TLC indicated that starting material was not completely consumed by this time, so the same quantity of 3-chloroperbenzoic acid was further added and the mixture was stirred for a few hours more. The phases of the reaction mixture were separated and the aqueous layer was extracted with dichloromethane. The combined organic phases were dried over sodium sulphate, filtered and the solvent was removed in vacuo. The resulting material was purified by chromatography on silica gel (eluent: heptane/ethyl acetate 1:1 (v:v)). This gave the title compound (90 mg) as a yellow solid. LC-MS (ZMD): UV Detection: 220 nm; Rₜ=1.06 min. MS: (M⁺+1)=240.

### 2-Methyl-6,7-Dihydro-5H-quinolin-8-one-(E)-oxime

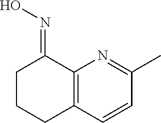

A 250 mL single-necked round-bottomed flask, equipped with a condenser, was charged with a solution of 2-methyl-6,7-dihydro-5H-quinolin-8-one (7.00 g) (CA Registry Number: 849643-01-2) in absolute ethanol (70 mL). Under stirring, first hydroxylamine-hydrochloride (4.50 g) was added and then a solution of NaOH (8.70 g) dissolved in water (14.00 mL) was added in portions. Stirring was continued under heating to reflux for 6.0 hours. Following the course of the reaction by TLC indicated that starting materials were consumed by this time. The suspension was cooled to room temperature. Under stirring and cooling with an ice-water cooling bath, 10 mL of water was added and the pH was adjusted to 6 by the addition of 6 M aqueous HCl. Extraction was carried out using ethyl acetate (2×100 mL). The combined organic phases were washed with brine and then dried over sodium sulphate, filtered and the solvent was removed in vacuo to give a yellow solid (7.65 g).

Analytical Data for the Title Compound:

LC-MS (Method ZMD) UV Detection: 220 nm; Rₜ=0.20, MS: (M⁺+1)=177, (M⁺+23)=179; melting point=177-181° C.

TLC: Plates: Merck DC-Plates, silica gel F₂₅₄, saturated atmosphere in developing tank, UV detection, eluent: ethyl acetate/triethylamine 10:1 (v:v); R_{f} of title compound=0.26, R_{f} of the ketone starting material=0.46.

The preparation of the following starting materials is described in the literature

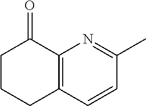

CA Registry Number: 849643-01-2
U.S. Pat. Appl. Publ. (2005), 75 pp., Cont.-in-part of U.S. Ser. No. 437,807. CODEN: USXXCO US 2005075366 A1 20050407

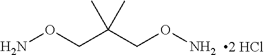

CA Registry Number: 1034433-68-5
PCT Int. Appl. (2008), 187 pp. CODEN: PIXXD2 WO 2008074418 A2 20080626

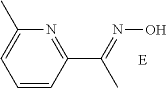

CA Registry Number: 23089-39-6

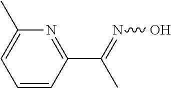

CA Registry Number: 18103-88-3
Talanta (1969), 16(3), 448-52; DE 2447258 (19760408); Journal of Heterocyclic Chemistry (1968), 5(2), 161-4.

### Preparation of 4-chloro-2-methyl-6,7-dihydro-8(5H)-quinolinone

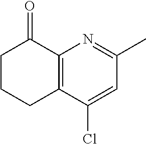

### Step A)

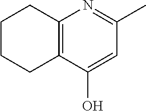

4-Hydroxy-2-methylquinoline (10.0 g) (CA Registry Number: 607-67-0) was charged to a reactor containing absolute ethanol (90.0 mL) under nitrogen atmosphere. Under stirring, a suspension of Raney nickel (2.0 g) in absolute ethanol (10.0 mL) was added to the reaction mixture. The nitrogen atmosphere was then replaced by hydrogen. The reaction mixture was stirred at 75° C. for 22 hours under a 100 bar hydrogen atmosphere, at which time analysis of the reaction mixture by TLC indicated that the starting material was consumed. The catalyst was filtered off and the solvent was removed in vacuo to give a white solid (8.35 g). The compound was used as such for the next step.

LC-MS (ZMD): UV Detection: 220 nm; Rₜ=0.40 min. MS: (M⁺+1) 164; melting point=237-240° C.

TLC: Plates: Merck DC-Plates, silica gel F₂₅₄, saturated atmosphere in developing tank, UV detection, eluent: dichloromethane/methanol 9:1 (v:v); R_{f} of title compound=0.22, R_{f} of quinoline starting material=0.34.

### Step B)

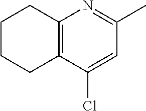

A 50 mL single-necked round-bottom flask, equipped with a condenser, was charged with a solution of 2-methyl-5,6,7,8-tetrahydro-quinolin-4-ol (4.00 g) in phosphorus oxide chloride (18.3 mL) under an argon atmosphere. The resulting colorless solution was stirred at 100° C. for 3.5 hours, after which time TLC indicated that no starting material was remaining. The solvent was removed in vacuo and hot water (40-50° C.) was added carefully and slowly to the residue to hydrolyse the remaining phosphorus oxide chloride. Under cooling with an ice-water cooling bath, the pH was adjusted to 12 by the addition of 4 M aqueous NaOH. The resulting solution was extracted using chloroform (2×50 mL). The combined organic layers were washed with brine (25 mL) and then dried over sodium sulphate, filtered and the solvent was removed in vacuo to give a light yellow oil (4.21 g).

The compound was used as such for the next step.

LC-MS (ZMD): UV Detection: 220 nm; Rₜ=0.87 min. MS: (M⁺+1)=182.

TLC: Plates: Merck DC-Plates, silica gel F₂₅₄, saturated atmosphere in developing tank, UV detection, eluent: heptane/ethyl acetate 1:4 (v:v); R_{f} of title compound=0.40, R_{f} of quinolinol starting material=0.

### Step C)

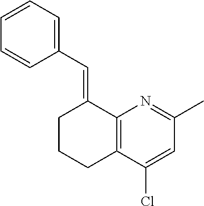 [SMILES: Cc1cc(Cl)c2c(n1)/C(=C/c1ccccc1)CCC2]

A 25 mL single-necked round-bottom flask, equipped with a condenser, was charged with a solution of 4-chloro-2-methyl-5,6,7,8-tetrahydroquinoline (560 mg) in acetic anhydride (0.49 mL). Under stirring, benzaldehyde (0.34 mL) was added and the resulting yellow solution was stirred under heating to reflux for 3.5 hours. Following the course of the reaction by TLC indicated that the starting material was consumed by this time. The resulting brown solution was cooled to room temperature. Crushed ice was added and the pH was adjusted to 10 using a small amount of 2M aqueous NaOH. Extraction was carried out using ethyl acetate (2×20 mL). The combined organic phases were dried over sodium sulphate, filtered and the solvent was removed in vacuo to give a brown gum (750 mg). The crude material was purified by chromatography on silica gel (eluent: heptane/ethyl acetate 98:2 (v:v)). This gave the desired compound (263 mg) as a yellow oil.

LC-MS (Method ZMD) UV Detection: 220 nm; Rₜ=2.23, MS: (M⁺+1)=270.

TLC: Plates: Merck DC-Plates, silica gel F₂₅₄, saturated atmosphere in developing tank, UV detection, eluent: heptanes/ethyl acetate 9:1 (v:v); R_{f} of title compound=0.44, R_{f} of the chloroquinoline starting material=0.09.

### Step D)

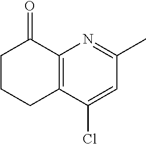

A 25 mL single-necked round-bottom flask was charged with a solution of 8-benzylidene-4-chloro-2-methyl-5,6,7,8-tetrahydro-quinoline (263 mg) in dichloromethane/methanol (2.0:3.8 mL). Under stirring and cooling to −78° C. with a dry ice-acetone cooling bath, ozone was passed through the reaction mixture for 3 minutes until a light blue color was observed. Then dimethyl sulfide (2.0 mL) was added at −78° C. The reaction mixture was then allowed to reach room temperature and stirred for 4 hours. Solvents were removed in vacuo, then the resulting orange gum was taken up in diethyl ether and aqueous HCl (1M; 5 mL) was added. Extraction of the acidic by-products was carried out using diethyl ether (2×20 mL). Crushed ice was added to the aqueous layer and the pH was adjusted to 10 by the addition of 2M aqueous NaOH. The resulting solution was extracted using chloroform (2×20 mL). The combined organic layers were dried over sodium sulphate, filtered and the solvent was removed in vacuo to give a yellow solid (96 mg).

Analytical Data for the Title Compound:

LC-MS (Method ZMD) UV Detection: 220 nm; Rₜ=1.28, MS: (M⁺+1)=196.

TLC: Plates: Merck DC-Plates, silica gel F₂₅₄, saturated atmosphere in developing tank, UV detection, eluent: heptanes/ethyl acetate 4:1 (v:v); R_{f} of title compound=0.04, R_{f} of the benzylidene starting material=0.59.

The preparation of the following starting material is described in the literature and it is available commercially

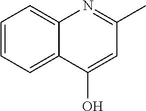

Registry Number: 607-67-0

### Preparation of 2,4-Dimethyl-6,7-dihydro-8(5H)-quinolinone

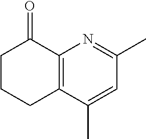

### Step A)

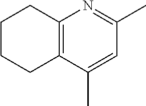

A 5 mL microwave tube was charged with a solution of 4-chloro-2-methyl-5,6,7,8-tetrahydroquinoline (500 mg) in 1,2-dichloroethane (2.50 mL). Under stirring, trimethylboroxine (380 mg), potassium carbonate (647 mg) and dichloro[1,1′-bis(diphenylphosphino)ferrocene]palladium(II) dichloromethane adduct (101 mg) were added and the resulting red suspension was degassed under argon for 5 minutes. The reaction mixture was subjected to microwave irradiation at 120° C. for 0.5 hour. After addition of new portions of trimethylboroxine (2×380 mg) and catalyst (101 mg), the reaction mixture was again subjected to microwave irradiation at 120° C. for 2×0.5 hour. Following the course of the reaction by TLC indicated that the starting material was consumed by this time. The resulting brown material was purified by chromatography on silica gel (eluent: heptane/ethyl acetate 4:1 (v:v)). This gave the desired compound (345 mg) as a light brown oil.

LC-MS (Method ZMD) UV Detection: 220 nm; Rₜ=0.75, MS: (M⁺+1)=162.

TLC: Plates: Merck DC-Plates, silica gel F₂₅₄, saturated atmosphere in developing tank, UV detection, eluent: heptane/ethyl acetate 1:2 (v:v); R_{f} of title compound=0.28, R_{f} of the chloroquinoline starting material=0.40.

### Step B)

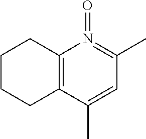

2,4-Dimethyl-5,6,7,8-tetrahydro-quinoline (150 mg) was charged to a 10 mL single-necked round-bottom flask containing chloroform (1.50 mL). Under stirring and cooling with an ice-water cooling bath, 3-chloroperbenzoic acid (344 mg) was added portion wise. The resulting orange solution was stirred at room temperature for 5 hours, at which time analysis of the reaction mixture by TLC indicated that the starting material was consumed. Under cooling with an ice-water cooling bath, the pH was adjusted to pH 12 by the addition of aqueous NaOH (4M; 2.0 mL). The resulting solution was extracted using chloroform (3×10 mL). The combined organic layers were washed with brine (10 mL) and then dried over sodium sulphate, filtered and the solvent was removed in vacuo to give a light orange gum (180 mg). This intermediate was used as such for the following step.

LC-MS (ZMD): UV Detection: 220 nm; Rₜ=1.26 min. MS: (M⁺+1) 178.

TLC: Plates: Merck DC-Plates, silica gel F₂₅₄, saturated atmosphere in developing tank, UV detection, eluent: heptane/ethyl acetate 1:2 (v:v); R_{f} of title compound=0, R_{f} of quinoline starting material=0.28.

### Step C)

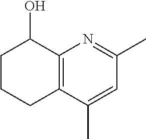

A 25 mL single-necked round-bottom flask, equipped with a condenser, was charged with a solution of 2,4-dimethyl-5,6,7,8-tetrahydro-quinoline-1-oxide (334 mg) in dichloromethane (2.00 mL) under an argon atmosphere. Under stirring and cooling with an ice-water cooling bath, trifluoroacetic anhydride (2.66 mL) was added dropwise and the resulting orange solution was stirred under heating to reflux for 22 hours. Following the course of the reaction by TLC indicated that starting material was consumed by this time. The resulting brown solution was cooled to room temperature. Crushed ice was added and the pH was adjusted to 12 using aqueous NaOH (2M; 5 mL). Extraction was carried out using dichloromethane (3×10 mL). The combined organic phases were dried over sodium sulphate, filtered and the solvent was removed in vacuo to give a dark brown gum (226 mg). This intermediate was used without further purification in the next step.

LC-MS (Method ZMD) UV Detection: 220 nm; Rₜ=0.25, MS: (M⁺+1)=178, (M⁺−18)=160.

TLC: Plates: Merck DC-Plates, silica gel F₂₅₄, saturated atmosphere in developing tank, UV detection, eluent: heptanes/ethyl acetate 1:4 (v:v); R_{f} of title compound=0.08, R_{f} of the quinoline-oxide starting material=0.

### Step D)

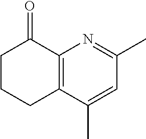

A 25 mL single-necked round-bottom flask, equipped with a condenser, was charged with a solution of 2,4-dimethyl-5,6,7,8-tetrahydro-quinolin-8-ol (226 mg) in chloroform (2.00 mL). Under stirring, manganese(IV) oxide (443 mg) was added and the resulting black suspension was stirred under heating to reflux for 18 hours, after which time TLC indicated that no starting material remained. The resulting black material was purified by chromatography on silica gel (eluent: heptane/ethyl acetate gradient from 1:1 to 1:2 (v:v)). This gave the tittle compound (78 mg) as an orange gum.

Analytical data for the title compound:

LC-MS (ZMD): UV Detection: 220 nm; Rₜ=0.34 min. MS: (M⁺+1)=176.

TLC: Plates: Merck DC-Plates, silica gel F₂₅₄, saturated atmosphere in developing tank, UV detection, eluent: heptane/ethyl acetate 1:4 (v:v); R_{f} of title compound=0.11, R_{f} of quinolinol starting material=0.08.

### Preparation of 9-Methyl-2,3-dihydro-1H-acridin-4-one

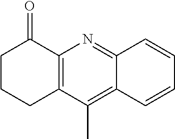 [SMILES: Cc1c2c(nc3ccccc13)C(=O)CCC2]

### Step A) Preparation of 9-Methyl-1,2,3,4-tetrahydroacridine

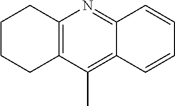

In a round-bottom flask, cyclohexanone (6.1 mL, 58 mmol) was heated to 90° C., and 2-aminoacetophenone hydrochloride (10 g; 58 mmol) was added in small fractions. The flask was then equipped with a condenser, and the crude heterogeneous mixture was further heated overnight at 110° C. After cooling to room temperature, the red-orange solid was dissolved in ethanol/HCl (12N) [95/5 v/v]. The solution was then neutralized with aqueous NaOH solution. The ethanol was evaporated, and the product extracted with diethyl ether (2×100 mL). The combined organic layers were washed with water (2×100 mL), dried over magnesium sulphate and filtered, and the solvent was removed under reduced pressure. The desired product was finally obtained as a brown-yellow solid (10.2 g, 89%). ¹H NMR (200.131 MHz; CDCl₃) δ₍ₚₚₘ₎: 7.94 (dd, ³J=8.3 Hz and ⁴J=1.1 Hz, 1H), 7.87 (dd, ³J=8.3 Hz and ⁴J=1.3 Hz, 1H), 7.55 (ddd, ³J=8.3 Hz, ³J=8.3 Hz and ⁴J=1.3 Hz, 1H), 7.38 (ddd, ³J=8.3 Hz, ³J=8.3 Hz and ⁴J=1.1 Hz, 1H), 3.07 (t br, ³J=6.7 Hz, 2H), 2.79 (t br, ³J=6.1 Hz, 2H), 2.43 (s, 3H), 1.86 (m, 2×2H). ¹³C NMR (50.332 MHz, CDCl₃) δ₍ₚₚₘ₎: 157.8, 145.5, 140.6, 128.0, 126.4, 128.6, 127.6, 124.8, 122.9, 34.2, 26.5, 22.8, 22.4, 12.9. HRMS (EI) m/z calcd for [M]⁺ (found): 197.1204 (197.1198). Anal. Calcd for C₁₄H₁₅N (found): C, 85.24 (85.25); H, 7.66 (7.72); N, 7.10 (6.78).

### Step B) Preparation of N-Oxide-9-methyl-1,2,3,4-tetrahydroacridine

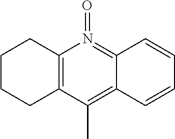 [SMILES: Cc1c2c([n+]([O-])c3ccccc13)CCCC2]

A solution of 3-chloroperbenzoic acid (26 g, 105 mmol) in dichloromethane (300 mL) was slowly added to a solution of 9-methyl-1,2,3,4-tetrahydroacridine (10.2 g, 52 mmol) in dichloromethane (100 mL) at 0° C. The mixture was stirred for 4 h at room temperature and quenched with an aqueous NaOH solution. The organic layers were further washed with water (5×100 mL) and dried over magnesium sulphate, and the solvent was removed under reduced pressure giving desired product as a brownish solid. (10.83 g, 98%). ¹H NMR (200.131 MHz, CDCl₃) δ₍ₚₚₘ₎: 8.77 (dd, ³J=8.5 Hz and ⁴J=1.2 Hz, 1H), 7.97 (dd, ³J=8.5 Hz and ⁴J=0.9 Hz, 1H), 7.70-7.50 (m, 2×1H), 3.19 (t, ³J=6.1 Hz, 2H), 2.85 (t, ³J=6.2 Hz, 2H), 2.51 (s, 3H), 1.88 (m, 2×2H). ¹³C NMR (50.332 MHz, CDCl₃) δ₍ₚₚₘ₎: 146.7, 139.1, 131.6, 129.9, 127.7, 129.0, 127.3, 123.9, 119.6, 27.1, 26.6, 22.0, 21.4, 13.4. HRMS (EI) calcd for [M]⁺ (found): 213.1154 (213.1159).

### Step C) Preparation of 9-Methyl-1,2,3,4-tetrahydroacridin-4-ol

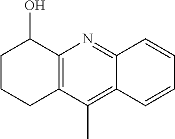 [SMILES: Cc1c2c(nc3ccccc13)C(O)CCC2]

In a two-neck round-bottom flask equipped with a reflux condenser, N-oxide-9-methyl-1,2,3,4-tetrahydroacridine (11.2 g, 52 mmol) was dissolved in dichloromethane (250 mL). Trifluoroacetic anhydride (17 mL, 120 mmol) was slowly added at room temperature (the reaction is exothermic). The solution was stirred for 5 h, and the solvent was evaporated. The crude solid was dissolved in methanol (50 mL) and saponified by an aqueous K₂CO₃ solution (2M; 150 mL); a brown solid precipitated. The methanol was removed under reduced pressure, and the product was extracted with dichloromethane (2×150 mL). The combined organic layers were washed with brine (2×50 mL), dried over magnesium sulphate, and evaporated to dryness. The desired product was recovered as a brown solid (9.4 g, 84%). ¹H NMR (200.131 MHz, CDCl₃) δ₍ₚₚₘ₎: 7.96 (d, ³J=8.3 Hz, 1H), 7.91 (d, ³J=8.4 Hz, 1H), 7.58 (dd, ³J=8.3 Hz and ³J=8.1 Hz, 1H), 7.45 (dd, ³J=8.1 Hz and ³J=8.4 Hz, 1H), 4.95 (s br, 1H), 4.76 (dd, ³J=10.3 Hz and ³J=10.0 Hz, 1H), 2.89 (m, 2H), 2.54 (s, 3H), 2.40-1.92 (2×m, 2×1H), 1.82 (m, 2H). ¹³C NMR (50.332 MHz, CDCl₃) δ₍ₚₚₘ₎: 159.2, 145.3, 142.0, 127.7, 127.3, 129.2, 128.5, 126.0, 123.5, 70.2, 30.3, 26.7, 19.6, 13.8. HRMS (EI) calcd for [M]⁺ (found): 213.1153 (213.1154).

### Step D) Preparation of 9-Methyl-2,3-dihydro-1H-acridin-4-one

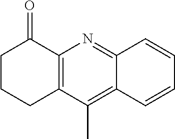 [SMILES: Cc1c2c(nc3ccccc13)C(=O)CCC2]

To a dichloromethane solution (300 mL) of 9-methyl-1,2,3,4-tetrahydroacridin-4-ol (9.4 g, 44 mmol) was added manganese(IV) oxide (23 g, 264 mmol) at room temperature, and the heterogeneous solution was allowed to stir for 2 days. After filtration over Celite, the solvent was evaporated. The crude dark solid was purified by column chromatography (neutral alumina, dichloromethane as eluant). After evaporation of the solvent, the title compound was recovered as a brownish solid (5.41 g, 58%). ¹H NMR (200.131 MHz, CDCl₃) δ₍ₚₚₘ₎: 8.31 (dd, ³J=8.1 Hz and ⁴J=0.8 Hz, 1H), 7.94 (dd, ³J=8.0 Hz and ⁴J=1.4 Hz, 1H), 7.67-7.51 (m, 2H), 3.08 (t, ³J=6.1 Hz, 2H), 2.82 (t, ³J=6.4 Hz, 2H), 2.60 (s, 3H), 2.22 (m, 2H). ¹³C NMR (50.332 MHz, CDCl₃) δ₍ₚₚₘ₎: 198.2, 148.4, 146.9, 143.6, 134.1, 129.4, 132.4, 129.6, 128.9, 123.8, 40.2, 27.2, 22.4, 14.5. HRMS (EI) m/z calcd for [M]⁺ (found): 211.0997 (211.0989). Anal. Calcd for C₁₄H₁₃NO (found): C, 79.59 (79.72); H, 6.20 (6.28); N, 6.63 (6.10).

### Preparation of 2-Methyl-4-phenoxy-6,7-dihydro-5H-quinolin-8-one

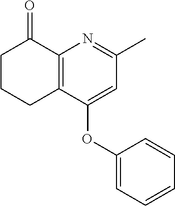 [SMILES: Cc1cc(Oc2ccccc2)c2c(n1)C(=O)CCC2]

### Step A) Preparation of 4-Chloro-2-methyl-5,6,7,8-tetrahydro-quinoline 1-oxide

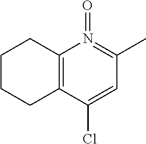

In a round-bottom flask, 4-chloro-2-methyl-5,6,7,8-tetrahydro-quinoline (3.0 g, 17 mmol) was stirred in chloroform (17 mL) at room temperature to give a light brown solution. The solution was cooled to 0° C. using an ice bath. At this temperature, 3-chloroperbenzoic acid (6.1 g, 25 mmol) was added portionwise over 5 minutes to give a yellow suspension. The reaction mixture was stirred at 0° C. for 10 minutes and the ice bath was then removed. The reaction mixture was allowed to warm to room temperature and further stirred at that temperature for 5 hours, giving a yellow suspension. The reaction was then cooled using an ice bath. Water and aqueous sodium hydroxide solution (4N; 25 mL) were added to the reaction mixture to give a reaction mixture of pH 14. The reaction mixture was extracted twice with chloroform (30 mL). The organic fractions were dried using sodium sulphate and concentrated under reduced pressure to give a light yellow solid (3.36 g). LC-MS (Method ZMD) UV Detection: 220 nm; Rₜ=1.39, MS: (M⁺+1)=198

### Step B) Preparation of 4-Chloro-2-methyl-5,6,7,8-tetrahydro-quinolin-8-ol

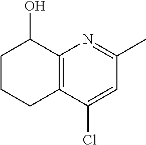

Preparation of 4-Chloro-2-methyl-5,6,7,8-tetrahydro-quinolin-8-ol: In a round-bottom flask, 4-chloro-2-methyl-5,6,7,8-tetrahydro-quinoline 1-oxide (3.1 g, 16 mmol) was stirred in dichloromethane (16 mL) at room temperature to give a yellow solution. The solution was cooled to 0° C. using an ice bath. At this temperature, trifluoroacetic anhydride (17.7 mL, 125 mmol) was added via a syringe over 10 minutes. The reaction mixture was stirred at 0° C. for 15 minutes and the ice bath was then removed. The reaction mixture was allowed to warm to room temperature and further stirred at that temperature for 5 hours, giving a yellow solution. The reaction was then cooled using an ice bath and aqueous sodium hydroxide solution (8N; 35 mL) was added to the reaction mixture over 20 minutes to give an orange suspension, which was stirred at room temperature for a further 4 hours. The reaction mixture was extracted twice with dichloromethane (50 mL). The organic fractions were dried using sodium sulphate and concentrated under reduced pressure to give a light yellow solid (2.75 g). This was used without further purification. mp=87-90° C.

### Step C) 2-Methyl-4-phenoxy-5,6,7,8-tetrahydro-quinolin-8-ol

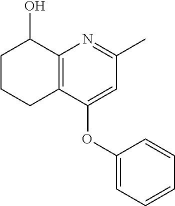 [SMILES: Cc1cc(Oc2ccccc2)c2c(n1)C(O)CCC2]

In a 5 mL closed Supelco vessel, phenol (3.1 g, 16 mmol) was stirred in 1-methyl-pyrrolidone (1.0 mL) at room temperature to give a colourless solution. Sodium bis(trimethylsilyl) amide (0.232 g, 1.265 mmol) was added to this solution to give a light yellow suspension. This was stirred at room temperature for 40 minutes resulting in a beige solution. A solution of 4-chloro-2-methyl-5,6,7,8-tetrahydro-quinolin-8-ol (2.5 g, 1.265 mmol) in 1-methyl-pyrrolidone (0.5 mL) was slowly added to the reaction mixture via syringe, giving a yellow suspension. The reaction mixture was stirred at 60° C. for 1 hour, giving a dark green solution. It was then stirred at 120° C. for 90 minutes to give a red-brown solution, followed by stirring for a further 2 hours at 160° C. resulting in a brown solution. At this time, the reaction mixture was transferred to a 10 mL Tiny Clave and stirred at 175° C. for 16 hours, giving a dark brown solution. The reaction mixture was allowed to cool to room temperature and then water and aqueous sodium hydroxide solution (2N; 30 mL) was added. The reaction mixture was extracted twice with diethyl ether (20 mL) and then the combined organic layers were washed twice with water (20 mL). The organic layer was dried over sodium sulphate and concentrated under reduced pressure to give a yellow gum. This gum was further purified by flash chromatography over silica (eluent: heptanes:ethyl acetate 2:1). This gave a yellow gum (0.09 g; 52% pure). This was used without further purification. This was used without further purification.

LC-MS (Method ZMD) UV Detection: 220 nm; Rₜ=1.00, MS: (M⁺+1)=256

### Step D) Preparation of 2-Methyl-4-phenoxy-6,7-dihydro-5H-quinolin-8-one

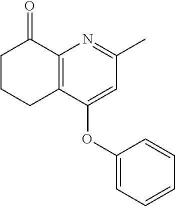 [SMILES: Cc1cc(Oc2ccccc2)c2c(n1)C(=O)CCC2]

In a round-bottom flask equipped with a condenser, 2-methyl-4-phenoxy-5,6,7,8-tetrahydro-quinolin-8-ol (0.09 g, 0.35 mmol) was stirred in chloroform (2 mL) at room temperature to give a yellow solution. To the reaction mixture was added manganese (IV) oxide (0.12 g, 1.4 mmol) to give a black suspension. This was stirred at reflux for 74 hours resulting in a black suspension. At this time the reaction mixture was allowed to return to room temperature. The reaction mixture was filtered, and the filter cake was twice washed with chloroform (10 mL). This gave a dark brown gum (0.1 g) which was purified by flash chromatography over silica (heptanes:ethyl acetate 1:1). This gave a yellow gum (0.0154 g).

LC-MS (Method ZMD) UV Detection: 220 nm; Rₜ=1.18, MS: (M⁺+1)=254

### Preparation of 2-Methyl-4-pyrrolidin-1-yl-6,7-dihydro-5H-quinolin-8-one

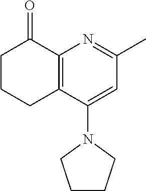 [SMILES: Cc1cc(N2CCCC2)c2c(n1)C(=O)CCC2]

### Step A) Preparation of 4-Chloro-2-methyl-5,6,7,8-tetrahydro-quinoline 1-oxide

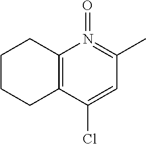

In a round-bottom flask, 4-chloro-2-methyl-5,6,7,8-tetrahydro-quinoline (3.0 g, 17 mmol) was stirred in chloroform (17 mL) at room temperature to give a light brown solution. The solution was cooled to 0° C. using an ice bath. At this temperature, 3-chloroperbenzoic acid (6.1 g, 25 mmol) was added portionwise over 5 minutes to give a yellow suspension. The reaction mixture was stirred at 0° C. for 10 minutes and the ice bath was then removed. The reaction mixture was allowed to warm to room temperature and further stirred at that temperature for 5 hours, giving a yellow suspension. The reaction was then cooled using an ice bath. Water and aqueous sodium hydroxide solution (4N; 25 mL) were added to the reaction mixture to give a reaction mixture of pH 14. The reaction mixture was extracted twice with chloroform (30 mL). The organic fractions were dried using sodium sulphate and concentrated under reduced pressure to give a light yellow solid (3.36 g).

LC-MS (Method ZMD) UV Detection: 220 nm; Rₜ=1.39, MS: (M⁺+1)=198

### Step B) Preparation of 4-Chloro-2-methyl-5,6,7,8-tetrahydro-quinolin-8-ol

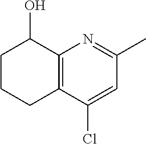

In a round-bottom flask, 4-chloro-2-methyl-5,6,7,8-tetrahydro-quinoline 1-oxide (3.1 g, 16 mmol) was stirred in dichloromethane (16 mL) at room temperature to give a yellow solution. The solution was cooled to 0° C. using an ice bath. At this temperature, trifluoroacetic anhydride (17.7 mL, 125 mmol) was added via a syringe over 10 minutes. The reaction mixture was stirred at 0° C. for 15 minutes and the ice bath was then removed. The reaction mixture was allowed to warm to room temperature and further stirred at that temperature for 5 hours, giving a yellow solution. The reaction was then cooled using an ice bath and aqueous sodium hydroxide solution (8N; 35 mL) was added to the reaction mixture over 20 minutes to give an orange suspension, which was stirred at room temperature for a further 4 hours. The reaction mixture was extracted twice with dichloromethane (50 mL). The organic fractions were dried using sodium sulphate and concentrated under reduced pressure to give a light yellow solid (2.75 g; mp=87-90° C.). This was used without further purification. mp=87-90° C.

### Step C) Preparation of 2-Methyl-4-pyrrolidin-1-yl-5,6,7,8-tetrahydro-quinolin-8-ol

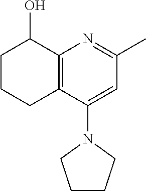 [SMILES: Cc1cc(N2CCCC2)c2c(n1)C(O)CCC2]

In a 10 mL Tiny Clave, 4-chloro-2-methyl-5,6,7,8-tetrahydro-quinolin-8-ol (0.4 g, 2.0 mmol) was stirred in pyrrolidone (1.7 mL, 20 mmol) at room temperature to give a yellow solution. The reaction mixture was then stirred at 150° C. for 8 hours to give a brown solution. The reaction mixture was then allowed to return to room temperature. Water and aqueous sodium hydroxide solution (2N; 5 mL) were then added. The reaction mixture was extracted twice with diethyl ether (15 mL) and then the combined organic layers were washed with brine (10 mL). The organic layer was dried over sodium sulphate and concentrated under reduced pressure to give a brown gum (0.5 g). This gum was filtered over silica. The filter cake was washed with a mixture of 95:5 chloroform:methanol. The filtrate was concentrated under reduced pressure to give a yellow solid (0.4 g). mp=97-98° C.

### Step D) Preparation of 2-Methyl-4-pyrrolidin-1-yl-6,7-dihydro-5H-quinolin-8-one

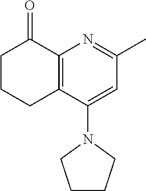 [SMILES: Cc1cc(N2CCCC2)c2c(n1)C(=O)CCC2]

In a round-bottom flask equipped with a condenser, 2-methyl-4-pyrrolidin-1-yl-5,6,7,8-tetrahydro-quinolin-8-ol (0.36 g, 1.55 mmol) was stirred in chloroform (2 mL) at room temperature to give a yellow-orange solution. To the reaction mixture was added manganese (IV) oxide (0.54 g, 6.198 mmol) to give a black suspension. This was stirred at reflux for 74 hours resulting in a black suspension. At this time the reaction mixture was allowed to return to room temperature. The reaction mixture was filtered, and the filter cake was twice washed with chloroform (15 mL). This gave a dark brown gum (0.38 g) which was purified by flash chromatography over silica (eluent: chloroform/methanol 95:5). This gave a yellow gum (0.0154 g).

LC-MS (Method ZMD) UV Detection: 220 nm; Rₜ=0.18, MS: (M⁺+1)=231

### Preparation of 2-Methoxymethyl-4-methyl-6,7-dihydro-5H-quinolin-8-one

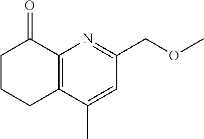

### Step A) Preparation of (4-Methyl-5,6,7,8-tetrahydro-quinolin-2-yl)-methanol

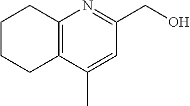

The reactor was charged with a solution of (4-methyl-quinolin-2-yl)-methanol (9 g; 52 mmol) in trifluoroacetic acid (90 mL) and a suspension of platinum (IV) oxide hydrate in trifluoroacetic acid. After 2 h at 22° C./4 bar/H₂ uptake 99%, a NMR control (¹H NMR, CDCl3 after a basic work-up of the sample with aq. NH₃) indicated complete and clean conversion. The catalyst was filtered off, and the solvent was removed in vacuo to give a dark brown oil. Under ice cooling, this oil was diluted with water (35 mL) and the pH was adjusted to pH 14 by careful addition of 8M aqueous NaOH. Extraction was carried out using ethyl acetate (3×100 mL). The combined organic layers were dried over sodium sulphate, filtered and the solvent was removed in vacuo to give a brown gum. The resulting material was purified by chromatography on silica gel to give the title compound (4.4 g) as a beige solid.

LC-MS (ZCQ) UV Detection: 220 nm; Rₜ=0.23, MS: (M⁺+1)=178

TLC: Plates: Merck DC-Plates, silica gel F₂₅₄, saturated atmosphere in developing tank, UV detection, eluent: ethyl acetate; R_{f} of title compound=0.11, R_{f} of the starting material=0.26.

### Step B) Preparation of 2-Methoxymethyl-4-methyl-5,6,7,8-tetrahydro-quinoline

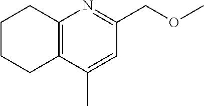

A 25 mL dried single-necked round-bottom flask, under nitrogen, was charged with a solution of (4-methyl-5,6,7,8-tetrahydro-quinolin-2-yl)-methanol (0.5 g; 2.8 mmol) in tetrahydrofuran (3 mL). Sodium hydride (0.123 g; 2.8 mmol) was added portionwise over 2 min. The resulting suspension was stirred at ambient temperature for 45 min. Iodomethane (0.176 mL; 2.8 mmol) was added dropwise. The solution was stirred at ambient temperature for 3 h more. The resulting solution was quenched with water (5 mL) and extraction was carried out using ethyl acetate (2×10 mL). The combined organic layers were dried over sodium sulphate, filtered and the solvent was removed in vacuo to give a yellow oil (0.52 g). This intermediate was used without further purification in the next step.

LC-MS (ZMD): UV Detection: 220 nm; Rₜ=0.48 min. MS: (M⁺+1)=192.

TLC: Plates: Merck DC-Plates, silica gel F₂₅₄, saturated atmosphere in developing tank, UV detection, eluent: heptane/ethyl acetate 1:4 (v:v); R_{f} of title compound=0.28, R_{f} of the starting material=0.13.

### Step C) Preparation of 2-Methoxymethyl-4-methyl-5,6,7,8-tetrahydro-quinoline 1-oxide

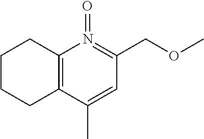

A 25 mL single-necked round-bottom flask, was charged with a solution of 2-methoxymethyl-4-methyl-5,6,7,8-tetrahydro-quinoline (0.58 g; 3.03 mmol) in chloroform (3 mL). Under stirring and cooling with an ice-water cooling bath, 3-chloroperbenzoic acid (1.12 g; 4.54 mmol) was added portionwise over 2 min. The resulting yellow suspension was stirred at 0° C. for 10 min then at ambient temperature for 16 h. Under ice cooling, the suspension was quenched with water and the pH was adjusted to 14 by the addition of aqueous NaOH (4M; 5 mL). Extraction was carried out using chloroform (2×10 mL). The combined organic layers were dried over sodium sulphate, filtered and the solvent was removed in vacuo to give a light yellow solid (0.65 g). This intermediate was used without further purification in the next step.

LC-MS (ZMD): UV Detection: 220 nm; Rₜ=1.31 min. MS: (M⁺+1)=208.

TLC: Plates: Merck DC-Plates, silica gel F₂₅₄, saturated atmosphere in developing tank, UV detection, eluent: heptane/ethyl acetate 1:4 (v:v); R_{f} of title compound=0.02, R_{f} of the starting material=0.28.

### Step D) Preparation of 2-Methoxymethyl-4-methyl-5,6,7,8-tetrahydro-quinolin-8-ol

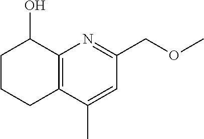

A 25 mL single-necked round-bottom flask, was charged with a solution of 2-methoxymethyl-4-methyl-5,6,7,8-tetrahydro-quinoline 1-oxide (0.65 g; 3.135 mmol) in dichloromethane (3.5 mL). Under stirring and cooling with an ice-water cooling bath trifluoroacetic anhydride (3.54 mL; 25.076 mmol) was added slowly via syringe over 3 min. The resulting yellow solution was stirred at 0° C. for 15 min then ambient temperature for 66 h. Under ice cooling, the pH was adjusted to 14 by the addition of aqueous NaOH solution (8N; 5 mL) over 5 min. The biphasic solution was stirred vigorously at ambient temperature for 4 h. Extraction was carried out using dichloromethane (2×5 mL). The combined organic layers were dried over sodium sulphate, filtered and the solvent was removed in vacuo to give a brown gum (0.53 g). This intermediate was used without further purification in the next step.

LC-MS (ZMD): UV Detection: 220 nm; Rₜ=0.18 min. MS: (M⁺+1)=208.

TLC: Plates: Merck DC-Plates, silica gel F₂₅₄, saturated atmosphere in developing tank, UV detection, eluent: heptane/ethyl acetate 1:4 (v:v); R_{f} of title compound=0.16, R_{f} of the starting material=0.02.

### Step E) Preparation of 2-Methoxymethyl-4-methyl-6,7-dihydro-5H-quinolin-8-one

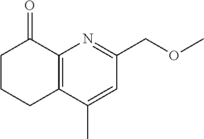

A 25 mL single-necked round-bottom flask, equipped with a condenser, was charged with a solution of 2-methoxymethyl-4-methyl-5,6,7,8-tetrahydro-quinolin-8-ol (0.36 g; 1.737 mmol) in chloroform (2 mL). Under stirring, manganese (IV) oxide (0.604 g; 6.947 mmol) was added and the resulting black suspension was stirred under heating to reflux for 18 hours, after which time TLC indicated that no starting material was remaining. The resulting black suspension was allowed to return to ambient temperature and filtered over hyflo before purification by chromatography on silica gel (eluent: heptane/ethyl acetate 1:2). This gave the title compound (0.168 g) as a light yellow solid.

LC-MS (ZMD): UV Detection: 220 nm; Rₜ=1.12 min. MS: (M⁺+1)=206.

TLC: Plates: Merck DC-Plates, silica gel F₂₅₄, saturated atmosphere in developing tank, UV detection, eluent: heptane/ethyl acetate 1:4 (v:v); R_{f} of title compound=0.09, R_{f} of the starting material=0.16.

¹H NMR (200.131 MHz, CDCl₃) δ₍ₚₚₘ₎. 7.46 (s, 1H), 4.65 (s, 2H), 3.47 (s, 3H), 2.9 (t, 2H), 2.8 (t, 2H), 2.35 (s, 3H), 2.2 (q, 2H).

### Preparation of 4-Ethoxy-6,7-dihydro-5H-quinolin-8-one

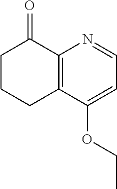

### Step A) Preparation of 4-Ethoxy-5,6,7,8-tetrahydro-quinoline

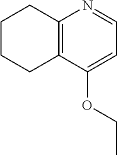

The reactor was charged with a solution of 4-ethoxy-quinoline (1.86 g) in trifluoroacetic acid (17 mL) and a suspension of platinum(IV) oxide hydrate (1.08 g) in trifluoroacetic acid. After 7 h at 22° C./4 bar/H₂ uptake 85%, NMR control (¹H NMR, CDCl₃ after a basic work-up of the sample with aq. NH₃) indicated complete and clean conversion. The catalyst was filtered off and the filtrate was concentrated under reduced pressure. Under ice cooling, 8N aqueous NaOH solution was added to the resulting oil (10 mL, pH=14). Extraction was carried out using dichloromethane (3×30 mL). The combined organic layers were dried over sodium sulphate, filtered and the solvent was removed in vacuo to give a yellow oil (1.52 g). This intermediate was used without further purification in the next step.

LC-MS (ZMD): UV Detection: 220 nm; Rₜ=0.76 min. MS: (M⁺+1)=178.

TLC: Plates: Merck DC-Plates, silica gel F₂₅₄, saturated atmosphere in developing tank,

UV detection, eluent: heptane/ethyl acetate 1:4 (v:v); R_{f} of title compound=0.08, R_{f} of the starting material=0.16.

### Step B) Preparation of 4-Ethoxy-5,6,7,8-tetrahydro-quinoline 1-oxide

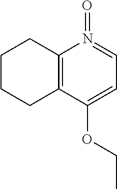

A 50 mL single-necked round-bottom flask, was charged with a solution of 4-ethoxy-5,6,7,8-tetrahydro-quinoline (1.45 g; 8.18 mmol) in chloroform (8 mL). Under stirring and cooling with an ice-water cooling bath, 3-chloroperbenzoic acid (3.03 g; 12.27 mmol) was added portionwise over 2 min. The resulting yellow suspension was stirred at 0° C. for 10 min then at ambient temperature for 19 h. Under ice cooling, the suspension was quenched with water and the pH was adjusted to 14 by the addition of aqueous NaOH (4M; 12 mL). Extraction was carried out using chloroform (2×25 mL). The combined organic layers were dried over sodium sulphate, filtered and the solvent was removed in vacuo to give a yellow oil (1.45 g). This intermediate was used without further purification in the next step.

LC-MS (ZMD): UV Detection: 220 nm; Rₜ=1.24 min. MS: (M⁺+1)=194.

TLC: Plates: Merck DC-Plates, silica gel F₂₅₄, saturated atmosphere in developing tank, UV detection, eluent: dichloromethane/methanol 9:1 (v:v); R_{f} of title compound=0.28, R_{f} of the starting material=0.35.

### Step C) Preparation of 4-Ethoxy-5,6,7,8-tetrahydro-quinolin-8-ol

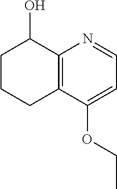

A 5 mL single-necked round-bottom flask was charged with a solution of 4-ethoxy-5,6,7,8-tetrahydro-quinoline 1-oxide (0.1 g; 0.517 mmol) in trifluoroacetic anhydride (0.88 mL). The resulting yellow solution was stirred at reflux for 15 h. The solution was allowed to return to ambient temperature. Under ice cooling, the pH was adjusted to 14 by the addition of aqueous NaOH solution (8N; 2 mL) over 5 min and dichloromethane was then added (2 mL). The biphasic solution was stirred vigorously at ambient temperature for 5 h. As the intermediate product was still observed, methanol was added (3 drops) and the vigorously stirring was continued for 16 h. Extraction was carried out using dichloromethane (2×10 mL). The combined organic layers were dried over sodium sulphate, filtered and the solvent was removed in vacuo to give a yellow solid (61 mg). This intermediate was used without further purification in the next step.

LC-MS (ZMD): UV Detection: 220 nm; Rₜ=0.95 min. MS: (M⁺+1)=194.

TLC: Plates: Merck DC-Plates, silica gel F₂₅₄, saturated atmosphere in developing tank, UV detection, eluent: heptane/ethyl acetate 1:4 (v:v); R_{f} of title compound=0.32, R_{f} of the starting material=0.28.

### Step D) Preparation of 4-Ethoxy-6,7-dihydro-5H-quinolin-8-one

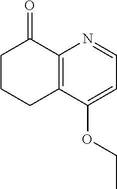

A 25 mL single-necked round-bottom flask, equipped with a condenser, was charged with a solution of 4-ethoxy-5,6,7,8-tetrahydro-quinolin-8-ol (0.193 g; 0.99 mmol) in chloroform (2 mL). Under stirring, manganese (IV) oxide (0.347 g; 3.99 mmol) was added and the resulting black suspension was stirred under heating to reflux for 5 h, after which time TLC indicated that no starting material was remaining. The resulting black suspension was allowed to return to ambient temperature and filtered over hyflo before purification by chromatography on silica gel (eluent: heptane/ethyl acetate 1:2). This gave the title compound (94.9 mg) as a yellow gum.

LC-MS (ZMD): UV Detection: 220 nm; Rₜ=0.41 min. MS: (M⁺+1)=192.

TLC: Plates: Merck DC-Plates, silica gel F₂₅₄, saturated atmosphere in developing tank, UV detection, eluent: heptane/ethyl acetate 1:4 (v:v); R_{f} of title compound=0.11, R_{f} of the starting material=0.02.

¹H NMR (200.131 MHz, CDCl₃) δ₍ₚₚₘ₎: 8.55 (t, 1H), 6.7 (d, 1H), 4.1 (dd, 2H), 2.9 (m, 2H), 2.75 (m, 2H), 2.15 (t, 2H), 1.4 (t, 3H).

### Preparation of 2-Methyl-4-phenyl-6,7-dihydro-5H-quinolin-8-one

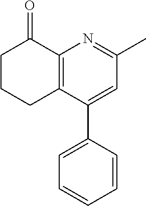 [SMILES: Cc1cc(-c2ccccc2)c2c(n1)C(=O)CCC2]

### Step A) Preparation of 2-Methyl-4-phenyl-5,6,7,8-tetrahydro-quinoline 1-oxide

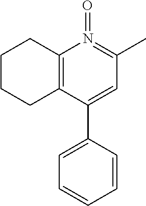 [SMILES: Cc1cc(-c2ccccc2)c2c([n+]1[O-])CCCC2]

A 25 mL single-necked round-bottom flask, was charged with a solution of 2-methyl-4-phenyl-5,6,7,8-tetrahydro-quinoline (0.39 g; 1.76 mmol) in chloroform (2 mL). Under stirring and cooling with an ice-water cooling bath, 3-chloroperbenzoic acid (0.65 g; 2.65 mmol) was added. The resulting light brown suspension was stirred at ambient temperature for 2.5 h. Under ice cooling, the suspension was quenched with water and the pH was adjusted to 14 by the addition of aqueous NaOH (4M; 2 mL). Extraction was carried out using chloroform (3×10 mL). The combined organic layers were washed with brine (8 mL), dried over sodium sulphate, filtered and the solvent was removed in vacuo to give a light yellow oil (0.36 g). This intermediate was used without further purification in the next step.

LC-MS (ZMD): UV Detection: 220 nm; Rₜ=1.56 min. MS: (M⁺+1)=240.

TLC: Plates: Merck DC-Plates, silica gel F₂₅₄, saturated atmosphere in developing tank, UV detection, eluent: heptane/ethyl acetate 1:2 (v:v); R_{f} of title compound=0, R_{f} of the starting material=0.32.

### Step B) Preparation of 2-Methyl-4-phenyl-5,6,7,8-tetrahydro-quinolin-8-ol

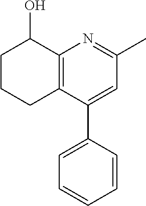 [SMILES: Cc1cc(-c2ccccc2)c2c(n1)C(O)CCC2]

A 25 mL single-necked round-bottom flask was charged with a solution of 2-methyl-4-phenyl-5,6,7,8-tetrahydro-quinoline 1-oxide (0.44 g; 1.85 mmol) in dichloromethane (2 mL). Under stirring and cooling with an ice-water cooling bath, trifluoroacetic anhydride (3.88 mL; 18.51 mmol) was added slowly via a syringe over 2 min. The resulting dark yellow solution was stirred at 0° C. for 15 min then ambient temperature for 2.5 h. Crushed ice was added and the pH was adjusted to 14 using aqueous NaOH (4M; 5 mL). The biphasic solution was stirred vigorously at ambient temperature for 2.5 h. Extraction was carried out using dichloromethane (2×10 mL). The combined organic layers were dried over sodium sulphate, filtered and the solvent was removed in vacuo to give a yellow solid (0.34 g). This intermediate was used without further purification in the next step.

LC-MS (ZMD): UV Detection: 220 nm; Rₜ=0.96 min. MS: (M⁺+1)=240.

TLC: Plates: Merck DC-Plates, silica gel F₂₅₄, saturated atmosphere in developing tank, UV detection, eluent: heptane/ethyl acetate 1:2 (v:v); R_{f} of title compound=0.25, R_{f} of the starting material=0.

### Step C) Preparation of 2-Methyl-4-phenyl-6,7-dihydro-5H-quinolin-8-one

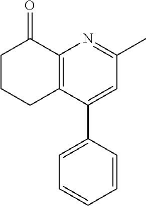 [SMILES: Cc1cc(-c2ccccc2)c2c(n1)C(=O)CCC2]

A 50 mL single-necked round-bottom flask, equipped with a condenser, was charged with a solution of 2-methyl-4-phenyl-5,6,7,8-tetrahydro-quinolin-8-ol (0.34 g; 1.41 mmol) in chloroform (2 mL). Under stirring, manganese (IV) oxide (0.49 g; 5.65 mmol) was added and the resulting black suspension was stirred under heating to reflux for 5 h, after which time TLC indicated that no starting material remained. The resulting black suspension was allowed to return to ambient temperature and filtered over hyflo before purification by chromatography on silica gel (eluent: heptane/ethyl acetate 1:1). This gave the title compound (155 mg) as a yellow-orange gum.

LC-MS (ZMD): UV Detection: 220 nm; Rₜ=1.30 min. MS: (M⁺+1)=238.

TLC: Plates: Merck DC-Plates, silica gel F₂₅₄, saturated atmosphere in developing tank, UV detection, eluent: heptane/ethyl acetate 1:2 (v:v); R_{f} of title compound=0.19, R_{f} of the starting material=0.25.

¹H NMR (200.131 MHz, CDCl₃) δ₍ₚₚₘ₎: 7.45 (m, 3H), 7.3 (d, 2H), 7.2 (s, 1H), 2.85 (m, 2H), 2.8 (m, 2H), 2.65 (s, 3H), 2.05 (t, 2H).

### Preparation of Acetic acid 4-ethoxy-5,6,7,8-tetrahydro-quinolin-8-yl ester

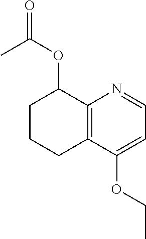 [SMILES: CCOc1ccnc2c1CCCC2OC(C)=O]

A 100 mL single-necked round-bottom flask was charged with a solution of 4-ethoxy-5,6,7,8-tetrahydro-quinoline 1-oxide (1.37 g; 7.089 mmol) in acetic anhydride (12 mL). The resulting yellow solution was stirred at 100° C. for 16 h. Then the solution was allowed to return to ambient temperature. Under ice cooling, the pH was adjusted to 7 by the careful addition of saturated aqueous Na₂CO₃ solution (20 mL). Extraction was carried out using dichloromethane (3×20 mL). The combined organic layers were dried over sodium sulphate, filtered and the solvent was removed in vacuo to give a yellow oil (1.18 g). Purification by flash chromatography over a silica gel cartridge (60 g, 150 mL, 50 mL fractions) of this crude with CH₂Cl₂/MeOH (98:2) gave 0.62 g of the title compound in the form of a yellow oil (85% pure).

LC-MS (ZMD): UV Detection: 220 nm; Rₜ=0.99 min. MS: (M⁺+1)=236, (M⁺+23)=258.

### Preparation of 4-Difluoromethyl-2-methyl-6,7-dihydro-5H-quinolin-8-one

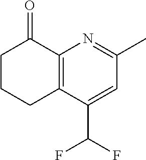

### Step A) preparation of 2-Methyl-5,6,7,8-tetrahydro-quinoline-4-carbaldehyde

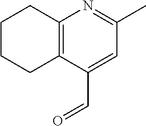

A 50 mL single-necked round-bottom flask, equipped with a condenser, was charged with a suspension of (2-methyl-5,6,7,8-tetrahydro-quinolin-4-yl)-methanol (800 mg; 4.51 mmol) in chloroform (30 mL). Under stirring, manganese (IV) oxide (1.96 g; 22.6 mmol) was added and the resulting black suspension was stirred at reflux for 2 hours, after which time TLC indicated that no starting material remained. The resulting black suspension was allowed to return to ambient temperature and was then filtered over celite and the filter cake was rinsed with chloroform. The solvent was removed in vacuo to give an orange oil (861 mg). This intermediate was used without further purification in the next step.

LC-MS (ZCQ): UV Detection: 220 nm; Rₜ=0.22 min. MS: (M⁺+1)=176.

TLC: Plates: Merck DC-Plates, silica gel F₂₅₄, saturated atmosphere in developing tank, UV detection, eluent: heptane/ethyl acetate 1:2 (v:v); R_{f} of title compound=0.48, R_{f} of the starting material=0.18.

### Step B) preparation of 4-Difluoromethyl-2-methyl-5,6,7,8-tetrahydro-quinoline

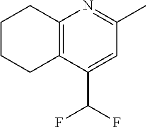

A 50 ml single-necked flask was charged with a solution of 2-methyl-5,6,7,8-tetrahydro-quinoline-4-carbaldehyde (930 mg; 5.3 mmol) in dichloromethane (10 mL). The resulting solution was cooled to −70° C., and then diethylaminosulfur trifluorid (1.7 mL; 13.3 mmol) was added carefully, and the reaction mixture was stirred at −20° C. for 2 hours. Stirring was continued then for 2 hours at ambient temperature, after which time TLC indicated that no starting material remained. The reaction was carefully quenched by the addition of ice and water. The pH was then adjusted to 14 by the addition of a 2M aqueous NaOH solution. Extraction was carried out using dichloromethane (3×20 mL). The combined organic layers were dried over sodium sulphate, filtered and the solvent was removed in vacuo to give a orange oil (816 mg). This intermediate was used without further purification in the next step.

LC-MS (ZCQ): UV Detection: 220 nm; Rₜ=0.52 min. MS: (M⁺+1)=198.

TLC: Plates: Merck DC-Plates, silica gel F₂₅₄, saturated atmosphere in developing tank, UV detection, eluent: heptane/ethyl acetate 1:2 (v:v); R_{f} of title compound=0.49, R_{f} of the starting material=0.41.

### Step C) preparation of 4-Difluoromethyl-2-methyl-5,6,7,8-tetrahydro-quinoline 1-oxide

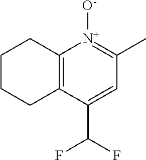

A 25 mL single-necked round-bottom flask, was charged with a solution of 4-difluoromethyl-2-methyl-5,6,7,8-tetrahydro-quinoline (940 mg; 4.77 mmol) in chloroform (6 mL). Under stirring and cooling with an ice-water cooling bath, 3-chloroperbenzoic acid (1.64 g; 9.53 mmol) was added portionwise. The resulting orange-brown solution was stirred at room temperature for 6 hours, at which time analysis of the reaction mixture by TLC indicated that the starting material was consumed. Under cooling with an ice-water cooling bath, the reaction was quenched with water (2 mL) and the pH adjusted to 14 by the addition of a 4M aqueous NaOH solution. Extraction was carried out using chloroform (3×25 mL). The combined organic layers were washed with brine (10 mL) and then dried over sodium sulphate, filtered and the solvent was removed in vacuo to give a light orange wax (1.08 g). This intermediate was used as such for the following step.

LC-MS (ZCQ): UV Detection: 220 nm; Rₜ=1.3 min. MS: (M⁺+1)=214.

TLC: Plates: Merck DC-Plates, silica gel F₂₅₄, saturated atmosphere in developing tank, UV detection, eluent: heptane/ethyl acetate 1:2 (v:v); R_{f} of title compound=0.16; R_{f} of starting material=0.7.

### Step D) Preparation of 4-Difluoromethyl-2-methyl-5,6,7,8-tetrahydro-quinolin-8-ol

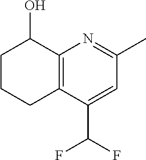

In a round-bottom flask, 4-difluoromethyl-2-methyl-5,6,7,8-tetrahydro-quinoline 1-oxide (1.00 g; 4.69 mmol) was stirred in dichloromethane (10 mL) at room temperature to give an orange solution. The solution was cooled to 0° C. using an ice-water cooling bath. At this temperature, trifluoroacetic acid anhydride (5.3 mL; 37.5 mmol) was added dropwise. The reaction mixture was stirred at 0° C. for 30 minutes and the ice bath was then removed. The reaction mixture was allowed to warm to room temperature and further stirred at that temperature for 3 hours, at which time analysis of the reaction mixture by TLC indicated that the starting material was consumed. The reaction was carefully quenched with water (2 mL) and the pH adjusted to 14 by the addition of an 8M aqueous NaOH solution. The mixture was stirred vigorously at room temperature for 3 hours. Extraction was carried out using dichloromethane (3×25 mL). The organic fractions were pooled and then dried using sodium sulphate, filtered and concentrated under reduced pressure to give a light orange wax. Purification by chromatography on silica gel (eluent: heptane/ethyl acetate 1:1) gave the title compound (377 mg) as a white solid. (M.P.=101-104° C.)

LC-MS (ZCQ): UV Detection: 220 nm; Rₜ=0.83 min. MS: (M⁺+1)=214.

TLC: Plates: Merck DC-Plates, silica gel F₂₅₄, saturated atmosphere in developing tank, UV detection, eluent: heptane/ethyl acetate 1:1 (v:v); R_{f} of title compound=0.33, R_{f} of the starting material=0.05.

### Step E) Preparation of 4-Difluoromethyl-2-methyl-6,7-dihydro-5H-quinolin-8-one

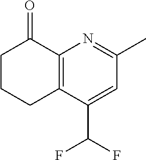

A 50 mL single-necked round-bottom flask, equipped with a condenser, was charged with a suspension of 4-difluoromethyl-2-methyl-5,6,7,8-tetrahydro-quinolin-8-ol (350 mg; 1.64 mmol) in chloroform (5 mL). Under stirring, manganese (IV) oxide (713 mg; 8.2 mmol) was added and the resulting black suspension was stirred at reflux for 24 hours, after which time TLC indicated that most of the starting material was consumed. After the reaction mixture was cooled down to ambient temperature. The resulting black suspension was filtered over celite and the filter cake rinsed with chloroform. The solvent was removed in vacuo to give a brown oil. Purification by chromatography on silica gel (eluent: heptane/ethyl acetate 1:1) gave the title compound (133 mg) as a light yellow oil.

LC-MS (ZCQ): UV Detection: 220 nm; Rₜ=1.21 min. MS: (M⁺+1)=212.

TLC: Plates: Merck DC-Plates, silica gel F₂₅₄, saturated atmosphere in developing tank, UV detection, eluent: heptane/ethyl acetate 1:1 (v:v); R_{f} of title compound=0.13, R_{f} of the starting material=0.42.

### Preparation of 2-Methyl-6,7-dihydro-5H-quinolin-8-one O-(3-aminooxy-propyl)-E-oxime

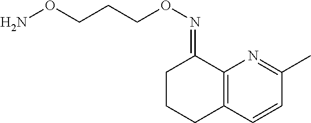 [SMILES: Cc1ccc2c(n1)/C(=N/OCCCON)CCC2]

A solution of hydroxylamine-O-[3-(aminooxy)-propyl] (1.74 g; 16.39 mmol) in absolute ethanol (75 mL) was charged to a 250 mL single-necked round-bottomed flask equipped with a dropping funnel which had previously been placed under an atmosphere of argon. Under stirring, para-toluenesulfphonic acid (0.16 g; 0.820 mmol) was added, followed by the dropwise addition of 2-methyl-6,7-dihydro-5H-quinolin-8-one (1.32 g; 8.197 mmol) dissolved in absolute ethanol (5 mL). The resulting yellow solution was stirred at room temperature for 45 minutes. Following the course of the reaction by TLC indicated that no starting materials were left at this point in time. The ethanol was removed in vacuo. Water (10 mL) was then added and the pH was adjusted to 14 by the addition of a 2M aqueous NaOH solution (5 mL). Extraction was carried out using ethyl acetate (2×30 mL). The combined organic layers were dried over sodium sulphate, filtered and the solvent was removed in vacuo to give a yellow gum (2.08 g).

LC-MS (Method ZMD): UV Detection: 220 nm; Rₜ=0.45 min, MS: (M⁺+1)=250

TLC: Plates: Merck DC-Plates, silica gel F254, saturated atmosphere in developing tank, UV detection, eluent: dichloromethane/methanol 95:5 (v:v); R_{f} of title compound=0.21, R_{f} of the starting material=0.42.

### Preparation of 2-Methyl-6,7-dihydro-5H-quinolin-8-one O-(3-(tert)butoxycarbonyl) aminooxy-propyl)-E-oxime

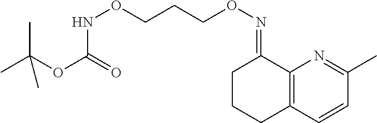 [SMILES: Cc1ccc2c(n1)/C(=N/OCCCONC(=O)OC(C)(C)C)CCC2]

In a 100 mL single-necked round-bottomed flask equipped with a dropping funnel, the previous crude 2-methyl-6,7-dihydro-5H-quinolin-8-one O-(3-aminooxy-propyl)-E-oxime (2.08 g) was dissolved in dichloromethane (10 mL). This solution was cooled down to 0° C. with an ice water cooling bath. Triethylamine (1.16 mL; 8.34 mmol) was slowly added by syringe followed by the dropwise addition of a solution of di-tert-butyl dicarbonate (1.82 g; 8.34 mmol) in dichloromethane (5 mL). The ice bath was removed and the mixture allowed to come back to room temperature. The reaction was then stirred at this temperature for 4 hours. Afterwards, the reaction was quenched by the addition of a saturated sodium bicarbonate solution (10 mL). Extraction was carried out using dichloromethane (2×25 mL) and the combined organic layers were washed with brine (10 mL), dried over sodium sulphate, filtered and concentrated under reduced pressure to give a yellow oil (3.31 g). Purification by flash chromatography over silica gel (eluent: tert-butylmethylether/cyclohexane 9:1+0.5% triethylamine) gave the title compound as a light yellow oil (2.56 g).

LC-MS (Method ZMD): UV Detection: 220 nm; Rₜ=1.22 min, MS: (M⁺+1)=350

TLC: Plates: Merck DC-Plates, silica gel F254, saturated atmosphere in developing tank, UV detection, eluent: tert-butylmethylether/cyclohexane 9:1+0.5% triethylamine; R_{f} of title compound=0.35, R_{f} of the starting material=0.07.

### Preparation of 2-Methyl-6,7-dihydro-5H-quinolin-8-one O-(3-aminooxy-propyl)-E-oxime

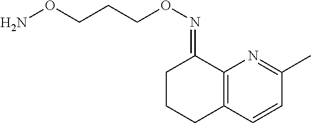 [SMILES: Cc1ccc2c(n1)/C(=N/OCCCON)CCC2]

A 50 mL single-necked round-bottomed flask, under Ar, was charged with a solution of 2-methyl-6,7-dihydro-5H-quinolin-8-one O-(3-(tert)butoxycarbonyl) aminooxy-propyl)-E-oxime (2.46 g; 7.04 mmol) in dichloromethane (5.44 mL). The resulting solution was cooled to 0° C. with an ice bath. Trifluoroacetic acid (5.23 mL; 70.4 mmol) was slowly added by syringe then the ice water cooling bath was removed and the light yellow solution allowed to come back to room temperature and stirred at this temperature for 3 hours. Following the course of the reaction by TLC indicated that no starting material remained. Under ice-cooling, the solution was quenched with water (5 mL) and the pH was adjusted to 14 by the addition of a 4M aqueous NaOH solution (15 mL). Extraction was carried out using dichloromethane (2×40 mL). The organic fractions were dried over sodium sulphate and the solvent removed in vacuo to give the title compound as a light yellow gum (1.35 g).

LC-MS (Method ZMD): UV Detection: 220 nm; Rₜ=0.38 min, MS: (M⁺+1)=250

TLC: Plates: Merck DC-Plates, silica gel F254, saturated atmosphere in developing tank, UV detection, eluent: tert-butylmethylether/cyclohexane 9:1+0.5% triethylamine; R_{f} of title compound=0.07, R_{f} of the starting material=0.35.

### Preparation of Hydroxylamine-O-[3-(aminooxy)-2-fluoropropyl]

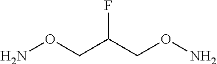

### Step A) Preparation of 2,2′-[(2-Hydroxy-1,3-propanediyl)bis(oxy)]bis-1H-isoindole-1,3(2H)-dione

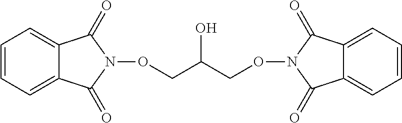 [SMILES: O=C1c2ccccc2C(=O)N1OCC(O)CON1C(=O)c2ccccc2C1=O]

A 1.5 L reactor, under nitrogen, was charged with a solution of n-hydroxyphtalimide (94 g; 0.575 mol) and sodium acetate (57 g; 0.69 mol) in dimethylformamide (600 mL). The mixture was stirred at ambient temperature for 40 minutes, then 1,3-dibromo-2-propanol (24 mL; 0.23 mol) was added and the resulting thick brown suspension was stirred first at 60° C. for 12 hours then at ambient temperature for 18 hours. The solvent was removed under reduced pressure (high vacuum, oil bath at 50° C.). The residue was redissolved in ethyl acetate (400 mL) and washed with an aqueous sodium bicarbonate solution until the red colour of the organic layer disappeared. The organic layer was then dried over sodium sulphate, filtered and the solvent removed in vacuo. Hot ethanol (400 mL) was added slowly to this residue to obtain a light yellow solution. Upon lowering the temperature slowly, crystallization could be induced. The crystalline material was collected on a filter, washed with cold ethanol and then dried in an oven at 40° C. to give the title compound as a white powder (6.8 g).

LC-MS (ZCQ): UV Detection: 220 nm; Rₜ=1.47 min. MS: (M⁺+1)=383.

TLC: Plates: Merck DC-Plates, silica gel F₂₅₄, saturated atmosphere in developing tank, UV detection, eluent: heptane/ethyl acetate 1:2 (v:v); R_{f} of title compound=0.62, R_{f} of the starting material=0.2.

### Step B) Preparation of 2,2′-[(2-Fluoro-1,3-propanediyl)bis(oxy)]bis-1H-isoindole-1,3(2H)-dione

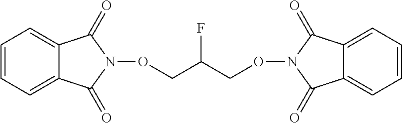 [SMILES: O=C1c2ccccc2C(=O)N1OCC(F)CON1C(=O)c2ccccc2C1=O]

A 100 ml flask was charged with a solution 2,2′-[(2-hydroxy-1,3-propanediyl)bis(oxy)]bis-1H-isoindole-1,3(2H)-dione (4.00 g; 10.46 mmol) in dichloromethane (35 mL) which was cooled at −70° C. Diethylaminosulfur trifluorid (2.05 mL; 15.7 mmol) was added slowly. The resulting light-yellow solution was stirred for 2 hours at −20° C., then for 2 hours at room temperature. Analysis of an aliquot of the reaction mixture by TLC indicated that still a substantial amount of starting material was present. After cooling down to −70° C., a further portion of diethylaminosulfur trifluorid (2.7 mL; 20.9 mmol) was added. The reaction was then stirred at ambient temperature until all the starting material was consumed (TLC). The mixture was then carefully quenched with ice and water, and the pH was adjusted to 14 by the addition of a 2M aqueous NaOH solution. Extraction was carried out using dichloromethane (3×100 mL). The solvent was removed in vacuo to give a beige solid. Purification by chromatography on silica gel (eluent: heptane/ethyl acetate 1:2) gave the title compound (1.52 g) as a white powder.

LC-MS (ZCQ): UV Detection: 220 nm; Rₜ=1.60 min. MS: (M⁺+1)=385.

TLC: Plates: Merck DC-Plates, silica gel F₂₅₄, saturated atmosphere in developing tank, UV detection, eluent: heptane/ethyl acetate 1:2 (v:v); R_{f} of title compound=0.51, R_{f} of the starting material=0.42.

### Step C) Preparation of Hydroxylamine-O-[3-(aminooxy)-2-fluoropropyl]

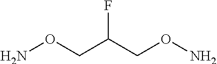

A 50 mL flask was charged with a solution 2,2′-[(2-fluoro-1,3-propanediyl)bis(oxy)]bis-1H-isoindole-1,3(2H)-dione (1.50 g; 3.9 mmol) in ethanol (8 mL). Hydrazine monohydrate (0.38 mL; 7.8 mmol) was then added slowly. The resulting mixture was stirred at reflux for 2 hours. Following the course of the reaction by LC-MS indicated that no starting material remained at this point in time. The mixture was allowed to come back to ambient temperature. The white precipitate thus obtained was filtered and the filtrate was concentrated in vacuo to give a beige solid. The crude solid was dissolved in a minimal amount of a 2M aqueous HCl solution (pH of the water phase was 1). An extraction was done using ethyl acetate. Afterwards, an excess of a 4M aqueous NaOH solution was added (pH 14), and extraction was carried out using tetrahydrofuran. The solvent was removed in vacuo to give a beige wax (290 mg).

LC-MS (ZCQ): UV Detection: 220 nm; Rₜ=0.19 min. MS: (M⁺+1)=125.

### Preparation of 2,3,5,6,7,8-Hexahydro-1H-acridin-4-one

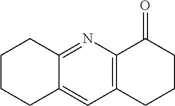 [SMILES: O=C1CCCc2cc3c(nc21)CCCC3]

### Step A) Preparation of 1,2,3,4,5,6,7,8-Octahydro-acridine 10-oxide

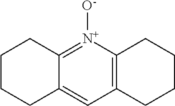 [SMILES: [O-][n+]1c2c(cc3c1CCCC3)CCCC2]

A 100 mL flask, was charged with a solution of 1,2,3,4,5,6,7,8-octahydroacrydine (5.00 g; 26.7 mmol) in chloroform (28 mL). Under stirring and cooling with an ice-water cooling bath, 3-chloroperbenzoic acid (8.97 g; 40.04 mmol) was added portionwise. The resulting yellow suspension was stirred at room temperature for 3 hours, at which time analysis of the reaction mixture by TLC indicated that the starting material was consumed. The reaction mixture was carefully poured onto ice and water and the pH was adjusted to pH 12 by the addition of a 4M aqueous NaOH solution (10 mL). The resulting solution was extracted using dichloromethane (2×30 mL). The combined organic layers were washed with brine then dried over sodium sulphate, filtered and the solvent was removed in vacuo to give the title compound (6.07 g). This intermediate was used as such in the following step.

TLC: Plates: Merck DC-Plates, silica gel F₂₅₄, saturated atmosphere in developing tank, UV detection, eluent: ethyl acetate; R_{f} of title compound=0.13; R_{f} of starting material=0.53.

### Step B) Preparation of 1,2,3,4,5,6,7,8-Octahydro-acridin-4-ol

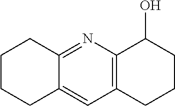 [SMILES: OC1CCCc2cc3c(nc21)CCCC3]

In a 200 mL flask, 1,2,3,4,5,6,7,8-octahydro-acridine 10-oxide (5.32 g; 26.17 mmol) was stirred in dichloromethane (35 mL) at room temperature to give a red-brown solution. The solution was cooled to 0° C. using an ice water cooling bath. At this temperature, trifluoroacetic acid anhydride (5.6 mL; 39.25 mmol) was added dropwise. The reaction mixture was stirred at 0° C. for 30 minutes and the cooling bath was then removed. The reaction mixture was further stirred at room temperature for 4 hours, at which time analysis of the reaction mixture by TLC indicated that the starting material was consumed. The reaction was then carefully quenched by the addition of water and ice, and, the PH was adjusted to 12 by the addition of a 2M aqueous NaOH solution (30 mL). The mixture was stirred vigorously at room temperature for 16 hours. After phase separation, the water phase was further extracted using dichloromethane. The organic fractions were dried using sodium sulphate, filtered and concentrated under reduced pressure to give a yellow solid. This intermediate was used as such for the following step.

LC-MS (ZMD): UV Detection: 220 nm; Rₜ=0.44 min. MS: (M⁺+1)=204.

TLC: Plates: Merck DC-Plates, silica gel F₂₅₄, saturated atmosphere in developing tank, UV detection, eluent: ethyl acetate; R_{f} of title compound=0.68, R_{f} of the starting material=0.18.

### Step C) Preparation of 2,3,5,6,7,8-Hexahydro-1H-acridin-4-one

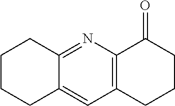 [SMILES: O=C1CCCc2cc3c(nc21)CCCC3]

A 100 mL single-necked round-bottom flask, equipped with a condenser, was charged with a solution of 1,2,3,4,5,6,7,8-octahydro-acridin-4-ol (3.02 g; 14.86 mmol) in chloroform (34 mL). Under stirring, manganese (IV) oxide (5.16 g; 59.42 mmol) was added and the resulting black suspension was stirred at reflux for 3 hours, after which time TLC indicated that no starting material remained. The reaction mixture was allowed to come back to ambient temperature. The resulting black suspension was filtered over celite which was rinsed with dichloromethane. From the combined organic phases, the solvent was removed in vacuo. Purification by chromatography on silica gel (eluent: cyclohexane/ethyl acetate 9:1) gave the title compound (2.55 g) as a light yellow oil.

LC-MS (ZMD): UV Detection: 220 nm; Rₜ=0.95 min. MS: (M⁺+1)=202.

TLC: Plates: Merck DC-Plates, silica gel F₂₅₄, saturated atmosphere in developing tank, UV detection, eluent: cyclohexane/ethyl acetate 1:1 (v:v); R_{f} of title compound=0.15, R_{f} of the starting material=0.35.

### Preparation of 11-Methyl-7,8,9,10-tetrahydro-cyclohepta[b]quinolin-6-one

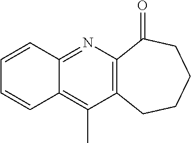 [SMILES: Cc1c2c(nc3ccccc13)C(=O)CCCC2]

### Step A) Preparation of 11-Methyl-7,8,9,10-tetrahydro-6H-cyclohepta[b]quinoline

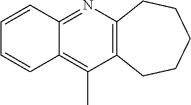 [SMILES: Cc1c2c(nc3ccccc13)CCCCC2]

A 100 mL flask was charged with 2-aminoacetophenon (10 g; 74 mmol). Cycloheptanone (9.6 g; 81.4 mmol) was added. To this brown solution was added citric acid (3.4 g; 37 mmol). The reaction mixture was heated at 100° C. for 48 hours. Following the course of the reaction by LC-MS indicated that no 2-aminoacetophenon remained. The reaction mixture was allowed to come back to ambient temperature. It was then poured onto water whereupon a precipitation was observed. The precipitate was filtered. The material was then redisssolved in diethylether followed by the evaporation of the solvent in vacuo to obtain brown crystals (15.6 g). This intermediate was used as such for the following step.

LC-MS (ZMD): UV Detection: 220 nm; Rₜ=0.99 min. MS: (M⁺+1)=212.

### Step B) 11-Methyl-7,8,9,10-tetrahydro-6H-cyclohepta[b]quinoline 5-oxide

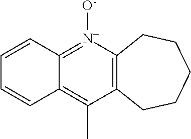 [SMILES: Cc1c2c([n+]([O-])c3ccccc13)CCCCC2]

A 250 mL flask was charged with a solution of 11-Methyl-7,8,9,10-tetrahydro-6H-cyclohepta[b]quinoline (10.00 g; 47.3 mmol) in chloroform (40 mL). Under stirring and cooling with an ice-water cooling bath, 3-chloroperbenzoic acid (17.6 g; 71 mmol) was added portionwise. The resulting brown solution was stirred at room temperature for 3 hours, at which time analysis of the reaction mixture by TLC indicated that the starting material was consumed. The reaction mixture was carefully poured onto ice and water and the pH was adjusted to 10 by the addition of a 2N aqueous NaOH solution (50 mL). Extraction was carried out using dichloromethane. The combined organic layers were washed with brine then dried over sodium sulphate, filtered and the solvent was removed in vacuo to give the title compound as a brown oil (10.90 g). This intermediate was used as such for the following step.

LC-MS (ZMD): UV Detection: 220 nm; Rₜ=1.55 min. MS: (M⁺+1)=228.

TLC: Plates: Merck DC-Plates, silica gel F₂₅₄, saturated atmosphere in developing tank, UV detection, eluent: cyclohexane/ethyl acetate 1:9 (v:v); R_{f} of title compound=0.33, R_{f} of the starting material=0.79.

### Step C) Preparation of 11-Methyl-7,8,9,10-tetrahydro-6H-cyclohepta[b]quinolin-6-ol

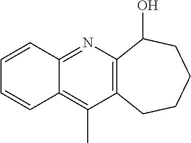 [SMILES: Cc1c2c(nc3ccccc13)C(O)CCCC2]

In a 200 mL flask, 11-Methyl-7,8,9,10-tetrahydro-6H-cyclohepta[b]quinoline 5-oxide (9.0 g; 39.6 mmol) was stirred in dichloromethane (80 mL) at room temperature to give a brown solution. The solution was cooled to 0° C. using an ice-water cooling bath. Trifluoroacetic acid anhydride (8.4 mL; 59.4 mmol) was added dropwise. The reaction mixture was stirred at 0° C. for 30 minutes and the cooling bath was then removed. The reaction mixture was stirred at that temperature for 2 hours, at which time analysis of the reaction mixture by TLC indicated that the starting material was consumed. The reaction was then carefully quenched with water and ice and the pH adjusted to 12 by the addition of a 2M aqueous NaOH solution (60 mL). The mixture was then vigorously stirred at room temperature for 16 hours. Extraction was carried out using dichloromethane. The organic fractions were washed with brine, dried over sodium sulphate, filtered and concentrated under reduced pressure to give a brown oil. Purification by chromatography on silica gel (eluent: cyclohexane/ethyl acetate 9:1) gave the title compound (2.18 g) as a brown-red solid.

LC-MS (ZMD): UV Detection: 220 nm; Rₜ=0.41 min. MS: (M⁺+1)=228.

### Step D) Preparation of 11-Methyl-7,8,9,10-tetrahydro-cyclohepta[b]quinolin-6-one

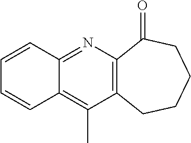 [SMILES: Cc1c2c(nc3ccccc13)C(=O)CCCC2]

A 50 mL single-necked round-bottom flask, equipped with a condenser, was charged with a solution of 11-Methyl-7,8,9,10-tetrahydro-6H-cyclohepta[b]quinolin-6-ol (1.9 g; 8.4 mmol) in chloroform (20 mL). Under stirring, manganese (IV) oxide (2.9 g; 33.6 mmol) was added and the resulting black suspension was stirred at reflux for 16 hours, after which time TLC indicated that no starting material remained. The reaction mixture was allowed to come back to ambient temperature. The resulting black suspension was filtered over celite ad the filter cake rinsed with dichloromethane. The solvent was removed in vacuo. Purification by chromatography on silica gel (eluent: cyclohexane/ethyl acetate 7:3) gave the title compound (930 mg) as a yellow oil.

LC-MS (ZMD): UV Detection: 220 nm; Rₜ=1.55 min. MS: (M⁺+1)=226.

TABLE 26
Physical data of compounds of formula (I):

| | | RT (mins) | |
|---|---|---|---|
| Compound | Structure | (method) | Molecular ion |
| P.01 | 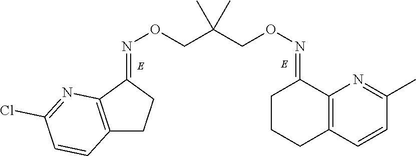 [SMILES: Cc1ccc2c(n1)/C(=N/OCC(C)(C)CO/N=C1\CCc3ccc(Cl)nc31)CCC2] | 1.52 (ZCQ) | 427 ([M + 1]⁺) 449 ([M + 23]⁺) |
| P.02 | 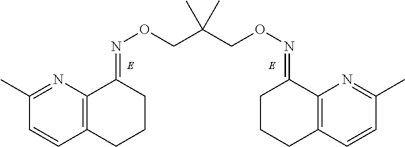 | 1.20 (ZMD) | 421 ([M + 1]⁺) 211 ([M + 2]²⁺) 443 ([M + 23]⁺) |
| P.03 | 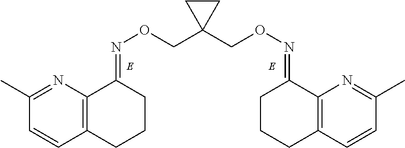 | 1.10 (ZMD) | 419 ([M + 1]⁺) 210 ([M + 2]²⁺) |
| P.04 | 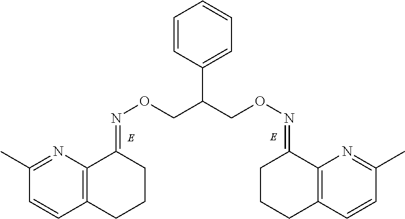 | 1.27 (ZCQ) | 469 ([M + 1]⁺) 235 ([M + 2]²⁺) |
| P.05 | 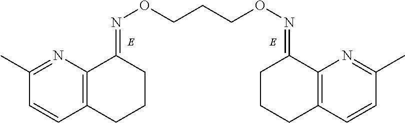 | 1.06 (ZMD) | 393 ([M + 1]⁺) 197 ([M + 2]²⁺) 415 ([M + 23]⁺) |
| P.06 | 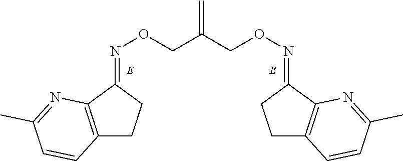 | 1.60 (ZMD) | 377 ([M + 1]⁺) 189 ([M + 2]²⁺) 399 ([M + 23]⁺) |
| P.07 | 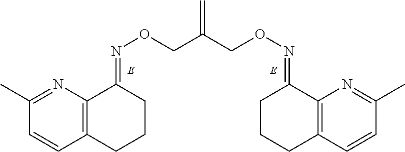 | 1.10 (ZCQ) | 405 ([M + 1]⁺) 203 ([M + 2]²⁺) 427 ([M + 23]⁺) |
| P.08 | 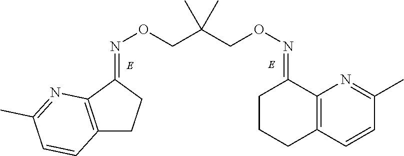 | 1.38 (ZCQ) | 407 ([M + 1]⁺) 204 ([M + 2]²⁺) |
| P.09 | 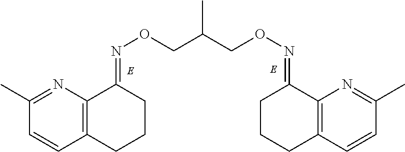 | 1.14 (ZMD) | 407 ([M + 1]⁺) 204 ([M + 2]²⁺) |
| P.10 | 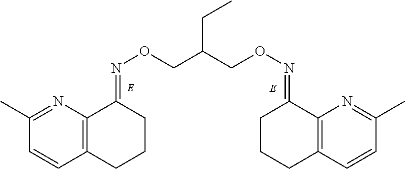 | 1.21 (ZMD) | 421 ([M + 1]⁺) 211 ([M + 2]²⁺) |
| P.11 | 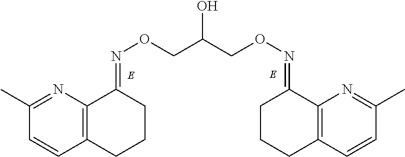 | 0.95 (ZMD) | 409 ([M + 1]⁺) 205 ([M + 2]²⁺) 431 ([M + 23]⁺) |
| P.12 | 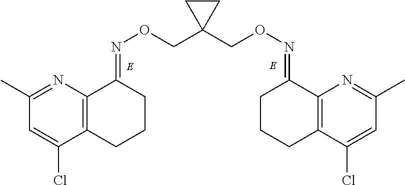 | 2.09 (ZMD) | 487 ([M + 1]⁺) 244 ([M + 2]²⁺) 509 ([M + 23]⁺) |
| P.13 | 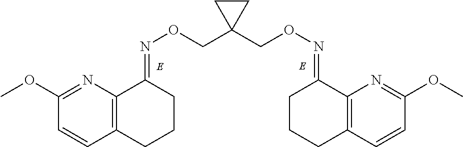 | 2.11 (ZMD) | 451 ([M + 1]⁺) 226 ([M + 2]²⁺) 473 ([M + 23]⁺) |
| P.14 | 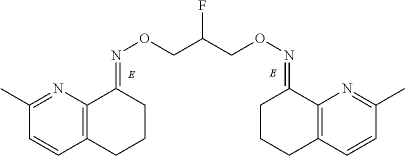 | 1.09 (ZMD) | 411 ([M + 1]⁺) 433 ([M + 2]²⁺) 206 ([M + 23]⁺) |
| P.15 | 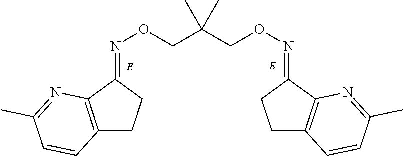 | 1.74 (ZCQ) | 393 ([M + 1]⁺) 197 ([M + 2]²⁺) 415 ([M + 23]⁺) |
| P.16 | 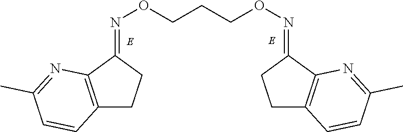 | 1.52 (ZCQ) | 365 ([M + 1]⁺) 138 ([M + 2]²⁺) 399 ([M + 23]⁺) |
| P.17 | 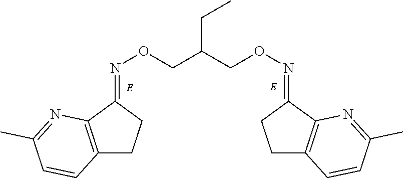 | 1.74 (ZCQ) | 393 ([M + 1]⁺) 197 ([M + 2]²⁺) 415 ([M + 23]⁺) |
| P.18 | 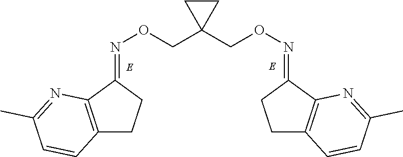 | 1.57 (ZCQ) | 391 ([M + 1]⁺) 196 ([M + 2]²⁺) 413 ([M + 23]⁺) |
| P.19 | 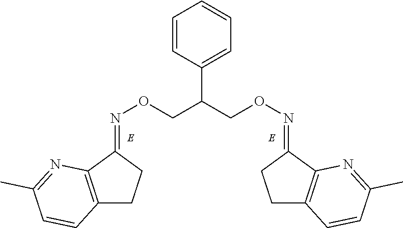 | 1.83 (ZCQ) | 441 ([M + 1]⁺) 221 ([M + 2]²⁺) |
| P.20 | 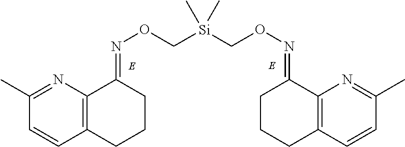 | 1.24 (ZCQ) | 437 ([M + 1]⁺) 459 ([M + 23]⁺) |
| P.21 | 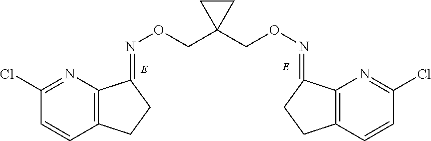 [SMILES: Clc1ccc2c(n1)/C(=N/OCC1(CO/N=C3\CCc4ccc(Cl)nc43)CC1)CC2] | | Melting point = 170-173° C. |
| P.22 | 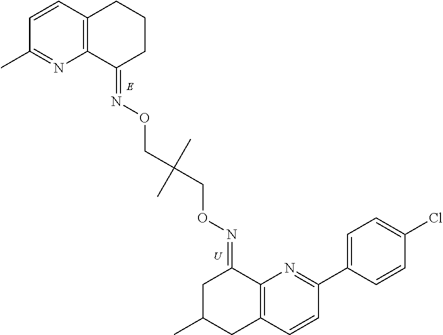 | 1.83 (U-LC) | 531.56 ([M + 1]⁺) |
| P.23 | 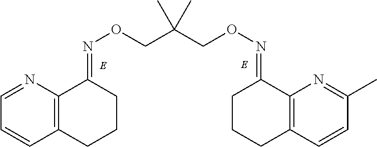 [SMILES: Cc1ccc2c(n1)/C(=N/OCC(C)(C)CO/N=C1\CCCc3cccnc31)CCC2] | 1.26 (ZMD) | 407 ([M + 1]⁺) 429 ([M + 23]⁺) |
| P.24 | 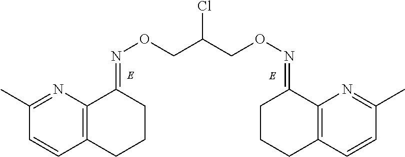 | 1.23 (ZCQ) | 427 ([M + 1]⁺) 449 ([M + 23]⁺) |
| P.25 | 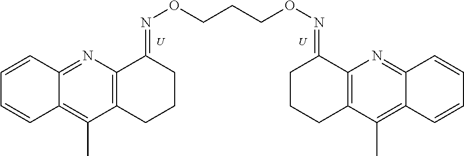 | 1.45 (ZMD) | 493 ([M + 1]⁺) 515 ([M + 23]⁺) |
| P.26 | 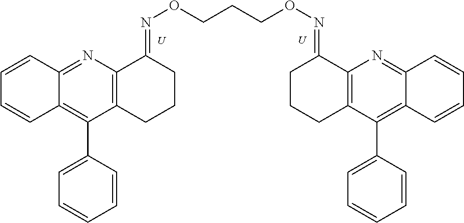 | 2.29 (ZMD) | 617 ([M + 1]⁺) 639 ([M + 23]⁺) Melting point = 205-210° C. |
| P.27 | 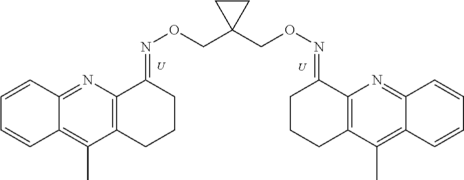 | 1.47 (ZMD) | 519 ([M + 1]⁺) 541 ([M + 23]⁺) |
| P.28 | 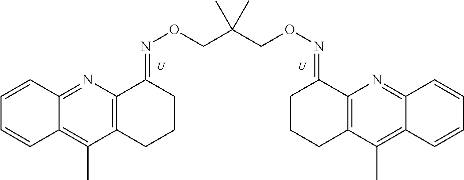 | 1.76 (ZCQ) | 521 ([M + 1]⁺) 543 ([M + 23]⁺) |
| P.29 | 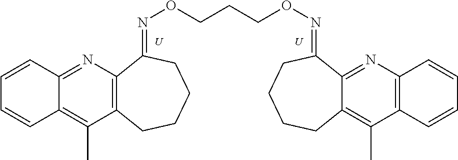 | 2.01 (ZMD) | 521 ([M + 1]⁺) 543 ([M + 23]⁺) |
| P.30 | 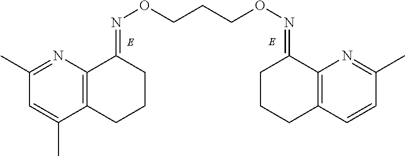 | 1.04 (ZCQ) | 407 ([M + 1]⁺) |
| P.31 | 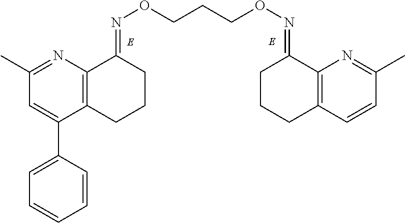 | 1.30 (ZMD) | 469 ([M + 1]⁺) |
| P.32 | 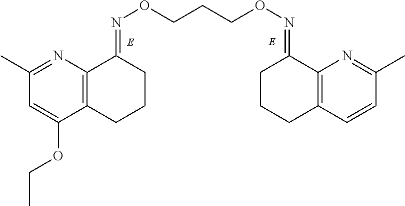 | 1.17 (ZMD) | 437 ([M + 1]⁺) |
| P.33 | 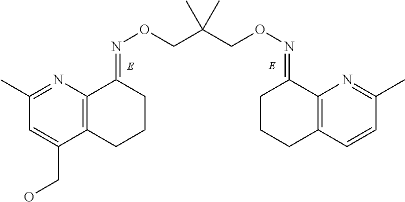 | 1.06 (ZCQ) | 437 ([M + 1]⁺) Melting point = 61-64° C. |
| P.34 | 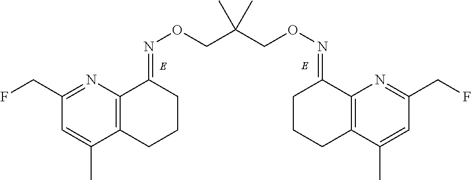 [SMILES: Cc1cc(CF)nc2c1CCC/C2=N\OCC(C)(C)CO/N=C1\CCCc2c(C)cc(CF)nc21] | 1.94 (ZCQ) | 485 ([M + 1]⁺) |
| P.35 | 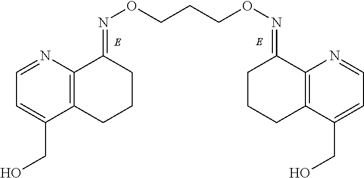 [SMILES: OCc1ccnc2c1CCC/C2=N\OCCCO/N=C1\CCCc2c(CO)ccnc21] | 0.99 (ZMD) | 425 ([M + 1]⁺) |
| P.36 | 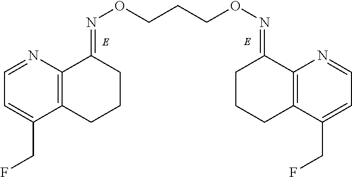 [SMILES: FCc1ccnc2c1CCC/C2=N\OCCCO/N=C1\CCCc2c(CF)ccnc21] | 1.29 (ZMD) | 429 ([M + 1]⁺) 451 ([M + 23]⁺) |
| P.37 | 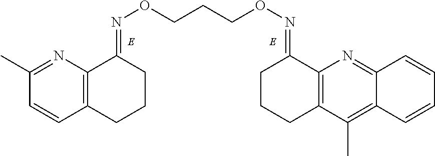 [SMILES: Cc1ccc2c(n1)/C(=N/OCCCO/N=C1\CCCc3c1nc1ccccc1c3C)CCC2] | 1.25 (ZMD) | 443 ([M + 1]⁺) |
| P.38 | 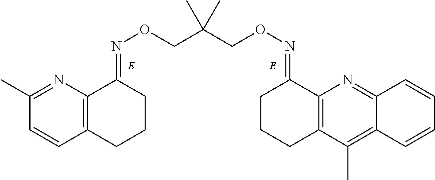 [SMILES: Cc1ccc2c(n1)/C(=N/OCC(C)(C)CO/N=C1\CCCc3c1nc1ccccc1c3C)CCC2] | 1.33 (ZMD) | 471 ([M + 1]⁺) |
| P.39 | 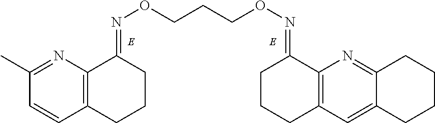 [SMILES: Cc1ccc2c(n1)/C(=N/OCCCO/N=C1\CCCc3cc4c(nc31)CCCC4)CCC2] | 1.15 (ZMD) | 433 ([M + 1]⁺) |
| P.40 | 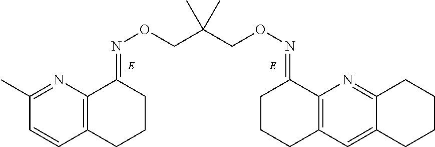 [SMILES: Cc1ccc2c(n1)/C(=N/OCC(C)(C)CO/N=C1\CCCc3cc4c(nc31)CCCC4)CCC2] | 1.25 (ZMD) | 461 ([M + 1]⁺) |
| P.41 | 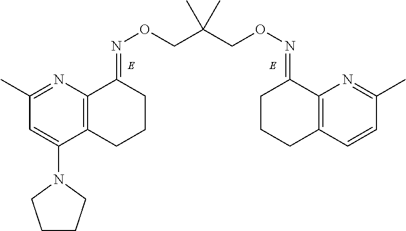 | 1.23 (ZMD) | 490 ([M + 1]⁺) |
| P.42 | 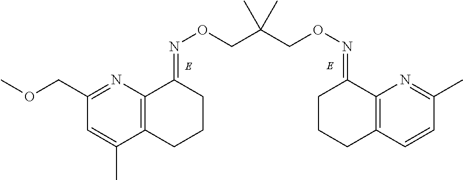 | 1.38 (ZMD) | 465 ([M + 1]⁺) 487 ([M + 23]⁺) |
| P.43 | 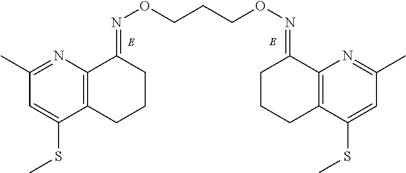 | 1.14 (ZMD) | 485 ([M + 1]⁺) 507 ([M + 23]⁺) |
| P.44 | 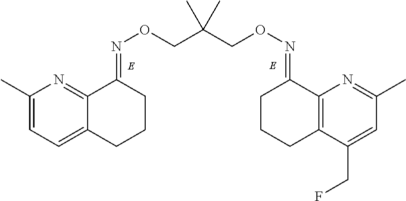 | 1.25 (ZCQ) | 453 ([M + 1]⁺) |
| P.45 | 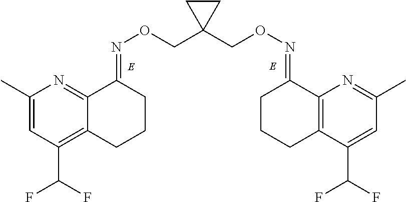 | 1.86 (ZCQ) | 519 ([M + 1]⁺) 541 ([M + 23]⁺) |
| P.46 | 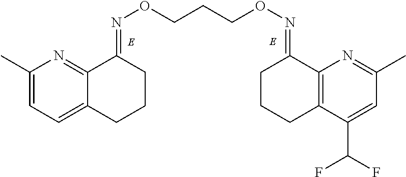 | 1.38 (ZCQ) | 443 ([M + 1]⁺) |
| P.47 | 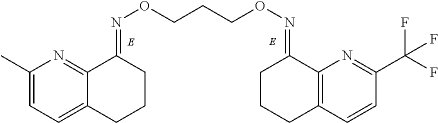 [SMILES: Cc1ccc2c(n1)/C(=N/OCCCO/N=C1\CCCc3ccc(C(F)(F)F)nc31)CCC2] | 1.43 (ZCQ) | 447 ([M + 1]⁺) |
| P.48 | 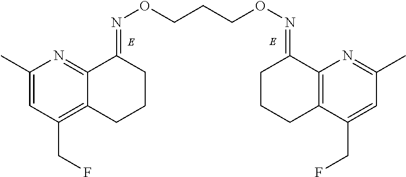 | 1.23 (ZCQ) | 457 ([M + 1]⁺) |
| P.49 | 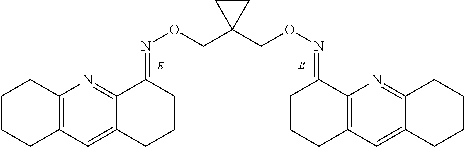 [SMILES: c1c2c(nc3c1CCC/C3=N\OCC1(CO/N=C3\CCCc4cc5c(nc43)CCCC5)CC1)CCCC2] | 1.25 (ZMD) | 499 ([M + 1]⁺) |
| P.50 | 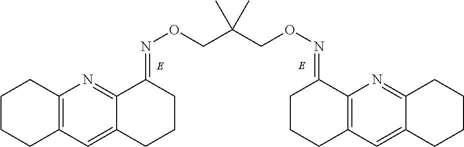 [SMILES: CC(C)(CO/N=C1\CCCc2cc3c(nc21)CCCC3)CO/N=C1\CCCc2cc3c(nc21)CCCC3] | 1.31 (ZMD) | 501 ([M + 1]⁺) |
| P.51 | 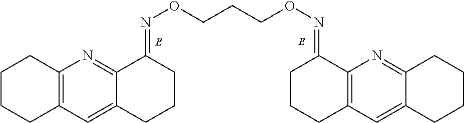 [SMILES: c1c2c(nc3c1CCC/C3=N\OCCCO/N=C1\CCCc3cc4c(nc31)CCCC4)CCCC2] | 1.22 (ZMD) | 473 ([M + 1]⁺) |

A “U” designation in respect of the compounds in Table 26 means that the isolated compound was a mixture of both the E and Z isomers
or an uncharacterised single isomer.

TABLE 27
Physical data of intermediates

| | | RT (mins) | |
|---|---|---|---|
| Compound | Structure | (method) | Molecular ion |
| I.01 | 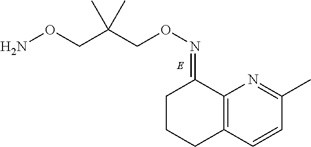 [SMILES: Cc1ccc2c(n1)/C(=N/OCC(C)(C)CON)CCC2] | 0.83 (ZCQ) | 278 ([M + 1]⁺) 300 ([M + 23]⁺) |
| I.02 | 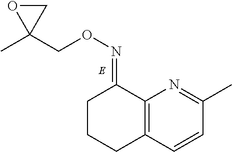 | 1.21 (ZCQ) | 221 ([M + 1]⁺) 243 ([M + 23]⁺) |
| I.03 | 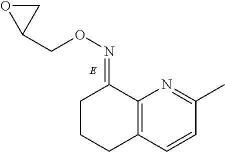 [SMILES: Cc1ccc2c(n1)/C(=N/OCC1CO1)CCC2] | 0.78 (ZMD) | 233 ([M + 1]⁺) 255 ([M + 23]⁺) |
| I.04 | 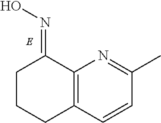 | 0.20 (ZMD) | 177 ([M + 1]⁺) 199 ([M + 23]⁺) |
| I.05 | 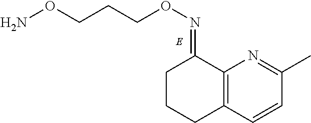 [SMILES: Cc1ccc2c(n1)/C(=N/OCCCON)CCC2] | 0.38 (ZMD) | 250 ([M + 1]+) |
| I.06 | 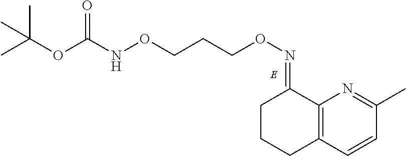 [SMILES: Cc1ccc2c(n1)/C(=N/OCCCONC(=O)OC(C)(C)C)CCC2] | 1.22 (ZMD) | 350 ([M + 1]+) |
| I.07 | 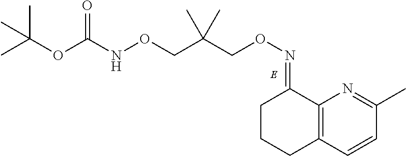 [SMILES: Cc1ccc2c(n1)/C(=N/OCC(C)(C)CONC(=O)OC(C)(C)C)CCC2] | 1.46 (ZMD) | 378 ([M + 1]+) 400 ([M + 23]+) |

LC-Method Used

Method U-LC
ACQUITY SQD Mass Spectrometer from Waters (Single quadrupole mass spectrometer)
Ionisation method: Electrospray
Polarity: positive ions
Capillary (kV) 3.80, Cone (V) 20.00, Extractor (V) 3.00, Source Temperature (° C.) 150, Desolvation Temperature (° C.) 400, Cone Gas Flow (L/Hr) 60, Desolvation Gas Flow (L/Hr) 700
Mass range: 100 to 800 Da
Column: Waters ACQUITY UPLC HSS T3; Column length: 30 mm; Internal diameter of column: 2.1 mm; Particle Size: 1.8 micron; Temperature: 60° C.
DAD Wavelength range (nm): 210 to 400

Solvent Gradient:
A=water/methanol 9:1, 0.1% HCOOH
B=Acetonitrile+0.1% HCOOH

| Time | A % | B % | Flow (mL/min) |
|---|---|---|---|
| 0 | 100.0 | 0.0 | 0.75 |
| 2.5 | 0.0 | 100.0 | 0.75 |
| 2.8 | 0.0 | 100.0 | 0.75 |
| 3.00 | 100.0 | 0.0 | 0.75 |

Method ZMD
ZMD Mass Spectrometer from Waters (Single quadrupole mass spectrometer)
Instrument Parameter:
Ionisation method: Electrospray
Polarity: positive ions
Capillary (kV) 3.80, Cone (V), Extractor (V) 3.00, Source Temperature (° C.) 150, Desolvation Temperature (° C.) 350, Cone Gas Flow (L/Hr) OFF, Desolvation Gas Flow (L/Hr) 600
Mass range: 100 to 900 Da
HP 1100 HPLC from Agilent: solvent degasser, binary pump, heated column compartment and diode-array detector.
Column: Phenomenex Gemini C18, 3 mm particle size, 110 Å 30×3 mm,
Temp: 60° C.
DAD Wavelength range (nm): 200 to 500

Solvent Gradient:
A=water+0.05% HCOOH
B=Acetonitrile/Methanol (4:1, v:v)+0.04% HCOOH

| Time | A % | B % | Flow (ml/min) |
|---|---|---|---|
| 0.00 | 95.0 | 5.0 | 1.700 |
| 2.00 | 0.0 | 100.0 | 1.700 |
| 2.80 | 0.0 | 100.0 | 1.700 |
| 2.90 | 95.0 | 5.0 | 1.700 |
| 3.00 | 95.0 | 5.0 | 1.700 |

Method ZCQ
ZQ Mass Spectrometer from Waters (Single quadrupole mass spectrometer)
Instrument Parameter:
Ionisation method: Electrospray
Polarity: positive ions
Capillary (kV) 3.00, Cone (V) 30.00, Extractor (V) 2.00, Source Temperature (° C.) 100, Desolvation Temperature (° C.) 250, Cone Gas Flow (L/Hr) 50, Desolvation Gas Flow (L/Hr) 400
Mass range: 100 to 900 Da
HP 1100 HPLC from Agilent: solvent degasser, quaternary pump (ZCQ)/binary pump (ZDQ), heated column compartment and diode-array detector.
Column: Phenomenex Gemini C18, 3 mm particle size, 110 Å, 30×3 mm, Temp: 60° C.
DAD Wavelength range (nm): 200 to 500

Solvent Gradient:
A=water+0.05% HCOOH
B=Acetonitrile/Methanol (4:1, v:v)+0.04% HCOOH

| Time | A % | B % | Flow (ml/min) |
|---|---|---|---|
| 0.00 | 95.0 | 5.0 | 1.700 |
| 2.00 | 0.0 | 100.0 | 1.700 |
| 2.80 | 0.0 | 100.0 | 1.700 |
| 2.90 | 95.0 | 5.0 | 1.700 |
| 3.00 | 95.0 | 5.0 | 1.700 |

### BIOLOGICAL EXAMPLES

### Phytophthora Infestans/Tomato/Leaf Disc Preventative (Late Blight)

Tomato leaf disks were placed on water agar in 24-well plates and sprayed with formulated test compound diluted in water at an application rate of 200 ppm. The leaf disks were inoculated with a spore suspension of the fungus 1 day after application. The inoculated leaf disks were incubated at 16° C. and 75% relative humidity under a light regime of 24 h darkness followed by 12/12 h (light/dark) darkness in a climate cabinet and the activity of a compound was assessed as percent disease control compared to untreated when an appropriate level of disease damage appears in untreated check leaf disks (5-7 days after application). The following compounds gave at least 80% control of Phytophthora infestans:

P.40, P.39, P.38, P.32, P.30, P.23, P.10, P.09, P.05, P.04, P.02, P.49, P.51.

Plasmopara Viticola/Grape/Leaf Disc Preventative (Late Blight):

Grape vine leaf disks were placed on water agar in 24-well plates and sprayed with formulated test compound diluted in water at an application rate of 200 ppm. The leaf disks were inoculated with a spore suspension of the fungus 1 day after application. The inoculated leaf disks were incubated at 19° C. and 80% relative humidity under a light regime of 12/12 h (light/dark) in a climate cabinet and the activity of a compound was assessed as percent disease control compared to untreated when an appropriate level of disease damage appears in untreated check leaf disks (6-8 days after application). The following compounds gave at least 80% control of Plasmopara viticola:

P.40, P.39, P.38, P.37, P.32, P.31, P.30, P.10.

Blumeria Graminis f. Sp. Tritici (Erysiphe Graminis f. Sp. Tritici)/Wheat/Leaf Disc Preventative (Powdery Mildew on Wheat):

Wheat leaf segments cv. Kanzler were placed on agar in a 24-well plate and sprayed with the formulated test compound diluted in water at an application rate of 200 ppm. The leaf disks were inoculated by shaking powdery mildew infected plants above the test plates 1 day after application. The inoculated leaf disks were incubated at 20° C. and 60% relative humidity under a light regime of 24 h darkness followed by 12 h/12 h (dark/light) in a climate chamber and the activity of a compound was assessed as percent disease control compared to untreated when an appropriate level of disease damage appears on untreated check leaf segments (6-8 days after application). The following compounds gave at least 80% control of Blumeria graminis:

P.41, P.40, P.39, P.38, P.37, P.32, P.31, P.30, P.28, P.27, P.25, P.24, P.23, P.14, P.13, P.10, P.09, P.05, P.07, P.08, P.04, P.03, P.20, P.02, P.42, P.44, P.45, P.46, P.47, P.48, P.49, P.50, P.51.

Puccinia Recondita f. Sp. Tritici/Wheat/Leaf Disc Preventative (Brown Rust):

Wheat leaf segments cultivated variety (cv) Kanzler were placed on agar in 24-well plates and sprayed with formulated test compound diluted in water at an application rate of 200 ppm. The leaf disks were inoculated with a spore suspension of the fungus 1 day after application. The inoculated leaf segments were incubated at 19° C. and 75% relative humidity under a light regime of 12/12 h (light/dark) in a climate cabinet and the activity of a compound was assessed as percent disease control compared to untreated when an appropriate level of disease damage appears in untreated check leaf segments (7-9 days after application). The following compounds gave at least 80% control of Puccinia recondita f. sp. tritici:

P.40, P.39, P.38, P.37, P.32, P.31, P.30, P.25, P.24, P.23, P.14, P.13, P11, P.10, P.09, P.05, P.07, P.04, P.03, P.20, P.02, P.42, P.44, P.45, P. 46, P.47, P.48, P.49, P.51.

Puccinia Recondita f. Sp. Tritici/Wheat/Leaf Disc Curative (Brown Rust):

Wheat leaf segments cv Kanzler were placed on agar in 24-well plates. The leaf segments were inoculated with a spore suspension of the fungus. The plates were stored in darkness at 19° C. and 75% relative humidity. The formulated test compound diluted in water was applied at an application rate of 200 ppm 1 day after inoculation. The leaf segments were incubated at 19° C. and 75% relative humidity under a light regime of 12/12 h (light/dark) in a climate cabinet and the activity of a compound is assessed as percent disease control compared to untreated when an appropriate level of disease damage appears in untreated check leaf segments (6-8 days after application). The following compounds gave at least 80% control of Puccinia recondita f. sp. tritici:

P.40, P.39, P.38, P.37, P.34, P.31, P.30, P.24, P.23, P.14, P.13, P11, P.10, P.09, P.05, P.07, P.04, P.03, P.20, P.02, P.42, P.44, P.45, P. 46, P.47, P.48.

Maanaporthe Grisea (Pyricularia oryzae)/Rice/Leaf Disc Preventative (Rice Blast)

Rice leaf segments cv. Ballila are placed on agar in a multiwell plate (24-well format) and sprayed with the formulated test compound diluted in water at an application rate of 200 ppm. The leaf segments are inoculated with a spore suspension of the fungus 2 days after application. The inoculated leaf segments are incubated at 22° C. and 80% rh under a light regime of 24 h darkness followed by 12 h light/12 h darkness in a climate cabinet and the activity of a compound is assessed as percent disease control compared to untreated when an appropriate level of disease damage appears in untreated check leaf segments (5-7 days after application). The following compounds gave at least 80% control of Magnaporthe grisea

P.40, P.39, P.38, P.37, P.34, P.32, P.30, P.42, P.44, P.45, P.46, P.48, P.49, P.51.

Phaeosphaeria Nodorum (Septoria nodorum)/Wheat/Leaf Disc Preventative (Glume Blotch):

Wheat leaf segments cv Kanzler were placed on agar in a 24-well plate and sprayed with formulated test compound diluted in water at an application rate of 200 ppm. The leaf disks are inoculated with a spore suspension of the fungus 2 days after application. The inoculated test leaf disks are incubated at 20° C. and 75% relative humidity under a light regime of 12/12 h (light/dark) in a climate cabinet and the activity of a compound is assessed as percent disease control compared to untreated when an appropriate level of disease damage appears in untreated check leaf disks (5-7 days after application). The following compounds gave at least 80% control of Phaeosphaeria nodorum:

P.41, P.40, P.39, P.38, P.37, P.34, P.33 P.32, P.31, P.30, P.28, P.27, P.25, P.24, P.23, P.14, P.22, P.13, P11, P.10, P.09, P.05, P.07, P.04, P.03, P.20, P.02, P.42, P.44, P.45, P.46, P.47, P.48, P.49, P.50, P.51.

Pyrenophora Teres/Barley/Leaf Disc Preventative (Net Blotch):

Barley leaf segments cv Hasso are placed on agar in a 24-well plate and sprayed with formulated test compound diluted in water at an application rate of 200 ppm. The leaf segments are inoculated with a spore suspension of the fungus two days after application of the test solution. The inoculated leaf segments are incubated at 20° C. and 65% relative humidity under a light regime of 12/12 h (light/dark) in a climate cabinet and the activity of a compound is assessed as disease control compared to untreated when an appropriate level of disease damage appears in untreated check leaf segments (5-7 days after application). The following compounds gave at least 80% control of Pyrenophora teres:

P.41, P.40, P.39, P.38, P.37, P.34, P.32, P.31, P.30, P.28, P.27, P.25, P.24, P.23, P.13, P11, P.10, P.09, P.05, P.07, P.04, P.03, P.20, P.02, P.42, P.44, P.45, P.46, P.47, P.48, P.50, P.51.

Alternaria Solani/Tomato/Leaf Disc (Early Blight):

Tomato leaf disks cv. Baby are placed on agar in multiwell plates (24-well format) and sprayed with the formulated test compound diluted in water at an application rate of 200 ppm. The leaf disks are inoculated with a spore suspension of the fungus 2 days after application. The inoculated leaf disks are incubated at 23° C./21° C. (day/night) and 80% rh under a light regime of 12/12 h (light/dark) in a climate cabinet and the activity of a compound is assessed as percent disease control compared to untreated when an appropriate level of disease damage appears on untreated check disk leaf disks (5-7 days after application). The following compounds gave at least 80% control of Alternaria solani

P.40, P.39, P.38, P.37, P.31, P.30, P.10, P.09, P.05, P.07, P.20

Pythium Ultimum/Liquid Culture (Seedling Damping Off):

Mycelia fragments and oospores of a newly grown liquid culture of the fungus were directly mixed into nutrient broth (PDB potato dextrose broth). After placing a DMSO solution of test compound into a 96 well microtiter plate at an application rate 200 ppm, the nutrient broth containing the fungal mycelia/spore mixture was added. The test plates were incubated at 24° C. and the inhibition of growth was determined photometrically 2-3 days after application. The following compounds gave at least 80% control of Pythium ultimum:

P.40, P.39, P.38, P.37, P.31, P.30, P.24, P.23, P.14, P.10, P.09, P.05, P.07, P.20, P.03, P.02, P.42, P.44, P.46, P.48, P.51.

Botryotinia Fuckeliana (Botrytis cinerea)/Liquid Culture (Gray Mould):

Conidia of the fungus from cryogenic storage were directly mixed into nutrient broth (Vogels broth). After placing a DMSO solution of test compound into a 96-well microtiter plate at an application rate 200 ppm, the nutrient broth containing the fungal spores was added. The test plates were incubated at 24° C. and the inhibition of growth was determined photometrically 3-4 days after application. The following compounds gave at least 80% control of Botryotinia fuckeliana:

P.41, P.40, P.39, P.38, P.37, P.36, P.34, P.32, P.31, P.30, P.28, P.27, P.25, P.24, P.14, P.22, P.13, P.12, P.10, P.09, P.05, P.07, P.08, P.04, P.03, P.20, P.01, P.02, P.42, P.43, P.44, P.45, P. 46, P.47, P.48, P.49, P.50, P.51.

Glomerella Lagenarium (Colletotrichum lagenarium)/Liquid Culture (Anthracnose):

Conidia of the fungus from cryogenic storage were directly mixed into nutrient broth (PDB potato dextrose broth). After placing a DMSO solution of test compound into a 96-well microtiter plate at an application rate ≦200 ppm, the nutrient broth containing the fungal spores was added. The test plates were incubated at 24° C. and the inhibition of growth is measured photometrically 3-4 days after application. The following compounds gave at least 80% control of Glomerella lagenarium:

P.40, P.39, P.38, P.37, P.34, P.31, P.30, P.28, P.27, P.25, P.24, P.23, P.14, P.22, P.13, P.12, P.10, P.09, P.05, P.07, P.04, P.20, P.01, P.02, P.42, P.45, P.46, P.47, P.48, P.49, P.50, P.51.

Mycosphaerella Arachidis (Cercospora arachidicola)/Liquid Culture (Early Leaf Spot):

Conidia of the fungus from cryogenic storage were directly mixed into nutrient broth (PDB potato dextrose broth). After placing a DMSO solution of test compound into a 96-well microtiter plate at an application rate ≦200 ppm, the nutrient broth containing the fungal spores was added. The test plates are incubated at 24° C. and the inhibition of growth was determined photometrically 4-5 days after application. The following compounds gave at least 80% control of Mycosphaerella arachidis:

P.41, P.40, P.39, P.38, P.37, P.36, P.31, P.30, P.28, P.27, P.25, P.23, P.14, P.22, P.13, P.12, P.10, P.09, P.05, P.07, P.08, P.04, P.20, P.03, P.01, P.02, P.49, P.50, P.51.

Mycosphaerella graminicola (Septoria tritici)/Liquid Culture (Septoria Blotch):

Conidia of the fungus from cryogenic storage were directly mixed into nutrient broth (PDB potato dextrose broth). After placing a DMSO solution of test compound into a 96-well microtiter plate at an application rate ≦200 ppm, the nutrient broth containing the fungal spores was added. The test plates were incubated at 24° C. and the inhibition of growth was determined photometrically 4-5 days after application. The following compounds gave at least 80% control of Mycosphaerella graminicola:

P.41, P.40, P.39, P.38, P.37, P.36, P.34, P.32, P.31, P.30, P.28, P.27, P.25, P.24, P.23, P.14, P.22, P.13, P.12, P.10, P.09, P.05, P.07, P.04, P.20, P.03, P.02, P.42, P.43, P.44, P.45, P.46, P.47, P.48, P.49, P.50, P.51.

Gaeumannomyces Graminis/Liquid Culture (Take-all of Cereals):

Mycelial fragments of the fungus from cryogenic storage were directly mixed into nutrient broth (PDB potato dextrose broth). After placing a DMSO solution of test compound at an application rate ≦200 ppm into a 96-well microtiter plate at an application rate of 200 ppm, the nutrient broth containing the fungal spores is added. The test plates were incubated at 24° C. and the inhibition of growth was determined photometrically 4-5 days after application. The following compounds gave at least 80% control of Gaeumannomyces graminis:

P.40, P.39, P.38, P.37, P.36, P.34, P.31, P.30, P.28, P.27, P.25, P.24, P.23, P.14, P.22, P.13, P.12, P.10, P.09, P.05, P.07, P.04, P.03, P.20, P.02, P.42,P.43, P.44, P.45, P. 46, P.47, P.48.

Monographella nivalis (Microdochium nivale)/Liquid Culture (Foot Rot Cereals):

Conidia of the fungus from cryogenic storage were directly mixed into nutrient broth (PDB potato dextrose broth). After placing a DMSO solution of test compound into a 96-well microtiter plate at an application rate ≦200 ppm, the nutrient broth containing the fungal spores was added. The test plates were incubated at 24° C. and the inhibition of growth was determined photometrically 4-5 days after application. The following compounds gave at least 80% control of Monographella nivalis:

P.31, P.30, P.23, P.14, P.22, P.13, P.12, P.17, P.10, P.09, P.05, P.20, P.01, P.02, P.42, P.46, P.48, P.51.

Thanatephorus Cucumeris (Rhizoctonia solani)/Liquid Culture (Foot Rot, Damping-Off):

Mycelia fragments of a newly grown liquid culture of the fungus are directly mixed into nutrient broth (PDB potato dextrose broth). After placing a DMSO solution of the test compounds into a 96-well microtiter plate at an application rate 200 ppm, the nutrient broth containing the fungal material was added. The test plates were incubated at 24° C. and the inhibition of growth was determined photometrically 3-4 days after application. The following compounds gave at least 80% control of Thanatephorus cucumeris:

P.41, P.40, P.39, P.38, P.37, P.31, P.30, P.13, P.12, P.20, P.02, P.49, P.50, P.51.

Sclerotinia Sclerotiorum/Liquid Culture (Cottony Rot)

Mycelia fragments of a newly grown liquid culture of the fungus are directly mixed into nutrient broth (PDB potato dextrose broth). After placing a (DMSO) solution of test compound into a microtiter plate at an application rate 200 ppm (96-well format) the nutrient broth containing the fungal material is added. The test plates are incubated at 24° C. and the inhibition of growth is determined photometrically 3-4 days after application. The following compounds gave at least 80% control of Sclerotinia sclerotiorum

P.40, P.39, P.38, P.37, P.44, P.46, P.49, P.51.

1. A compound of formula (I) 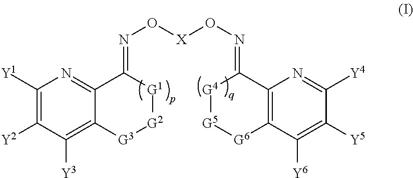
wherein
X represents X-2, X-3, X-4 or X-5: 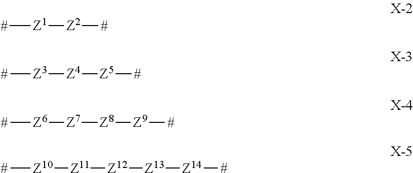
Z¹, Z², Z³, Z⁵, Z⁶, Z⁷, Z⁸, Z⁹, Z¹⁰, Z¹¹, Z¹³ and Z¹⁴ independently of one another represent CR¹R², C═CR³R⁴ or C═O;
Z⁴ and Z¹² independently of one another represent C═CR³R⁴, CR⁵R⁶, SiR⁷R⁸ or C═O;
each R¹ and R² independently of one another represent hydrogen, halogen, OH, C₁-C₄ alkyl, C₁-C₄ haloalkyl, C₃-C₆ cycloalkyl, C₃-C₆ halocycloalkyl, C₁-C₄ alkylthio, C₁-C₄ alkylsulphinyl, C₁-C₄ alkylsulphonyl, phenyl or CN, wherein the phenyl is optionally substituted by one or more groups independently selected from halogen, CN, C₁-C₄ alkyl, C₁-C₄ haloalkyl, C₁-C₄ alkoxy and C₁-C₄ haloalkoxy;
or R¹ and R² together with the carbon atom to which they are attached may form a C₃-C₆ cycloalkyl group or a C₃-C₆ halocycloalkyl group;
each R³ and R⁴ independently of one another represent hydrogen, halogen, C₁-C₄ alkyl or C₁-C₄ haloalkyl;
each R⁵, R⁶, R⁷ and R⁸ independently of one another represent hydrogen, halogen, OH, C₁-C₄ alkyl, C₁-C₄ haloalkyl, C₃-C₆ cycloalkyl, C₃-C₆ halocycloalkyl, phenyl or CN, wherein phenyl is optionally substituted by one or more groups independently selected from halogen, CN, C₁-C₄ alkyl, C₁-C₄ haloalkyl, C₁-C₄ alkoxy and C₁-C₄ haloalkoxy;
or R⁵ and R⁶ together with the carbon atom to which they are attached may form a C₃-C₆ cycloalkyl group or a C₃-C₆ halocycloalkyl group;
wherein the groupings X-2, X-3, X-4 and X-5 may contain at most one ring which contains either only one of the radicals Z¹ to Z¹⁴ or two radicals Z¹ to Z¹⁴ or three radicals Z¹ to Z¹⁴ or four radicals Z¹ to Z¹⁴ as ring members; and wherein radicals Z¹, Z², Z³, Z⁵, Z⁶, Z⁹, Z¹⁰ and Z¹⁴ are not substituted by OH;
Y¹, Y², Y³, Y⁴, Y⁵ and Y⁶ independently of one another represent hydrogen, halogen, CN, NO₂, C₁-C₈ alkyl, C₁-C₄-alkoxy-C₁-C₄-alkyl, C₁-C₄-alkoxy-C₁-C₄-alkoxy-C₁-C₄-alkyl, C₃-C₈ cycloalkyl, C₂-C₈ alkenyl, C₂-C₈ alkynyl, phenyl, pyridyl, pyrimidinyl, COR⁹, OR¹⁰, SH, C₁-C₈ alkylthio, C₁-C₈ alkylsulphinyl, C₁-C₈ alkylsulphonyl, N(R¹¹)₂, CO₂R¹⁰, O(CO)R⁹, CON(R¹¹)₂, NR¹¹COR⁹ or CR⁹N—OR¹⁰, wherein the alkyl, cycloalkyl, alkenyl, alkynyl, phenyl, pyrimidinyl and pyridyl are optionally substituted by one or more groups independently selected from halogen, CN, NH₂, NO₂, OH, C₁-C₄ alkyl, C₁-C₄ haloalkyl, C₁-C₄ alkoxy, C₁-C₄ haloalkoxy, C₁-C₄ alkylthio, C₁-C₄ alkylsulphinyl and C₁-C₄ alkylsulphonyl;
or independently Y¹ and Y², Y² and Y³, Y⁴ and Y⁵, Y⁵ and Y⁶ together with the fragment of the pyridyl ring to which they are attached may form a partially or fully unsaturated 5- to 7-membered carbocyclic ring or a 5- to 7-membered heterocyclic ring containing one to three heteroatoms independently selected from O, S, N and N(R¹¹), providing that the heterocycle does not contain adjacent oxygen atoms, adjacent sulphur atoms, or adjacent sulphur and oxygen atoms, and wherein the ring formed by Y¹ and Y², Y² and Y³, Y⁴ and Y⁵, Y⁵ and Y⁶ is optionally substituted by one or more groups independently selected from halogen, CN, NH₂, NO₂, OH, C₁-C₄ alkyl, C₁-C₄ haloalkyl, C₁-C₄ alkoxy and 1-C₄ haloalkoxy;
each R⁹ independently of one another represents hydrogen, C₁-C₈ alkyl, C₃-C₈ cycloalkyl, C₂-C₈ alkenyl, C₂-C₈ alkynyl, benzyl, phenyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄ haloalkyl, C₁-C₄ alkoxy and 1-C₄ haloalkoxy;
each R¹⁰ independently of one another represents hydrogen, C₁-C₈ alkyl, C₃-C₈ cycloalkyl, C₃-C₈ alkenyl, C₃-C₈ alkynyl, benzyl, phenyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄-haloalkyl, C₁-C₄ alkoxy, C₁-C₄ haloalkoxy and C₁-C₄-alkoxy-C₁-C₄-alkyl;
each R¹¹ independently of one another represents hydrogen, OH, C₁-C₈ alkyl, C₁-C₈ alkoxy, C₁-C₈-alkoxy-C₁-C₄-alkyl, C₃-C₈ alkenyl, C₃-C₈ alkynyl, or COR⁹, wherein the alkyl, alkoxy, alkenyl and alkynyl are optionally substituted by one or more halogen;
wherein when two radicals R¹¹ are attached to the same nitrogen atom, these radicals can be identical or different;
wherein when two radicals R¹¹ are attached to the same nitrogen atom, both of these radicals cannot be OH, C₁-C₄ alkoxy or C₁-C₄ haloalkoxy;
and wherein when two radicals R¹¹ are attached to the same nitrogen atom, these two radicals together with the nitrogen atom to which they are attached may form a cycle B-1, B-2, B-3, B-4, B-5, B-6, B-7 or B-8: 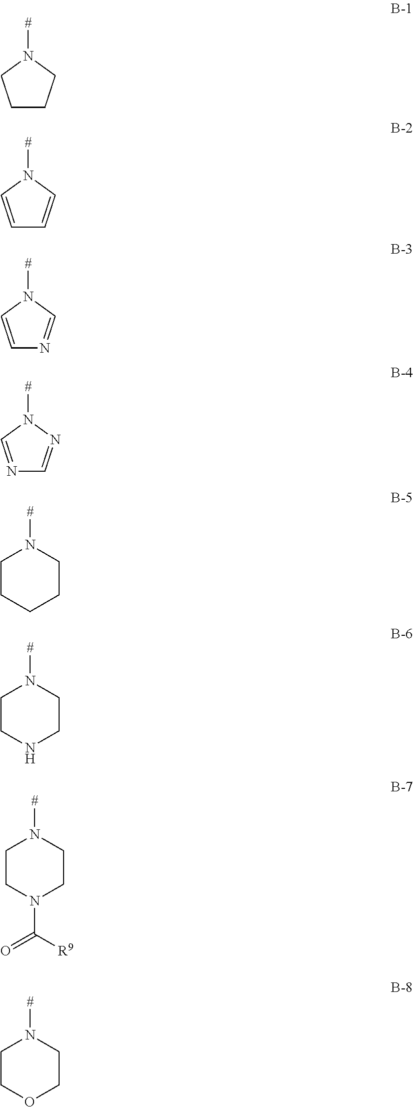
wherein the cycle formed is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;
G¹, G², G⁴ and G⁵ independently of one another represent —C(R¹²R¹³)—;
G³ and G⁶ independently of one another represent —C(R¹²R¹³)—, O, N(R¹⁴) or S;
or G¹ and G², or G² and G³, or G¹ and G¹, or G⁴ and G⁵, or G⁵ and G⁶, or G⁴ and G⁴ together represent —CR¹²═CR¹³—;
each R¹² and R¹³ independently of one another represent hydrogen, halogen, C₁-C₄ alkyl, C₁-C₄ haloalkyl, C₁-C₄ alkoxy or C₁-C₄ haloalkoxy;
R¹⁴ represents hydrogen, OH, C₁-C₄ alkyl, C₁-C₄ alkoxy, C₃-C₆ cycloalkyl, C₁-C₈ alkylcarbonyl or C₁-C₈ haloalkylcarbonyl; and
p and q are each independently 0, 1 or 2;
or a salt or an N-oxide thereof.

2. A compound according to claim 1, wherein G¹, G², G³, G⁴, G⁵ and G⁶ represent methylene.

3. A compound according to claim 1, wherein p and q are independently of one another 1 or 2.

4. A compound according to claim 1, wherein p and q are 1.

5. A compound according to claim 1, wherein X represents X-3 or X-5.

6. A compound according to claim 1, wherein X represents X-3.

7. A compound according to claim 1, wherein
X represents X-3;
Z³ and Z⁵ represent methylene;
Z⁴ represents C═CR³R⁴, CR⁵R⁶ or SiR⁷R⁸;
R³ and R⁴ independently of one another represent hydrogen, halogen, methyl or halomethyl;
R⁵, R⁶, R⁷ and R⁸ independently of one another represent hydrogen, halogen, OH, C₁-C₄ alkyl, C₁-C₄ haloalkyl or phenyl, wherein the phenyl is optionally substituted by one or more groups independently selected from halogen, CN, methyl, halomethyl, methoxy and halomethoxy;
or R⁵ and R⁶ together with the carbon atom to which they are attached may form a C₃-C₆ cycloalkyl group optionally substituted by halogen.

8. A compound according to claim 1, wherein
Y¹, Y², Y³, Y⁴, Y⁵ and Y⁶ independently of one another represent hydrogen, halogen, N(R¹¹)₂, CN, NO₂, C₁-C₈ alkyl, C₁-C₆-alkoxy-C₁-C₄-alkyl, C₃-C₈ cycloalkyl, C₂-C₆ alkenyl, C₂-C₆ alkynyl, phenyl, pyridyl, OR¹⁰, SH, C₁-C₈ alkylthio, C₁-C₈ alkylsulphinyl or C₁-C₈ alkylsulphonyl, wherein the alkyl, cycloalkyl, alkenyl, alkynyl, phenyl and pyridyl are optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;
or independently Y¹ and Y², Y² and Y³, Y⁴ and Y⁵, Y⁵ and Y⁶ together with the fragment of the pyridyl ring to which they are attached may form a partially or fully unsaturated 5- to 7-membered carbocyclic ring, wherein the ring formed by Y¹ and Y², Y² and Y³, Y⁴ and Y⁵, or Y⁵ and Y⁶ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;
wherein each R¹⁰ independently of one another represent hydrogen, C₁-C₄ alkyl, C₃-C₆ cycloalkyl, C₃-C₆ alkenyl, C₃-C₆ alkynyl, benzyl, phenyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄-haloalkyl, C₁-C₄ alkoxy, C₁-C₄ haloalkoxy and C₁-C₄-alkoxy-C₁-C₄-alkyl;
each R¹¹ independently of one another represent hydrogen or C₁-C₈ alkyl, wherein the alkyl, is optionally substituted by one or more halogen;
wherein when two radicals R¹¹ are attached to the same nitrogen atom, these radicals can be identical or different;
and wherein when two radicals R¹¹ are attached to the same nitrogen atom, these two radicals together with the nitrogen atom to which they are attached may form a cycle B-1, B-2, B-3, B-4 or B-5 wherein the cycle formed is optionally substituted by one or more groups independently selected from halogen, methyl and halomethyl.

9. A compound according to claim 1, wherein
Y¹, Y³, Y⁴, and Y⁶ independently of one another represent hydrogen, halogen, N(R¹¹)₂, CN, NO₂, C₁-C₆ alkyl, C₁-C₄-alkoxy-C₁-C₄-alkyl, C₃-C₆ cycloalkyl, C₂-C₆ alkenyl, C₂-C₆ alkynyl, phenyl, pyridyl, C₁-C₄-alkoxy, C₁-C₄-alkenoxy, C₁-C₄-alkynoxy, phenoxy, SH, C₁-C₈ alkylthio, C₁-C₈ alkylsulphinyl or C₁-C₈ alkylsulphonyl, wherein the alkyl, cycloalkyl, alkenyl, alkynyl, phenyl and pyridyl are optionally substituted by one or more groups independently selected from halogen, CN, NH₂, NO₂, OH, methyl, methoxy and halomethyl;
Y² and Y⁵ independently of one another represent hydrogen, halogen, C₁-C₄ alkyl, or C₁-C₄ haloalkyl;
or independently Y¹ and Y², Y⁴ and Y⁵ together with the fragment of the pyridyl ring to which they are attached may form a partially or fully unsaturated 6-membered carbocyclic ring wherein the ring formed by Y¹ and Y², or Y⁴ and Y⁵ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;
wherein each R¹¹ independently of one another represent hydrogen or C₁-C₈ alkyl, wherein the alkyl, is optionally substituted by one or more halogen;
wherein when two radicals R¹¹ are attached to the same nitrogen atom, these radicals can be identical or different;
and wherein when two radicals R¹¹ are attached to the same nitrogen atom, these two radicals together with the nitrogen atom to which they are attached may form a cycle B-1, B-2, B-3, B-4 or B-5 wherein the cycle formed is optionally substituted by one or more groups independently selected from halogen, methyl and halomethyl.

10. A compound according to claim 1, wherein
X represents X-3;
Z³ and Z⁵ represent methylene;
Z⁴ represents C═CR³R⁴, CR⁵R⁶ or SiR⁷R⁸;
R³ and R⁴ independently of one another represent hydrogen, halogen, methyl or halomethyl;
R⁵, R⁶, R⁷ and R⁸ independently of one another represent hydrogen, halogen, OH, C₁-C₄ alkyl, C₁-C₄ haloalkyl or phenyl, wherein the phenyl is optionally substituted by one or more groups independently selected from halogen, CN, methyl, halomethyl, methoxy and halomethoxy;
or R⁵ and R⁶ together with the carbon atom to which they are attached may form a C₃-C₆ cycloalkyl group optionally substituted by halogen;
Y¹, Y², Y³, Y⁴, Y⁵ and Y⁶ independently of one another represent hydrogen, halogen, N(R¹¹)₂, CN, NO₂, C₁-C₆ alkyl, C₁-C₄-alkoxy-C₁-C₄-alkyl, C₃-C₆ cycloalkyl, C₂-C₆ alkenyl, C₂-C₆ alkynyl, phenyl, pyridyl, C₁-C₄-alkoxy, C₁-C₄-alkenoxy, C₁-C₄-alkynoxy, phenoxy, SH, C₁-C₈ alkylthio, C₁-C₈ alkylsulphinyl or C₁-C₈ alkylsulphonyl, wherein the alkyl, cycloalkyl, alkenyl, alkynyl, phenyl and pyridyl are optionally substituted by one or more groups independently selected from halogen, CN, NH₂, NO₂, OH, methyl and halomethyl;
or independently Y¹ and Y², Y² and Y³, Y⁴ and Y⁵, Y⁵ and Y⁶ together with the fragment of the pyridyl ring to which they are attached may form a partially or fully unsaturated 5- to 7-membered carbocyclic ring, wherein the ring formed by Y¹ and Y², Y² and Y³, Y⁴ and Y⁵, Y⁵ and Y⁶ is optionally substituted by one or more groups independently selected from halogen, CN, NH₂, NO₂, OH, methyl and halomethyl;
each R¹¹ independently of one another represent hydrogen or C₁-C₈ alkyl, wherein the alkyl, is optionally substituted by one or more halogen;
wherein when two radicals R¹¹ are attached to the same nitrogen atom, these radicals can be identical or different;
and wherein when or two radicals R¹¹ are attached to the same nitrogen atom, these two radicals together with the nitrogen atom to which they are attached may form a cycle B-1, B-2, B-3, B-4 or B-5 wherein the cycle formed is optionally substituted by one or more groups independently selected from halogen, methyl and halomethyl;
G¹, G², G³ G⁴, G⁵ and G⁶ represent methylene; and
p and q are 1.

11. A compound according to claim 1, wherein Y¹ represents the same substituent as Y⁴, Y² represents the same substituent as Y⁵, and Y³ represents the same substituent as Y⁶, and wherein p is the same as q and are either 1 or 2, and wherein G¹ represents the same substituent as G⁴, G² represents the same substituent as G⁵ and G³ represents the same substituent as G⁶.

12. A compound according to claim 1, wherein Y¹ represents the same substituent as Y⁴, Y² represents the same substituent as Y⁵, and Y³ represents the same substituent as Y⁶, and wherein p is the same as q and are either 1 or 2, and wherein G¹ represents the same substituent as G⁴, G² represents the same substituent as G⁵ and G³ represents the same substituent as G⁶, and wherein X is either X-3 or X-5 and wherein Z³ represents the same substituent as Z⁵, Z¹¹ represents the same substituent as Z¹³ and Z¹⁰ represents the same substituent as Z¹⁴.

13. A process for the production of a compound of formula (I) as defined in claim 1 comprising reacting a compound of formula (IIb) with a compound of formula (V) as shown in scheme A 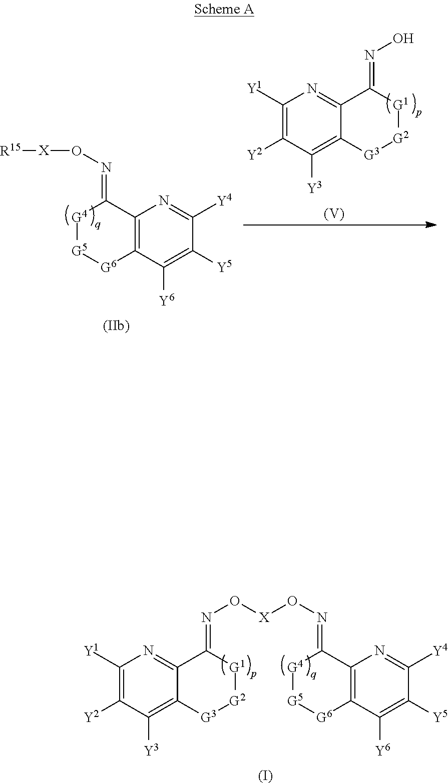
wherein R¹⁵ represents halogen, —O—SO₂—R¹⁶ or trichloroacetimidate;
R¹⁶ represents C₁-C₄-alkyl, C₁-C₄-haloalkyl or phenyl, wherein the phenyl is optionally substituted by one or two substituents independently selected from methyl, trihalomethyl, NO₂, CN, C₁-C₇-alkoxycarbonyl;
and X, G¹, G², G³, G⁴, G⁵, G⁶, Y¹, Y², Y³, Y⁴, Y⁵, Y⁶, p, and q are as defined for the compound of formula (I) in claim 1; or
a process for the production of a compound of formula (I) comprising reacting a compound of formula (VIa) with a compound of formula (VIIa) to produce a compound of formula (IIa) and reacting the compound of formula (IIa) with a compound of formula (VIIIa) as shown in scheme B 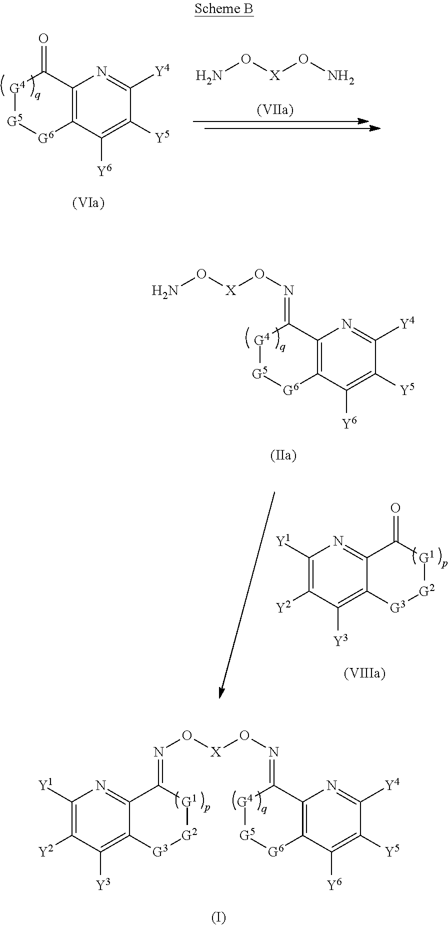
wherein X, G¹, G², G³, G⁴, G⁵, G⁶, Y¹, Y², Y³, Y⁴, Y⁵, Y⁶, p, and q are as defined for the compound of formula (I) in claim 1; or
a process for the production of a compound of formula (I) comprising reacting a compound of formula (VIa) with a compound of formula (VIIIa) and a compound of formula (VIIa) as shown in scheme C 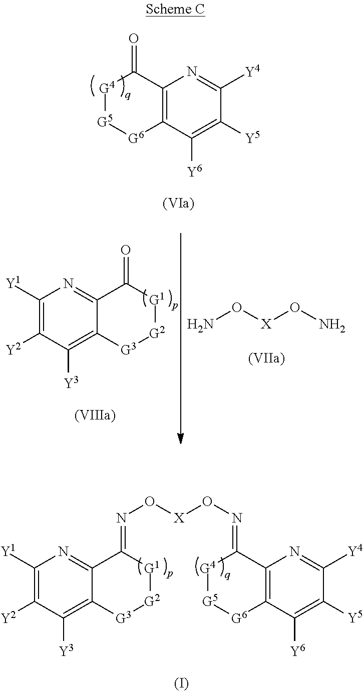
wherein X, G¹, G², G³, G⁴, G⁵, G⁶, Y¹, Y², Y³, Y⁴, Y⁵, Y⁶, p, and q are as defined for the compound of formula (I) in claim 1.

14. A fungicidal composition comprising a fungicidally effective amount of a compound of formula (I) as defined in claim 1, optionally comprising an additional active ingredient.

15. A method of controlling or preventing phytopathogenic diseases on useful plants or on propagation material thereof, which comprises applying to the useful plants, the locus thereof or propagation material thereof a fungicidally effective amount of a compound of formula (I) as defined in claim.
